(19) United States
(12) Patent Application Publication
(10) Pub. No.: US 2019/0245883 A1
(43) Pub. Date: Aug. 8, 2019

(54) PENETRATION TESTING OF A NETWORKED SYSTEM

(71) Applicant: XM CYBER LTD., Hertsliya (IL)

(72) Inventors: Boaz GORODISSKY, Hod-Hasharon (IL); Adi ASHKENAZY, Tel Aviv (IL); Ronen SEGAL, Hertzelia (IL); Menahem LASSER, Kohav-Yair (IL)

(21) Appl. No.: 16/258,702

(22) Filed: Jan. 28, 2019

Related U.S. Application Data
(63) Continuation-in-part of application No. 15/681,782, filed on Aug. 21, 2017.
Application No. 15/681,782 is a continuation-in-part of application No. 15/874,429, filed on Jan. 18, 2018.
Application No. 15/874,429 is a continuation-in-part of application No. 15/940,376, filed on Mar. 29, 2018.
Application No. 15/940,376 is a continuation-in-part of application No. 15/911,168, filed on Mar. 4, 2018, now Pat. No. 10,038,711.
Application No. 15/911,168 is a continuation of application No. 15/874,429, filed on Jan. 18, 2018.
Application No. 15/940,376 is a continuation-in-part of application No. 15/874,429, filed on Jan. 18, 2018.
Application No. 15/874,429 is a continuation-in-part of application No. 15/983,309, filed on May 18, 2018, now Pat. No. 10,257,220.
Application No. 15/983,309 is a continuation of application No. PCT/IB2018/053298, filed on May 11, 2018.
Application No. 15/983,309 is a continuation-in-part of application No. 15/911,168, filed on Mar. 4, 2018, now Pat. No. 10,038,711.
Application No. 15/911,168 is a continuation-in-part of application No. 16/186,557, filed on Nov. 11, 2018.
(60) Provisional application No. 62/451,850, filed on Jan. 30, 2017.
(60) Provisional application No. 62/453,056, filed on Feb. 1, 2017.
(60) Provisional application No. 62/451,850, filed on Jan. 30, 2017.
(60) Provisional application No. 62/482,535, filed on Apr. 6, 2017.
(60) Provisional application No. 62/510,794, filed on May 25, 2017.
(60) Provisional application No. 62/510,794, filed on May 25, 2017.
(60) Provisional application No. 62/586,600, filed on Nov. 15, 2017.

(51) Int. Cl. H04L 29/06; H04L 12/26

(52) U.S. Cl. CPC H04L 63/1433; H04L 41/048; H04L 43/50; H04L 63/30

(57) ABSTRACT

Methods and systems for penetration testing of a networked system by a penetration testing system that is user-interface controlled, so that a penetration testing campaign is executed according to manually and explicitly-selected capabilities of an attacker of the campaign. The testing includes receiving manually-entered inputs explicitly selecting one or more capabilities of the attacker of the penetration testing campaign, executing the penetration testing according to the selected capabilities of the attacker, and reporting at least one security vulnerability determined to exist in the networked system.

### CROSS-REFERENCE TO RELATED APPLICATIONS

This patent application is a continuation-in-part of U.S. patent application Ser. No. 15/681,782 filed on Aug. 21, 2017 and entitled “Setting-up penetration testing campaigns” which claims the benefit of U.S. Provisional Patent Application No. 62/453,056 filed on Feb. 1, 2017 and the benefit of U.S. Provisional Patent Application No. 62/451,850 filed on Jan. 30, 2017. application Ser. Nos. 15/681,782, 62/453,056 and 62/451,850 are all incorporated herein by reference in their entirety.

This patent application is also a continuation-in-part of U.S. patent application Ser. No. 15/874,429 filed on Jan. 18, 2018 and entitled “Penetration testing of a networked system,” which claims the benefit of U.S. Provisional Patent Application No. 62/451,850 filed on Jan. 30, 2017. application Ser. Nos. 15/874,429 and 62/451,850 are both incorporated herein by reference in their entirety.

The present application is also a continuation-in-part of U.S. patent application Ser. No. 15/940,376 filed on Mar. 29, 2018 and entitled “Systems and methods for detecting computer vulnerabilities that are triggered by events,” which (i) claims the benefit of U.S. Provisional Patent Application 62/482,535 filed on Apr. 6, 2017; (ii) is a Continuation In Part of U.S. patent application Ser. No. 15/911,168 filed on Mar. 4, 2018, which is a continuation of U.S. patent application Ser. No. 15/874,429 filed on Jan. 18, 2018, which claims the benefit of U.S. Provisional Patent Application No. 62/451,850 filed on Jan. 30, 2017, both Ser. Nos. 15/911,168 and 15/874,429 being entitled “Penetration Testing of a Networked System”; and (iii) is a Continuation In Part of the aforementioned U.S. patent application Ser. No. 15/874,429. Aforementioned U.S. patent application Ser. No. 15/911,168 was issued as U.S. Pat. No. 10,038,711 on Jul. 31, 2018. The aforementioned U.S. patent applications Ser. Nos. 15/940,376, 15/911,168, 15/874,429, 62/482,535 and 62/451,850 are all incorporated herein by reference in their entirety.

This patent application is also a continuation-in-part of U.S. patent application Ser. No. 15/983,309 filed on May 18, 2018 and entitled “Verifying success of compromising a network node during penetration testing of a networked system,” which claims the benefit of U.S. Provisional Patent Application No. 62/510,794 filed on May 25, 2017. patent application Ser. No. 15/983,309 is a continuation in part of U.S. patent application Ser. No. 15/911,168 filed on Mar. 4, 2018, which is a continuation of U.S. patent application Ser. No. 15/874,429 filed on Jan. 18, 2018, which claims the benefit of U.S. Provisional Patent Application No. 62/451,850 filed on Jan. 30, 2017. patent application Ser. No. 15/983,309 is also a continuation of PCT/IB2018/053298 filed on May 11, 2018, which claims the benefit of U.S. Provisional Patent Application No. 62/510,794 filed on May 25, 2017. The aforementioned patent applications Ser. Nos. 15/983,309, 62/510,794, 15/911,168, 15/874,429, 62/451,850 and PCT/IB2018/053298 are all incorporated herein by reference in their entirety.

This patent application is also a continuation-in-part of U.S. patent application Ser. No. 16/186,557 filed on Nov. 11, 2018 and entitled “Selectively choosing between actual-attack and simulation/evaluation for validating a vulnerability of a network node during execution of a penetration testing campaign”, which claims the benefit of U.S. Provisional Patent Application No. 62/586,600 filed on Nov. 15, 2017. applications Ser. Nos. 16/186,557 and 62/586,600 are both incorporated herein by reference in their entirety.

### BACKGROUND

There is currently a proliferation of organizational networked systems. Every type of organization, be it a commercial company, a university, a bank, a government agency or a hospital, heavily relies on one or more networks interconnecting multiple computing nodes. Failures of the networked system of an organization or even of only a portion of it might cause a significant damage, up to completely shutting down all operations. Additionally, much of the data of the organization (and for some organizations even all data) exists somewhere on its networked system, including all confidential data comprising its “crown jewels” such as prices, details of customers, purchase orders, employees' salaries, technical formulas, etc. Loss of such data or leaks of such data to outside unauthorized entities might be disastrous for the organization.

Many organizational networks are connected to the Internet at least through one network node, and consequently they are subject to attacks by computer hackers or by hostile adversaries. Even an organizational network that is not connected to the Internet might be attacked by an employee of the organization. Quite often the newspapers are reporting incidents in which websites crashed, sensitive data was stolen or service to customers was denied, where the failures were the results of hostile penetration into an organization's networked system.

Thus, many organizations invest a lot of efforts and costs in preventive means designed to protect their networked systems against potential threats. There are many defensive products offered in the market claiming to provide protection against one or more known modes of attack, and many organizations arm themselves to the teeth with multiple products of this kind.

However, it is difficult to tell how effective such products really are in achieving their stated goals of blocking hostile attacks, and consequently most CISO's (Computer Information Security Officers) will admit (maybe only off the record), that they don't really know how well they can withstand an attack from a given adversary. The only way to really know how strong and secure a networked system is, is by trying to attack it as a real adversary would. This is known as penetration testing (pen testing, in short), and is a very common approach that is even required by regulation in some developed countries.

Penetration testing requires highly talented people to man the testing team. Those people should be familiar with each and every known security vulnerability and attacking method and should also have a very good familiarity with networking techniques and multiple operating systems implementations. Such people are hard to find and therefore many organizations give up establishing their own penetration testing teams and resort to hiring external expert consultants for carrying out that role (or completely give up penetration testing). But external consultants are expensive and therefore are typically called in only for brief periods separated by long time intervals in which no such testing is done. This makes the penetration testing ineffective as security vulnerabilities caused by new forms of attacks that appear almost daily are discovered only months after becoming serious threats to the organization.

Additionally, even rich organizations that can afford hiring talented experts for in-house penetration testing teams do not achieve good protection. Testing for security vulnerabilities of a large networked system containing many types of computers, operating systems, network routers and other devices is both a very complex and a very tedious process. The process is prone to human errors of missing testing for certain threats or misinterpreting the damages of certain attacks. Also, because a process of full testing of a large networked system against all threats is quite long, the organization might again end with a too long discovery period after a new threat appears.

Because of the above deficiencies automated penetration testing solutions were introduced in recent years by multiple vendors. These automated solutions reduce human involvement in the penetration testing process, or at least in some of its functions.

A penetration testing process involves at least the following main functions: (i) a reconnaissance function, (ii) an attack function, and (ii) a reporting function. The process may also include additional functions, for example a cleanup function that restores the tested networked system to its original state as it was before the test. In an automated penetration testing system, at least one of the above three functions is at least partially automated, and typically two or three of them are at least partially automated.

A reconnaissance function is the function within a penetration testing system that handles the collection of data about the tested networked system. The collected data may include internal data of networks nodes, data about network traffic within the tested networked system, business intelligence data of the organization owning the tested networked system, etc. The functionality of a prior art reconnaissance function can be implemented, for example, by software executing in a server that is not one of the network nodes of the tested networked system, where the server probes the tested networked system for the purpose of collecting data about it.

An attack function is the function within a penetration testing system that handles the determination of whether security vulnerabilities exist in the tested networked system based on data collected by the reconnaissance function. The functionality of a prior art attack function can be implemented, for example, by software executing in a server that is not one of the nodes of the tested networked system, where the server attempts to attack the tested networked system for the purpose of verifying that it can be compromised.

A reporting function is the function within a penetration testing system that handles the reporting of results of the penetration testing system. The functionality of a prior art reporting function may be implemented, for example, by software executing in the same server that executes the functionality of the attack function, where the server reports the findings of the attack function to an administrator or a CISO of the tested networked system.

FIG. 1A (PRIOR ART) is a block diagram of code modules of a typical penetration testing system. FIG. 1B (PRIOR ART) is a related flow-chart.

In FIG. 1A, code for the reconnaissance function, for the attack function, and for the reporting function are respectively labelled as 20, 30 and 40, and are each schematically illustrated as part of a penetration testing system code module (PTSCM) labelled as 10. The term ‘code’ is intended broadly and may include any combination of computer-executable code and computer-readable data which when read affects the output of execution of the code. The computer-executable code may be provided as any combination of human-readable code (e.g. in a scripting language such as Python), machine language code, assembler code and byte code, or in any form known in the art. Furthermore, the executable code may include any stored data (e.g. structured data) such as configuration files, XML files, and data residing in any type of database (e.g. a relational database, an object-database, etc.).

In one example and as shown in FIG. 1B, the reconnaissance function (performed in step S21 by execution of reconnaissance function code 20), the attack function (performed in step S31 by execution of attack function code 30) and the reporting function (performed in step S41 by execution of reporting function code 40) are executed in strictly sequential order so that first the reconnaissance function is performed by executing code 20 thereof, then the attack function is performed by executing code 30 thereof, and finally the reporting function is performed 40 by executing code thereof. However, the skilled artisan will appreciate that this order is just one example, and is not a requirement. For example, the attack and the reporting functions may be performed in parallel or in an interleaved way, with the reporting function reporting first results obtained by the attack function, while the attack function is working on additional results. Similarly, the reconnaissance and the attack functions may operate in parallel or in an interleaved way, with the attack function detecting a vulnerability based on first data collected by the reconnaissance function, while the reconnaissance function is working on collecting additional data.

FIG. 1A also illustrates code of an optional cleanup function which is labeled as 50. Also illustrated in FIG. 1B is step S51 of performing a cleanup function—e.g. by cleanup function code 50 of FIG. 1A.

“A campaign of penetration testing” is a specific run of a specific test of a specific networked system by the penetration testing system.

A penetration-testing-campaign module may comprise at least part of reconnaissance function code 20, attack function code 30 and optionally cleanup function code 50—for example, in combination with suitable hardware (e.g. one or more computing device 110 and one or more processor(s) 120 thereof) for executing the code.

FIG. 2 illustrates a prior art computing device 110 which may have any form-factor including but not limited to a laptop, a desktop, a mobile phone, a server, a tablet, or any other form factor. The computing device 110 in FIG. 2 includes (i) computer memory 160 which may store code 180; (ii) one or more processors 120 (e.g. central-processing-unit (CPU)) for executing code 180; (iii) a human-interface device 140 (e.g. mouse, keyboard, touchscreen, gesture-detecting apparatus including a camera, etc.) or an interface (e.g. USB interface) to receive input from a human-interface device; (iv) a display device 130 (e.g. computer screen) or an interface (e.g. HDMI interface, USB interface) for exporting video to a display device and (v) a network interface 150 (e.g. a network card, or a wireless modem).

Memory 160 may include any combination of volatile (e.g. RAM) and non-volatile (e.g. ROM, flash, disk-drive) memory.

Code 180 may include operating-system code—e.g. Windows®, Linux®, Android®, Mac-OS ®.

Computing device 110 may include a user-interface for receiving input from a user (e.g. manual input, visual input, audio input, or input in any other form) and for visually displaying output. The user-interface (e.g. graphical user interface (GUI)) of computing device 110 may thus include the combination of HID device 140 or an interface thereof (i.e. in communication with an external HID device 140), display device 130 or an interface thereof (i.e. in communication with an external display device), and user-interface (UI) code stored in memory 160 and executed by one or more processor(s) 120. The user-interface may include one or more GUI widgets such as labels, buttons (e.g. radio buttons or check boxes), sliders, spinners, icons, windows, panels, text boxes, and the like.

In one example, a penetration testing system is the combination of (i) code 10 (e.g. including reconnaissance function code 20, attack function code 30, reporting function code 40, and optionally cleaning function code 50); and (ii) one or more computing devices 110 which execute the code 10. For example, a first computing device may execute a first portion of code 10 and a second computing device (e.g. in networked communication with the first computing device) may execute a second portion of code 10.

FIGS. 3 and 4A-4D relate to a prior art example of penetration testing of a networked system. FIG. 3 shows a timeline—i.e. the penetration test begins at a time labelled as T_{Begin Pen-Test}. Subsequent points in time, during the penetration test, are labelled in FIG. 3 as T¹_{During Pen-Test}, T²_{During Pen-Test} and T³_{During Pen-Test}.

FIG. 4A shows an example networked system comprising a plurality of 24 network nodes labelled N101, N102 . . . N124. In the present document, a network node may be referred to simply as ‘node’—‘network node’ and ‘node’ are interchangeable.

Each network node may be a different computing device 110. Two network nodes are “immediate neighbors” of each other if and only if they have a direct communication link between them that does not pass through any other network node.

In the example of FIG. 4A, this is represented by an edge between the two nodes—thus, in this example nodes N108 and N112 are immediate neighbors while nodes N108 and N115 are not immediate neighbors.

Embodiments of the invention relate to penetration testing of networked systems, such as that illustrated in FIG. 4A.

During penetration testing, a node may become compromised. In the examples of FIGS. 4A-4D compromised nodes are indicated by an “X” in the circle—all other nodes have not yet been compromised.

The term “compromising a network node” is defined as: Successfully causing execution of an operation in the network node that is not allowed for the entity requesting the operation by the rules defined by an administrator of the network node, or successfully causing execution of code in a software module of the network node that was not predicted by the vendor of the software module. Examples for compromising a network node are reading a file without having read permission for it, modifying a file without having write permission for it, deleting a file without having delete permission for it, exporting a file out of the network node without having permission to do so, getting an access right higher than the one originally assigned without having permission to get it, getting a priority higher than the one originally assigned without having permission to get it, changing a configuration of a firewall network node such that it allows access to other network nodes that were previously hidden behind the firewall without having permission to do it, and causing execution of software code by utilizing a buffer overflow. As shown by the firewall example, the effects of compromising a certain network node are not necessarily limited to that certain network node. In addition, executing successful ARP spoofing, denial-of-service, man-in-the-middle or session-hijacking attacks against a network node are also considered compromising that network node, even if not satisfying any of the conditions listed above in this definition.

According to the example illustrated in FIGS. 4A-4D, initially, at time T_{Begin Pen-Test}, when the penetration test begins, none of the network-nodes have yet been compromised. Between time T_{Begin Pen-Test} and T¹_{During Pen-Test}, network node N122 is compromised—this is indicated in FIG. 4B by the “X.' Between time T¹_{During Pen-Test} and T²_{During Pen-Test}, network nodes N116 and N112 are compromised, as indicated by the X's in FIG. 4C. Between time T²_{During Pen-Test} and T³_{During Pen-Test}, network nodes N110 and N111 are compromised, as indicated by the X's in FIG. 4D.

In this particular example, it is assumed that it is easier for an attacker to compromise a node if one or more of its immediate neighbors has been compromised.

When a user desires to operate a prior art penetration testing system for running a test on a specific networked system, the penetration testing system must know what test it should execute. For example, the penetration testing system must know what is the type of attacker against whom the test is making its assessment (a state-sponsored actor, a cyber criminal etc.) and what are his capabilities. As another example, the penetration testing system must know what is the goal of the attacker according to which the attack will be judged as a success or a failure (copying a specific file and exporting it out of the tested networked system, encrypting a specific directory of a specific network node for ransom, etc.).

A specific run of a specific test of a specific networked system by a penetration testing system is called a “campaign” of that penetration testing system and entails performing at least the reconnaissance (step S21 of FIG. 1B), attack (step S31 of FIG. 1B) and reporting (step S41 of FIG. 1B) functions. A collection of values for all information items a penetration testing system must know before executing a campaign is called “specifications of the campaign” or “scenario”. For example, the type of the attacker and the goal of the attacker are specific information items of a campaign, and specific values for them are parts of the specifications of any campaign.

The results of the penetration testing campaign may be reported by performing the reporting function (step S41) of FIG. 1B.

All prior art penetration testing systems are not flexible in letting the user define the specifications of a campaign. Typically, those systems are delivered with a library of pre-defined campaign specifications from which the user should choose.

Some prior art penetration testing systems provide slightly better flexibility by allowing the user to select a scenario based on explicit selection of the type of the attacker. The user may be presented with a closed list of alternatives for the type of the attacker—a state-sponsored actor, a cyber criminal, an amateur hacker, etc., and he may choose one of those alternatives. Once the user picks one of the listed alternatives, the system selects a pre-defined scenario whose type of attacker is the same as the picked alternative. All other fields of the specifications of the campaign (goal of the attacker, capabilities of the attacker, etc.) are automatically decided either by the selected pre-defined scenario or by internal algorithms of the penetration testing system, with no explicit input from the user. The internal algorithms may depend on the user-selected type of attacker and/or on pre-defined information items of the selected pre-defined scenario, and/or on a random process. For example, the capabilities of the attacker may be automatically defined based on the type of the attacker, while the lateral movement strategy of the attacker may be picked at random from a pre-defined list of available strategies.

This rigid campaign definition is not satisfactory for many users, who would like to have greater control over the specifications of the campaigns they run for testing their networked systems. Such control will allow them to test specific combinations of features of scenarios, which might be impossible to test with prior art systems.

FIG. 32 illustrates one example of a networked system 200 that may be subjected to penetration testing. The networked system comprises a plurality of nodes—in the example of FIG. 32, 16 nodes are illustrated, each labeled by the letter “N” followed by an integer. Also illustrated in FIG. 32 are two external computing devices 254, 252 that reside outside the networked system 200. Computing device 254 resides ‘in the cloud’ relative to the networked system 200, while computing device 252 is in communication with the networked system 200 via a local-area network (LAN).

Both of nodes 254 and 252 are “networked system external”—i.e. outside of networked system 200. The term ‘networked system external’ is abbreviated as “NS-external”.

In the present document, a network node may be referred to simply as ‘node’—‘network node’ and ‘node’ are interchangeable. Each network node may be different a computing device 110 illustrated in FIG. 2.

A Discussion of Actual Attack vs. Simulated Attack

All prior art penetration testing systems can be characterized as doing either an “actual attack penetration testing” or as doing a “simulated penetration testing”.

A prior art actual attack penetration testing system does its penetration testing by accessing and attempting to attack the tested networked system. Such a system actually accesses the tested networked system during the test and is not limiting itself to simulation. This includes (i) collecting data by the reconnaissance function about the tested networked system and its components by actively probing it. The probing is done by sending queries or other messages to one or more network nodes of the tested networked system, and then deducing information about the tested networked system from the received responses or from network traffic triggered by the queries or the messages. The reconnaissance function is fully implemented by software executing outside the tested networked system or by software executing in one or more network nodes of the tested networked system that analyze network traffic and network packets of the tested networked system, and (ii) verifying that the tested networked system can be compromised by actively attempting to compromise it and checking if it was indeed compromised. This implies that a side-effect of executing an actual attack penetration test might be actually compromising the tested networked system. Typically, prior art actual attack penetration testing systems include a function of cleanup and recovery at the end of the test, in which any compromising operation that was done during the test is undone.

A prior art simulated penetration testing system does its penetration testing by avoiding disturbance to the tested networked system and specifically by avoiding any risk of compromising it. This implies, among other things, that (i) no installation of software agents of any kind on network nodes of the tested networked system is allowed, and (ii) whenever there is a need to verify that the tested networked system can be compromised by an operation or a sequence of operations, the verification is done by simulating the results of that operation or sequence of operations or by otherwise evaluating them, without taking the risk of actually compromising the tested networked system. Some prior art simulated penetration testing systems implement the simulation by duplicating all or parts of the hardware of the tested networked system. Then when there is a need for verifying that an operation or a sequence of operations compromises the tested networked system, this is done by actually attacking the duplicated system without risking the tested system. While this implementation achieves the goal of avoiding the risk of not compromising the tested networked system, it is highly expensive and also difficult to accurately implement, and therefore rarely used.

While the prior art automated penetration testing systems provide great advantages over manual penetration testing systems, they still do not provide a fully satisfactory solution, as they suffer from some deficiencies, examples of which are explained below.

Prior art automated penetration testing systems face difficulties in their reconnaissance function's ability to collect internal data of network nodes. Internal data of a network node is data that is only directly accessible to code executing by a processor of that network node. This may include, for example, factual data about the network node such as the version of the firmware of a solid-state drive installed in that network node. Unless the internal node was already compromised by the penetration testing system, it might be difficult or even impossible for it to determine such internal fact. A human hostile attacker may gain knowledge of such fact by indirect means—for example if he had previously been an employee of the organization owning the tested networked system, or if he is an employee of the vendor supplying the organization with solid-state drives. Once the attacker possesses knowledge of the fact, he might use it to advantage for compromising the network node and consequently compromising the networked system. But a prior art penetration testing system that does not have access to that internal data of the network node might miss the detection of a security vulnerability related to a specific firmware version. This deficiency is mainly problematic for simulated penetration testing systems, but is also relevant to actual attack penetration testing systems, as even active probing by the penetration testing system may not be enough for obtaining internal data of a network node that was not yet compromised when the attempt to probe is performed from outside of the probed network node.

Another deficiency is relevant only to actual attack penetration testing systems that might actually compromise the tested networked system during the test. This characteristic of actual attack penetration testing systems is by itself a security vulnerability. As the testing process might compromise the networked system, there is a risk that the recovery function of the penetration testing system, that is supposed to undo the compromising and make the tested networked system safe again, might fail in fully doing that, and the tested networked system might be left with one or more compromised components without the CISO of the owning organization being aware of it. Additionally, even if the penetration testing system's recovery function is faultless, the testing still makes the tested networked system vulnerable and exposed to attacks during the test, before the recovery function is activated.

Another deficiency of an actual attack penetration testing system is that it cannot answer “what if” questions, as one cannot attack a configuration that does not exist in the real world. For example, a CISO of an organization may want to find out whether adding a new security tool will indeed improve his networked system's immunity to attacks. Or to find how much would the immunity degrade if he will remove an existing security tool that costs a lot of money in licensing fees. In both cases an actual attack penetration testing system cannot answer the question. Another example is determining the vulnerability of a networked system against a new type of attack whose existence is known, but its detailed implementation is not yet known. Again, an actual attack penetration testing system cannot make such determination.

Prior art automated penetration testing systems can successfully detect many types of vulnerabilities in the tested networked system. However, they have difficulty in detecting an important class of vulnerabilities, termed herein “opportunistic vulnerabilities”.

An “opportunistic vulnerability” is a security vulnerability that becomes available to attackers only after an occurrence of a specific event. In many cases, an opportunistic security vulnerability remains available to attackers only for a limited time interval, and once that time interval is over, the vulnerability is no longer available to them. However, in some cases an opportunistic vulnerability remains available to attackers with no time limit.

In some cases the availability of the vulnerability to the attackers is created by the occurrence of the event—for example when a transmission of a network message creates the weakness making an attack possible. In other cases, the availability of the vulnerability to attackers is not created by the occurrence of the event, but rather exists beforehand, and the occurrence of the event makes the existing vulnerability known to the attackers.

A specific event that triggers the availability of a specific opportunistic vulnerability is said to be an event “associated with” that specific opportunistic vulnerability, and the specific opportunistic vulnerability is said to be an opportunistic vulnerability “associated with” that specific event.

A specific event that triggers the availability of a specific opportunistic vulnerability may trigger that availability unconditionally. That is—the specific opportunistic vulnerability will become available to attackers following every occurrence of the specific event. However, it may also be the case that the specific event might sometimes trigger the specific opportunistic vulnerability and sometimes not trigger it, depending on some condition.

An event is said to be associated with an opportunistic vulnerability and an opportunistic vulnerability is said to be associated with an event if the event may trigger the opportunistic vulnerability, regardless if the triggering relation is conditional or unconditional. In the first case we say that the event is “unconditionally associated” with the opportunistic vulnerability, and in the second case we say that the event is “potentially associated” or “conditionally associated” with the opportunistic event. As a result of the above, detecting an event that is associated with an opportunistic vulnerability does not necessarily imply that the vulnerability will be available to the attacker in a future occurrence of the event. In order to conclude that the opportunistic vulnerability will indeed be available to the attacker for a future occurrence of the event, it must be determined that the condition enabling the triggering of the vulnerability by the event (if such exists) is satisfied.

A time interval during which a specific opportunistic vulnerability is available to attackers (if such limiting time interval exists for that specific opportunistic vulnerability) is said to be a time interval “associated with” that specific opportunistic vulnerability.

A time interval associated with an opportunistic vulnerability may be of a fixed length for all occurrences of the event associated with that opportunistic vulnerability, or it may have different length in different occurrences of the associated event and be terminated by the occurrence of another event that makes the use of the vulnerability to attackers no longer possible.

As one example of an opportunistic vulnerability, it might be the case that a bug in a storage driver causes a buffer overflow to occur in a certain network node whenever a USB storage device in inserted into a USB port of the network node, if the volume name of the storage device is longer than a certain length. Thus, the event of the insertion of the storage device having a volume name of a specific length may create an opportunity which attackers may exploit for compromising that network node, an opportunity that ceases to exist after any access to the inserted storage device.

Another example of an opportunistic vulnerability is when a transmission by a network node of a certain message type of a certain network protocol creates an opportunity for attackers to respond with a malicious reply message, which leads to compromising of the network node. In this example, the opportunity for the attacker is triggered by the event of transmission of the first message and is only available to the attacker until a true addressee of the first message responds to the message.

Many prior art penetration testing systems detect vulnerabilities by blindly attempting to compromise a network node without having certainty, in advance, whether the attempted vulnerability indeed compromises the attacked node. Clearly, vulnerabilities of the opportunistic type create a problem for such penetration testing systems. Since an event triggering the opportunistic vulnerability may occur at random, and the window of opportunity for attackers to exploit the opportunistic vulnerability may be limited, it is quite likely that an attempted “blind attack” by a penetration testing system will fail to detect the vulnerability. This is particularly true when the window of opportunity is short, as is the case in many real-life opportunistic vulnerabilities, including many of the examples provided herein. Thus, the prior art testing system would not detect that opportunistic vulnerability, while in reality the network node is subject to a threat of being compromised by a sophisticated attacker that knows how to time his attack to occur within the window of opportunity opened by the triggering event. Such an attacker might lay dormant while monitoring the network node for an occurrence of the triggering event, and upon detection of such an event, may exploit the newly created opportunistic vulnerability while the window of opportunity is still open.

Even penetration testing systems that use simulation instead of actual attacks face difficulties when trying to detect opportunistic vulnerabilities. In order to conclude that a given network node is prone to a given opportunistic vulnerability, it is necessary to determine that the event associated with the opportunistic vulnerability that triggers the vulnerability to occur may actually occur in the given network node. For example, if the triggering event of an opportunistic vulnerability is a transmission of a certain type of message of a certain network protocol out of the given network node, it might be the case that the given network node, even though theoretically prone to that vulnerability, in reality never uses the certain network protocol or never uses the certain type of message triggering the vulnerability. It may be possible to make an educated guess by the penetration testing system as to whether the triggering message is in actual use based on the applications installed in the network node and what versions they are, but this is quite difficult to do, and even under best case circumstances does not provide certainty.

The problems faced by prior art penetration testing systems when dealing with opportunistic vulnerabilities are even more severe when the event associated with the opportunistic vulnerability is a free event.

A “free event of a network node” is an event occurring in a network node of the networked system, which event is initiated in and by the node in which it occurs, and is not directly caused or triggered by an entity outside that node.

An occurrence of a free event in a network node may be triggered by:
i. A user of the node—for example by the user inserting a USB thumb drive or submitting a query to a web server.
ii. An operating system of the node—for example, by the operating system sending a request message according to the ARP (Address Resolution Protocol) protocol in order to find out which MAC (Media Access Control) address (e.g. Ethernet address) corresponds to a given IP address.
   According to the ARP protocol, a first network node that wants to communicate with a second node located on the same local network, but knows only the IP address of the second node and not its MAC address (i.e. the required translation of the second node's IP address to its MAC address is not found in the address matching cache of the first node), submits an ARP request message containing its own MAC and IP addresses and the known IP address of the second node. In response, the second node is expected, when identifying its IP address in the ARP request message, to send an ARP reply message containing its own MAC and IP addresses as well as the MAC and IP addresses of the first node that sent the ARP request. Upon identifying that the reply is addressed to it, the first node can extract from the reply the previously unknown MAC address of the second node, store it in its address matching cache for later use, and use the MAC address for communicating with the second node.
iii. An application executing on the node—for example, a browser sending a message according to the WPAD (Web Proxy Auto-Discovery) protocol in order to find out a configuration file that determines a proxy server for a target URL.
   According to the WPAD protocol, a network node that needs to determine the right proxy server for a target URL submits a WPAD message according to the DHCP (Dynamic Host Configuration Protocol) or the DNS (Domain Name System) protocols. The node expects to receive back an answer from a DHCP server or a DNS server containing a URL directing it to a configuration file, which in turn directs the node to the right proxy server for the target URL.

As elaborated herein below, all the above free event examples are associated with opportunistic vulnerabilities. In other words, each of the free events of the above examples may trigger a security vulnerability that creates an opportunity for a hostile attacker to compromise the network node, where the vulnerability becomes available to the attacker after the occurrence of the free event and because of it.

For example, when a user submits a query to a web server within the networked system that is already compromised by the attacker, the attacker can use the opportunity to compromise the node making the submission. The web server, which is under control of the attacker, may construct an answer page (for example an HTML page) that contains malicious code, that when rendered by the browser of the querying node compromises that node.

As another example, when an operating system of a first node transmits into the network an ARP request message asking for the MAC address of a second node having a given IP address, a third node, that is under the control of an attacker, might use the opportunity to perform “ARP spoofing”. This may be accomplished by the third node responding to the ARP request message before the true addressee of the message (the second node) does so. The false response provided by the third, compromised, node will be a formally-valid ARP reply message that includes a false MAC address belonging to the third node, or to another compromised node. As a result, the false MAC address will be used by the first node for communicating with what it believes to be the second node, while in reality the first node will be communicating with a compromised node which is controlled by the attacker. This might lead to a successful denial-of-service, man-in-the-middle, or session-hijacking attack, thus compromising the first node by the attacker.

As still another example, when a browser running on a first node transmits into the network a WPAD message asking to determine a proxy server for a target URL to which it wants access, a second node that is under the control of the attacker might use the opportunity and respond to the message, before any valid addressee of the message (which is a valid DHCP or DNS server) does so. This false response might include a false URL leading to a false configuration file that in turn determines a false proxy server that is under the control of the attacker. From now on, all communications the first node believes it is directing to the target URL are actually sent to the false proxy server, which is controlled by the attacker. As in the previous example, this might lead to compromising of the first node by the attacker.

As still another example, when a user inserts a USB thumb drive into a USB port of a first node, it may be determined that the currently inserted USB thumb drive is the same device that was previously detected being inserted into a USB port of a second network node (i.e. the same device serial number is detected in both cases) that is already compromised by an attacker. This finding implies that the user may be moving the USB thumb drive back and forth between the two nodes. The attacker may rely on this finding to compromise the first node, by making the second node download a malicious file onto the USB thumb drive the next time it is inserted into the second node, such that when the USB thumb drive will later be inserted into the first node, the first node will be compromised by the poisoned file.

In addition to the difficulties explained above for all opportunistic vulnerabilities, additional difficulties exist when a prior art penetration testing system has to detect an opportunistic vulnerability associated with a free event, because the triggering event is a free event. The additional difficulties arise from the fact that free events are asynchronous relative to the testing process, and cannot be generated or caused from outside of the targeted network node.

Additional difficulties are caused to prior art penetration testing systems when these have to detect an opportunistic vulnerability associated with an event that is an internal event of a network node. The additional difficulties arise from the fact that internal events are, by their nature, impossible to directly detect by software executing on a remote computing device that is separate from the targeted network node.

Thus, there is need in the art for an automatic penetration testing solution that efficiently and correctly handles opportunistic vulnerabilities, and especially opportunistic vulnerabilities that have free events associated with them.

Every penetration testing system operates by iteratively (physically or simulatively) compromising network nodes of the tested networked system. At any iteration during the testing process some of the network nodes of the tested networked system are considered to be already compromised by the potential attacker, and the penetration testing system is attempting to compromise an additional network node (not yet compromised) by utilizing the already-compromised network nodes that are operating under the control of the attacker's instructions. Once an additional network node is found to be compromisable, it is added to the group of already-compromised network nodes and a new iteration begins.

As a hypothetical example, there might be malicious code circulating in cyberspace and available to potential attackers known as the “Bad 7 Trojan”. This Bad 7 Trojan only compromises nodes running the Windows 7® Operating System under a specific set of circumstances, discussed below.

A penetration testing system has a frequent need to identify a vulnerability that would compromise a given network node. This identification is typically achieved by using a pre-compiled knowledge base about known vulnerabilities, that depends on characteristics of the given network node. In one example related to the Bad 7 Trojan, the penetration testing system may have in its knowledge base a rule saying that a network node running the Windows 7 Operating System might be compromised by sending it a specific network message through a specific Internet port.

However, knowing that a target network node might be compromised by a specific vulnerability is not the same as knowing for sure it would be compromised by that specific vulnerability under the current specific conditions in the target network node. For example, the target network node may have installed on it a patch provided by Microsoft for making the Windows 7 Operating System immune to that vulnerability—i.e. immune to the Bad 7 Trojan. Or the administrator of the target network node may have disabled the service that is typically using the specific Internet port (i.e. port number “XYZ”) used by the specific vulnerability (i.e used by the Bad 7 Trojan) and therefore the network node is currently not listening to that specific port and is thus currently not vulnerable to anything sent to it through that specific port. Additionally, even if a target network node would be compromised by the specific vulnerability under the current conditions if it receives a certain network message through the specific port (i.e. causing the node to execute the code of the Bad 7 Trojan), it might still be the case that a firewall that is protecting the target network node is blocking the damaging network message from reaching the specific port of the target network node, thus making it non-compromisable in practice.

Therefore, it is clear that without detailed knowledge about what is going on inside the target network node it is not always possible to know for sure whether a given potential vulnerability would compromise a given network node under current conditions. This is a major issue for penetration testing systems that need to know for sure that a given network node could be compromised before reporting a penetration success. As a result, when a penetration testing system determines that a given vulnerability might compromise a given network node, it has to find a way of validating that this is indeed so under current conditions.

The common approaches adopted by prior art penetration testing systems are:

a. Validating by actual attack—testing whether the given vulnerability succeeds in compromising the target network node by actually attempting to compromise the target network node using the vulnerability, and then finding out if the network node was indeed compromised.

b. Validating by simulation or by evaluation—testing whether the given vulnerability succeeds in compromising the target network node either by simulating the tested networked system and attempting to compromise it using the vulnerability in the simulation, or by evaluating the success/failure of applying the vulnerability by using pre-compiled knowledge about the vulnerability plus fresh data about current conditions in the target network node. In both cases the validation is done without actually attempting to compromise the tested networked system.

None of the above approaches provides a fully satisfactory solution to the validation problem. The actual attack method has the severe drawback of risking actually compromising the tested networked system. Even though penetration testing systems employing this method attempt to undo any compromising operations they performed during the test, it is difficult to guarantee that full recovery will always be achieved. The simulation/evaluation method has the drawback of sometimes lacking knowledge of data that is essential for reaching a correct result. If the condition for successful compromising depends on data that is internal to the target network node (for example the version of the firmware of a storage device internal to the node), then the method cannot reliably validate the success of the compromising by the vulnerability.

A possible remedy to the drawback of the simulation/evaluation method is to employ a reconnaissance client agent for collecting information about the target network node. A reconnaissance client agent is a software module that can be installed on a network node and can be executed by a processor of that network node for partially or fully implementing the reconnaissance function of a penetration test. The reconnaissance function is the function that is in charge of the collection of data useful for the penetration testing process, and this may include the collection of data that is internal to the network node in which the agent is installed.

As an example, US Application No. 2016/0044057 (hereinafter “057 application” or '057) to Chenette et al. discloses a penetration testing system that uses an agent software module installed in the target node (called “server” in '057), that is in charge of validation of vulnerabilities in that target node. When the penetration testing system of '057 needs to verify that a given vulnerability can compromise the target node under current conditions, an exploit payload is sent to the target node where the exploit contains code implementing the vulnerability. The agent installed on the target node receives the payload, but instead of attempting to execute the code (which would expose us to the danger of compromising the networked system by the testing process), it examines the code and determines whether the target node would have been compromised by executing it, taking into account the current state of the node and the defenses currently in place in it. As a client agent has access to internal data of the node in which it is installed, this solution solves the problem from which other evaluation-based penetration testing systems suffer, as explained above.

However, the solution of '057 suffers from other drawbacks. The client agent of '057 has to validate every type of vulnerability that is potentially applicable to the node on which it is installed. For each such vulnerability, it must implement logic for determining whether that vulnerability will succeed in compromising the node under current conditions. This logic is specific for each vulnerability and is not always simple and straight-forward. Therefore, when the number of potential vulnerabilities is high, as is usually the case, the complexity and code size of the client agent become high too. While penetration testing systems are complex systems, it is highly desirable that their complexity will reside in the central server from which the testing sessions are initiated and controlled, and will not be duplicated in code installed on each one of the many network nodes taking part in the test. Moreover, new vulnerabilities are discovered on almost a daily basis and require very frequent updates of the vulnerabilities validation logic of penetration testing systems. Having to frequently update the locally-installed agents in the many nodes of a tested networked system is a logistic nightmare and should better be avoided.

One additional drawback of the '057 method is that it relies on sending to the target node code or some other representation of the potential vulnerability. It is not always the case that a vulnerability is known to the penetration testing system with such detail. In many cases a newly-discovered vulnerability is known in general terms but not much detail is known about its implementation. In such case the agent-based '057 method cannot be used for validating success in compromising the target node by newly-discovered vulnerabilities.

There is thus a need for validating that a given vulnerability will indeed compromise a given node under current conditions, without suffering from the drawbacks described above.

In this disclosure, the phrase ‘active method of validation’ (or the equivalent ‘active method’) is used in connection with validation methods using actual attack. Similarly, the phrase ‘passive method of validation’ (or the equivalent ‘passive method’) is used in connection with validation methods using simulation or other type of evaluation.

U.S. Pat. No. 10,038,711 discloses penetration testing systems that employ reconnaissance agent penetration testing. Such penetration testing systems are characterized by using a reconnaissance agent software module installed on some network nodes of the tested networked system, where the instances of the reconnaissance agent take part in implementing the reconnaissance function. With regard to verifying that the tested networked system can be compromised by an operation or a sequence of operations, reconnaissance agent penetration testing systems may use either actual attack methods (active validation) or simulation/evaluation methods (passive validation).

This section is provided to reveal information believed by the applicant to be of possible relevance. No admission is necessarily intended, nor should be construed, that any of the information anywhere in this background section (in particular, that U.S. Pat. No. 10,038,711) constitutes prior art against the present invention.

As explained above, every penetration testing system operates by iteratively compromising (physically or by simulation/evaluation) network nodes of the tested networked system. At any iteration during the testing process some of the nodes of the tested networked system are considered to be already compromised by the potential attacker, and the penetration testing system is attempting to compromise one or more additional network nodes (not yet compromised) by utilizing the already-compromised nodes that are operating under the control of the attacker's instructions. Once an additional network node is found to be compromisable, it is added to the group of already-compromised nodes and a new iteration begins.

Thus, a penetration testing system has a frequent need to identify a vulnerability that would compromise a given network node. This identification is typically achieved by using a pre-compiled knowledge base about known vulnerabilities, that depends on characteristics of the given network node. For example, the penetration testing system may have in its knowledge base a rule saying that a network node running the Windows 7 Operating System might be compromised by sending it a specific network message through a specific Internet port.

However, knowing that a node might be compromised is not the same as knowing for sure it would be compromised by the examined vulnerability under current conditions. For example, the target node may have installed on it a patch provided by Microsoft for making the Windows 7 Operating System immune to that vulnerability. Or the administrator of the target node may have disabled the service that is typically using the specific Internet port and therefore the node is currently not listening to that specific Internet port and is thus currently not vulnerable to anything sent to it through that specific Internet port.

Therefore, it is clear that without detailed knowledge about what is going on inside the target node it is not always possible to know for sure whether a given potential vulnerability would compromise a given network node under current conditions. This is a major issue for penetration testing systems, that need to know for sure that a given node could be compromised before reporting a penetration vulnerability. As a result, when a penetration testing system determines that a given vulnerability might compromise a given network node, it has to find a way of validating that this is indeed so under current conditions.

As explained above, the common solutions adopted by prior art penetration testing systems are:

a. Validating by actual attack—testing whether the given vulnerability succeeds in compromising the given node by actually attempting to compromise the node by exploiting the vulnerability, and then finding out if the attempt was successful and the node was indeed compromised.

b. Validating by simulation or by other evaluation—testing whether the given vulnerability succeeds in compromising the given node by either simulating the tested networked system and attempting to compromise it by exploiting the vulnerability in the simulation, or by evaluating the success/failure of exploiting the vulnerability by using pre-compiled knowledge about the vulnerability plus data about current conditions in the network node. In both cases the validation is done without actually attempting to compromise the tested networked system and thus without risking an actual compromising of the network node.

Each of the above approaches has its drawbacks. The actual attack method has the severe drawback of risking actually compromising the tested networked system. Even though penetration testing systems employing this method attempt to undo any compromising operations they performed during the test, it is difficult to guarantee that full recovery will always be achieved. The simulation/evaluation method has the drawback of sometimes lacking knowledge of data that is essential for reaching a correct result. If the condition for successful compromising depends on data that is internal to the target node (for example the version of the firmware of a storage device internal to the node), then the method cannot reliably validate the success of the compromising by the vulnerability unless special arrangements are done in order to obtain the required information during the execution of the penetration testing campaign.

Prior art penetration testing systems are quite rigid regarding the validation approach they employ—a given penetration testing system either employs validation by actual attack or validation by simulation/evaluation. This implies:

a. For a given penetration testing campaign, there is no way of employing validation by actual attack for some potential vulnerabilities and validation by simulation/evaluation for other potential vulnerabilities.

b. For a given scenario template, there is no way of employing validation by actual attack for execution of some campaigns that are based on the scenario template and employing validation by simulation/evaluation for execution of other campaigns that are also based on the scenario template.

c. For a given tested networked system, there is no way of employing validation by actual attack for execution of some penetration testing campaigns and employing validation by simulation/evaluation for execution of other penetration testing campaigns, even when different campaigns are based on different scenario templates.

But in many situations a user of a penetration testing system may want to have more flexibility. For example:

a. A user may want to execute a penetration testing campaign in which some potential vulnerabilities are validated by actual attack, while other potential vulnerabilities are validated by simulation or evaluation.

As an example, the user may prefer to use validation by actual attack for most vulnerabilities because it provides better reliability for the validation conclusions, but for some specific vulnerabilities would like to use validation by simulation/evaluation because the damage to the tested networked system in case an actual attack exploiting any of these specific vulnerabilities turns out to be successful (e.g. a shutdown of the network node) is unacceptable and therefore cannot be risked.

As another example, the user may prefer to use validation by simulation/evaluation for most vulnerabilities because it is important not to risk compromising the tested networked system, but for some specific vulnerabilities would like to use validation by actual attack because the importance of the resources put at risk by these specific vulnerabilities (e.g. password files) is so high that the most reliable validation conclusions are desired, even at the cost of risking the compromising of the tested networked system during the test (e.g. by exporting a password file to the penetration testing system, which may be under the control of the organization owning the tested networked system, and thus causing no real damage when being compromised during the penetration test).

b. A user may want to execute multiple penetration testing campaigns where all campaigns are based on the same scenario template, when some of the campaigns employ validation by actual attack, while other campaigns employ validation by simulation/evaluation.

As an example, the user may prefer to use validation by actual attack for most of the campaigns because this provides better reliability for the validation conclusions, but for some specific campaigns would like to use validation by simulation/evaluation because at the time of those specific runs a flawless operation of the tested networked system is critical and no risk of the system being compromised can be taken.

As another example, the user may prefer to use validation by simulation/evaluation for most of the campaigns because it is important not to risk compromising the tested networked system, but for some specific campaigns would like to use validation by actual attack because it is desired to get the most reliable validation conclusions once in a while, even at the cost of risking the compromising of the tested networked system.

c. A user may want to execute some penetration testing campaigns while employing validation by actual attack, and to execute some other penetration testing campaigns while employing validation by simulation/evaluation (where different campaigns are based on different scenario templates).

As an example, for some campaigns which are set with the goal of the attacker being exporting certain files out of the tested networked system, the user may accept the risk of compromising the networked system and wish to employ validation by actual attack, as the damage at risk is not critical (at least when the penetration testing system, which is the receiver of the exported files, is under control of the organization owning the tested networked system). For other campaigns which are set up with the goal of the attacker being damaging of certain files, the user may not agree to accept the risk and therefore wishes to employ validation by simulation/evaluation.

There is thus a need for providing users of penetration testing systems with greater flexibility in controlling the method of validation of potential vulnerabilities employed during the penetration testing process.

### SUMMARY OF EMBODIMENTS

A method of penetration testing of a networked system by a penetration testing system that is controlled by a user interface of a computing device so that a penetration testing campaign is executed according to one or more manually and explicitly-selected capabilities of an attacker of the penetration testing campaign, the method comprising: receiving, by the penetration testing system and via the user interface of the computing device, one or more manually-entered inputs, the one or more manually-entered inputs explicitly selecting one or more capabilities of the attacker of the penetration testing campaign; executing the penetration testing campaign, by the penetration testing system and according to the manually and explicitly-provided selection of the one or more capabilities of the attacker, so as to test the networked system; and reporting, by the penetration testing system, at least one security vulnerability determined to exist in the networked system by the executing of the penetration testing campaign, wherein the reporting comprises at least one of (i) causing a display device to display a report describing the at least one security vulnerability, and (ii) electronically transmitting a report describing the at least one security vulnerability.

In some embodiments, the method is carried out so that before receiving the one or more manually-entered inputs that explicitly select the one or more capabilities of the attacker, the penetration testing system automatically computes and displays an explicit recommendation for selecting the one or more capabilities of the attacker.

In some embodiments, the received one or more manually-entered inputs comprises an explicit user approval of the explicit recommendation.

In some embodiments, further comprising: subsequent to the receiving by the penetration testing system of the one or more manually-entered inputs that explicitly select the one or more capabilities of the attacker, receiving, by the penetration testing system and via the user interface of the computing device, one or more additional manually-entered inputs, the one or more additional manually-entered inputs explicitly selecting a value for a second information item of the penetration testing campaign, wherein the second information item is not a capability of the attacker.

In some embodiments, the executing of the penetration testing campaign is performed using both (i) the manually and explicitly selected value for the second information item, and (ii) the manually and explicitly selected one or more capabilities of the attacker.

In some embodiments, further comprising: subsequent to the receiving by the penetration testing system of the one or more manually-entered inputs that explicitly select the one or more capabilities of the attacker, receiving, by the penetration testing system and via the user interface of the computing device, one or more additional manually-entered inputs, the one or more additional manually-entered inputs explicitly selecting a method of one of the manually and explicitly selected one or more capabilities of the attacker.

In some embodiments, the executing of the penetration testing campaign is performed using both (i) the manually and explicitly selected one or more capabilities of the attacker, and (ii) the manually and explicitly selected method.

A system for penetration testing of a networked system, the system comprising: a. an attacker-capability-selection user interface including one or more user interface components for manual and explicit selection of one or more capabilities of an attacker of a penetration testing campaign; b. a penetration-testing-campaign module programmed to perform the penetration testing campaign whose attacker has the one or more capabilities that are manually and explicitly selected via the attacker-capability-selection user interface; and c. a reporting module for reporting at least one security vulnerability determined to exist in the networked system according to results of the penetration testing campaign that is performed by the penetration-testing-campaign module, wherein the reporting module is configured to report the at least one security vulnerability by performing at least one of (i) causing a display device to display a report describing the at least one security vulnerability, and (ii) electronically transmitting a report describing the at least one security vulnerability.

In some embodiments, the system further comprises a recommendation module configured to automatically compute an explicit recommendation for selecting the one or more capabilities of the attacker, wherein the attacker-capability-selection user interface displays the explicit recommendation.

In some embodiments, the system is configured so that the manual and explicit selection of the one or more capabilities of the attacker includes a manual and explicit approval of the explicit recommendation.

In some embodiments, the system further comprises a second user interface including one or more user interface components for manual and explicit selection of a value of a second information item of the penetration testing campaign, the second information item being other than a capability of the attacker, wherein the system is configured to receive the manual and explicit selection of the value of the second information item subsequent to the manual and explicit selection of the one or more capabilities.

In some embodiments, the penetration-testing-campaign module is configured, subsequent to the manual and explicit selection of both (i) the one or more capabilities of the attacker and (ii) the value of the second information item, to perform the penetration testing campaign using both (i) the manually and explicitly selected one or more capabilities of the attacker and (ii) the manually and explicitly selected value of the second information item.

In some embodiments, the system further comprises a second user interface including one or more user interface components for manual and explicit selection of a method of one capability of the manually and explicitly selected one or more capabilities of the attacker of the penetration testing campaign, wherein the system is configured to receive the manual and explicit selection of the method of the one capability subsequent to the manual and explicit selection of the one capability.

In some embodiments, the penetration-testing-campaign module is configured, subsequent to the manual and explicit selection of both (i) the one or more capabilities of the attacker and (ii) the method of the one capability, to perform the penetration testing campaign using both (ii) the manually and explicitly selected one or more capabilities of the attacker and (ii) the manually and explicitly selected method of the one capability.

A method of penetration testing of a networked system by a penetration testing system that is controlled by a user interface of a computing device so that a penetration testing campaign is executed according to one or more manually and explicitly-selected traits of an attacker of the penetration testing campaign, the method comprising: receiving, by the penetration testing system and via the user interface of the computing device, one or more manually-entered inputs, the one or more manually-entered inputs explicitly selecting one or more traits of the attacker of the penetration testing campaign; executing the penetration testing campaign, by the penetration testing system and according to the manually and explicitly-provided selection of the one or more traits of the attacker, so as to test the networked system; and reporting, by the penetration testing system, at least one security vulnerability determined to exist in the networked system by the executing of the penetration testing campaign, wherein the reporting comprises at least one of (i) causing a display device to display a report describing the at least one security vulnerability, and (ii) electronically transmitting a report describing the at least one security vulnerability.

In some embodiments, the method is carried out so that before receiving the one or more manually-entered inputs that explicitly select the one or more traits of the attacker, the penetration testing system automatically computes and displays an explicit recommendation for selecting the one or more traits of the attacker.

In some embodiments, the received one or more manually-entered inputs comprises an explicit user approval of the explicit recommendation.

In some embodiments, the method further comprising: subsequent to the receiving by the penetration testing system of the one or more manually-entered inputs that explicitly select the one or more traits of the attacker, receiving, by the penetration testing system and via the user interface of the computing device, one or more additional manually-entered inputs, the one or more additional manually-entered inputs explicitly selecting a value for a second information item of the penetration testing campaign, wherein the second information item is not a trait of the attacker.

In some embodiments, the executing of the penetration testing campaign is performed using both (i) the manually and explicitly selected value for the second information item, and (ii) the manually and explicitly selected one or more traits of the attacker.

A system for penetration testing of a networked system, the system comprising: a. an attacker-trait-selection user interface including one or more user interface components for manual and explicit selection of one or more traits of an attacker of a penetration testing campaign; b. a penetration-testing-campaign module programmed to perform the penetration testing campaign whose attacker has the one or more traits that are manually and explicitly selected via the attacker-trait-selection user interface; and c. a reporting module for reporting at least one security vulnerability determined to exist in the networked system according to results of the penetration testing campaign that is performed by the penetration-testing-campaign module, wherein the reporting module is configured to report the at least one security vulnerability by performing at least one of (i) causing a display device to display a report describing the at least one security vulnerability, and (ii) electronically transmitting a report describing the at least one security vulnerability.

In some embodiments, the system further comprises a recommendation module configured to automatically compute an explicit recommendation for selecting the one or more traits of the attacker, wherein the attacker-trait-selection user interface displays the explicit recommendation.

In some embodiments, the system is configured so that the manual and explicit selection of the one or more traits of the attacker includes a manual and explicit approval of the explicit recommendation.

In some embodiments, the system further comprises a second user interface including one or more user interface components for manual and explicit selection of a value of a second information item of the penetration testing campaign, the second information item being other than a trait of the attacker, wherein the system is configured to receive the manual and explicit selection of the value of the second information item subsequent to the manual and explicit selection of the one or more traits.

In some embodiments, the penetration-testing-campaign module is configured, subsequent to the manual and explicit selection of both (i) the one or more traits of the attacker and (ii) the value of the second information item, to perform the penetration testing campaign using both (i) the manually and explicitly selected one or more traits of the attacker and (ii) the manually and explicitly selected value of the second information item. A method of penetration testing of a networked system by a penetration testing system that is controlled by a user interface of a computing device so that a penetration testing campaign is executed according to a manual and explicit selecting of one or more network nodes of the networked system, the method comprising: receiving, by the penetration testing system and via the user interface of the computing device, one or more manually-entered inputs, the one or more manually-entered inputs explicitly selecting the one or more network nodes of the networked system, wherein at least one of the manually and explicitly selected nodes is other than the computing device; in accordance with the manual and explicit selecting of the network nodes, executing the penetration testing campaign by the penetration testing system so as to test the networked system, the penetration testing campaign being executed under the assumption that the manually and explicitly selected one or more network nodes of the networked system are already compromised at the time of beginning the penetration testing campaign; and reporting, by the penetration testing system, at least one security vulnerability determined to exist in the networked system by the executing of the penetration testing campaign, wherein the reporting comprises at least one of (i) causing a display device to display a report describing the at least one security vulnerability, and (ii) electronically transmitting a report describing the at least one security vulnerability.

In some embodiments, the method is carried out so that before receiving the one or more manually-entered inputs that explicitly select the one or more network nodes of the networked system, the penetration testing system automatically computes and displays an explicit recommendation for selecting the one or more network nodes that are already compromised at the time of beginning the penetration testing campaign.

In some embodiments, the received one or more manually-entered inputs comprises an explicit user approval of the explicit recommendation.

In some embodiments, the method further comprising: subsequent to the receiving by the penetration testing system of the one or more manually-entered inputs that explicitly select the one or more network nodes of the networked system, receiving, by the penetration testing system and via the user interface of the computing device, one or more additional manually-entered inputs, the one or more additional manually-entered inputs explicitly selecting a value for a second information item of the penetration testing campaign, wherein the second information item is not a set of one or more network nodes that are assumed to be already compromised at the time of beginning the penetration testing campaign.

In some embodiments, the executing of the penetration testing campaign is performed using both (i) the manually and explicitly selected value for the second information item, and (ii) an assumption that the manually and explicitly selected one or more network nodes of the networked system are already compromised at the time of beginning the penetration testing campaign.

A system for penetration testing of a networked system, the system comprising: a. a network-nodes-selection user interface including one or more user interface components for manual and explicit selection of one or more network nodes, where the network-nodes-selection user interface resides in a computing device and at least one of the manually and explicitly selected one or more network nodes is other than the computing device; b. a penetration-testing-campaign module programmed to perform a penetration testing campaign under the assumption that the manually and explicitly selected one or more network nodes of the networked system are already compromised at the time of beginning the penetration testing campaign; and c. a reporting module for reporting at least one security vulnerability determined to exist in the networked system according to results of the penetration testing campaign that is performed by the penetration-testing-campaign module, wherein the reporting module is configured to report the at least one security vulnerability by performing at least one of (i) causing a display device to display a report describing the at least one security vulnerability, and (ii) electronically transmitting a report describing the at least one security vulnerability.

In some embodiments, the system further comprises a recommendation module configured to automatically compute an explicit recommendation for selecting the one or more network nodes, wherein the network-nodes-selection user interface displays the explicit recommendation.

In some embodiments, the system is configured so that the manual and explicit selection of the one or more network nodes includes a manual and explicit approval of the explicit recommendation.

In some embodiments, the system further comprises a second user interface including one or more user interface components for manual and explicit selection of a value of a second information item of the penetration testing campaign, the second information item being other than one or more network nodes, wherein the system is configured to receive the manual and explicit selection of the value of the second information item subsequent to the manual and explicit selection of the one or more network nodes.

In some embodiments, the penetration-testing-campaign module is configured, subsequent to the manual and explicit selection of both (i) the one or more network nodes and (ii) the value of the second information item, to perform the penetration testing campaign using both (i) the manually and explicitly selected one or more network nodes and (ii) the manually and explicitly selected value of the second information item.

A method of penetration testing of a networked system by a penetration testing system that is controlled by a user interface of a computing device so that a penetration testing campaign is executed according to a manually and explicitly provided node-selection condition, the method comprising: receiving, by the penetration testing system and via the user interface of the computing device, one or more manually-entered inputs, the one or more manually-entered inputs explicitly selecting a Boolean node-selection condition, the manually and explicitly selected node-selection condition defining a proper subset of network nodes of the networked system such that any network node of the networked system is a member of the subset of network nodes if and only if it satisfies the condition; in accordance with the manual and explicit selecting of the node-selection condition, executing the penetration testing campaign by the penetration testing system so as to test the networked system, the penetration testing campaign being executed under the assumption that every node of the subset of network nodes is already compromised at the time of beginning the penetration testing campaign; and reporting, by the penetration testing system, at least one security vulnerability determined to exist in the networked system by the executing of the penetration testing campaign, wherein the reporting comprises at least one of (i) causing a display device to display a report describing the at least one security vulnerability, and (ii) electronically transmitting a report describing the at least one security vulnerability.

In some embodiments, the method is carried out so that before receiving the one or more manually-entered inputs that explicitly select the Boolean node-selection condition, the penetration testing system automatically computes and displays an explicit recommendation for selecting the Boolean node-selection condition.

In some embodiments, the received one or more manually-entered inputs for selecting the Boolean node-selection condition comprise an explicit user approval of the explicit recommendation.

In some embodiments, the method further comprising: subsequent to the receiving by the penetration testing system of the one or more manually-entered inputs that explicitly select the Boolean node-selection condition, receiving, by the penetration testing system and via the user interface of the computing device, one or more additional manually-entered inputs, the one or more additional manually-entered inputs explicitly selecting a value for a second information item of the penetration testing campaign, wherein the second information item is not a node-selection condition defining a subset of network nodes that are assumed to be already compromised at the time of beginning the penetration testing campaign.

In some embodiments, the executing of the penetration testing campaign is performed using both (i) the manually and explicitly selected value for the second information item, and (ii) an assumption that every node of the subset of network nodes is already compromised at the time of beginning the penetration testing campaign.

A system for penetration testing of a networked system, the system comprising: a. a node-selection-condition user interface including one or more user interface components for manually and explicitly selecting a Boolean node-selection condition defining a proper subset of network nodes of the networked system such that any network node of the networked system is a member of the subset of network nodes if and only if it satisfies the condition; b. a penetration-testing-campaign module programmed to perform a penetration testing campaign under the assumption that every network node of the subset of network nodes is already compromised at the time of beginning the penetration testing campaign; and c. a reporting module for reporting at least one security vulnerability determined to exist in the networked system according to results of the penetration testing campaign that is performed by the penetration-testing-campaign module, wherein the reporting module is configured to report the at least one security vulnerability by performing at least one of (i) causing a display device to display a report describing the at least one security vulnerability, and (ii) electronically transmitting a report describing the at least one security vulnerability.

In some embodiments, the system further comprises a recommendation module configured to automatically compute an explicit recommendation for selecting the Boolean node-selection condition, wherein the node-selection-condition user interface displays the explicit recommendation.

In some embodiments, the system is configured so that the manual and explicit selection of the Boolean node-selection condition includes a manual and explicit approval of the explicit recommendation.

In some embodiments, the system further comprises a second user interface including one or more user interface components for manual and explicit selection of a value of a second information item of the penetration testing campaign, the second information item being other than a Boolean node-selection condition, wherein the system is configured to receive the manual and explicit selection of the value of the second information item subsequent to the manual and explicit selection of the Boolean node-selection condition.

In some embodiments, the penetration-testing-campaign module is configured, subsequent to the manual and explicit selection of both (i) the Boolean node-selection condition and (ii) the value of the second information item, to perform the penetration testing campaign using both (i) the manually and explicitly selected Boolean node-selection condition and (ii) the manually and explicitly selected value of the second information item.

A method of penetration testing of a networked system by a penetration testing system that is controlled by a user interface of a computing device so that a penetration testing campaign is executed according to an automatic selecting of one or more network nodes of the networked system, the method comprising: determining, by the penetration testing system, at least one of (i) a type of an attacker of the penetration testing campaign, and (ii) whether one or more network nodes of the networked system satisfy a pre-defined Boolean condition; based on a result of the determining, automatically selecting, by the penetration testing system, the one or more network nodes of the networked system, wherein at least one of the automatically selected network nodes is other than the computing device; in accordance with the automatically selecting of the network nodes, executing the penetration testing campaign by the penetration testing system so as to test the networked system, the penetration testing campaign being executed under the assumption that the automatically selected one or more network nodes of the networked system are already compromised at the time of beginning the penetration testing campaign; and reporting, by the penetration testing system, at least one security vulnerability determined to exist in the networked system by the executing of the penetration testing campaign, wherein the reporting comprises at least one of (i) causing a display device to display a report describing the at least one security vulnerability, and (ii) electronically transmitting a report describing the at least one security vulnerability.

In some embodiments, the determining comprises determining the type of the attacker of the penetration testing campaign.

In some embodiments, the determining of the type of the attacker comprises automatically determining the type of the attacker by the penetration testing system.

In some embodiments, the determining of the type of the attacker comprises receiving, via the user interface of the computing device, one or more manually-entered inputs that explicitly select the type of the attacker.

In some embodiments, the determining comprises automatically determining whether the one or more network nodes of the networked system satisfy the pre-defined Boolean condition.

In some embodiments, the pre-defined Boolean condition is satisfied for a given network node if and only if the given network node has a direct connection to a computing device that is outside the networked system.

In some embodiments, the pre-defined Boolean condition is satisfied for a given network node if and only if the given network node has an operating system that is a member of a pre-defined set of operating systems.

In some embodiments, the pre-defined Boolean condition is satisfied for a given network node if and only if the given network node has a cellular communication channel.

A system for penetration testing of a networked system that is controlled by a user interface of a computing device, the system comprising: a. a node-selection module configured to: determine at least one of (i) a type of an attacker of a penetration testing campaign, and (ii) whether one or more network nodes of the networked system satisfy a pre-defined Boolean condition; and based on a result of the determining, automatically select one or more network nodes of the networked system, wherein at least one of the automatically selected network nodes is other than the computing device; b. a penetration-testing-campaign module programmed to perform the penetration testing campaign under the assumption that the automatically selected one or more network nodes of the networked system are already compromised at the time of beginning the penetration testing campaign; and c. a reporting module for reporting at least one security vulnerability determined to exist in the networked system according to results of the penetration testing campaign that is performed by the penetration-testing-campaign module, wherein the reporting module is configured to report the at least one security vulnerability by performing at least one of (i) causing a display device to display a report describing the at least one security vulnerability, and (ii) electronically transmitting a report describing the at least one security vulnerability.

In some embodiments, the node-selection module is configured to determine the type of the attacker of the penetration testing campaign.

In some embodiments, the node-selection module is configured to automatically determine the type of the attacker of the penetration testing campaign.

In some embodiments, the node-selection module is configured to determine the type of the attacker by receiving, via the user interface of the computing device, one or more manually-entered inputs that explicitly select the type of the attacker.

In some embodiments, the node-selection module is configured to automatically determine whether the one or more network nodes of the networked system satisfy the pre-defined Boolean condition.

In some embodiments, the pre-defined Boolean condition is satisfied for a given network node if and only if the given network node has a direct connection to a computing device that is outside the networked system.

In some embodiments, the pre-defined Boolean condition is satisfied for a given network node if and only if the given network node has an operating system that is a member of a pre-defined set of operating systems.

In some embodiments, the pre-defined Boolean condition is satisfied for a given network node if and only if the given network node has a cellular communication channel.

A method of penetration testing of a networked system by a penetration testing system that is controlled by a user interface of a computing device so that a penetration testing campaign is executed according to one or more manually and explicitly-selected goals of an attacker of the penetration testing campaign, the method comprising: receiving, by the penetration testing system and via the user interface of the computing device, one or more manually-entered inputs, the one or more manually-entered inputs explicitly selecting one or more goals of the attacker of the penetration testing campaign, wherein at least one goal of the one or more goals satisfies at least one condition selected from the group consisting of: i. the at least one goal is a resource-specific goal; ii. the at least one goal is a file-specific goal; iii. the at least one goal is a node-count-maximizing goal; iv. the at least one goal is a file-count-maximizing goal; v. the at least one goal is an encryption-related goal; vi. the at least one goal is a file-exporting goal; vii. the at least one goal is a file-size-related goal; viii. the at least one goal is a file-type-related goal; ix. the at least one goal is a file-damage-related goal; and x. the at least one goal is a node-condition-based goal; executing the penetration testing campaign, by the penetration testing system and according to the manually and explicitly-provided selection of the one or more goals of the attacker, so as to test the networked system; and reporting, by the penetration testing system, at least one security vulnerability determined to exist in the networked system by the executing of the penetration testing campaign, wherein the reporting comprises at least one of (i) causing a display device to display a report describing the at least one security vulnerability, and (ii) electronically transmitting a report describing the at least one security vulnerability. In some embodiments, the at least one goal is a resource-specific goal.

In some embodiments, the at least one goal is a file-specific goal.

In some embodiments, the at least one goal is a node-count-maximizing goal.

In some embodiments, the at least one goal is a file-count-maximizing goal.

In some embodiments, the at least one goal is an encryption-related goal.

In some embodiments, the at least one goal is a file-exporting goal.

In some embodiments, the at least one goal is a file-size-related goal.

In some embodiments, the at least one goal is a file-type-related goal.

In some embodiments, the at least one goal is a file-damage-related goal.

In some embodiments, the at least one goal is a node-condition-based goal.

In some embodiments, the method is carried out so that before receiving the one or more manually-entered inputs that explicitly select the one or more goals of the attacker, the penetration testing system automatically computes and displays an explicit recommendation for selecting the one or more goals of the attacker.

In some embodiments, the received one or more manually-entered inputs comprises an explicit user approval of the explicit recommendation.

In some embodiments, the method further comprising: subsequent to the receiving by the penetration testing system of the one or more manually-entered inputs that explicitly select the one or more goals of the attacker, receiving, by the penetration testing system and via the user interface of the computing device, one or more additional manually-entered inputs, the one or more additional manually-entered inputs explicitly selecting a value for a second information item of the campaign of the penetration testing system, wherein the second information item is not a goal of the attacker.

In some embodiments, the executing of the penetration testing campaign is performed using both (i) the manually and explicitly selected value for the second information item, and (ii) the manually and explicitly selected one or more goals of the attacker.

A system for penetration testing of a networked system, the system comprising: a. a goals-selection user interface including one or more user interface components for manual and explicit selection of one or more goals of an attacker of a penetration testing campaign, wherein at least one goal of the one or more goals satisfies at least one condition selected from the group consisting of: i. the at least one goal is a resource-specific goal; ii.

the at least one goal is a file-specific goal; iii. the at least one goal is a node-count-maximizing goal; iv. the at least one goal is a file-count-maximizing goal; v. the at least one goal is an encryption-related goal; vi. the at least one goal is a file-exporting goal; vii. the at least one goal is a file-size-related goal; viii. the at least one goal is a file-type-related goal; ix. the at least one goal is a file-damage-related goal; and x. the at least one goal is a node-condition-based goal; b. a penetration-testing-campaign module programmed to perform the penetration testing campaign whose attacker has the one or more goals that are manually and explicitly selected via the goals-selection user interface; and c. a reporting module for reporting at least one security vulnerability determined to exist in the networked system according to results of the penetration testing campaign that is performed by the penetration-testing-campaign module, wherein the reporting module is configured to report the at least one security vulnerability by performing at least one of (i) causing a display device to display a report describing the at least one security vulnerability, and (ii) electronically transmitting a report describing the at least one security vulnerability.

In some embodiments, the at least one goal is a resource-specific goal.

In some embodiments, the at least one goal is a file-specific goal.

In some embodiments, the at least one goal is a node-count-maximizing goal.

In some embodiments, the at least one goal is a file-count-maximizing goal.

In some embodiments, the at least one goal is an encryption-related goal.

In some embodiments, the at least one goal is a file-exporting goal.

In some embodiments, the at least one goal is a file-size-related goal.

In some embodiments, the at least one goal is a file-type-related goal.

In some embodiments, the at least one goal is a file-damage-related goal.

In some embodiments, the at least one goal is a node-condition-based goal.

In some embodiments, the system further comprises a recommendation module configured to automatically compute an explicit recommendation for selecting the one or more goals of the attacker, wherein the goals-selection user interface displays the explicit recommendation.

In some embodiments, the system is configured so that the manual and explicit selection of the one or more goals of the attacker includes a manual and explicit approval of the explicit recommendation.

In some embodiments, the system further comprises a second user interface including one or more user interface components for manual and explicit selection of a value of a second information item of the penetration testing campaign, the second information item being other than a goal of the attacker, wherein the system is configured to receive the manual and explicit selection of the value of the second information item subsequent to the manual and explicit selection of the one or more goals.

In some embodiments, the penetration-testing-campaign module is configured, subsequent to the manual and explicit selection of both (i) the one or more goals of the attacker and (ii) the value of the second information item, to perform the penetration testing campaign using both (i) the manually and explicitly selected one or more goals of the attacker and (ii) the manually and explicitly selected value of the second information item.

A method of penetration testing of a networked system by a penetration testing system that is controlled by a user interface of a computing device so that a penetration testing campaign is executed according to an automatic selecting of one or more goals of an attacker of the penetration testing campaign, the method comprising: a. determining, by the penetration testing system, a type of the attacker of the penetration testing campaign; b. automatically selecting, by the penetration testing system and according to the type of the attacker of the penetration testing campaign, one or more goals of the attacker; c. executing the penetration testing campaign, by the penetration testing system and according to i. the type of the attacker of the penetration testing campaign, and ii. the automatically selected one or more goals, so as to test the networked system; d. reporting, by the penetration testing system, at least one security vulnerability determined to exist in the networked system by the executing of the penetration testing campaign, wherein the reporting comprises at least one of (i) causing a display device to display a report describing the at least one security vulnerability, and (ii) electronically transmitting a report describing the at least one security vulnerability.

In some embodiments, the determining of the type of the attacker comprises automatically determining the type of the attacker by the penetration testing system.

In some embodiments, the determining of the type of the attacker comprises receiving, via the user interface of the computing device, one or more manually-entered inputs that explicitly select the type of the attacker.

In some embodiments, at least one goal of the one or more goals satisfies at least one condition selected from the group consisting of: i. the at least one goal is a resource-specific goal; ii. the at least one goal is a file-specific goal; iii. the at least one goal is a node-count-maximizing goal; iv. the at least one goal is a file-count-maximizing goal; v. the at least one goal is an encryption-related goal; vi. the at least one goal is a file-exporting goal; vii. the at least one goal is a file-size-related goal; viii. the at least one goal is a file-type-related goal; ix. the at least one goal is a file-damage-related goal; and x. the at least one goal is a node-condition-based goal.

In some embodiments, the automatic selecting of one or more goals includes performing at least one of a. in response to a determination that the attacker type is state-sponsored, automatically selecting a goal to export as many files that are of a file type that may contain drawings as possible; b. in response to a determination that the attacker type is cyber-criminal, automatically selecting a goal to export as many Excel files as possible.

A system for penetration testing of a networked system, the system comprising: a. a goals-selection module configured to: i. determine a type of an attacker of a penetration testing campaign; and ii. based on a result of the determining, automatically select one or more goals of the attacker of the penetration testing campaign; b. a penetration-testing-campaign module programmed to perform the penetration testing campaign according to: i. the type of the attacker of the penetration testing campaign, and ii. the automatically selected one or more goals; c. a reporting module for reporting at least one security vulnerability determined to exist in the networked system according to results of the penetration testing campaign that is performed by the penetration-testing-campaign module, wherein the reporting module is configured to report the at least one security vulnerability by performing at least one of (i) causing a display device to display a report describing the at least one security vulnerability, and (ii) electronically transmitting a report describing the at least one security vulnerability.

In some embodiments, the goals-selection module is configured to automatically determine the type of the attacker of the penetration testing campaign.

In some embodiments, the goals-selection module is configured to determine the type of the attacker by receiving, via a user interface of a computing device, one or more manually-entered inputs that explicitly select the type of the attacker.

In some embodiments, at least one goal of the one or more goals satisfies at least one condition selected from the group consisting of: i. the at least one goal is a resource-specific goal; ii. the at least one goal is a file-specific goal; iii. the at least one goal is a node-count-maximizing goal; iv. the at least one goal is a file-count-maximizing goal; v. the at least one goal is an encryption-related goal; vi. the at least one goal is a file-exporting goal; vii. the at least one goal is a file-size-related goal; viii. the at least one goal is a file-type-related goal; ix. the at least one goal is a file-damage-related goal; and x. the at least one goal is a node-condition-based goal.

In some embodiments, the goals-selection module is configured to perform at least one of the following: a. in response to a determination that the attacker type is state-sponsored, a goal to export as many files that are of a file type that may contain drawings as possible is automatically selected; b. in response to a determination that the attacker type is cyber-criminal, a goal to export as many Excel files as possible is automatically selected.

A method of penetration testing of a networked system by a penetration testing system that is controlled by a user interface of a computing device so that a penetration testing campaign is executed according to a manually and explicitly-selected lateral movement strategy of an attacker of the penetration testing campaign, the method comprising: receiving, by the penetration testing system and via the user interface of the computing device, one or more manually-entered inputs, the one or more manually-entered inputs explicitly selecting the lateral movement strategy of the attacker of the penetration testing campaign; executing the penetration testing campaign, by the penetration testing system and according to the manually and explicitly-provided lateral movement strategy of the attacker, so as to test the networked system; and reporting, by the penetration testing system, at least one security vulnerability determined to exist in the networked system by the executing of the penetration testing campaign, wherein the reporting comprises at least one of (i) causing a display device to display a report describing the at least one security vulnerability, and (ii) electronically transmitting a report describing the at least one security vulnerability.

In some embodiments, the method is carried out so that before receiving the one or more manually-entered inputs that explicitly select the lateral movement strategy of the attacker, the penetration testing system automatically computes and displays an explicit recommendation for selecting the lateral movement strategy of the attacker.

In some embodiments, the received one or more manually-entered inputs comprises an explicit user approval of the explicit recommendation.

In some embodiments, the method further comprising: subsequent to the receiving by the penetration testing system of the one or more manually-entered inputs that explicitly select the lateral movement strategy of the attacker, receiving, by the penetration testing system and via the user interface of the computing device, one or more additional manually-entered inputs, the one or more additional manually-entered inputs explicitly selecting a value for a second information item of the penetration testing campaign, wherein the second information item is not a lateral movement strategy of the attacker.

In some embodiments, the executing of the penetration testing campaign is performed using both (i) the manually and explicitly selected value for the second information item, and (ii) the manually and explicitly selected lateral movement strategy of the attacker.

A system for penetration testing of a networked system, the system comprising: a. a lateral-movement-strategy-selection user interface including one or more user interface components for explicit and manual selection of a lateral movement strategy of an attacker of a penetration testing campaign; b. a penetration-testing-campaign module programmed to perform the penetration testing campaign according to the lateral movement strategy that is manually and explicitly selected via the lateral-movement-strategy-selection user interface; and c. a reporting module for reporting at least one security vulnerability determined to exist in the networked system according to results of the penetration testing campaign that is performed by the penetration-testing-campaign module, wherein the reporting module is configured to report the at least one security vulnerability by performing at least one of (i) causing a display device to display a report describing the at least one security vulnerability, and (ii) electronically transmitting a report describing the at least one security vulnerability.

In some embodiments, the system further comprises a recommendation module configured to automatically compute an explicit recommendation for selecting a lateral movement strategy of the attacker, wherein the lateral-movement-strategy-selection user interface displays the explicit recommendation.

In some embodiments, the system is configured so that the manual and explicit selection of the lateral movement strategy of the attacker includes a manual and explicit approval of the explicit recommendation.

In some embodiments, the system further comprises a second user interface including one or more user interface components for manual and explicit selection of a value of a second information item of the penetration testing campaign, the second information item being other than a lateral movement strategy of the attacker, wherein the system is configured to receive the manual and explicit selection of the value of the second information item subsequent to the manual and explicit selection of the lateral movement strategy.

In some embodiments, the penetration-testing-campaign module is configured, subsequent to the manual and explicit selection of both (i) the lateral movement strategy of the attacker and (ii) the value of the second information item, to perform the penetration testing campaign using both (i) the manually and explicitly selected lateral movement strategy of the attacker and (ii) the manually and explicitly selected value of the second information item.

A method of penetration testing of a networked system by a penetration testing system that is controlled by a user interface of a computing device so that a penetration testing campaign is executed according to an automatic selecting of a lateral movement strategy of an attacker of the penetration testing campaign, the method comprising: a. determining, by the penetration testing system, at least one of (i) a type of the attacker of the penetration testing campaign and (ii) one or more goals of the attacker of the penetration testing campaign; b. based on a result of the determining, automatically selecting by the penetration testing system a lateral movement strategy of the attacker of the penetration testing campaign; c. executing the penetration testing campaign, by the penetration testing system and according to i. the at least one of the type of the attacker and the one or more goals of the attacker, and ii. the automatically selected lateral movement strategy of the attacker, so as to test the networked system; d. reporting, by the penetration testing system, at least one security vulnerability determined to exist in the networked system by the executing of the penetration testing campaign, wherein the reporting comprises at least one of (i) causing a display device to display a report describing the at least one security vulnerability, and (ii) electronically transmitting a report describing the at least one security vulnerability.

In some embodiments, the determining comprises determining the type of the attacker of the penetration testing campaign.

In some embodiments, the determining of the type of the attacker comprises automatically determining the type of the attacker by the penetration testing system.

In some embodiments, the determining of the type of the attacker comprises receiving, via the user interface of the computing device, one or more manually-entered inputs that explicitly select the type of the attacker.

In some embodiments, the determining comprises determining the one or more goals of the attacker of the penetration testing campaign.

In some embodiments, the determining of the one or more goals of the attacker comprises automatically determining the one or more goals of the attacker by the penetration testing system.

In some embodiments, the determining of the one or more goals of the attacker comprises receiving, via the user interface of the computing device, one or more manually-entered inputs that explicitly select the one or more goals of the attacker.

A system for penetration testing of a networked system, the system comprising: a. a lateral-movement-strategy-selection module configured to: determine at least one of (i) a type of the attacker of the penetration testing campaign and (ii) one or more goals of the attacker of the penetration testing campaign; based on a result of the determining, automatically select a lateral movement strategy of the attacker of the penetration testing campaign; b. a penetration-testing-campaign module programmed to perform the penetration testing campaign according to the automatically selected lateral movement strategy; and c. a reporting module for reporting at least one security vulnerability determined to exist in the networked system according to results of the penetration testing campaign that is performed by the penetration-testing-campaign module, wherein the reporting module is configured to report the at least one security vulnerability by performing at least one of (i) causing a display device to display a report describing the at least one security vulnerability, and (ii) electronically transmitting a report describing the at least one security vulnerability.

In some embodiments, the lateral-movement-strategy-selection module is configured to determine the type of the attacker of the penetration testing campaign.

In some embodiments, the lateral-movement-strategy-selection module is configured to automatically determine the type of the attacker of the penetration testing campaign.

In some embodiments, the lateral-movement-strategy-selection module is configured to determine the type of the attacker by receiving, via a user interface of a computing device, one or more manually-entered inputs that explicitly select the type of the attacker.

In some embodiments, the lateral-movement-strategy-selection module is configured to determine the one or more goals of the attacker of the penetration testing campaign.

In some embodiments, the lateral-movement-strategy-selection module is configured to automatically determine the one or more goals of the attacker of the penetration testing campaign.

In some embodiments, the lateral-movement-strategy-selection module is configured to determine the one or more goals of the attacker by receiving, via a user interface of a computing device, one or more manually-entered inputs that explicitly select the one or more goals of the attacker.

A method of penetration testing of a networked system by a penetration testing system that is controlled by a user interface of a computing device so that a penetration testing campaign is executed according to manually and explicitly-selected sensitivity to detection of an attacker of the penetration testing campaign, the method comprising: receiving, by the penetration testing system and via the user interface of the computing device, one or more manually-entered inputs, the one or more manually-entered inputs explicitly selecting a level of sensitivity to detection of the attacker of the penetration testing campaign; executing the penetration testing campaign, by the penetration testing system and according to the manually and explicitly-provided selection of the level of sensitivity to detection of the attacker, so as to test the networked system; and reporting, by the penetration testing system, at least one security vulnerability determined to exist in the networked system by the executing of the penetration testing campaign, wherein the reporting comprises at least one of (i) causing a display device to display a report describing the at least one security vulnerability, and (ii) electronically transmitting a report describing the at least one security vulnerability.

In some embodiments, the method is carried out so that before receiving the one or more manually-entered inputs that explicitly select the level of sensitivity to detection of the attacker, the penetration testing system automatically computes and displays an explicit recommendation for selecting the level of sensitivity to detection of the attacker.

In some embodiments, the received one or more manually-entered inputs comprises an explicit user approval of the explicit recommendation.

In some embodiments, further comprising: subsequent to the receiving by the penetration testing system of the one or more manually-entered inputs that explicitly select the level of sensitivity to detection of the attacker, receiving, by the penetration testing system and via the user interface of the computing device, one or more additional manually-entered inputs, the one or more additional manually-entered inputs explicitly selecting a value for a second information item of the penetration testing campaign, wherein the second information item is not a level of sensitivity to detection of the attacker.

In some embodiments, the executing of the penetration testing campaign is performed using both (i) the manually and explicitly selected value for the second information item, and (ii) the manually and explicitly selected level of sensitivity to detection of the attacker.

In some embodiments, the manual and explicit selection of the level of sensitivity to detection of the attacker is a selection between two pre-defined alternative levels. In some embodiments, the manual and explicit selection of the level of sensitivity to detection of the attacker is a selection from a list of multiple pre-defined levels, the list containing at least three levels.

In some embodiments, the manual and explicit selection of the level of sensitivity to detection of the attacker is a selection in which any value from a pre-defined numerical interval may be selected.

A system for penetration testing of a networked system, the system comprising: a. an attacker-sensitivity-selection user interface including one or more user interface components for manual and explicit selection of a level of sensitivity to detection of an attacker of a penetration testing campaign; b. a penetration-testing-campaign module programmed to perform the penetration testing campaign whose attacker has the level of sensitivity to detection that is manually and explicitly selected via the attacker-sensitivity-selection user interface; and c. a reporting module for reporting at least one security vulnerability determined to exist in the networked system according to results of the penetration testing campaign that is performed by the penetration-testing-campaign module, wherein the reporting module is configured to report the at least one security vulnerability by performing at least one of (i) causing a display device to display a report describing the at least one security vulnerability, and (ii) electronically transmitting a report describing the at least one security vulnerability.

In some embodiments, the system further comprises a recommendation module configured to automatically compute an explicit recommendation for selecting the level of sensitivity to detection of the attacker, wherein the attacker-sensitivity-selection user interface displays the explicit recommendation.

In some embodiments, the system is configured so that the manual and explicit selection of the level of sensitivity to detection of the attacker includes a manual and explicit approval of the explicit recommendation.

In some embodiments, the system further comprises a second user interface including one or more user interface components for manual and explicit selection of a value of a second information item of the penetration testing campaign, the second information item being other than a level of sensitivity to detection of the attacker, wherein the system is configured to receive the manual and explicit selection of the value of the second information item subsequent to the manual and explicit selection of the level of sensitivity to detection.

In some embodiments, the penetration-testing-campaign module is configured, subsequent to the manual and explicit selection of both (i) the level of sensitivity to detection of the attacker and (ii) the value of the second information item, to perform the penetration testing campaign using both (i) the manually and explicitly selected level of sensitivity to detection of the attacker and (ii) the manually and explicitly selected value of the second information item.

In some embodiments, the manual and explicit selection of the level of sensitivity to detection of the attacker is a selection between two pre-defined alternative levels.

In some embodiments, the manual and explicit selection of the level of sensitivity to detection of the attacker is a selection from a list of multiple pre-defined levels, the list containing at least three levels.

In some embodiments, the manual and explicit selection of the level of sensitivity to detection of the attacker is a selection in which any value from a pre-defined numerical interval may be selected.

To date, there are two main approaches in penetration testing: (i) actual attack penetration testing, which has the advantage of accuracy, and (ii) simulated penetration testing, which avoids exposing the tested networked system to risk during penetration testing.

An automated penetration testing system that is neither a direct attack penetration testing system, nor a simulated penetration testing system is now disclosed. It includes the use of a reconnaissance agent software modules (RASM) installed on multiple network nodes of the tested networked system, and therefore it is referred to herein as “reconnaissance agent penetration testing system”. As discussed below, in embodiments of the invention, the penetration testing system makes use of ‘internal data’ of multiple nodes of the tested networked system—this internal data is transmitted from the multiple nodes to a remote computing device on which a penetration testing software module is installed.

Towards this end, apparatus and methods are now disclosed which address the above deficiencies, including not exposing any node of the tested networked system to risk, while still providing one or more advantages of actual attack penetration systems.

As will be explained below, these features are combined with software architecture features such that: (i) instances of the RASM installed on multiple network nodes (hereinafter RASM-hosting nodes') of the tested networked system transmit internal data of the RASM-hosting nodes to the remote computing device; (ii) this internal data is analyzed on the remote computing device; (iii) all of the analysis required for determining a method for an attacker to compromise the networked system is performed by the remote computing device; and (iv) no network node is put under a risk of being compromised during the testing process.

The aforementioned software architecture features may be useful, for example, for minimizing the CPU burden of penetration testing imposed on each of the multiple nodes of the penetration-tested networked system. Alternatively or additionally, these software architecture features may be useful for updating—e.g. when new threats need to be added to a threat-database, there is no need to update this threat-database on each of the RASM-hosting nodes. Instead, the threat-database may be updated only on the remote computing device.

Preferably, these RASM instances are not completely autonomous, but rather obtain the internal data of the RASM-hosting network nodes and/or transmit the internal data in response to a data-requesting command received, by each of the RASM-hosting network nodes, from the remote computing device.

Similar to actual-attack penetration testing systems, actual data from the network nodes is analyzed to determine the method for the attacker to compromise the networked system. According to the present invention, this actual data includes actual internal data. It should be noted that the internal data of a specific node (i) is only directly accessible to code executing by a processor of the specific node and (ii) is only accessible to any code executing outside of the specific node by receiving it from code executing by a processor of the specific node. Therefore, in order to the remote computing device to analyze such internal data, the RASM instances must be installed on each of the network nodes from which it is desired to obtain data during the test.

Internal data of a network node includes one or more of:
(A) Internal events occurring in the network node, for example the insertion of a USB stick into the network node;
(B) Internal conditions existing in the network node, for example whether the CPU of a given network node is heavily loaded or not; and
(C) Internal factual data about the network node, for example the firmware version of a solid-state storage device attached to the network node.

Even though analysis is performed using actual internal data from the actual network nodes, no node is ever placed at risk during the penetration testing—this is in contrast with actual attack penetration testing systems (this is the ‘second rule’ discussed below).

Thus, according to embodiments of the invention, the penetration testing is carried out to enforce both first and second rules:
(A) According to the first rule, all of the analyzing of the internal data for determining the method for the attacker to compromise the networked system is performed by the remote computing device. As noted above, this may be useful, for example, for minimizing the CPU burden of penetration testing imposed on each of the nodes of the penetration-tested networked system. Alternatively or additionally (and as noted above), this may be useful for updating—e.g. when new threats need to be added to a threat-database, there is no need to update this threat-database on each of the nodes. Instead, the threat-database may be updated only on the remote computing device; and
(B) According to the second rule, no node is ever placed at risk during the penetration testing. Thus, in embodiments of the invention, it is now possible to enjoy the benefits of the second rule while simultaneously obtaining results that are more accurate than those obtainable by conventional simulated penetration testing.

In order to better understand embodiments of the invention, the reader is referred to three use case examples presented below in the Detailed Description of the Embodiments Section of this document.

Optionally, and in some embodiments preferably, the RASM is preinstalled on each of the participating nodes. Thus, some embodiments provide a RASM ‘pre-installation feature’ instead of (or in addition to) the features of having the first and second rules enforced.

The pre-installation may make the penetration testing simpler and more reliable. The pre-installation can be closely monitored by the IT people of the organization and any problem or issue of access right can be resolved prior to the testing. Additionally, if agents are employed without being pre-installed, then they are installed instead at runtime during the testing process. This implies that the state of the tested networked system is being changed by the test and unexpected side-effects might occur.

In some embodiments, the RASM instances are pre-installed and both the first and second rules are enforced.

In some embodiments, the RASM instances are pre-installed and only the first rule is enforced.

In some embodiments, the RASM instances are pre-installed and only the second rule is enforced.

One aspect of the invention relates to a method for executing a penetration test of a networked system by a penetration testing system so as to determine, while enforcing first and second rules, a method for an attacker to compromise the networked system. According to the method, the penetration testing system comprises (A) a penetration testing software module installed on a remote computing device and (B) a reconnaissance agent software module (RASM) installed on at least some network nodes of the networked system so that each network node of the networked system on which the RASM is installed is defined as a RASM-hosting network node.

The method for executing the penetration test comprising: a. obtaining, by each given RASM-hosting network node of one or more RASM-hosting network nodes, respective internal data of the given RASM-hosting network node, the obtaining comprising executing computer code of the RASM by one or more processors of the given RASM-hosting network node, the respective internal data including data about at least one of: A. an internal event of the given RASM hosting network node, B. an internal condition of the given RASM-hosting network node, and C. an internal fact of the given RASM-hosting network node; b. transmitting to the remote computing device, by each given RASM-hosting network node of the one or more RASM-hosting network nodes, the obtained respective internal data of the given RASM-hosting network node, the transmitting comprising executing computer code of the RASM by the one or more processors of the given RASM-hosting network node; c. analyzing, by the remote computing device, the internal data transmitted by at least one RASM-hosting network node of the one or more RASM-hosting network nodes, so as to determine the method for the attacker to compromise the networked system, the analyzing comprising executing computer code of the penetration testing software module by one or more processors of the remote computing device; and d. reporting, by the penetration testing system, the method for the attacker to compromise the networked system, the reporting comprising executing computer code of the penetration testing software module by the one or more processors of the remote computing device, wherein the reporting comprises at least one of (i) causing a display device to display a report including information about the determined method for the attacker to compromise the networked system, (ii) recording the report including the information about the determined method for the attacker to compromise the networked system in a file, and (iii) electronically transmitting the report including the information about the determined method for the attacker to compromise the networked system, wherein each given RASM-hosting network node of the one or more RASM-hosting network nodes performs at least one of step (a) and step (b) in response to a receiving of one or more data-requesting commands from the remote computing device, and wherein the method for executing the penetration test is performed in a manner that enforces the first and second rules such that: A. according to the first rule, all of the analyzing of the internal data for determining the method for the attacker to compromise the networked system is performed by the remote computing device; and B. according to the second rule, no network node of the networked system is ever put at risk of being compromised by the executing of the penetration test.

In some embodiments, the RASM is installed on at least one of the one or more RASM-hosting network nodes prior to the beginning of the executing of the penetration test.

In some embodiments, the RASM is installed on all of the one or more RASM-hosting network nodes prior to the beginning of the executing of the penetration test.

In some embodiments, the RASM is installed on every network node of the networked system which is a RASM-hosting network node prior to the beginning of the executing of the penetration test.

In some embodiments, at least one given RASM-hosting network node of the one or more RASM-hosting network nodes performs the obtaining in response to the receiving, by the given RASM-hosting network node, of the one or more data-requesting commands from the remote computing device.

In some embodiments, at least one given RASM-hosting network node of the one or more RASM-hosting network nodes obtains at least some of the respective internal data of the given RASM-hosting network node transmitted in step (b) before the receiving of the one or more data-requesting commands by the given RASM-hosting network node.

In some embodiments, each given RASM-hosting network node of the one or more RASM-hosting network nodes performs both steps (a) and (b) in response to the receiving, by the given RASM-hosting network node, of the one or more data-requesting commands from the remote computing device.

In some embodiments, the information about the method for an attacker to compromise the networked system comprises at least one of: (i) information about a method for compromising one network node of the networked system (ii) information about one or more network nodes of the networked system which are vulnerable to attack, (iii) information about one or more resources of the networked system that could be damaged or exported out of the networked system by an attacker, and (iv) information about an ordered list of network nodes of the networked system, wherein an attacker could use a specific network node in said ordered list that is already compromised as a basis for compromising another network node that immediately follows said specific network node in said ordered list.

In some embodiments, the analyzing comprises: (i) assessing, by said remote computing device, if a first network node can be compromised; and (ii) in the event that the assessing indicates that said first network node can be compromised, A. simulating or evaluating, by said remote computing device, a result of compromising said first network node; and B. determining, by said remote computing device and based on said result, that a second network node can be compromised.

Another aspect of the invention relates to a penetration testing system for executing a penetration test of a networked system so as to determine, while enforcing first and second rules, a method for an attacker to compromise the networked system. The penetration testing system comprises: a. a remote computing device comprising a computer memory and one or more processors, the remote computing device in electronic communication with the networked system; b. a first non-transitory computer-readable storage medium containing first code of a reconnaissance agent software module (RASM), wherein execution of the first code of the RASM by respective one or more processors of each given network node of a first set of network nodes of the networked system, causes the one or more processors of the given network node of the first set to carry out the following: i. obtaining respective internal data of the given network node of the first set, the respective internal data including data about at least one of: A. an internal event of the given network node of the first set, B. an internal condition of the given network node of the first set, and C. an internal fact of the given network node of the first set; and ii. transmitting to the remote computing device and out of the given network node of the first set the obtained respective internal data of the given network node of the first set, such that at least one of the obtaining and the transmitting is performed in response to one or more data-requesting commands issued by the remote computing device; c. a second non-transitory computer-readable storage medium containing second code of a penetration testing software module, wherein execution of the second code of the penetration testing software module by the one or more processors of the remote computing device: i. analyzes the respective internal data transmitted by each given network node of a second set of network-nodes of the networked system so as to determine the method for the attacker to compromise the networked system; and ii. reports the method for the attacker to compromise the networked system, wherein the reporting comprises at least one of (A) causing a display device to display a report including information about the determined method for the attacker to compromise the networked system, (B) recording the report including the information about the determined method for the attacker to compromise the networked system in a file, and (C) electronically transmitting a report including the information about the determined method for the attacker to compromise the networked system, wherein (i) the execution of the first code of the RASM by the respective one or more processors of each given network node of the first set of network nodes of the networked system; and (ii) the execution of the second code of the penetration testing software module by the one or more processors of the remote computing device, subject the networked system to penetration testing while enforcing both of the first and second rules such that: A. according to the first rule, all of the analyzing of the internal data for determining the method for the attacker to compromise the networked system is performed by the remote computing device; and B. according to the second rule, no network node of the networked system is ever put at risk of being compromised by the executing of the penetration test.

In some embodiments, for at least one given network node of the first set of network nodes, the execution of the first code by the respective one or more processors of the given network node performs the obtaining in response to the one or more data-requesting commands issued by the remote computing device.

In some embodiments, for at least one given network node of the first set of network nodes, the execution of the first code by the respective one or more processors of the given network node performs the obtaining of at least some of the respective internal data of the given network node before the issuing of the one or more data-requesting commands by the remote computing device.

In some embodiments, for each given network node of the first set of network nodes, the execution of the first code by the respective one or more processors of the given network node performs the obtaining and the transmitting in response to the one or more data-requesting commands issued by the remote computing device.

In some embodiments, the information about the method for an attacker to compromise the networked system comprises at least one of: (i) information about a method for compromising one network node of the networked system (ii) information about one or more network nodes of the networked system which are vulnerable to attack, (iii) information about one or more resources of the networked system that could be damaged or exported out of the networked system by an attacker, and (iv) information about an ordered list of network nodes of the networked system, wherein an attacker could use a specific network node in said ordered list that is already compromised as a basis for compromising another network node that immediately follows said specific network node in said ordered list.

In some embodiments, the analyzing performed by the execution of the second code of the penetration testing software module by the one or more processors of the remote computing device comprises: (i) assessing if a first network node can be compromised; and (ii) in the event that the assessing indicates that said first network node can be compromised, A. simulating or evaluating a result of compromising said first network node; and B. determining that a second network node can be compromised.

Another aspect of the invention relates to a method for executing a penetration test of a networked system by a penetration testing system so as to determine a method for an attacker to compromise the networked system, where the penetration testing system comprises (A) a penetration testing software module installed on a remote computing device and (B) a reconnaissance agent software module (RASM) installable on network nodes of the networked system so that each network node of the networked system on which the RASM is installed is defined as a RASM-hosting network node.

The method for executing the penetration test comprises: a. subsequent to an installing of the RASM on at least some network nodes of the networked system, which installing occurs prior to starting the executing of the penetration test, performing the following: i. obtaining, by each given RASM-hosting network node of one or more RASM-hosting network nodes, respective internal data of the given RASM-hosting network node, the obtaining comprising executing computer code of the RASM by one or more processors of the given RASM-hosting network node, the respective internal data including data about at least one of: A. an internal event of the given RASM-hosting network node, B. an internal condition of the given RASM-hosting network node, and C. an internal fact of the given RASM-hosting network node; and ii. transmitting to the remote computing device, by each given RASM-hosting network node of the one or more RASM-hosting network nodes, the obtained respective internal data of the given RASM-hosting network node, the transmitting comprising executing computer code of the RASM by the one or more processors of the given RASM-hosting network node; b. analyzing, by the remote computing device, the internal data transmitted by at least one RASM-hosting network node of the one or more RASM-hosting network nodes, so as to determine the method for the attacker to compromise the networked system, the analyzing comprising executing computer code of the penetration testing software module by one or more processors of the remote computing device; and c. reporting, by the penetration testing system, the method for the attacker to compromise the networked system, the reporting comprising executing computer code of the penetration testing software module by the one or more processors of the remote computing device, wherein the reporting comprises at least one of (i) causing a display device to display a report including information about the determined method for the attacker to compromise the networked system, (ii) recording the report including the information about the determined method for the attacker to compromise the networked system in a file, and (iii) electronically transmitting the report including the information about the determined method for the attacker to compromise the networked system, wherein each given RASM-hosting network node of the one or more RASM-hosting network nodes performs at least one of step a(i) and step a(ii) in response to a receiving of one or more data-requesting commands from the remote computing device.

In some embodiments, further comprising the step of: d. before commencing step (a), installing the RASM on the at least some network nodes of the networked system.

In some embodiments, the method for executing the penetration test is performed in a manner that enforces at least one of first and second rules such that: A. according to the first rule, all of the analyzing of the internal data for determining the method for the attacker to compromise the networked system is performed by the remote computing device; and B. according to the second rule, no network node of the networked system is ever put at risk of being compromised by the executing of the penetration test.

In some embodiments, the method for executing the penetration test is performed in a manner that enforces at least the first rule.

In some embodiments, the method for executing the penetration test is performed in a manner that enforces at least the second rule.

In some embodiments, the method for executing the penetration test is performed in a manner that enforces both the first and second rules.

In some embodiments, at least one given RASM-hosting network node of the one or more RASM-hosting network nodes performs the obtaining in response to the receiving, by the given RASM-hosting network node, of the one or more data-requesting commands from the remote computing device.

In some embodiments, at least one given RASM-hosting network node of the one or more RASM-hosting network nodes obtains at least some of the respective internal data of the given RASM-hosting network node transmitted in step a(ii) before the receiving of the one or more data-requesting commands by the given RASM-hosting network node.

In some embodiments, each given RASM-hosting network node of the one or more RASM-hosting network nodes performs both steps a(i) and a(ii) in response to the receiving, by the given RASM-hosting network node, of the one or more data-requesting commands from the remote computing device.

In some embodiments, the information about the method for an attacker to compromise the networked system comprises at least one of: (i) information about a method for compromising one network node of the networked system (ii) information about one or more network nodes of the networked system which are vulnerable to attack, (iii) information about one or more resources of the networked system that could be damaged or exported out of the networked system by an attacker, and (iv) information about an ordered list of network nodes of the networked system, wherein an attacker could use a specific network node in said ordered list that is already compromised as a basis for compromising another network node that immediately follows said specific network node in said ordered list.

In some embodiments, said analyzing comprises: (i) assessing, by said remote computing device, if a first network node can be compromised; (ii) in the event that the assessing indicates that said first network node can be compromised, A. simulating or evaluating, by said remote computing device, a result of compromising said first network node; and B. determining, by said remote computing device and based on said result, that a second network node can be compromised.

Another aspect of the invention relates to a penetration testing system for executing a penetration test of a networked system so as to determine a method for an attacker to compromise the networked system, the penetration testing system comprising: a. a remote computing device comprising a computer memory and one or more processors, the remote computing device in electronic communication with the networked system; b. a first non-transitory computer-readable storage medium containing first code of a reconnaissance agent software module (RASM), wherein for a first set of network-nodes of the networked system on which the RASM is pre-installed before starting the executing of the penetration test, subsequent execution of the first code, after starting the executing of the penetration test, by respective one or more processors of each given network node of the first set of network nodes, causes the one or more processors of the given network node of the first set to carry out the following: i. obtaining respective internal data of the given network node of the first set, the respective internal data including data about at least one of: A. an internal event of the given network node of the first set, B. an internal condition of the given network node of the first set, and C. an internal fact of the given network node of the first set; and ii. transmitting to the remote computing device and out of the given network node of the first set the obtained respective internal data of the given network node of the first set, such that at least one of the obtaining and the transmitting is performed in response to one or more data-requesting commands issued by the remote computing device; and c. a second non-transitory computer-readable storage medium containing second code of a penetration testing software module, wherein execution of the second code of the penetration testing software module by the one or more processors of the remote computing device: i. analyzes the respective internal data transmitted by each given network node of a second set of network-nodes of the networked system, so as to determine the method for the attacker to compromise the networked system; and ii. reports the method for the attacker to compromise the networked system, wherein the reporting comprises at least one of (A) causing a display device to display a report including information about the determined method for the attacker to compromise the networked system, (B) recording the report including the information about the determined method for the attacker to compromise the networked system in a file, and (C) electronically transmitting a report including the information about the determined method for the attacker to compromise the networked system, wherein (i) the execution of the first code of the RASM by the respective one or more processors of each given network node of the first set of network nodes of the networked system; and (ii) the execution of the second code of the penetration testing software module by the one or more processors of the remote computing device, subject the networked system to penetration testing.

In some embodiments, (i) the execution of the first code of the RASM by the respective one or more processors of each given network node of the first set of network nodes of the networked system; and (ii) the execution of the second code of the penetration testing software module by the one or more processors of the remote computing device, subject the networked system to penetration testing while enforcing a rule such that all of the analyzing of the internal data for determining the method for the attacker to compromise the networked system is performed by the remote computing device.

In some embodiments, (i) the execution of the first code of the RASM by the respective one or more processors of each given network node of the first set of network nodes of the networked system; and (ii) the execution of the second code of the penetration testing software module by the one or more processors of the remote computing device, subject the networked system to penetration testing while enforcing a rule such that no network node of the networked system is ever put at risk of being compromised by the executing of the penetration test.

In some embodiments, (i) the execution of the first code of the RASM by the respective one or more processors of each given network node of the first set of network nodes of the networked system; and (ii) the execution of the second code of the penetration testing software module by the one or more processors of the remote computing device, subject the networked system to penetration testing while enforcing both first and second rules such that: A. according to the first rule, all of the analyzing of the internal data for determining the method for the attacker to compromise the networked system is performed by the remote computing device; and B. according to the second rule, no network node of the networked system is ever put at risk of being compromised by the executing of the penetration test.

In some embodiments, for at least one given network node of the first set of network nodes, the execution of the first code by the respective one or more processors of the given network node performs the obtaining in response to the one or more data-requesting commands issued by the remote computing device.

In some embodiments, for at least one given network node of the first set of network nodes, the execution of the first code by the respective one or more processors of the given network node performs the obtaining of at least some of the respective internal data of the given network node before the issuing of the one or more data-requesting commands by the remote computing device.

In some embodiments, for each given network node of the first set of network nodes, the execution of the first code by the respective one or more processors of the given network node performs the obtaining and the transmitting in response to the one or more data-requesting commands issued by the remote computing device.

In some embodiments, the information about the method for an attacker to compromise the networked system comprises at least one of: (i) information about a method for compromising one network node of the networked system (ii) information about one or more network nodes of the networked system which are vulnerable to attack, (iii) information about one or more resources of the networked system that could be damaged or exported out of the networked system by an attacker, and (iv) information about an ordered list of network nodes of the networked system, wherein an attacker could use a specific network node in said ordered list that is already compromised as a basis for compromising another network node that immediately follows said specific network node in said ordered list.

In some embodiments, the analyzing performed by the execution of the second code of the penetration testing software module by the one or more processors of the remote computing device comprises: (i) assessing if a first network node can be compromised; (ii) in the event that the assessing indicates that said first network node can be compromised, A. simulating or evaluating a result of compromising said first network node; and B. determining that a second network node can be compromised.

In some embodiments of the invention, the presently-disclosed penetration testing system further includes a penetration testing software module that is installed on a remote computing device which can communicate with at least one of the network nodes of the tested networked system on which a reconnaissance agent is installed. The penetration testing software module implements (i) the portion of the reconnaissance function that is not implemented by the multiple instances of the reconnaissance agent, (ii) the attack function and (iii) the reporting function. Optionally, it may also implement other functions of the penetration testing process, for example a recovery function.

In some embodiments of the invention, one or more (i.e. any combination of) the following features are provided:
A. The system includes a local agent installed on multiple network nodes.
B. The agent is installed before starting the test.
C. Each instance of the agent collects data, including internal data of the network node on which it is installed.
D. The system includes a remote server that does (at least) the determination of vulnerabilities.
E. The agent reports to the server in response to the server's commands.
F. The agent reports raw data and does not determine vulnerabilities. It is the server that does such determination.
G. The agent collects data without risking compromising the hosting node.
H. The remote server verifies that a potential vulnerability is indeed a vulnerability without risking compromising the networked system. This implies it is not using real attacks of the tested system.
I. The attack process is iterative—one node at a time.

Some embodiments of the invention relate to methods and systems for detecting opportunistic vulnerabilities in a network node of a networked system.

According to an aspect of an embodiment of the invention, there is provided a method for discovering and reporting a security vulnerability of a networked system by a penetration testing system, the networked system including a plurality of network nodes interconnected by one or more networks, wherein the penetration testing system includes (i) a reconnaissance agent software module, that (A) can be installed on one or more network nodes of the plurality of network nodes, and (B) when installed on a network node of the plurality of network nodes, is operable to detect at least some free events occurring in the network node on which it is installed and to transmit data about occurrences of the at least some free events to a remote computing device, and (ii) a penetration testing software module installed on the remote computing device and operable to communicate with at least one of the plurality of network nodes on which the reconnaissance agent software module is installed, the method including:
a) receiving, by the penetration testing software module installed on the remote computing device, a message from a first network node on which the reconnaissance agent software module is installed, the message notifying the remote computing device of a specific occurrence of a specific free event in the first network node, wherein the message originates from the reconnaissance agent software module installed on the first network node, and wherein the specific free event is one of:
   i) sending a network message out of the first network node caused by a command from a user of the first network node;
   ii) sending a network message out of the first network node caused by an operating system of the first network node;
   iii) sending a network message out of the first network node caused by a software application installed on the first network node;
   iv) mounting a storage volume onto the first network node; and
   v) physically attaching a physical device to the first network node;
b) identifying, by the penetration testing software module and based on the received message, a specific opportunistic vulnerability with which the specific free event is associated, wherein the identifying of the specific opportunistic vulnerability includes:
   i) identifying a method for an attacker to compromise the first network node, and
   ii) identifying that the method to compromise would be available to the attacker at or after a future occurrence of the specific free event in the first network node; and
c) reporting, by the penetration testing system, the specific opportunistic vulnerability, wherein the reporting includes at least one of: (i) causing a display device to display a report including information about the specific opportunistic vulnerability, (ii) storing the report including information about the specific opportunistic vulnerability in a file, and (iii) electronically transmitting the report including information about the specific opportunistic vulnerability.

In some embodiments, the specific free event is an internal event of the first network node.

In some embodiments, the identifying of the specific opportunistic vulnerability includes executing the method for an attacker to compromise so as to validate that the first network node is compromised by the method for an attacker to compromise.

In some embodiments, the identifying of the specific opportunistic vulnerability includes validating that the first network node is compromised by the method of an attacker to compromise by simulating or otherwise evaluating the method for an attacker to compromise, without attempting to compromise the first network node.

In some embodiments, the message notifying the remote computing device of the specific occurrence of the specific free event in the first network node is sent by the reconnaissance agent software module installed on the first network node immediately after and in response to detecting the specific occurrence of the specific free event in the first network node.

In some embodiments, the message notifying the remote computing device of the specific occurrence of the specific free event in the first network node is sent by the reconnaissance agent software module installed on the first network node according to a schedule that is independent of (i) a time of occurrence of the specific occurrence of the specific free event in the first network node, and (ii) a time of detection of the specific occurrence of the specific free event in the first network node by the reconnaissance agent software module installed on the first network node.

In some embodiments, the specific free event is an event of physically attaching a physical device to the first network node.

In some embodiments, the specific free event is an attaching of a storage device to a port of the of the first network node. In some embodiments, the storage device is a removable USB storage device and the port is a USB port.

In some embodiments, the specific free event is an attaching of a communication device to a port of the first network node.

In some embodiments, the specific free event is an event of mounting a storage volume onto the first network node.

In some embodiments, the specific free event is an event of sending a network message out of the first network node, the sending caused by a command from a user of the first network node.

In some embodiments, the specific free event is a submission of a query from the first network node to a server.

In some embodiments, the specific free event is an event of sending a network message out of the first network node, the sending caused by an operating system of the first network node.

In some embodiments, the specific free event is an event of sending an ARP request message out of the first network node.

In some embodiments, the specific free event is an event of sending a network message out of the first network node, the sending caused by a software application installed on the first network node.

In some embodiments, the specific free event is an event of sending a WPAD message out of the first network node.

According to an aspect of an embodiment of the invention, there is provided a system for discovering and reporting a security vulnerability of a networked system, the networked system including a plurality of network nodes interconnected by one or more networks, each network node of the plurality of network nodes including one or more processors, and at least one network node of the plurality of network nodes is in electronic communication with a remote computing device, the remote computing device including one or more processors, the penetration testing system including:
a) a reconnaissance agent non-transitory computer readable storage medium for instructions execution by the one or more processors of a first network node which is in electronic communication with the remote computing device, the reconnaissance agent non-transitory computer readable storage medium having stored:
   (1) instructions to detect at least some free events occurring in the first network node; and
   (2) instructions to transmit data about occurrences of the at least some free events to the remote computing device;
b) a penetration testing non-transitory computer readable storage medium for instructions execution by the one or more processors of the remote computing device, the penetration testing non-transitory computer readable storage medium having stored:
   (1) instructions to receive a message from the first network node, the message notifying the remote computing device of a specific occurrence of a specific free event in the first network node, wherein the specific free event is one of:
      (a) sending a network message out of the first network node caused by a command from a user of the first network node;
      (b) sending a network message out of the first network node caused by an operating system of the first network node;
      (c) sending a network message out of the first network node caused by a software application installed on the first network node;
      (d) mounting a storage volume onto the first network node; and
      (e) physically attaching a physical device to the first network node;
   (2) instructions to identify, based on the received message, a specific opportunistic vulnerability with which the specific free event is associated, wherein the instructions to identify the specific opportunistic vulnerability include:
      (a) instructions to identify a method for an attacker to compromise the first network node, and
      (b) instructions to identify that the method to compromise would be available to the attacker at or after a future occurrence of the specific free event in the first network node; and
      (c) instructions to report the specific opportunistic vulnerability, the instructions to report including at least one of: (i) instructions to cause a display device to display information about the specific opportunistic vulnerability, (ii) instructions to store the information about the specific opportunistic vulnerability in a file, and (iii) instructions to electronically transmit the information about the specific opportunistic vulnerability.

In some embodiments, the specific free event is an internal event of the first network node.

In some embodiments, the instructions to identify the specific opportunistic vulnerability include instructions to execute the method for an attacker to compromise so as to validate that the first network node is compromised by the method for an attacker to compromise.

In some embodiments, the instructions to identify the specific opportunistic vulnerability include instructions to simulate or otherwise evaluate the method for an attacker to compromise so as to validate that the first network node is compromised by the method of an attacker to compromise, without attempting to compromise the first network node.

In some embodiments, the message notifying the remote computing device of the specific occurrence of the specific free event in the first network node is sent by executing the instructions to transmit by the one or more processors of the first network node immediately after and in response to detecting the specific occurrence of the specific free event in the one first network node.

In some embodiments, the message notifying the remote computing device of the specific occurrence of the specific free event in the first network node is sent by executing the instructions to transmit by the one or more processors of the first network node according to a schedule that is independent of (i) a time of occurrence of the specific occurrence of the specific free event in the first network node, and (ii) a time of detection of the specific occurrence of the specific free event in the first network node.

In some embodiments, the specific free event is an event of physically attaching a physical device to the first network node.

In some embodiments, the specific free event is an attaching of a storage device to a port of the of the first network node. In some such embodiments, the storage device is a removable USB storage device and the port is a USB port.

In some embodiments, the specific free event is an attaching of a communication device to a port of the first network node.

In some embodiments, the specific free event is an event of mounting a storage volume onto the first network node.

In some embodiments, the specific free event is an event of sending a network message out of the first network node, the sending caused by a command from a user of the first network node.

In some embodiments, the specific free event is a submission of a query from the first network node to a server.

In some embodiments, the specific free event is an event of sending a network message out of the first network node, the sending caused by an operating system of the first network node.

In some embodiments, the specific free event is an event of sending an ARP request message out of the first network node.

In some embodiments, the specific free event is an event of sending a network message out of the first network node, the sending caused by a software application installed on the first network node.

In some embodiments, the specific free event is an event of sending a WPAD message out of the first network node.

When a penetration testing system determines that a potential vulnerability might compromise a target network node of a networked system, the penetration testing system has to find out that this is indeed so under current conditions—this is referred to as “validating.”

An automated penetration testing system for carrying out a penetration testing campaign of a networked system is now disclosed. This penetration testing system (i) does not employ the “validating by actual attack” technique described above, where the target node is exposed to risk of being compromised; and (ii) in embodiments of the invention, differs from and provides advantages over systems that employ the conventional “validation by simulation or by evaluation” technique, also described above.

The presently-disclosed automated penetration testing system employs a reconnaissance agent software module (RASM) installed on at least some network nodes of the networked system, including one or more target network nodes for which validation is performed.

Instead of performing validation (i.e. for a particular target node) by executing code of the RASM on the target node (as is done by the '057 application), validation: (i) is performed on a remote computing device in communication with the target node; (ii) is performed using internal data of the target node, which is received by the remote computing device from the RASM installed in the target node. In contrast with actual attack penetration testing systems, validation is performed without exposing the target node to a risk of being compromised.
Internal data of a network node (i.e. including the target node) includes one or more of:
   (A) Internal events occurring in the network node, for example the insertion of a USB stick into the network node;
   (B) Internal conditions existing in the network node, for example whether the CPU of a given network node is heavily loaded or not; and
   (C) Internal factual data about the network node, for example the firmware version of a solid-state storage device attached to the network node.

During the penetration testing campaign, execution of code of the RASM (i.e. execution of the instance of the RASM installed on the target node—the target node may also be referred to as a ‘hosting node’ of that instance) makes no attempt to actually compromise the target node. Additionally, execution of the RASM on the target node does not make any determination about whether or not a potential vulnerability would succeed to compromise the target node under current conditions. Instead, execution of the RASM on the target node primarily serves to obtain and transmit data about the target node out of the target node to the remote computing device—this data includes internal data of the target node, and optionally also includes other data of the target node or data of other nodes.

For each target node, the validation decisions are left to the remote computing device, rather than to the target node. Towards this end, the remote computing device hosts and/or implements both (i) a vulnerabilities knowledge base and (ii) validation logic for the potential vulnerabilities. For each validation to be decided for a given potential vulnerability and for a given target node, the remote computing device applies the decision logic associated with the given potential vulnerability according to the vulnerabilities knowledge base using data obtained from the target node, including internal data of the target node. This internal data of the target node is first obtained at the target node by execution thereon of the RASM installed on the target node, and subsequently received by the remote computing device from the RASM installed on the target node.

In order to better understand embodiments of the invention, the reader is referred to two use case examples presented below under the following headings (within the

“Detailed Description of the Embodiments”): (i) Use Case Example 1—Bad 7 Trojan; and (ii) Use Case Example 2—Potentially-Poisoned File in a Shared Folder (PPFSF) Vulnerability.

It should be noted that whenever the description of the proposed solution uses the terms “compromising a network node”, “compromising a networked system”, “an already-compromised network node”, “a not-yet-compromised network node” and the like, no actual compromising is meant. As the proposed solution is based on simulation or evaluation rather than on an actual attack, the above terms refer to a simulated or to an evaluated compromising. For example, “compromising a network node” means determining that the network node could be compromised, and “an already-compromised network node” means a network node which was already determined to be compromisable in previous stages of the current testing process.

A method of carrying out a penetration testing campaign of a networked system by a penetration testing system is disclosed herein where the penetration testing system comprises (A) a penetration testing software module installed on a remote computing device and (B) a reconnaissance agent software module (RASM) installed on at least some network nodes of the networked system. The presently-disclosed method comprises: a. subsequent to installing the RASM on the at least some network nodes, initiating the penetration testing campaign; b. subsequent to the initiating of the penetration testing campaign, selecting a target network node of the networked system on which the RASM is installed; c. based on the target network node, selecting a potential vulnerability that may compromise the target network node; d. subsequent to the selecting of the potential vulnerability, receiving at the remote computing device and from the RASM installed on the target network node, internal data of the target network node; e. validating that the target network node could be successfully compromised using the selected potential vulnerability, the validating being carried out in a manner which does not expose the target network node to a risk of being compromised and which is based on the received internal data of the target network node; f. based on the potential vulnerability, determining a method for an attacker to compromise the target network node; g. based on the method for an attacker to compromise the target network node, determining a security vulnerability of the networked system; and h. reporting the security vulnerability of the networked system, the reporting comprising at least one of (i) causing a display device to display a report including information about the determined security vulnerability of the networked system, (ii) recording the report including the information about the determined security vulnerability of the networked system in a file, and (iii) electronically transmitting the report including the information about the determined security vulnerability of the networked system, wherein each of steps a-h is performed by executing computer code of the penetration testing software module by one or more processors of the remote computing device.

In some embodiments, the internal data includes data about an internal event of the target network node.

In some embodiments, the internal data includes data about an internal condition of the target network node.

In some embodiments, the internal data includes data about an internal fact of the target network node.

In some embodiments, the selecting of the potential vulnerability is based on one or more properties of the target node.

In some embodiments, i. the method further comprises performing the following steps, subsequent to steps b-f and before step g: A. selecting an additional target network node of the networked system on which the RASM is installed; B. based on the additional target network node, selecting an additional potential vulnerability that may compromise the additional target network node; C. subsequent to the selecting of the additional potential vulnerability, receiving at the remote computing device and from the RASM installed on the additional target network node, internal data of the additional target network node; D. validating that the additional target network node could be successfully compromised using the additional potential vulnerability, the validating being carried out in a manner which does not expose the additional target network node to a risk of being compromised and which is based on the received internal data of the additional target network node; and E. based on the additional potential vulnerability, determining a method for an attacker to compromise the additional target network node; and ii. the determining of the security vulnerability of the networked system is further based on the method for an attacker to compromise the additional target network node.

In some embodiments, the information about the determined security vulnerability of the networked system comprises at least one of: (i) information about a method for compromising the target network node (ii) information about one or more network nodes of the networked system which are vulnerable to attack, (iii) information about one or more resources of the networked system that could be damaged or exported out of the networked system by an attacker, and (iv) information about an ordered list of network nodes of the networked system, wherein an attacker could use a specific network node in said ordered list that is already compromised as a basis for compromising another network node that immediately follows said specific network node in said ordered list.

In some embodiments, the receiving of the internal data of the target network node is in response to sending by the remote computing device a message to the target network node, the message requesting specific internal data according to the selected potential vulnerability.

A method of carrying out a penetration testing campaign of a networked system by a penetration testing system is disclosed herein where the penetration testing system comprises (A) a penetration testing software module installed on a remote computing device and (B) a reconnaissance agent software module (RASM) installed on at least some network nodes of the networked system. The presently-disclosed method comprises: a. subsequent to installing the RASM on the at least some network nodes, initiating the penetration testing campaign; b. subsequent to the initiating of the penetration testing campaign, selecting a target network node of the networked system on which the RASM is installed; c. based on the target network node, selecting a potential vulnerability that may compromise the target network node; d. receiving at the remote computing device and from the RASM installed on the target network node, internal data of the target network node; e. validating that the target network node could be successfully compromised using the selected potential vulnerability, the validating being carried out in a manner which does not expose the target network node to a risk of being compromised and which is based on the received internal data of the target network node; f. based on the potential vulnerability, determining a method for an attacker to compromise the target network node; g. based on the method for an attacker to compromise the target network node, determining a security vulnerability of the networked system; and h. reporting the security vulnerability of the networked system, the reporting comprising at least one of (i) causing a display device to display a report including information about the determined security vulnerability of the networked system, (ii) recording the report including the information about the determined security vulnerability of the networked system in a file, and (iii) electronically transmitting the report including the information about the determined security vulnerability of the networked system, wherein each of steps a-h is performed by executing computer code of the penetration testing software module by one or more processors of the remote computing device.

In some embodiments, the internal data includes data about an internal event of the target network node.

In some embodiments, the internal data includes data about an internal condition of the target network node.

In some embodiments, the internal data includes data about an internal fact of the target network node.

In some embodiments, the selecting of the potential vulnerability is based on one or more properties of the target node.

In some embodiments, i. the method further comprises performing the following steps, subsequent to steps b-f and before step g: A. selecting an additional target network node of the networked system on which the RASM is installed; B. based on the additional target network node, selecting an additional potential vulnerability that may compromise the additional target network node; C. receiving at the remote computing device and from the RASM installed on the additional target network node, internal data of the additional target network node; D. validating that the additional target network node could be successfully compromised using the additional potential vulnerability, the validating being carried out in a manner which does not expose the additional target network node to a risk of being compromised and which is based on the received internal data of the additional target network node; and E. based on the additional potential vulnerability, determining a method for an attacker to compromise the additional target network node; and ii. the determining of the security vulnerability of the networked system is further based on the method for an attacker to compromise the additional target network node.

In some embodiments, the information about the determined security vulnerability of the networked system comprises at least one of: (i) information about a method for compromising the target network node (ii) information about one or more network nodes of the networked system which are vulnerable to attack, (iii) information about one or more resources of the networked system that could be damaged or exported out of the networked system by an attacker, and (iv) information about an ordered list of network nodes of the networked system, wherein an attacker could use a specific network node in said ordered list that is already compromised as a basis for compromising another network node that immediately follows said specific network node in said ordered list.

In some embodiments, the receiving of the internal data of the target network node is in response to sending by the remote computing device a message to the target network node, the message requesting specific internal data according to the selected potential vulnerability.

A penetration testing system for carrying out a penetration testing campaign of a networked system in cooperation with a reconnaissance agent software module (RASM) installed on at least some network nodes of the networked system, the penetration testing system comprising: A. a remote computing device comprising a computer memory and one or more processors, the remote computing device in electronic communication with the networked system; and B. a non-transitory computer-readable storage medium containing first, second, third, fourth, fifth, sixth, seventh and eighth program instructions of a penetration testing software module, wherein: a. execution of the first program instructions, by the one or more processors of the remote computing device and subsequent to installing the RASM on the at least some network nodes, initiates the penetration testing campaign; b. execution of the second program instructions, by the one or more processors of the remote computing device and subsequent to the initiating of the penetration testing campaign, selects a target network node of the networked system on which the RASM is installed; c. execution of the third program instructions, by the one or more processors of the remote computing device, selects, based on the target network node, a potential vulnerability that may compromise the target network node; d. execution of the fourth program instructions, by the one or more processors of the remote computing device and subsequent to the selecting of the potential vulnerability, receives at the remote computing device and from the RASM installed on the target network node, internal data of the target network node; e. execution of the fifth program instructions, by the one or more processors of the remote computing device, validates that the target network node could be successfully compromised using the selected potential vulnerability such that the validating is carried out in a manner which does not expose the target network node to a risk of being compromised and which is based on the received internal data of the target network node;

f. execution of the sixth program instructions, by the one or more processors of the remote computing device, determines, based on the potential vulnerability, a method for an attacker to compromise the target network node; g. execution of the seventh program instructions, by the one or more processors of the remote computing device, determines, based on the method for an attacker to compromise the target network node, a security vulnerability of the networked system; and h. execution of the eighth program instructions, by the one or more processors of the remote computing device, reports the security vulnerability of the networked system, the reporting comprising at least one of (i) causing a display device to display a report including information about the determined security vulnerability of the networked system, (ii) recording the report including the information about the determined security vulnerability of the networked system in a file, and (iii) electronically transmitting the report including the information about the determined security vulnerability of the networked system. A penetration testing system for carrying out a penetration testing campaign of a networked system in cooperation with a reconnaissance agent software module (RASM) installed on at least some network nodes of the networked system, the penetration testing system comprising: A. a remote computing device comprising a computer memory and one or more processors, the remote computing device in electronic communication with the networked system; and B. a non-transitory computer-readable storage medium containing first, second, third, fourth, fifth, sixth, seventh and eighth program instructions of a penetration testing software module, wherein: a. execution of the first program instructions, by the one or more processors of the remote computing device and subsequent to installing the RASM on the at least some network nodes, initiates the penetration testing campaign; b. execution of the second program instructions, by the one or more processors of the remote computing device and subsequent to the initiating of the penetration testing campaign, selects a target network node of the networked system on which the RASM is installed; c. execution of the third program instructions, by the one or more processors of the remote computing device, selects, based on the target network node, a potential vulnerability that may compromise the target network node; d. execution of the fourth program instructions, by the one or more processors of the remote computing device, receives at the remote computing device and from the RASM installed on the target network node, internal data of the target network node; e. execution of the fifth program instructions, by the one or more processors of the remote computing device, validates that the target network node could be successfully compromised using the selected potential vulnerability such that the validating is carried out in a manner which does not expose the target network node to a risk of being compromised and which is based on the received internal data of the target network node; f. execution of the sixth program instructions, by the one or more processors of the remote computing device, determines, based on the potential vulnerability, a method for an attacker to compromise the target network node; g. execution of the seventh program instructions, by the one or more processors of the remote computing device, determines, based on the method for an attacker to compromise the target network node, a security vulnerability of the networked system; and h. execution of the eighth program instructions, by the one or more processors of the remote computing device, reports the security vulnerability of the networked system, the reporting comprising at least one of (i) causing a display device to display a report including information about the determined security vulnerability of the networked system, (ii) recording the report including the information about the determined security vulnerability of the networked system in a file, and (iii) electronically transmitting the report including the information about the determined security vulnerability of the networked system.

The aforementioned architecture of a penetration testing system may be useful, for example, for minimizing the CPU burden of penetration testing imposed on each of the multiple nodes of the penetration-tested networked system. Alternatively or additionally, these software architecture features may be useful for updating—e.g. when new threats need to be added to a threat-database, there is no need to update this threat-database on each of the RASM-hosting nodes. Instead, the threat-database may be updated only on the remote computing device.

Preferably, these RASM instances are not completely autonomous, but rather obtain the internal data of the RASM-hosting network nodes and/or transmit the internal data in response to a data-requesting command received, by each of the RASM-hosting network nodes, from the remote computing device.

Similar to actual-attack penetration testing systems, actual data from the network nodes is obtained and analyzed to determine the method for the attacker to compromise the networked system.

According to embodiments of the present invention, (i) this actual data includes actual internal data; and (ii) the penetration testing is carried out based on actual internal data of the target network node without putting the target node at risk of being compromised. Thus, it is now possible to enjoy the benefits of obtaining results that are more accurate and reliable than those obtainable by conventional simulated penetration testing without suffering from the risks associated with actual attack penetration testing.

Optionally, and in some embodiments preferably, the RASM is preinstalled before the beginning of the penetration testing campaign on each of the participating nodes.

The pre-installation may make the penetration testing simpler and more reliable. The pre-installation can be closely monitored by the IT people of the organization and any problem or issue of access right can be resolved prior to the testing. Additionally, if agents are employed without being pre-installed, then they are installed instead at runtime during the testing process. This implies that the state of the tested networked system is being changed by the test and unexpected side-effects might occur.

In some embodiments of the invention, one or more (i.e. any combination of) the following features are provided:
A. The system includes a local agent installed on multiple network nodes.
B. The agent is installed before starting the test.
C. Each instance of the agent collects data, including internal data of the network node on which it is installed.
D. The system includes a remote server that does (at least) the determination of vulnerabilities.
E. The agent reports to the server in response to the server's commands.
F. The agent reports raw data and does not determine vulnerabilities. It is the server that does such determination.
G. The agent collects data without risking compromising the hosting node.
H. The remote server verifies that a potential vulnerability is indeed a vulnerability without risking compromising the networked system. This implies it is not using real attacks of the tested system.
I. The attack process is iterative—one node at a time.

A method for penetration testing of a networked system by a penetration testing system, using both active and passive validation methods during a single penetration testing campaign, is disclosed herein. The presently-disclosed method comprises: a. determining a first target network node of the networked system to be the next network node to attempt to compromise during the single penetration testing campaign; b. determining a first vulnerability of network nodes to be used for compromising the first target network node; c. selecting a first validation method for validating the first vulnerability for the first target network node, a type of the first validation method being selected from the type group consisting of active validation and passive validation; d. validating the first vulnerability for the first target network node using the first validation method; e. determining a second target network node of the networked system to be the next network node to attempt to compromise during the single penetration testing campaign; f. determining a second vulnerability of network nodes to be used for compromising the second target network node; g. selecting a second validation method for validating the second vulnerability for the second target network node, a type of the second validation method being selected from the type group consisting of active validation and passive validation and being different from the type of the first validation method; h. validating the second vulnerability for the second target network node using the second validation method; and i. reporting at least one security vulnerability of the networked system determined to exist based on results of the executing of the single penetration testing campaign, wherein the reporting comprises performing at least one operation selected from the group consisting of: (A) causing a display device to display a report containing information about the at least one security vulnerability of the networked system, (B) storing the report containing information about the at least one security vulnerability of the networked system in a file and (C) electronically transmitting the report containing information about the at least one security vulnerability of the networked system, wherein all of steps a-i are performed by the penetration testing system, and all of steps a-h are performed during the single penetration testing campaign.

In some embodiments, the first and second validation methods are respectively selected in accordance with the first and second vulnerabilities.

In some embodiments, i. the selecting of the first validation method comprises: A. determining a first damage to the first target network node that can be caused by validating the first vulnerability for the first target network node by using active validation; and B. selecting the type of the first validation method to be a type of a validation method that is associated with the first damage; and ii. the selecting of the second validation method comprises: A. determining a second damage to the second target network node that can be caused by validating the second vulnerability for the second target network node by using active validation; and B. selecting the type of the second validation method to be a type of a validation method that is associated with the second damage. In some such embodiments, the determining of the first damage includes determining an extent of the first damage. Also, in some such embodiments, the determining of the first damage includes determining a likelihood of the first damage occurring.

In some embodiments, the selecting of the type of the first and second validation methods are performed such that the identity of the first vulnerability uniquely determines the type of the first validation method, and the identity of the second vulnerability uniquely determines the type of the second validation method.

In some embodiments, steps a-i are performed in the order listed.

In some embodiments, the penetration testing system is controlled by a user interface of a computing device, and the method for penetration testing of the networked system further comprises: j. receiving, by the penetration testing system and via the user interface of the computing device, one or more manually-entered inputs, the one or more manually-entered inputs explicitly defining at least one item selected from the group consisting of (i) a type of a validation method to be used for validating the first vulnerability, and (ii) a type of a validation method to be used for validating the second vulnerability.

A penetration testing system for executing penetration testing of a networked system using both active and passive validation methods during a single penetration testing campaign is disclosed herein. The presently disclosed penetration testing system comprises: a. a remote computing device comprising a computer memory and one or more processors, the remote computing device in networked communication with multiple network nodes of the networked system; b. a non-transitory computer-readable storage medium containing program instructions, wherein execution of the program instructions by the one or more processors of the remote computing device performs all of the following during the single penetration testing campaign: i. determine a first target network node of the networked system to be the next network node to attempt to compromise during the single penetration testing campaign; ii. determine a first vulnerability of network nodes to be used for compromising the first target network node; iii. select a first validation method for validating the first vulnerability for the first target network node, a type of the first validation method being selected from the type group consisting of active validation and passive validation; iv. cause a validation of the first vulnerability for the first target network node using the first validation method; v. determine a second target network node of the networked system to be the next network node to attempt to compromise during the single penetration testing campaign; vi. determine a second vulnerability of network nodes to be used for compromising the second target network node;

vii. select a second validation method for validating the second vulnerability for the second target network node, a type of the second validation method being selected from the type group consisting of active validation and passive validation and being different from the type of the first validation method; and viii. cause a validation of the second vulnerability for the second target network node using the second validation method; wherein the execution of the program instructions by the one or more processors of the remote computing device further performs: report at least one security vulnerability of the networked system determined to exist based on results of executing the single penetration testing campaign, wherein the reporting comprises performing at least one operation selected from the group consisting of: (A) causing a display device to display a report containing information about the at least one security vulnerability of the networked system, (B) storing the report containing information about the at least one security vulnerability of the networked system in a file and (C) electronically transmitting the report containing information about the at least one security vulnerability of the networked system.

A method for penetration testing of a networked system by a penetration testing system using both active and passive validation methods is disclosed herein. The presently disclosed method for penetration testing comprises: a. determining a first target network node of the networked system to be the next network node to attempt to compromise; b. determining a first vulnerability of network nodes to be used for compromising the first target network node; c. determining a first damage to the first target network node that can be caused by validating the first vulnerability for the first target network node by using active validation; d. selecting a first validation method for validating the first vulnerability for the first target network node, a type of the first validation method being: A. selected from the type group consisting of active validation and passive validation; and B. associated with the first damage; e. validating the first vulnerability for the first target network node using the first validation method; f. determining a second target network node of the networked system to be the next network node to attempt to compromise; g. determining a second vulnerability of network nodes to be used for compromising the second target network node; h. determining a second damage to the second target network node that can be caused by validating the second vulnerability for the second target network node by using active validation; i. selecting a second validation method for validating the second vulnerability for the second target network node, a type of the second validation method being: A. selected from the type group consisting of active validation and passive validation; B. associated with the second damage; and C. different from the type of the first validation method; j. validating the second vulnerability for the second target network node using the second validation method; and k. reporting at least one security vulnerability of the networked system determined to exist based on results of performing steps a-j, wherein the reporting comprises performing at least one operation selected from the group consisting of: (A) causing a display device to display a report containing information about the at least one security vulnerability of the networked system, (B) storing the report containing information about the at least one security vulnerability of the networked system in a file and (C) electronically transmitting the report containing information about the at least one security vulnerability of the networked system, wherein all of steps a-k are performed by the penetration testing system.

In some embodiments, all of steps a-j are performed during a single penetration testing campaign that is carried out by the penetration testing system.

In some embodiments, the determining of the first damage includes determining an extent of the first damage.

In some embodiments, the determining of the first damage includes determining a likelihood of the first damage occurring.

In some embodiments, steps a-k are performed in the order listed.

In some embodiments, the penetration testing system is controlled by a user interface of a computing device, and the method for penetration testing of the networked system further comprises: j. receiving, by the penetration testing system and via the user interface of the computing device, one or more manually-entered inputs, the one or more manually-entered inputs explicitly defining at least one item selected from the group consisting of (i) a type of a validation method associated with the first damage, and (ii) a type of a validation method associated with the second damage.

A penetration testing system for executing penetration testing of a networked system using both active and passive validation methods is disclosed herein. The presently disclosed penetration testing system comprises: a. a remote computing device comprising a computer memory and one or more processors, the remote computing device in networked communication with multiple network nodes of the networked system; b. a non-transitory computer-readable storage medium containing program instructions, wherein execution of the program instructions by the one or more processors of the remote computing device performs all of the following: i. determine a first target network node of the networked system to be the next network node to attempt to compromise; ii. determine a first vulnerability of network nodes to be used for compromising the first target network node; iii. determine a first damage to the first target network node that can be caused by validating the first vulnerability for the first target network node by using active validation; iv. select a first validation method for validating the first vulnerability for the first target network node, a type of the first validation method being: A. selected from the type group consisting of active validation and passive validation; and B. associated with the first damage; v. cause a validation of the first vulnerability for the first target network node using the first validation method; vi. determine a second target network node of the networked system to be the next network node to attempt to compromise; vii. determine a second vulnerability of network nodes to be used for compromising the second target network node; viii. determine a second damage to the second target network node that can be caused by validating the second vulnerability for the second target network node by using active validation; ix. select a second validation method for validating the second vulnerability for the second target network node, a type of the second validation method being: A. selected from the type group consisting of active validation and passive validation; B. associated with the second damage; and C. different from the type of the first validation method; x. cause a validation of the second vulnerability for the second target network node using the second validation method; and xi. report at least one security vulnerability of the networked system determined to exist based on results of performing operations b(i)-b(x), wherein the reporting comprises performing at least one operation selected from the group consisting of: (A) causing a display device to display a report containing information about the at least one security vulnerability of the networked system, (B) storing the report containing information about the at least one security vulnerability of the networked system in a file and (C) electronically transmitting the report containing information about the at least one security vulnerability of the networked system.

A method is disclosed herein for subjecting a single networked system to first and second penetration testing campaigns such that (i) both penetration testing campaigns are performed by a single penetration testing system; (ii) the first penetration testing campaign employs only active validation for validating vulnerabilities of network nodes of the single networked system; and (iii) the second penetration testing campaign employs only passive validation for validating vulnerabilities of network nodes of the single networked system. The presently disclosed method comprises: a. executing the first penetration testing campaign by the single penetration testing system, the executing of the first penetration testing campaign comprising performing one or more validation operations for validating vulnerabilities for network nodes of the single networked system, wherein the methods of validation used for all validation operations included in the first penetration testing campaign are active validation methods; b. executing the second penetration testing campaign by the single penetration testing system, the executing of the second penetration testing campaign comprising performing one or more validation operations for validating vulnerabilities for network nodes of the single networked system, wherein the methods of validation used for all validation operations included in the second penetration testing campaign are passive validation methods, and c. reporting, by the single penetration testing system, at least one security vulnerability of the single networked system determined to exist based on at least one member selected from the group consisting of (1) results of the executing of the first penetration testing campaign, and (2) results of the executing of the second penetration testing campaign, wherein the reporting comprises performing at least one operation selected from the group consisting of (i) causing a display device to display a report containing information about the at least one security vulnerability of the single networked system, (ii) storing the report containing information about the at least one security vulnerability of the single networked system in a file, and (iii) electronically transmitting the report containing information about the at least one security vulnerability of the single networked system.

In some embodiments, the second penetration testing campaign commences after the first penetration testing campaign has concluded.

In some embodiments, the first penetration testing campaign commences after the second penetration testing campaign has concluded.

In some embodiments, the second penetration testing campaign commences after the first penetration testing campaign has commenced but before the first penetration testing campaign has concluded.

In some embodiments, the first and second penetration testing campaigns are performed at least partially simultaneously.

In some embodiments, the first penetration testing campaign is based on a first scenario template, the second penetration testing campaign is based on a second scenario template, and the second scenario template is different from the first scenario template.

In some such embodiments, the identity of the first scenario template uniquely determines the use of active validation for all validation operations included in the first penetration testing campaign, and the identity of the second scenario template uniquely determines the use of passive validation for all validation operations included in the second penetration testing campaign.

Also in some such embodiments, the penetration testing system is controlled by a user interface of a computing device, and the method for executing the penetration testing campaigns further comprises: receiving, by the penetration testing system and via the user interface of the computing device, one or more manually-entered inputs, the one or more manually-entered inputs explicitly defining at least one of (i) a type of a validation method to be used for validating all vulnerabilities in the first penetration testing campaign that is based on the first scenario template, and (ii) a type of a validation method to be used for validating all vulnerabilities in the second penetration testing campaign that is based on the second scenario template.

In some other such embodiments, the penetration testing system is controlled by a user interface of a computing device, and the method for executing the penetration testing campaigns further comprises: receiving, by the penetration testing system and via the user interface of the computing device, one or more manually-entered inputs, the one or more manually-entered inputs explicitly defining at least one of (i) a type of a validation method to be used for validating vulnerabilities in all penetration testing campaigns that are based on the first scenario template, and (ii) a type of a validation method to be used for validating vulnerabilities in all penetration testing campaigns that are based on the second scenario template.

In some embodiments, the first penetration testing campaign and the second penetration testing campaign are both based on a common scenario template.

In some such embodiments, the penetration testing system is controlled by a user interface of a computing device, and the method for executing the penetration testing campaigns further comprises: receiving, by the penetration testing system and via the user interface of the computing device, one or more manually-entered inputs, the one or more manually-entered inputs explicitly defining at least one of (i) a type of a validation method to be used for validating all vulnerabilities in the first penetration testing campaign that is based on the common scenario template, and (ii) a type of a validation method to be used for validating all vulnerabilities in the second penetration testing campaign that is based on the common scenario template.

A penetration testing system is disclosed herein for subjecting a networked system to first and second penetration testing campaigns such that (i) both penetration testing campaigns are performed by the penetration testing system; (ii) the first penetration testing campaign employs only active validation for validating vulnerabilities of network nodes of the networked system; and (iii) the second penetration testing campaign employs only passive validation for validating vulnerabilities of network nodes of the networked system. The presently disclosed penetration testing system comprises: a. a remote computing device comprising a computer memory and one or more processors, the remote computing device in networked communication with multiple network nodes of the networked system; b. a non-transitory computer-readable storage medium containing program instructions, wherein execution of the program instructions by the one or more processors of the remote computing device performs all of the following during the first and second penetration testing campaigns: i. execute the first penetration testing campaign by the remote computing device, the executing of the first penetration testing campaign comprising causing one or more validation operations for validating vulnerabilities for network nodes of the networked system, wherein the methods of validation used for all validation operations included in the first penetration testing campaign are active validation methods; and ii. execute the second penetration testing campaign by the remote computing device, the executing of the second penetration testing campaign comprising causing one or more validation operations for validating vulnerabilities for network nodes of the networked system, wherein the methods of validation used for all validation operations included in the second penetration testing campaign are passive validation methods; wherein the execution of the program instructions by the one or more processors of the remote computing device further performs: report at least one security vulnerability of the networked system determined to exist based on at least one member selected from the group consisting of (1) results of the executing of the first penetration testing campaign, and (2) results of the executing of the second penetration testing campaign, wherein the reporting comprises performing at least one operation selected from the group consisting of (i) causing a display device to display a report containing information about the at least one security vulnerability of the networked system, (ii) storing the report containing information about the at least one security vulnerability of the networked system in a file, and (iii) electronically transmitting the report containing information about the at least one security vulnerability of the networked system.

Unless otherwise defined, all technical and scientific terms used herein have the same meaning as commonly understood by one of ordinary skill in the art to which the invention pertains, unless explicitly defined in this application. In case of conflict, the specification, including definitions, will take precedence.

As used herein, the terms “comprising”, “including”, “having” and grammatical variants thereof are to be taken as specifying the stated features, integers, steps or components but do not preclude the addition of one or more additional features, integers, steps, components or groups thereof. These terms encompass the terms “consisting of” and “consisting essentially of”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are used to designate like elements.

FIG. 1A (PRIOR ART) is a block diagram of code modules of a typical penetration testing system.

FIG. 1B (PRIOR ART) is a related flow-chart.

FIG. 2 (PRIOR ART) illustrates a prior art computing device.

FIG. 3 (PRIOR ART) illustrates a timeline related to the prior-art example of FIGS. 4A-4D.

FIGS. 4A-4D (PRIOR ART) illustrate a prior art example where network-nodes are compromised during a penetration test.

FIGS. 5A-5D illustrate an example where network-nodes are compromised during a penetration test that is set-up in according to some embodiments of the invention.

FIG. 7 illustrates a timeline related to the example of FIG. 8A.

FIGS. 8A-8B, 10A-10B, 13A-13B, 15A-15B, 17A-17B, 19A-19B, 22A-22B illustrate user engagements of user interfaces according to embodiments of the invention.

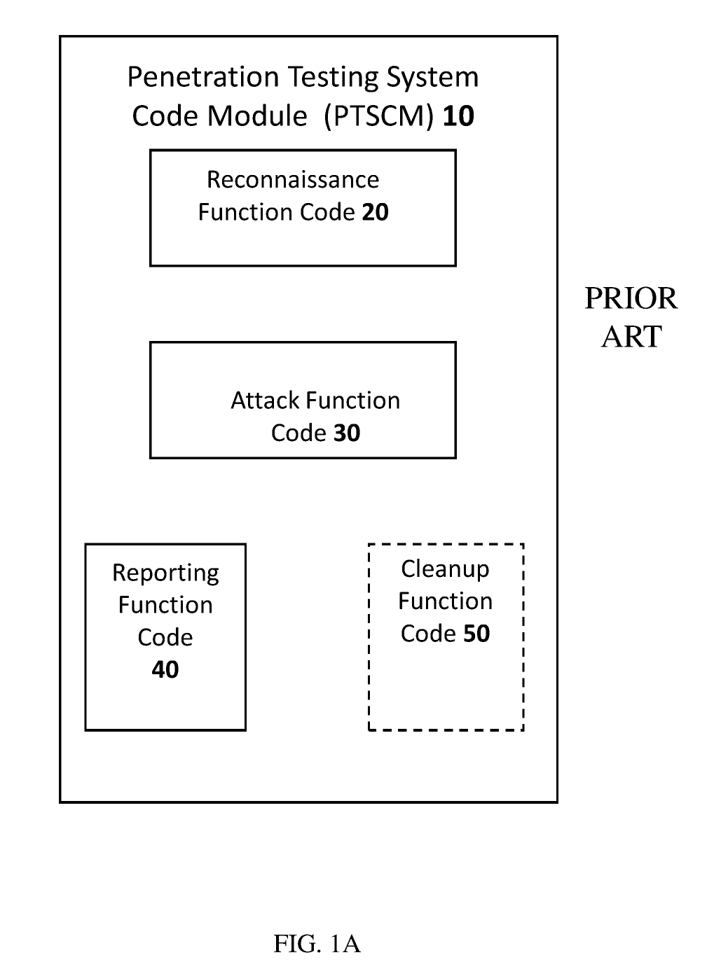

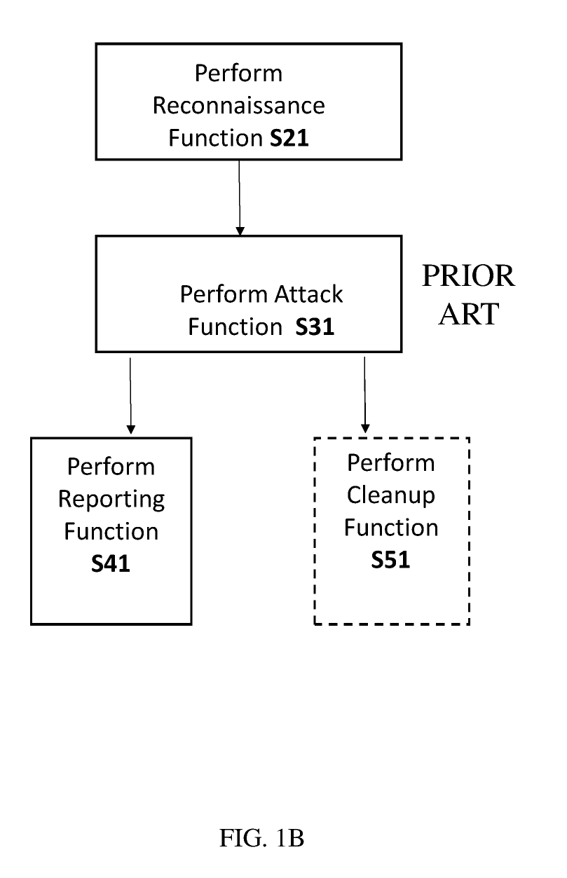

FIGS. 6, 9, 11A-11C, 12, 14, 16, 18, 20, 21, 23 and 26-31 are flow charts of methods of penetration testing of a networked system according to different embodiments of the invention.

FIGS. 24A-24B are two block diagrams showing examples of configurations of networked systems that are being tested by a penetration testing system code module (PTSCM).

FIG. 25 is a block diagram of one example of a penetration testing system code module.

FIG. 32 (PRIOR ART) illustrates a prior art example of a networked system that may be subjected to a penetration test—the networked system comprises a plurality of network nodes.

FIGS. 33-34 and 38 illustrate examples of penetration testing systems where a reconnaissance agent software module (RASM) is installed on multiple nodes of the networked system, where the RASM together with a penetration testing software module (PTSM) subject the networked system to penetration testing.

FIG. 35 illustrates communications between the PTSM and a plurality of RASMs.

FIGS. 36, 37A-37B, 39A-39C and 40A-40C are flow-charts of different methods of penetration testing the networked system according to embodiments of the invention.

FIG. 41 is a schematic illustration of a networked system including a system for discovering and reporting a security vulnerability of the networked system, according to an embodiment of the invention.

FIG. 42 is a flow chart of a method for discovering and reporting a security vulnerability of a networked system according to an embodiment of the invention.

FIG. 43 (PRIOR ART) illustrates a prior art example of a networked system that may be subjected to a penetration test—the networked system comprises a plurality of network nodes.

FIGS. 44, 45 and 49 illustrate examples of penetration testing systems where a reconnaissance agent software module (RASM) is installed on multiple nodes of the networked system, where the RASM together with a penetration testing software module (PTSM) subject the networked system to penetration testing.

FIG. 46 illustrates communications between the PTSM and a plurality of RASMs.

FIGS. 47, 48, and 50A-50B are flow-charts of different methods of penetration testing of a networked system according to embodiments of the invention.

FIG. 51 illustrates a timeline related to the examples of FIGS. 52A-52H.

FIGS. 52A-52H illustrate examples where network-nodes are tested using passive and active methods of validation during a penetration testing campaign.

FIG. 53 (PRIOR ART) illustrates a prior art example of a networked system that may be subjected to a penetration test—the networked system comprises a plurality of network nodes.

FIG. 54 shows a flow-chart of a method of penetration testing of a networked system according to embodiments of the invention.

FIGS. 55A, 55B and 56 are illustrative graphs of expected damage and risk factors, respectively, associated with performing active validation at the various network nodes.

FIGS. 57 and 58 show flow-charts of different methods of penetration testing of a networked system according to embodiments of the invention.

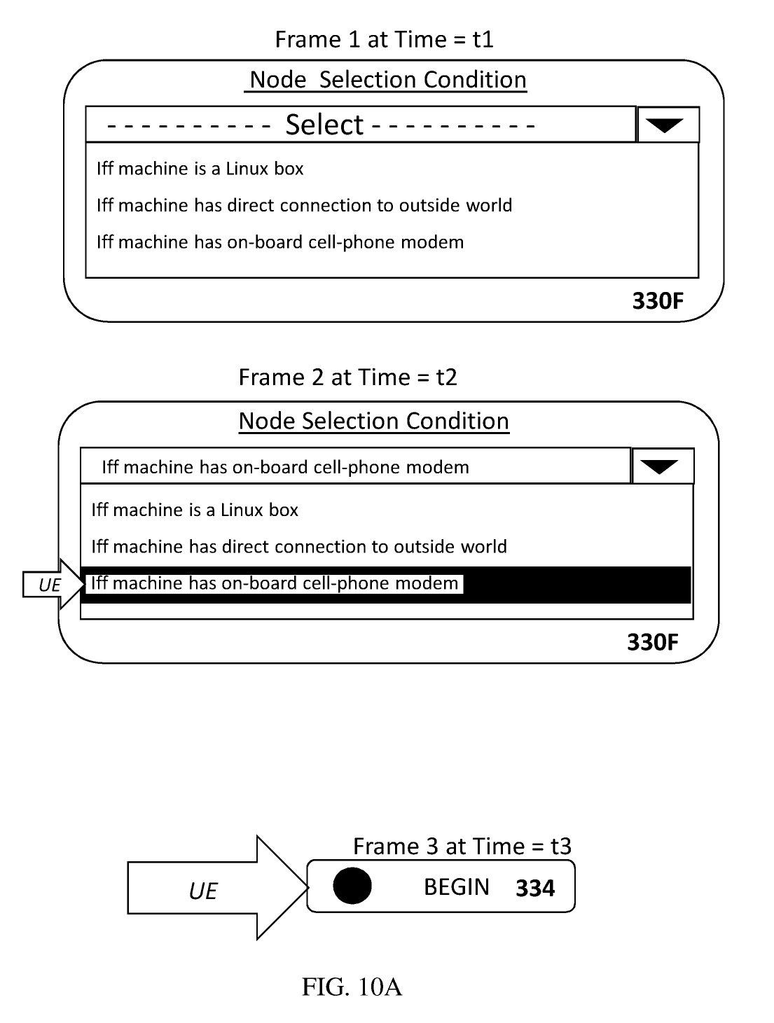

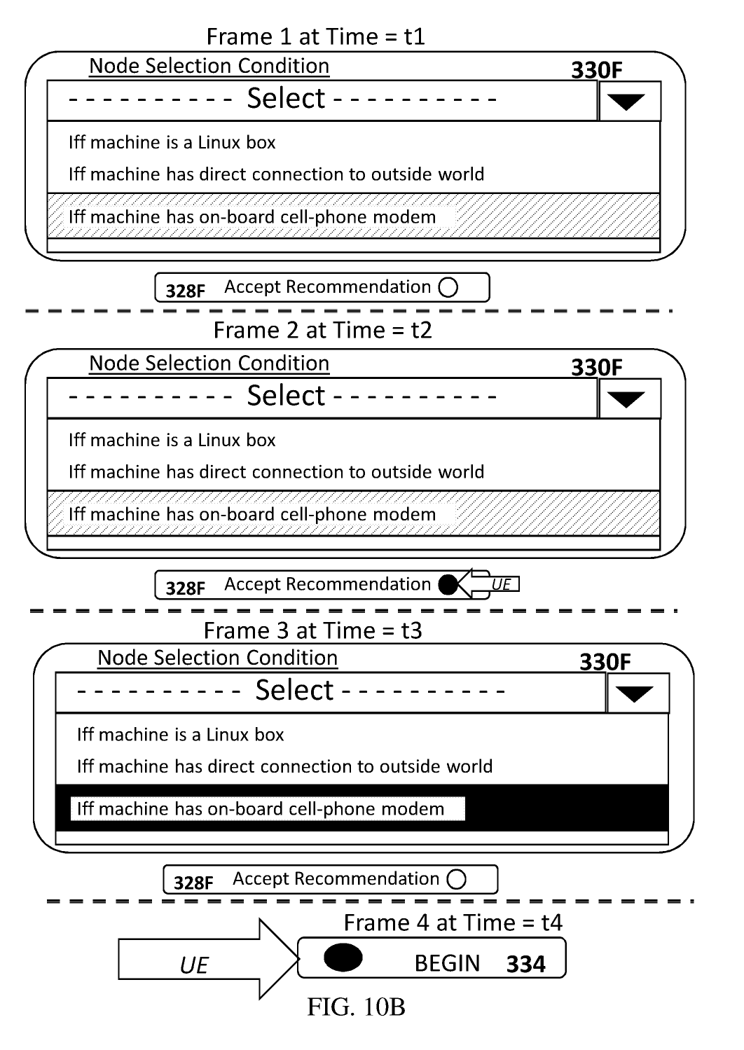

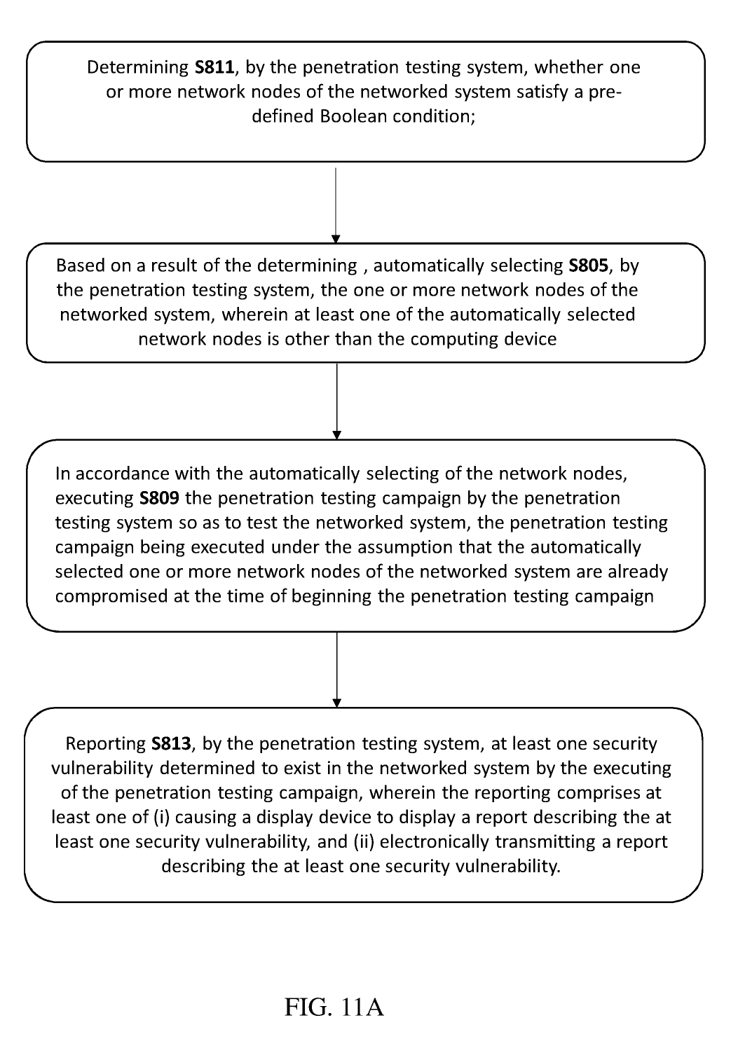

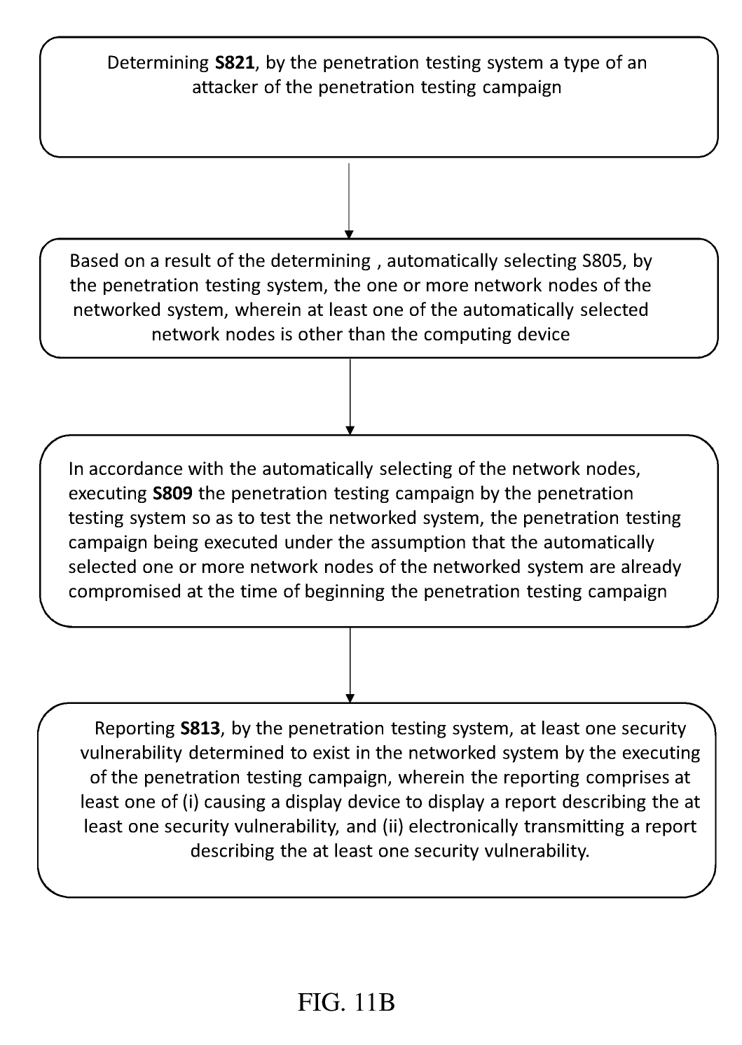

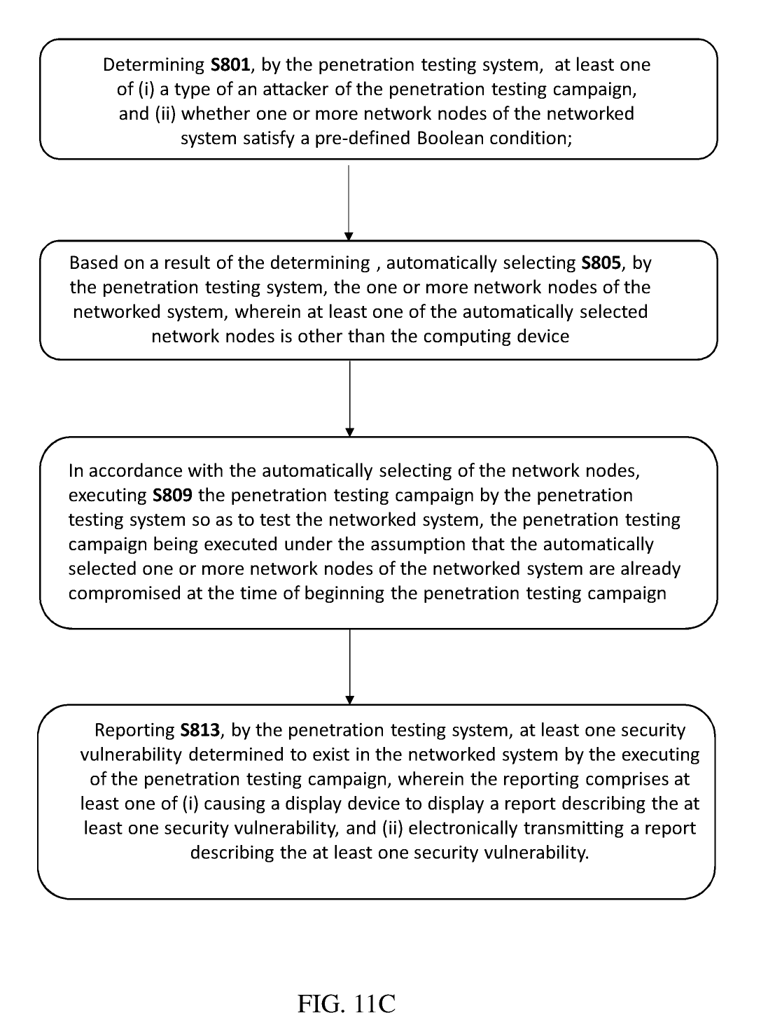

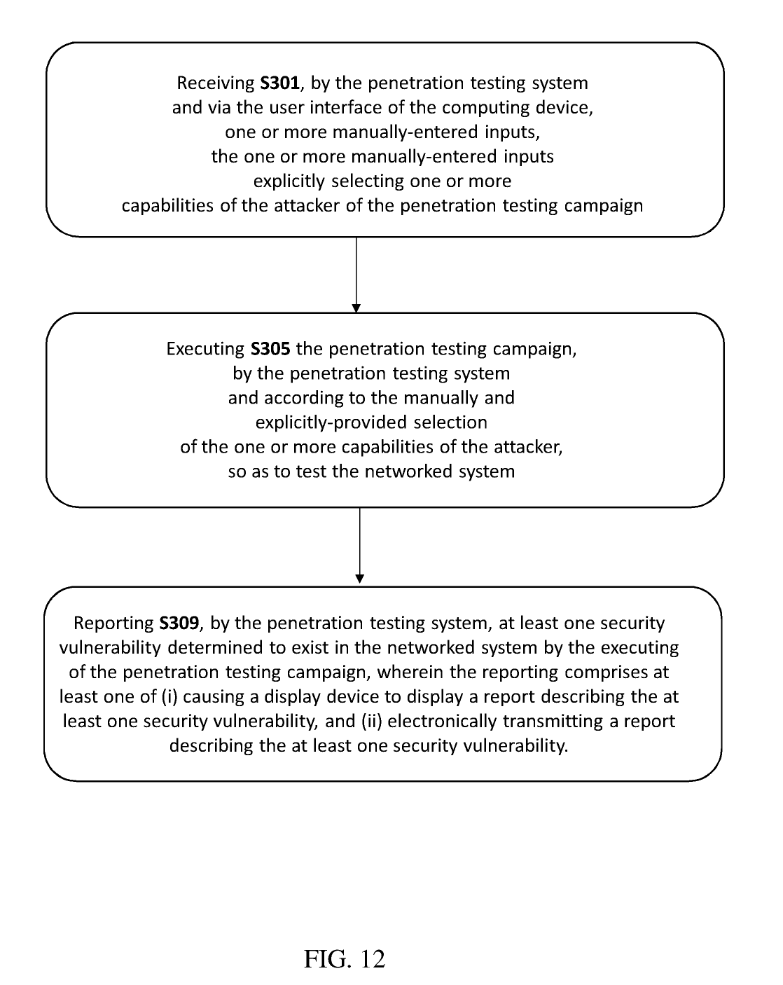

FIG. 59 shows examples of the respective timing of first and second penetration testing campaigns according to the method of FIG. 10.

FIG. 60 is a block diagram of reconnaissance agent penetration testing.

FIGS. 61A-C, 62A-D, and 63A-D are flow-charts of different methods of penetration testing of a networked system according to embodiments of the invention.

### DETAILED DESCRIPTION OF EMBODIMENTS

This disclosure should be interpreted according to the definitions in the “Definitions Section” at the end of the specification. In case of a contradiction between the definitions in the “Definitions Section” at the end of the specification and other sections of this disclosure, the “Definitions Section” at the end of the specification section should prevail.

In case of a contradiction between the “Definitions Section” at the end of the specification and a definition or a description in any other document, including in another document incorporated in this disclosure by refence, the “Definitions Section” at the end of the specification should prevail, even if the definition or the description in the other document is commonly accepted by a person of ordinary skill in the art.

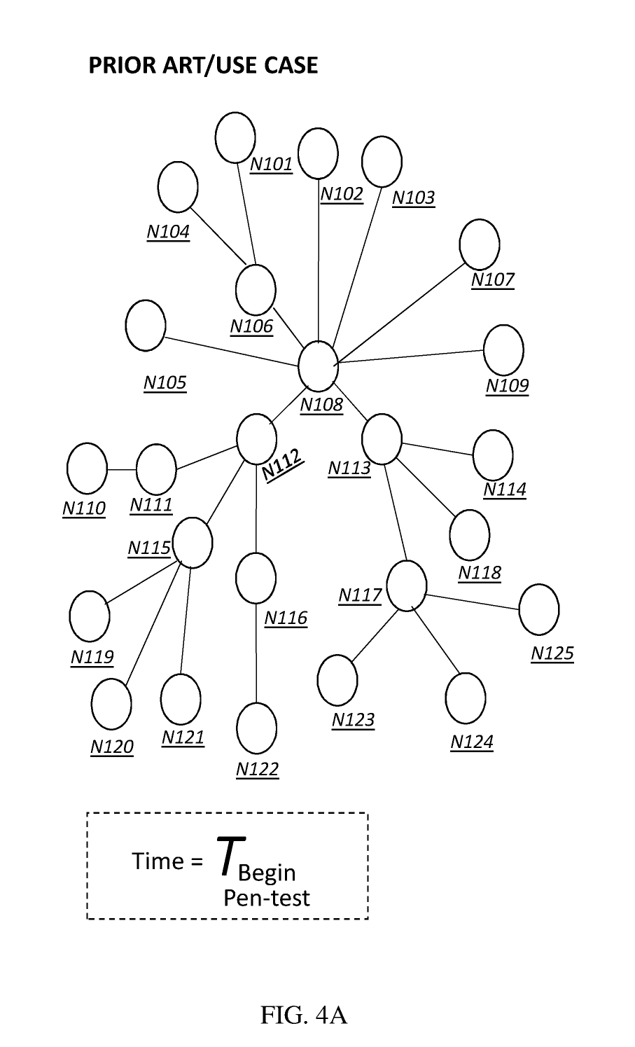

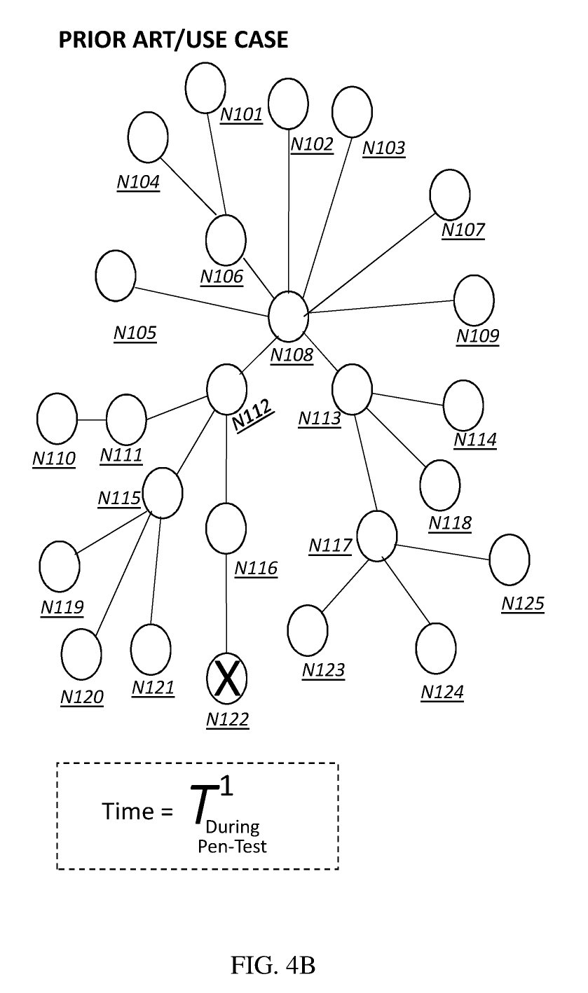

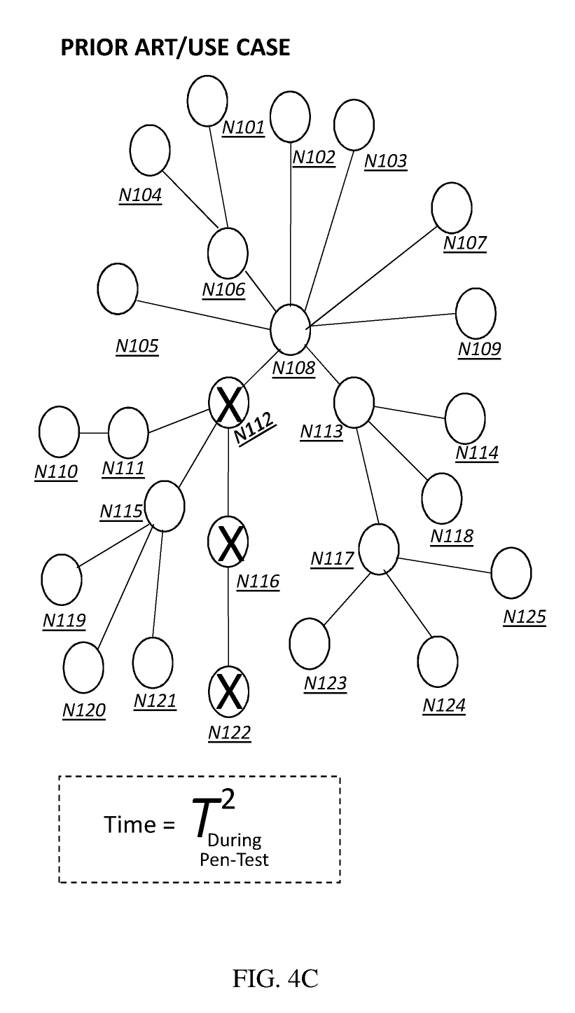

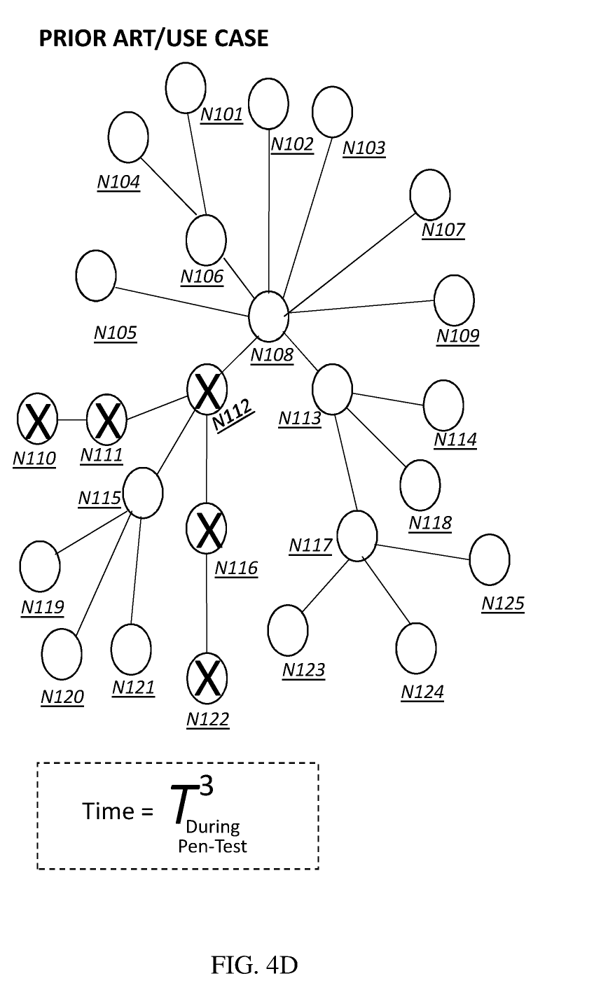

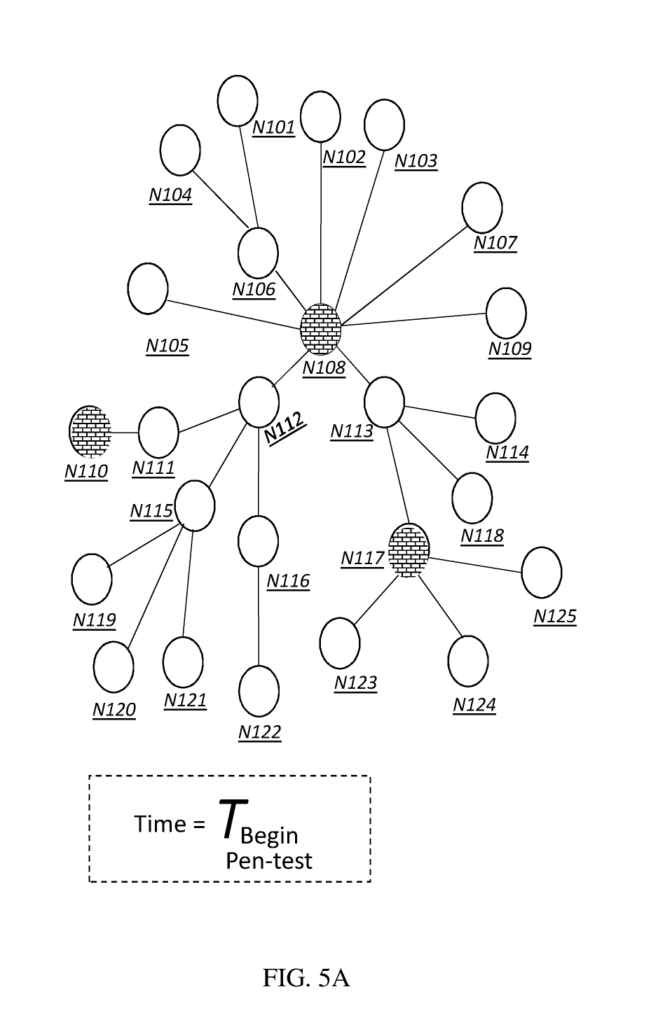

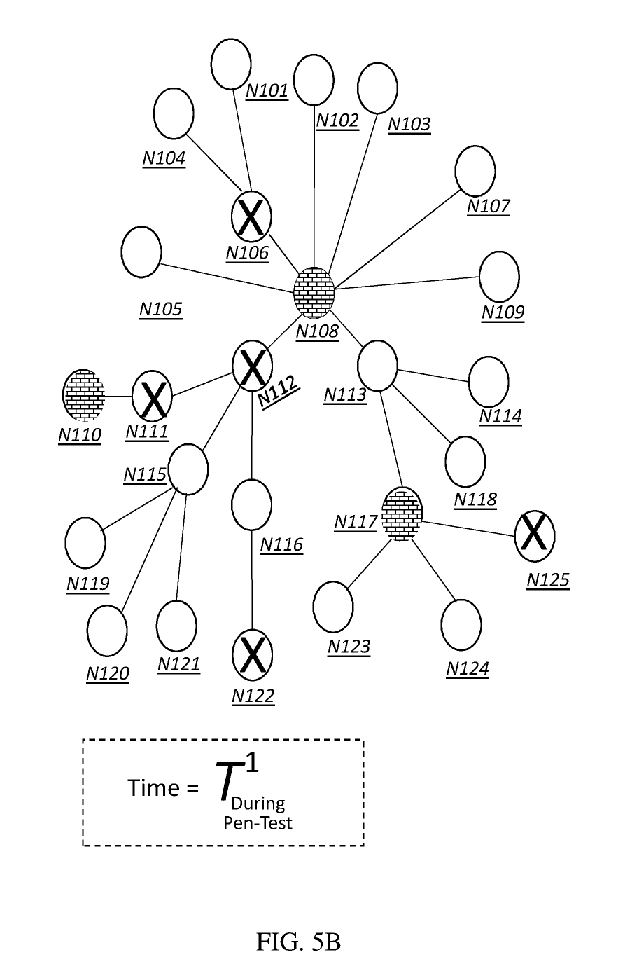

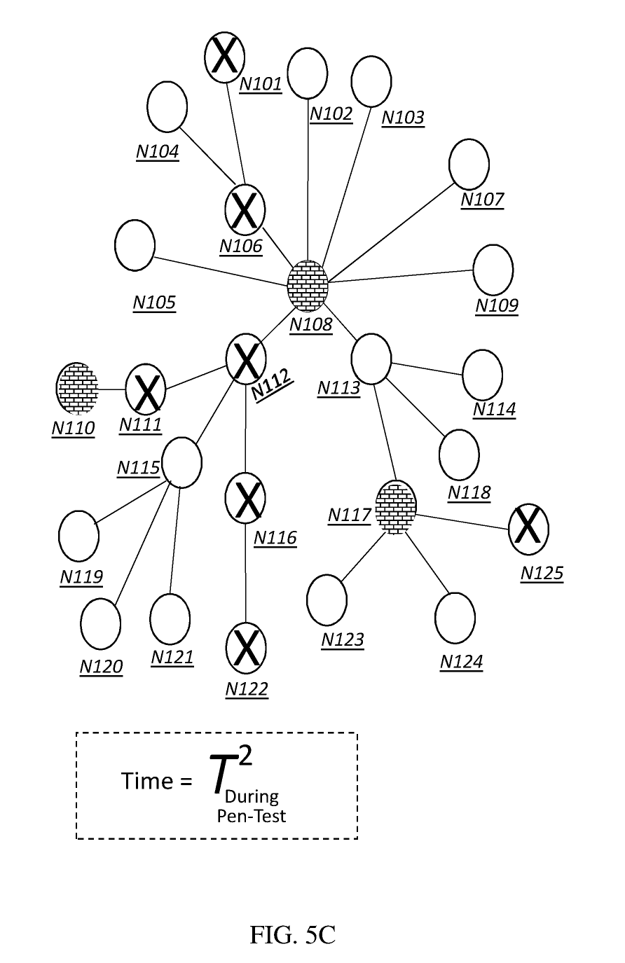

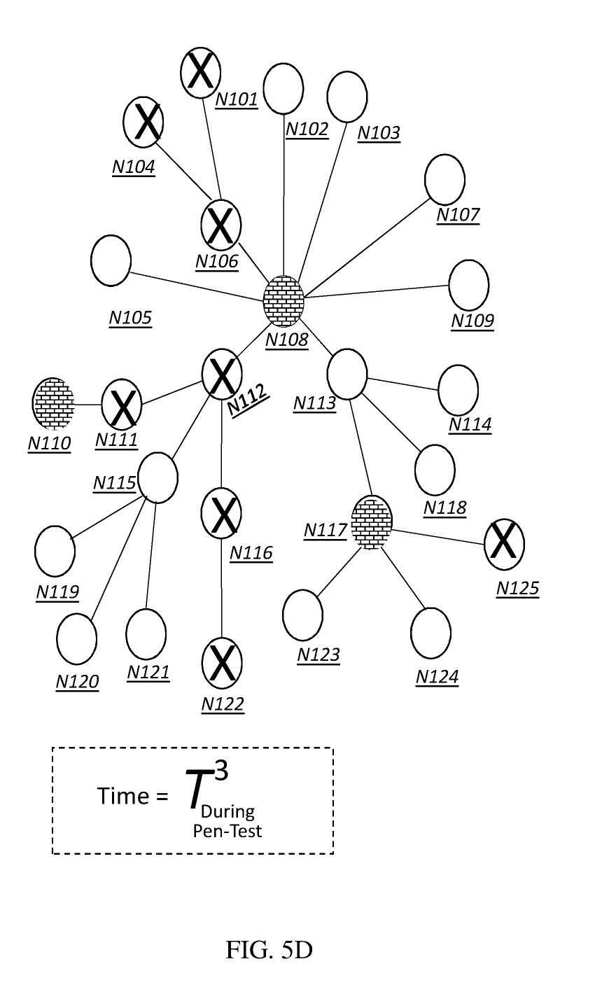

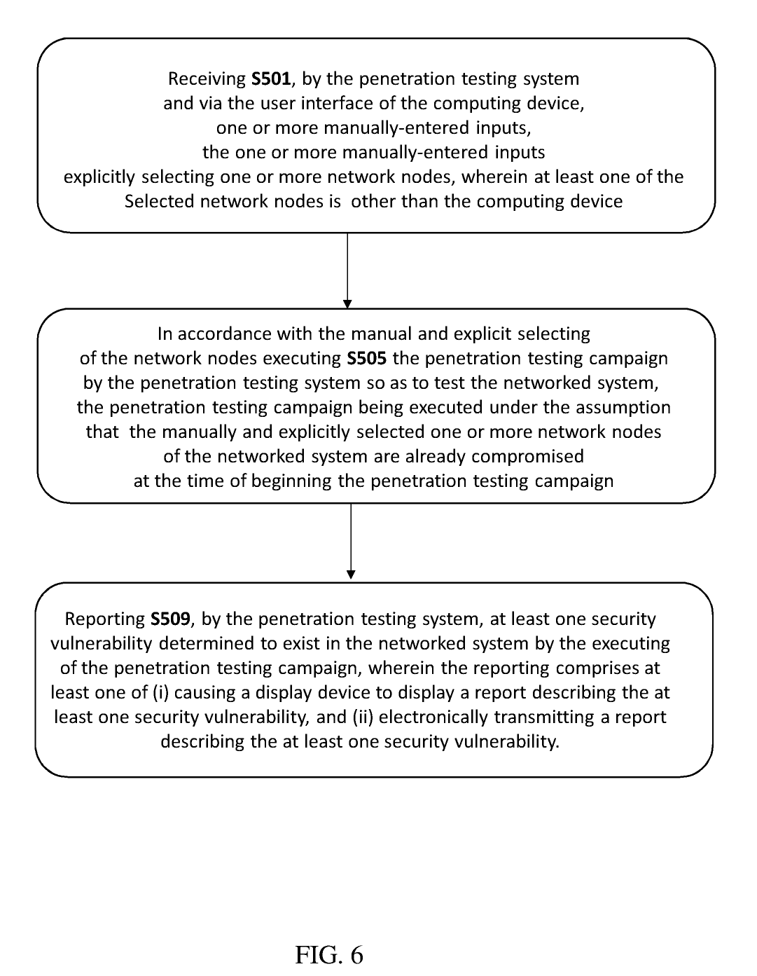

Embodiments of the invention relate to penetration testing of networked systems, such as that illustrated in FIG. 4A.

Penetration testing systems test networked systems. For example, the networked system comprises a plurality of network nodes (referred to simply as “nodes”) in communication with each other—e.g. see FIG. 4A.

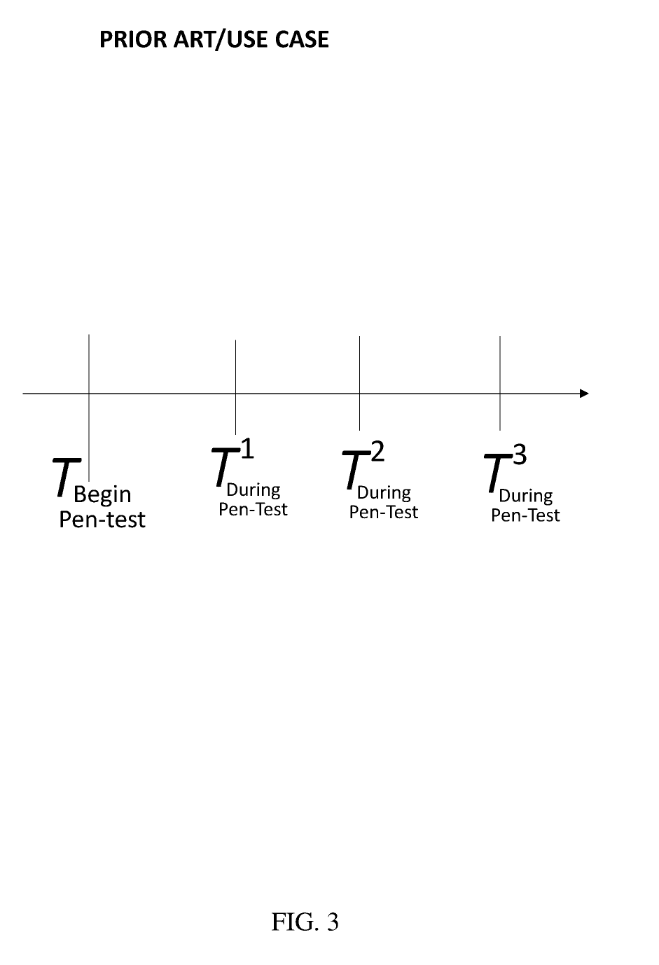

In prior art penetration testing systems (e.g. see the example discussed above with reference to FIGS. 3 and 4A-4D), a penetration testing campaign performs or emulates an attack of a potential attacker, starting from an initial state in which no network node of the tested networked system is compromised. The attacker is assumed to start by compromising a first network node (e.g. node N122 of FIG. 4B), then to take advantage of the already-compromised first node and compromise a second network node, then to take advantage of the already-compromised first and second nodes and compromise a third network node, and so on.

However, in some cases this way of operation does not satisfy the user's needs. The user may want to learn what might an attacker be able to achieve if s/he starts her/his attack with one or more specific nodes already under her/his control. This may be useful, for example, when evaluating the damages that might be incurred if the attacker is an employee of the organization owning the tested networked system that already controls his own network node. Another example is when knowing in advance that one or more given nodes are prone to being compromised (e.g. because they are accessible by the public) and evaluating the risks to the rest of the networked system after the one or more given nodes are compromised.

Therefore, it is useful to let a user of a penetration testing system to select one or more network nodes that will be assumed to be already compromised and under the control of the attacker when the penetration testing campaign starts. Such nodes are called herein “initially-compromised” or “initially-red” network nodes. When initially-compromised nodes are selected for a penetration testing campaign, these nodes are the only nodes that are assumed to be already compromised when the campaign starts. In other words, a node that is not selected to be an initially-compromised node for a campaign is assumed to be non-compromised when the campaign starts. An example related to initially-compromised nodes is presented below with reference to FIGS. 5A-5D.

In contrast to conventional penetration testing systems (i.e. where penetration testing campaigns are performed from an initial state in which no network node of the tested networked system is compromised), in a first embodiment of the invention the user manually and explicitly selects one or more nodes of the tested networked system as initially-compromised nodes. The skilled artisan is directed to FIGS. 6-7 and 8A-8B. The term ‘explicitly selecting’ is defined below—see definition “69” of the Definitions Section.

In contrast to conventional penetration testing systems (i.e. where penetration testing campaigns are performed from an initial state in which no network node of the tested networked system is compromised), in a second embodiment of the invention, before penetration testing, initially-compromised nodes are defined by the user as follows: the user manually and explicitly selects a Boolean node-selection condition defining which nodes or nodes are initially compromised. Any network node of the networked system that satisfies the Boolean condition is considered initially compromised. The skilled artisan is directed to FIGS. 9 and 10A-10B.

In contrast to conventional penetration testing systems (i.e. where penetration testing campaigns are performed from an initial state in which no network node of the tested networked system is compromised), in a third embodiment of the invention, the penetration testing system automatically selects one or more of the nodes that is to be considered initially-compromised. This selection may be performed, for example, according to features discussed with reference to FIGS. 11A-11C. The term ‘automatically selecting’ is defined below—see definition “70” of the Definitions Section.

It is appreciated that the first, second and/or third embodiments may be combined in any manner.

### A Discussion of the Example of FIGS. 5A-5D

Before discussing the first, second and third embodiments, an example related to initially-compromised nodes in general is now discussed with reference to FIGS. 5A-5D.

In contrast to the user-case of FIGS. 4A-4B where a campaign emulates an attack of a potential attacker, starting from an initial state in which no network node of the tested networked system is compromised, in the example of FIGS. 5A-5D, it is assumed that three nodes are initially-compromised: nodes N110, N108 and N117—this is designated by the ‘brick’ pattern.

According to the example illustrated in FIGS. 5A-5D, initially, at time T_{Begin Pen-Test}, when the penetration test begins, network-nodes N110, N108 and N117 are assumed to have been compromised. Between time T_{Begin Pen-Test} and T¹_{During Pen-Test}, network nodes

N111, N112, N106, N122 and N125 are compromised—this is indicated in FIG. 5B by the X's. Between time T¹_{During Pen-Test} and T²_{During Pen-Test}, network nodes N116 and N101 are compromised, as indicated by the X's in FIG. 5C. Between time T²_{During Pen-Test} and T³_{During Pen-Test}, network node N104 and is compromised, as indicated by the X's in FIG. 5D.

The networked system example of FIGS. 4A and 5A have a structure of a mathematical tree, in which there are no loops. Such example was selected for simplifying the figure and its explanation, but is not intended to limit the scope of the invention in any way. The invention is equally applicable to networked systems containing loops of network nodes in which each pair of nodes that are adjacent to each other in the loop are immediate neighbors. The inventios is also equally applicable to networked systems containing sub-networks comprising of many nodes, in which each two nodes belonging to the same sub-network are immediate neighbors. The invention is also equally applicable to networked systems containing any combination of trees, loops, sub-networks and other arrangements of network nodes.

### A Discussion of FIG. 6, 7, 8A-8B—a Method of Penetration Testing According to One or More Manually and Explicitly Selected Network Nodes

FIG. 6 is a flow chart of a method of penetration testing of a networked system by a penetration testing system that is controlled by a user interface of a computing device so that a penetration testing campaign is executed according to a manual and explicit selecting of one or more network nodes of the networked system.

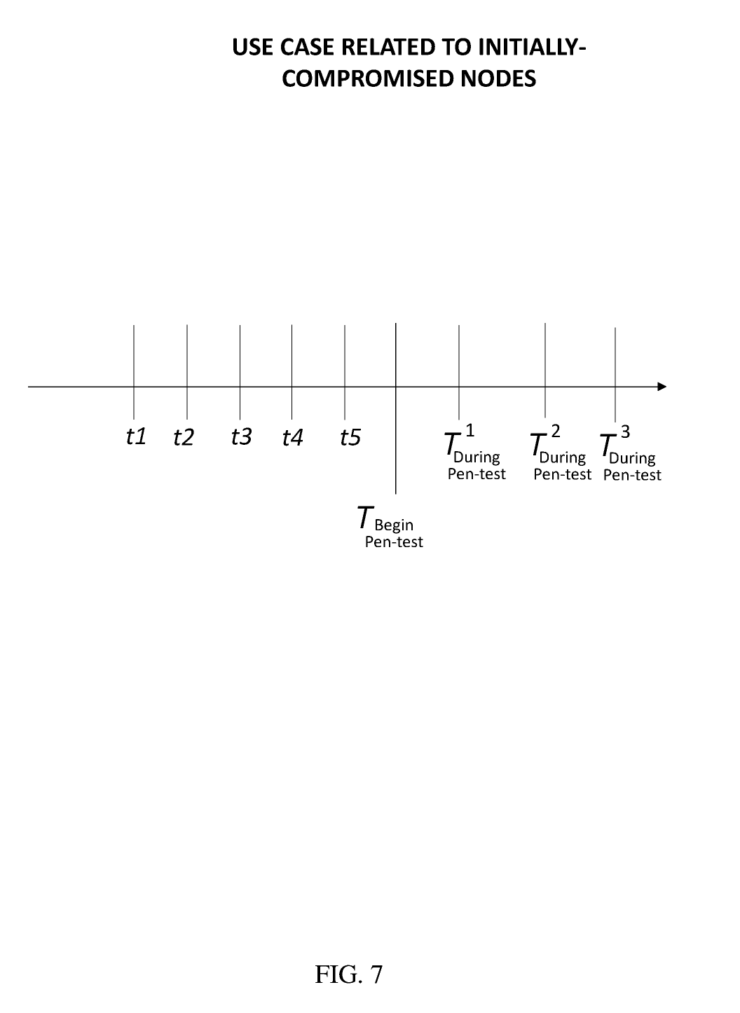

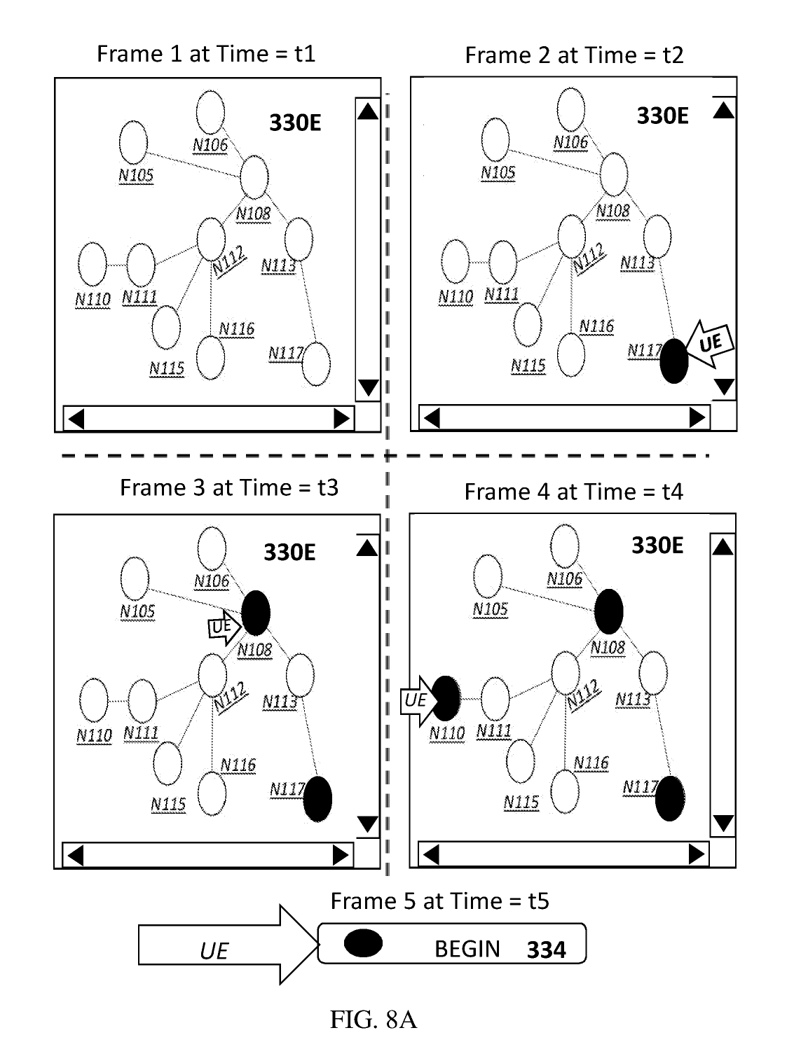

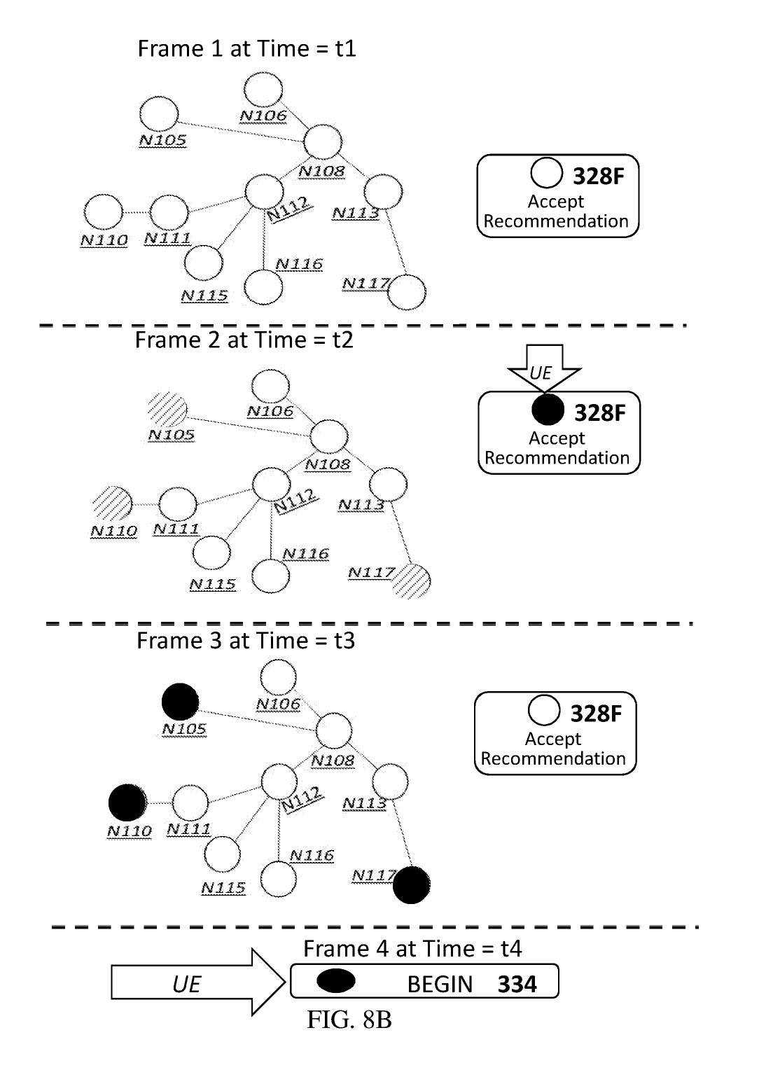

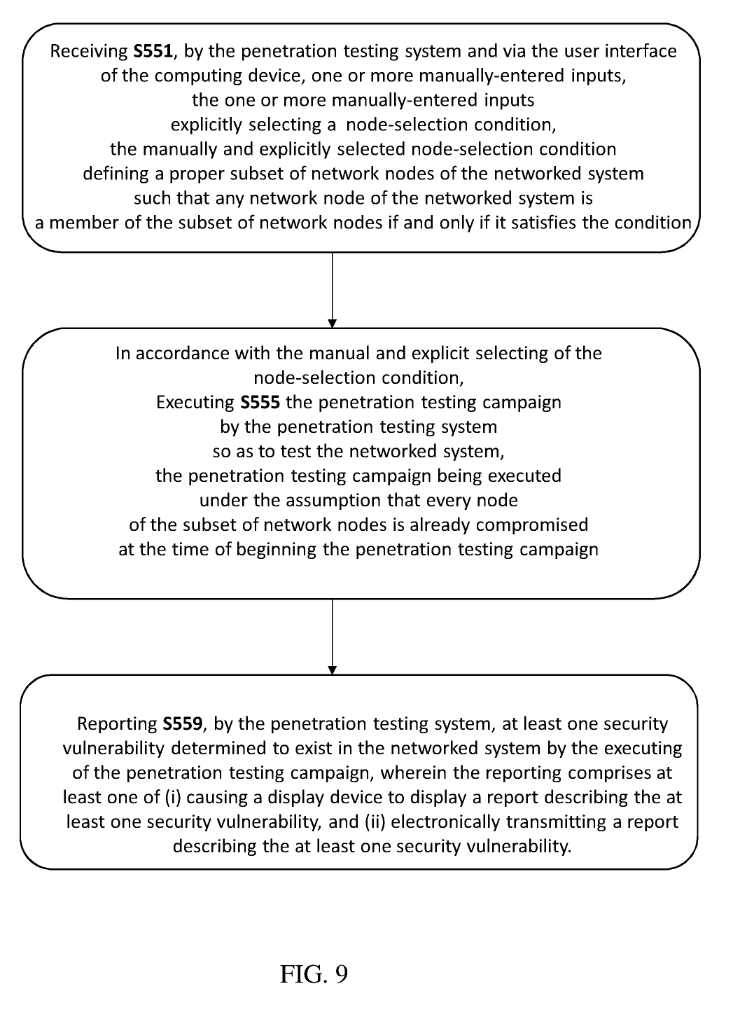

In one example, the selecting is performed using the GUI element 330E of FIG. 8A. that illustrates a first example of the method of FIG. 6 (also see the timeline of FIG. 7); FIG. 8B illustrates a second example of the method of FIG. 6. In both the first and second example the user can manually and explicitly select a set of nodes as initially-compromised that match the nodes of the example of FIGS. 5A-5D, illustrated by the brick-pattern.

In step S501 of FIG. 6, the penetration testing system receives (i.e. via the user interface of the computing device), one or more manually-entered inputs, where: (i) the one or more manually-entered inputs explicitly selects the one or more network nodes of the networked system and (ii) at least one of the manually and explicitly selected nodes is other than the computing device.

In Frame 1 of FIG. 8A, GUI element 330E of FIG. 8A illustrates 10 buttons (illustrated as empty circles), each of which is associated with a different network node (i.e. within the topology of the examples of FIGS. 5A-5D). Frames 1-4 of FIG. 8A illustrate the state of GUI element 330E at times t1-t4 (which are also shown on the timeline of FIG. 7). Frame 5 of FIG. 8A illustrates an action performed at time t5 using GUI element 334.

In all frames of FIG. 8A, UE is an abbreviation for ‘user engagement’—this relates to a user engagement of a GUI element. For example, the user provides a mouse click (e.g. depressing a mouse button) when a mouse pointer is located in a specific location of the GUI element. The skilled artisan will appreciate that a mouse click is just one example of a user engagement of a GUI element or portion thereof. In another example, a mouse-pointer points to an element without any need for a mouse-click; in another example, a user touches with his or her finger (or with a stylus) a GUI element for ‘user engagement’.

In Frame 2, at time t2 the user clicks on the button labelled N117 to manually and explicitly select node N117. In Frame t3, at time t3 the user clicks on the button labelled N108 to manually and explicitly select node N108. In Frame t4, at time t4 the user clicks on the button labelled N110 to manually and explicitly select node N110.

In Frame 5 of FIG. 8A at time t5, when the user's mouse-pointer is located within the ‘begin’ button 334, the user provides a mouse-click, thereby triggering steps S505 and S509 of FIG. 6, discussed below.

FIG. 8B illustrates a second non-limiting example related to step S501 of FIG. 6. Frame 1 illustrates an initial state of a GUI element displaying a portion of the network. In Frame 2, the penetration testing system provides a recommendation for three ‘candidate’ network-nodes—nodes N105, N110 and N117. The recommended nodes are illustrated in gray stripes. At time t2 of Frame 2, the user accepts the recommendation using GUI element 328F, thereby manually and explicitly selecting these three network nodes. Thus, in Frame 3 at time t3, the manually and explicitly selected nodes are illustrated in black.

In Frame 4 of FIG. 8B at time t4, the user clicks on ‘begin’ button 334, thereby triggering steps S505 and S509 of FIG. 6, discussed below.

One feature of step S501 is that at least one of the automatically selected network nodes is other than the computing device. This is clearly satisfied in the example of FIG. 8A where three distinct network nodes are selected. However, when a single network node is selected, this network note must be different than the “computer device” mentioned in step S501.

In step S505 of FIG. 6, the following is performed: in accordance with the manual and explicit selecting of the network nodes executing the penetration testing campaign by the penetration testing system so as to test the networked system, the penetration testing campaign being executed under the assumption that the manually and explicitly selected one or more network nodes of the networked system are already compromised at the time of beginning the penetration testing campaign.

In step S509 of FIG. 6, the following is performed: reporting, by the penetration testing system, at least one security vulnerability determined to exist in the networked system by the executing of the penetration testing campaign, wherein the reporting comprises at least one of (i) causing a display device to display a report describing the at least one security vulnerability, and (ii) electronically transmitting (e.g. over a computer network) (for example, from the computing device mentioned in step S501 to another computing device) a report describing the at least one security vulnerability.

In one example where the reporting comprises causing a display device to display a report describing the at least one security vulnerability, a computing device that performs the reporting causes a local display device (e.g. either residing in a common housing with the computing device that performs the reporting or connected via a local device interface) to display the report. Alternatively or additionally, data describing the report may be sent to another computing device (e.g. in communication with the computing device that performs the reporting via a local or remote network) to cause the other computing device to display the report on a display device local to the other computing device or to store it in a storage device for later use.

In some embodiments, the reporting may be in real time or substantially in real time. Alternatively, the reporting may be a delayed reporting where the data is first stored in volatile and/or non-volatile memory, and the reporting step may be completed only after some delay (e.g. even a delay of weeks or months or years).

Step S501 of FIG. 6 (along with steps S551 of FIG. 9, S811 of FIG. 11A, S821 of FIG. 11B, S801 of FIG. 11C, S301 of FIG. 12, S1351 of FIG. 14, S351 of FIG. 16, S601 of FIG. 18, S901 of FIG. 20, S401 of FIGS. 21 and S851 of FIG. 23) refers to a penetration testing system. In one example, the penetration testing system may include the hardware and software components of the user-interface used for providing the user input—e.g. for providing GUI element 330E. In another example, the penetration testing system receives the user input from a user-interface that is external to the penetration testing system.

### A Discussion of FIGS. 9 and 10A-10B—a Method of Penetration Testing Where the User Manually and Explicitly Selects a Boolean Node Selection Condition

As noted above, some embodiments relate to methods and apparatus where user-input manually and explicitly designates one or more nodes of the networked system as initially-compromised—e.g. see the example of FIGS. 5A-5D.

FIGS. 9 and 10A-10B relate to a second method where the user manually provides input for selecting which nodes (e.g. nodes N110, N108 and N117 of FIGS. 5A-5D) are assumed to be initially compromised.

In some embodiments, a user manually and explicitly selects a Boolean node-selection condition and a penetration testing campaign is performed according to the Boolean node-selection condition. FIG. 9 is a flow-chart of a method for penetration testing according to a manually and explicitly selected Boolean node-selection condition.

Specific examples of step S551 of the flow-chart of FIG. 9 are discussed below with reference to FIGS. 10A-10B.

In step S551 of FIG. 9 the penetration testing system receives (i.e. via the user interface of the computing device), one or more manually-entered inputs, where the one or more manually-entered inputs explicitly selects a Boolean node-selection condition. The manually and explicitly selected node-selection condition defines a proper subset of network nodes of the networked system such that any network node of the networked system is a member of the subset of network nodes if and only if it satisfies the condition.

A first example is presented in FIG. 10A.

Three candidate Boolean node-selection conditions are listed in GUI element 330F: (i) a first node-selection condition that states that a node is a selected (i.e. to be part of the ‘proper subset’ of network nodes) if and only if the node is a ‘Linux box’ (i.e. it is a computer executing Linux); (ii) a second node-selection condition that states that a node is a selected (i.e. to be part of the ‘proper subset’ of network nodes) if and only if the node has a direct connection to the outside world; and (iii) a third node-selection condition that states that a node is a selected (i.e. to be part of the ‘proper subset’ of network nodes) if and only if the node has an on-board cell-phone modem.

The first node-selection condition relates to software executing by a node; the second node-selection condition relates to a location of the node within the network; the third node-selection condition relates to hardware resources. FIG. 10A presents three frames—Frame 1 at time t1, Frame 2 at time t2, and Frame 3 at time t3.

In Frame 1, no selection has yet been made by the user. In Frame 2, at time t2 the user selects the third candidate node-selection condition in 330F—e.g. the user engagement of GUI element 330F may be provided by a mouse-click.

In Frame 3 of FIG. 10A at time t3, when the user's mouse-pointer is located within the ‘begin’ button 334, the user provides a mouse-click, thereby triggering steps S555 and S559 of FIG. 11, discussed below.

FIG. 10B shows another example, where the manual and explicit selecting of a Boolean node-selection condition defining the initially-compromised nodes of the penetration testing campaign is performed by the user accepting, by engaging an ‘accept recommendation” button 328F, a recommendation provided by the penetration testing system. Thus, frame 1 illustrates an initial step of GUI element 330F, in which GUI element 330F presents a recommended node-selection condition, shown in gray stripes. In Frame 2, the user accepts the recommendation, thereby effecting a manual and explicit selection of the “Iff machine has on-board cell-phone modem' node-selection condition. The user's selection of Frame 2 is shown in Frame 3, where the condition “Iff machine has on-board cell-phone modem” is shown in black.

In Frame 4 of FIG. 10B at time t4, the user clicks on ‘begin’ button 334, thereby triggering steps S555 and S559 of FIG. 9, discussed below.

In step S555 of FIG. 9, the following is performed: in accordance with the manual and explicit setting forth of the node-selection condition, executing the penetration testing campaign by the penetration testing system so as to test the networked system, the penetration testing campaign being executed under the assumption that every node of the subset of network nodes is already compromised at the time of beginning the penetration testing campaign.

In step S559 of FIG. 9, the following is performed: reporting, by the penetration testing system, at least one security vulnerability determined to exist in the networked system by the executing of the penetration testing campaign, wherein the reporting comprises at least one of (i) causing a display device to display a report describing the at least one security vulnerability, and (ii) electronically transmitting (e.g. over a computer network) (for example, from the computing device mentioned in step S551 to another computing device) a report describing the at least one security vulnerability.

In one example where the reporting comprises causing a display device to display a report describing the at least one security vulnerability, a computing device that performs the reporting causes a local display device (e.g. either residing in a common housing with the computing device that performs the reporting or connected via a local device interface) to display the report. Alternatively or additionally, data describing the report may be sent to another computing device (e.g. in communication with the computing device that performs the reporting via a local or remote network) to cause the other computing device to display the report on a display device local to the other computing device or to store it in a storage device for later use.

In some embodiments, the reporting may be in real time or substantially in real time. Alternatively, the reporting may be a delayed reporting where the data is first stored in volatile and/or non-volatile memory, and the reporting step may be completed only after some delay (e.g. even a delay of weeks or months or years).

In one particular example relating to the example of FIGS. 10A-10B which parallels the example of FIGS. 5A-5D, none of the nodes has an on-board cell-phone modem except for the following nodes—N110, N108 and N117.

A number of examples of Boolean node conditions: (example A) machine is a mobile node; (example B) machine is a node with a direct connection to the outside world; (example C) machine is a node where MS Word is installed; (example D) machine is a

Linux node; (example E) machine is a node with Windows 7.0 or lower; (example F) machine is a node physically situated in the State of California; (example G) machine provides FTP services to other nodes.

Example G is one example of a service dependent condition. Examples D-E are examples of operating-system (OS) dependent conditions. Example C is an example of a software-application dependent condition.

### A Discussion of FIG. 11A

FIG. 11A is a flow chart of a method of penetration testing of a networked system by a penetration testing system so that a penetration testing campaign is executed according to an automatic selecting of one or more network nodes of the networked system.

In step S811, the following is performed: determining whether one or more network nodes of the networked system satisfy a pre-defined Boolean condition. Some examples of pre-defined Boolean conditions are listed in 330F, discussed above. The Boolean condition is automatically selected by the penetration testing system. For example, a database may store a list of Boolean conditions, and one is selected randomly every time the penetration testing campaign is run.

In step S805, the following is performed: based on a result of the determining, automatically selecting, by the penetration testing system, the one or more network nodes of the networked system, wherein at least one of the automatically selected network nodes is other than the computing device.

In step S809, the following is performed: in accordance with the automatically selecting of the network nodes, executing the penetration testing campaign by the penetration testing system so as to test the networked system, the penetration testing campaign being executed under the assumption that the automatically selected one or more network nodes of the networked system are already compromised at the time of beginning the penetration testing campaign.

In step S813 of FIG. 11A, the following is performed: reporting, by the penetration testing system, at least one security vulnerability determined to exist in the networked system by the executing of the penetration testing campaign, wherein the reporting comprises at least one of (i) causing a display device to display a report describing the at least one security vulnerability, and (ii) electronically transmitting (e.g. over a computer network) a report describing the at least one security vulnerability.

In one example where the reporting comprises causing a display device to display a report describing the at least one security vulnerability, a computing device that performs the reporting causes a local display device (e.g. either residing in a common housing with the computing device that performs the reporting or connected via a local device interface) to display the report. Alternatively or additionally, data describing the report may be sent to another computing device (e.g. in communication with the computing device that performs the reporting via a local or remote network) to cause the other computing device to display the report on a display device local to the other computing device or to store it in a storage device for later use.

In some embodiments, the reporting may be in real time or substantially in real time. Alternatively, the reporting may be a delayed reporting where the data is first stored in volatile and/or non-volatile memory, and the reporting step may be completed only after some delay (e.g. even a delay of weeks or months or years).

### A Discussion of FIG. 11B

A “type of an attacker” is defined as a classification of the attacker that indicates its main incentive in conducting attacks of networked systems. Typical values for a type of an attacker are state-sponsored, opportunistic cyber criminal, organized cyber criminal and insider.

An attacker can have only a single type.

Some embodiments relate to methods and systems where one or more nodes are automatically selected by the penetration testing system according to a type of attacker. The type of attacker can be determined in any manner—e.g. according to user-input or automatically or in any other manner.

In one example, whenever it is determined that an attacker is state sponsored, nodes that operate Windows 7 are assumed to be initially compromised. In another example, whenever it is determined that the attacker is an insider, nodes that are physically located in field offices and not within the corporate headquarters are assumed to be initially compromised.

In step S821, the following is performed: determining S821, by the penetration testing system a type of an attacker of the penetration testing campaign. Also appearing in FIGS. 11B are steps S805, S809, and S813, discussed above.

These steps are the same steps as in FIG. 11A, and are not explained again.

### A Discussion of FIG. 11C

FIG. 11C is a flow chart of a method of penetration testing of a networked system by a penetration testing system so that a penetration testing campaign is executed according to an automatic selecting of one or more network nodes of the networked system.

In step S801, the following is performed: determining, by the penetration testing system, at least one of (i) a type of an attacker of the penetration testing campaign, and (ii) whether one or more network nodes of the networked system satisfy a pre-defined Boolean condition. The type of attacker can be determined in any manner—e.g. according to user-input or automatically or in any other manner.

Also appearing in FIG. 11B are steps S805, S809, and S813 discussed above.

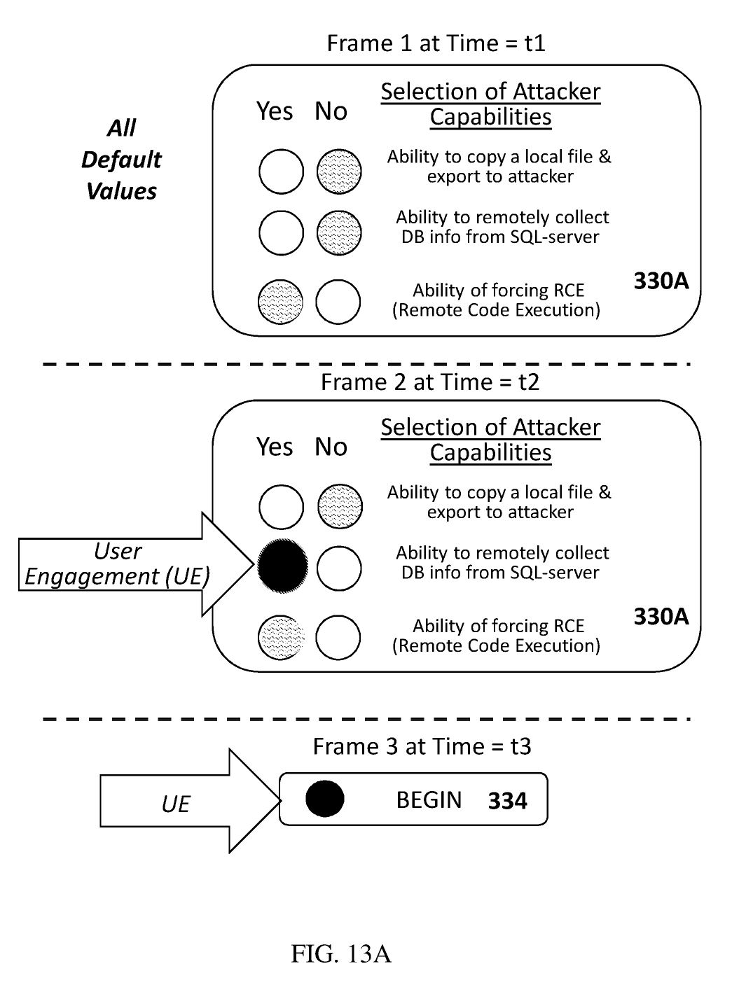

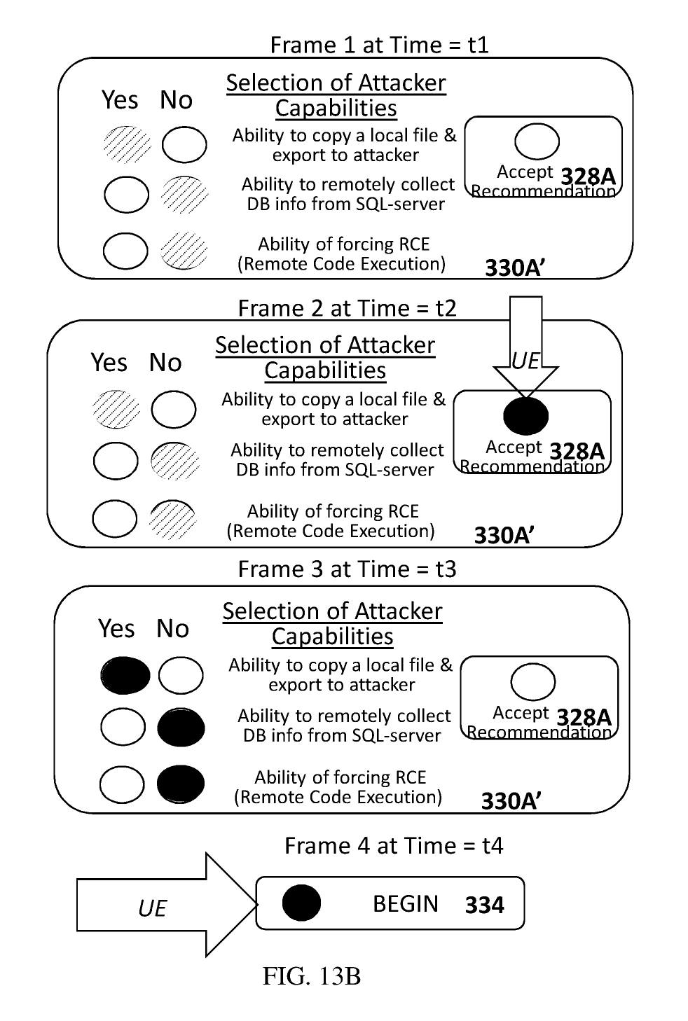

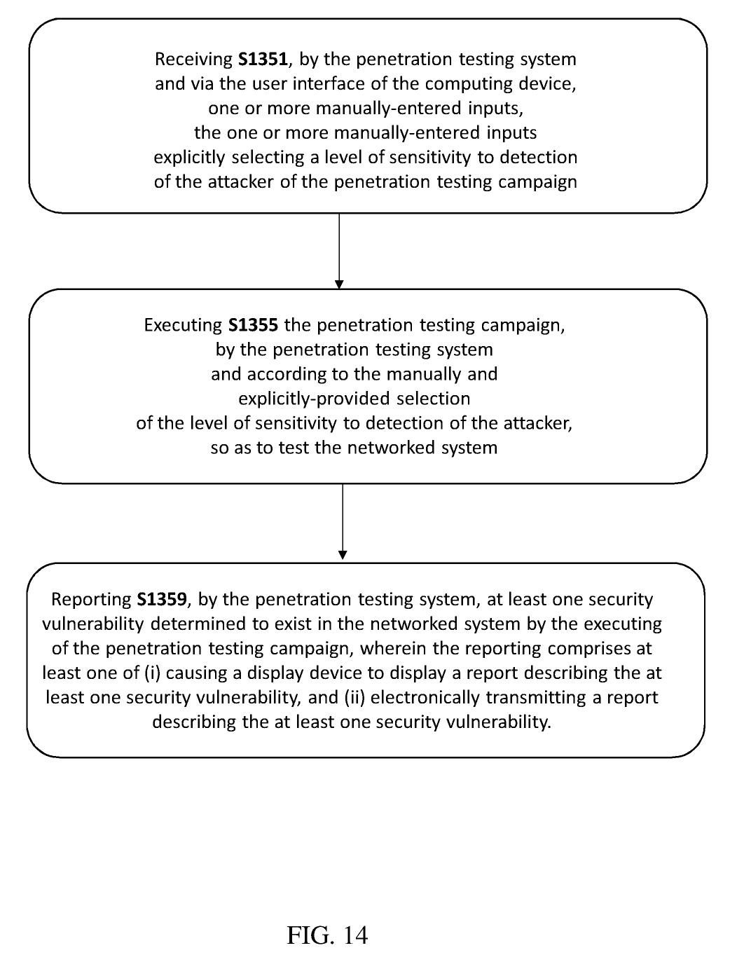

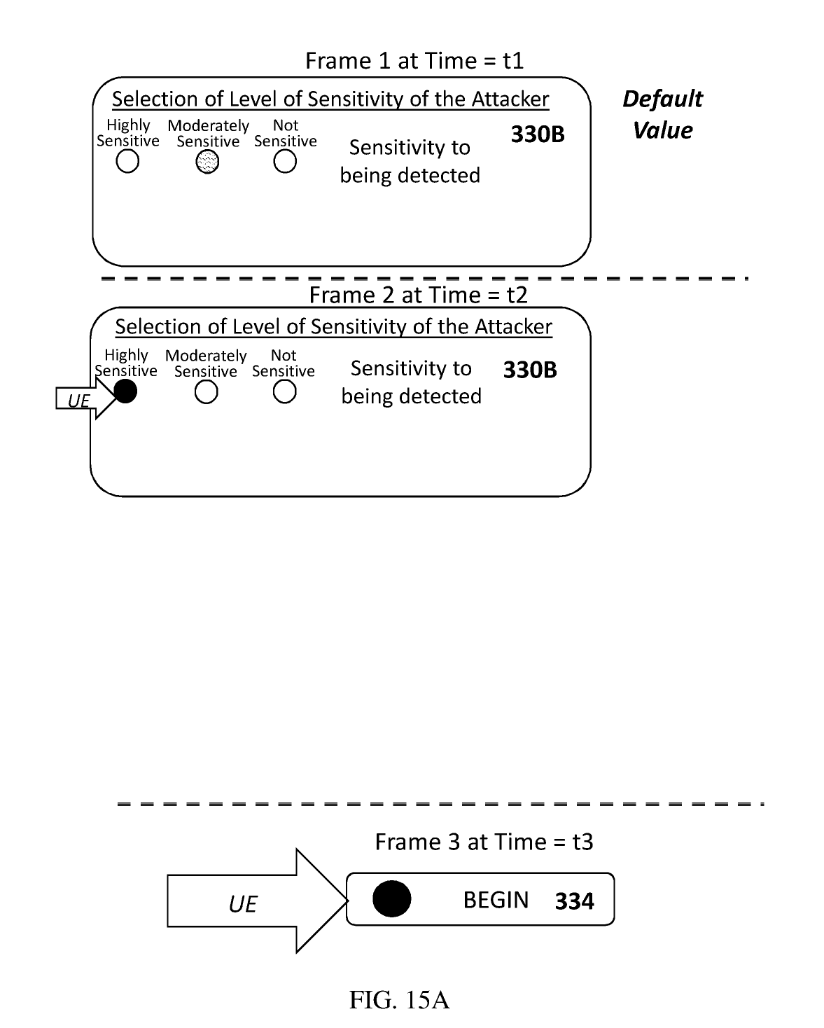

A Discussion of FIGS. 12 and 13A-13B—a Method of Penetration Testing According to One or More Manually and Explicitly Selected Capabilities of an Attacker of a Penetration Testing Campaign (e.g. Using GUI Element 330A)

In some embodiments, a user manually and explicitly selects one or more capabilities of an attacker of a penetration testing campaign. FIG. 12 is a flow-chart of a method for performing penetration testing according to manually and explicitly selected capabilities of an attacker of a penetration testing campaign.

Specific examples of step S301 of the flow-chart of FIG. 12 are discussed below with reference to FIGS. 13A-13B.

The term ‘capability’ of an attacker is defined below—see definition “27” of the ‘Definitions Section.’

In step S301 of FIG. 12, the penetration testing system receives (i.e. via the user interface of a computing device), one or more manually-entered inputs, where the one or more manually-entered inputs are explicitly selecting one or more capabilities of the attacker of the penetration testing campaign.

A first example is presented in FIG. 13A which relates to the example of the GUI element 330A.

Three attacker capabilities are listed in GUI element 330A: (i) the ability to copy a local file and export it to the attacker—if the user selects “YES” then the subsequent penetration testing campaign is performed in step S305 such that the attacker is assumed to have this capability; (ii) the ability to remotely collect database (DB) information (info) form the SQL-server of Microsoft®—if the user selects “YES” then the subsequent penetration testing campaign is performed in step S305 such that the attacker is assumed to have this capability; and (iii) the ability to force remote code execution (RCE)—if the user selects “YES” then the subsequent penetration testing campaign is performed in step S305 such that the attacker is assumed to have this capability.

FIG. 13A presents three frames—Frame 1 at time t1, Frame 2 at time t2, and Frame 3 at time t3. In FIG. 13A the default values are indicated by a gray ‘wave’ shading.

Frame 1 of FIG. 13A illustrates an initial state (i.e. at time ti) where only default values are presented as follows: (i) the attacker lacks the ability to copy a local file and export it to an attacker (i.e. “N”); (ii) the attacker lacks the ability to remotely collect database (DB) information from SQL server (i.e. “N”); and (ii) the attacker has the ability to force remote code execution (RCE) (i.e. “Y”).

In Frame 2 of FIG. 13A at time t2, the user engages the GUI element 330A (e.g. by clicking when a mouse pointer is within the circle next to the capability labeled “Ability to remotely collect DB info from SQL-server) to override the default value, changing from “NO” to “YES.”

In Frame 3 of FIG. 13A at time t3, when the user's mouse-pointer is located within the ‘begin’ button 334, the user provides a mouse-click, thereby triggering steps S305 and S309 of FIG. 12, discussed below.

FIG. 13B shows another example, where the manual and explicit selecting of the one or more capabilities of the attacker of the penetration testing campaign is performed by the user accepting, by engaging an ‘accept recommendation” button 328A, a recommendation provided by the penetration testing system.

Frame 1 of FIG. 13B illustrates an initial state (i.e. at time t1) of GUI element 330A’ where only system-recommended values are presented as follows: (i) the attacker has the ability to copy a local file and export it to an attacker (i.e. “Y”); (ii) the attacker lacks the ability to remotely collect database (DB) information from SQL server (i.e. “N”); and (iii) the attacker lacks the ability to force remote code execution (RCE) (i.e. “N”). Thus, the {Y,N,N} values are illustrated in diagonal gray lines, indicating that these values have not been manually and explicitly selected by the user—in the initial state of FIG. 13A, the {Y,N,N} values are only system-generated recommendations.

In Frame 2 of FIG. 13B at time t2, the user engages the GUI element 328A by clicking on the circle labelled ‘accept recommendation’ to accept the system-recommended values presented in Frame 1 of FIG. 13B.

In Frame 3 of FIG. 13B, the values {Y,N,N} that were previously (i.e. in Frame 1) presented in gray diagonal shading (i.e. when they were only system-recommended values) are now presented in solid black. Because the user manually and explicitly accepted the system-generated recommendations in Frame 2, the values {Y,N,N} are now manually and explicitly selected values, and are presented as such in Frame 3 of FIG. 13B. It should be noted that the user is not forced to accept the system-generated recommendations, but may override them. This freedom of choice is what makes the selection of the attacker capabilities a manual and explicit selection. If the user would not have an option of overriding the system's recommendations, then their selection would not be considered a manual and explicit selection.

In Frame 4 of FIG. 13B, the user clicks on the ‘begin’ button to begin the penetration testing campaign using the manually and explicitly selected { Y,N,N} values.

In step S305 of FIG. 12, the following is performed: executing the penetration testing campaign, by the penetration testing system and according to the manually and explicitly-provided selection of the one or more capabilities of the attacker, so as to test the networked system.

In step S309 of FIG. 12, the following is performed: reporting, by the penetration testing system, at least one security vulnerability determined to exist in the networked system by the executing of the penetration testing campaign, wherein the reporting comprises at least one of (i) causing a display device to display a report describing the at least one security vulnerability, and (ii) electronically transmitting (e.g. over a computer network) (for example, from the computing device mentioned in step S301 to another computing device) a report describing the at least one security vulnerability.

In one example where the reporting comprises causing a display device to display a report describing the at least one security vulnerability, a computing device that performs the reporting causes a local display device (e.g. either residing in a common housing with the computing device that performs the reporting or connected via a local device interface) to display the report. Alternatively or additionally, data describing the report may be sent to another computing device (e.g. in communication with the computing device that performs the reporting via a local or remote network) to cause the other computing device to display the report on a display device local to the other computing device or to store it in a storage device for later use.

In some embodiments, the reporting may be in real time or substantially in real time. Alternatively, the reporting may be a delayed reporting where the data is first stored in volatile and/or non-volatile memory, and the reporting step may be completed only after some delay (e.g. even a delay of weeks or months or years).

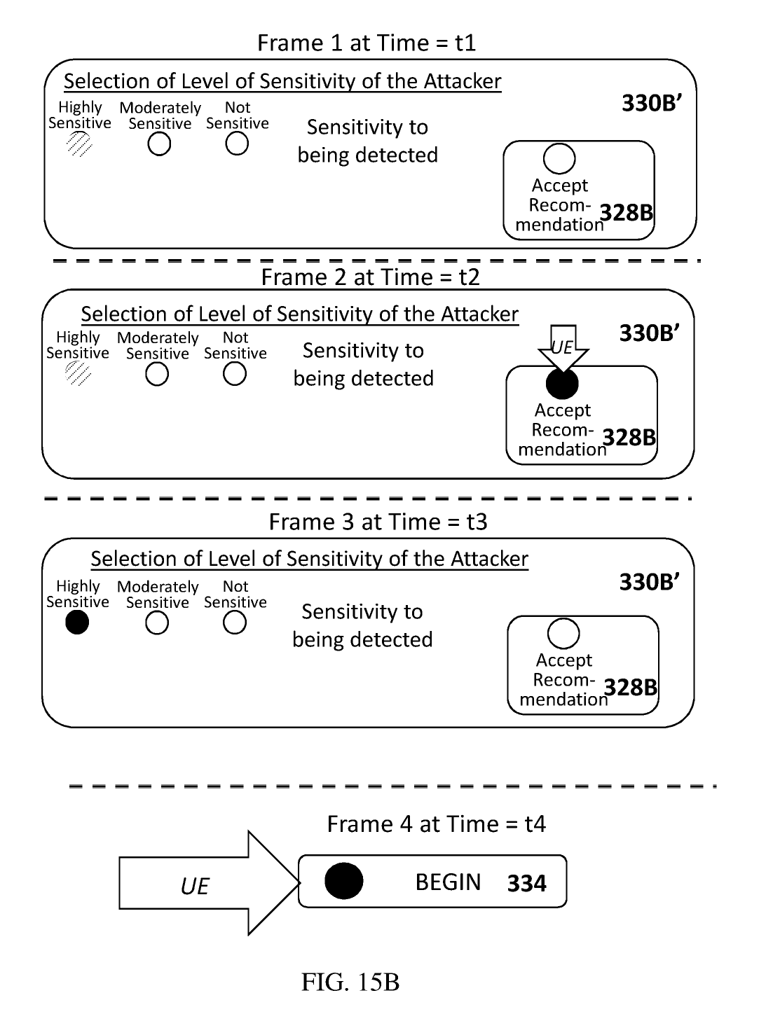

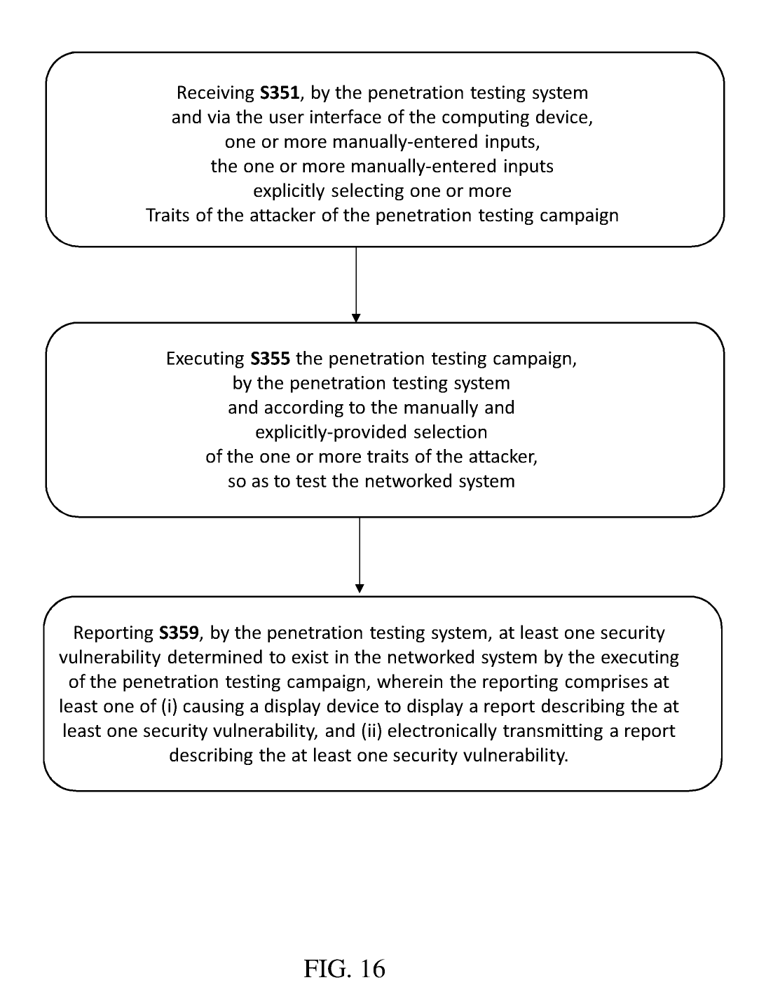

A Discussion of FIGS. 14 and 15A-15B—a Method of Penetration Testing According to a Manually and Explicitly Selected Level of Sensitivity to Detection of an Attacker of a Penetration Testing Campaign (e.g. Using GUI Element 330B)

In some embodiments, a user manually and explicitly selects a level of sensitivity to detection of an attacker of a penetration testing campaign.

The term ‘level of sensitivity to detection of an attacker’ is defined below—see definition “30” of the ‘Definitions Section’.

FIG. 14 is a flow-chart of a method of penetration testing of a networked system by a penetration testing system that is controlled by a user interface of a computing device so that a penetration testing campaign is executed according to manually and explicitly-selected level of sensitivity to detection of an attacker of the penetration testing campaign.

Specific examples of step S1351 of the flow-chart of FIG. 14 are discussed below with reference to FIGS. 15A-15B.

In step S1351 of FIG. 14, the penetration testing system receives (i.e. via the user interface of a computing device), one or more manually-entered inputs, where the one or more manually-entered inputs are explicitly selecting a level of sensitivity to detection of the attacker of the penetration testing campaign.

A first example is presented in FIG. 15A which relates to the example of the GUI element 330B.

GUI element 330B allows for the user to manually and explicitly select a level of sensitivity of the attacker to being detected (e.g. typically ‘lone-wolf’ or ‘free-wheeling’ attackers have ‘less to lose’ if detected while state-sponsored attackers are more sensitive to being detected).

For the particular example of FIG. 15A, the user may select ‘highly sensitive’ (HS), ‘moderately sensitive’ (MS) or ‘not sensitive’(NS)—if the user selects “highly sensitive” then the subsequent penetration testing campaign is performed in step S1355 in a manner where the attacker is constrained to be highly sensitive, if the user selects “moderately sensitive” then the subsequent penetration testing campaign is performed in step S1355 in a manner where the attacker is constrained to be moderately sensitive, if the user selects “not sensitive” then the subsequent penetration testing campaign is performed in step S1355 in a manner where the attacker is not sensitive to being detected.

FIG. 15A presents three frames—Frame 1 at time t1, Frame 2 at time t2, and Frame 3 at time t3.

Frame 1 of FIG. 15A illustrates an initial state (i.e. at time t1) where only a default value is selected as follows: the attacker is moderately sensitive to being detected (i.e. “MS”).

In Frame 2 of FIG. 15A at time t2, the user engages the GUI element 330B (e.g. by clicking when a mouse pointer is within the circle below the words ‘highly sensitive’) to override the default value of the sensitivity, changing from “MS” to “HS.”

In Frame 3 of FIG. 15A at time t3, when the user's mouse-pointer is located within the ‘begin’ button 334, the user provides a mouse-click, thereby triggering steps S1355 and S1359 of FIG. 14 using the manually and explicitly selected value {“HS”}.

FIG. 15B shows another example, where the manual and explicit selecting of the level of sensitivity to detection of the attacker of the penetration testing campaign is performed by the user accepting, by engaging an ‘accept recommendation” button 328B, a recommendation provided by the penetration testing system.

Frame 1 of FIG. 15B illustrates an initial state (i.e. at time t1) of GUI element 330B′ where only a system-recommended value is presented as follows: the attacker is highly sensitive to being detected (i.e. “HS” value).

Thus, the {HS } value is illustrated in diagonal gray lines, indicating that this value has not been manually and explicitly selected by the user—in the initial state of FIG. 15B, the {HS} value is only a system-generated recommendation.

In Frame 2 of FIG. 15B at time t2, the user engages the GUI element 328B by clicking on the circle labelled ‘accept recommendation’ to accept the system-recommended value presented in Frame 1 of FIG. 15B.

In Frame 3 of FIG. 15B, the value {HS} that was previously (i.e. in Frame 1) presented in gray diagonal shading (i.e. when it was only a system-recommended value) is now presented in solid black. Because the user accepted the system-generated recommendations in Frame 2, the value {HS} is now a manually and explicitly selected value, and is presented as such in Frame 3 of FIG. 15B. It should be noted that the user is not forced to accept the system-generated recommendation, but may override them. This freedom of choice is what makes the selection of the attacker's level of sensitivity to detection a manual and explicit selection.

In Frame 4 of FIG. 15B, the user clicks on the ‘begin’ button to begin the penetration testing campaign using the manually and explicitly selected { HS } value.

In step S1355 of FIG. 14, the following is performed: executing the penetration testing campaign, by the penetration testing system and according to the manually and explicitly-provided selection of the level of sensitivity to detection of the attacker, so as to test the networked system.

In step S1359 of FIG. 14, the following is performed: reporting, by the penetration testing system, at least one security vulnerability determined to exist in the networked system by the executing of the penetration testing campaign, wherein the reporting comprises at least one of (i) causing a display device to display a report describing the at least one security vulnerability, and (ii) electronically transmitting (e.g. over a computer network) (for example, from the computing device mentioned in step S1351 to another computing device) a report describing the at least one security vulnerability.

In one example where the reporting comprises causing a display device to display a report describing the at least one security vulnerability, a computing device that performs the reporting causes a local display device (e.g. either residing in a common housing with the computing device that performs the reporting or connected via a local device interface) to display the report. Alternatively or additionally, data describing the report may be sent to another computing device (e.g. in communication with the computing device that performs the reporting via a local or remote network) to cause the other computing device to display the report on a display device local to the other computing device or to store it in a storage device for later use.

In some embodiments, the reporting may be in real time or substantially in real time. Alternatively, the reporting may be a delayed reporting where the data is first stored in volatile and/or non-volatile memory, and the reporting step may be completed only after some delay (e.g. even a delay of weeks or months or years).

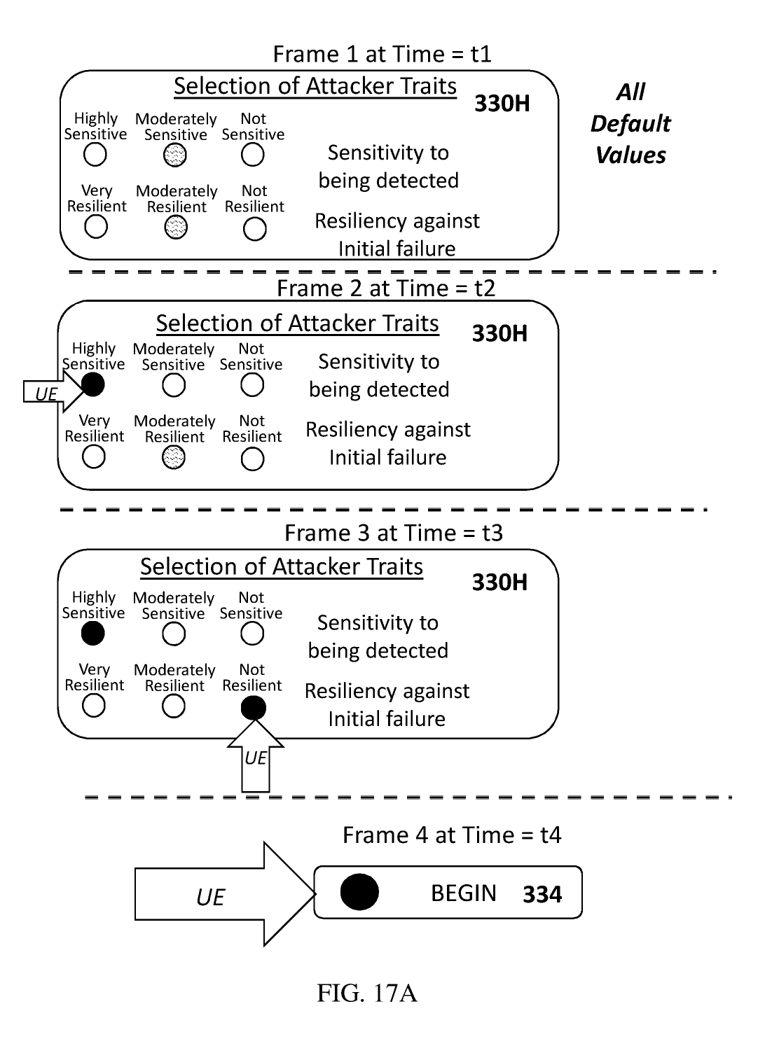

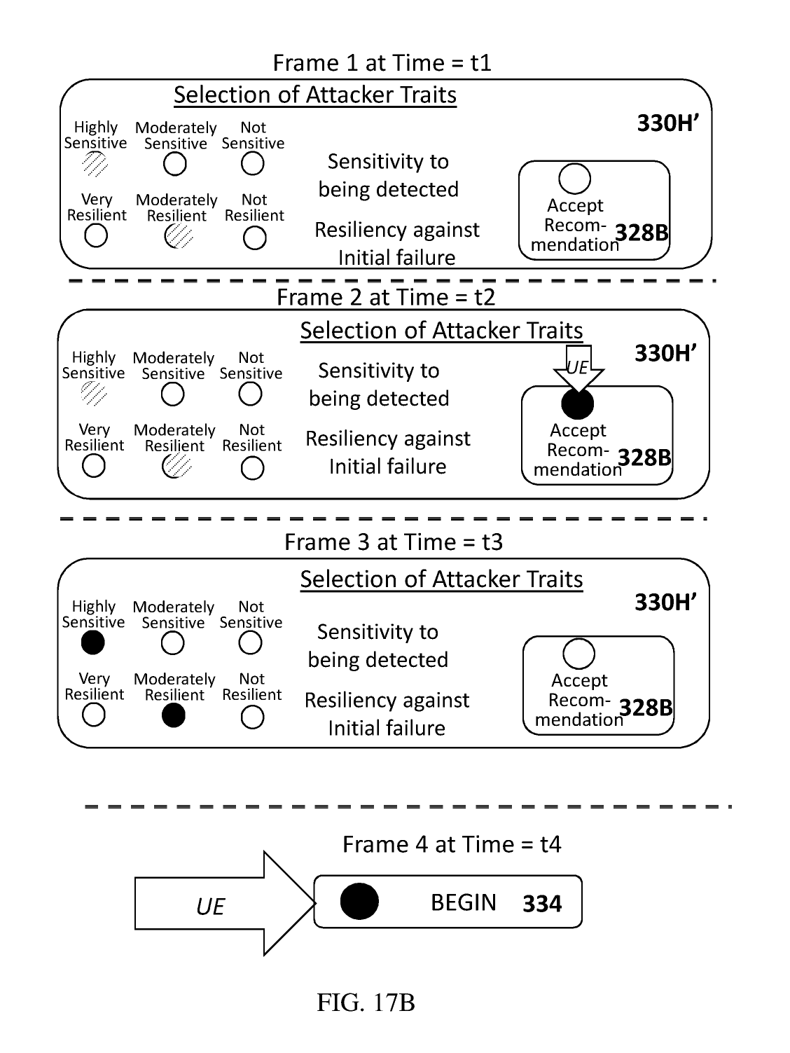

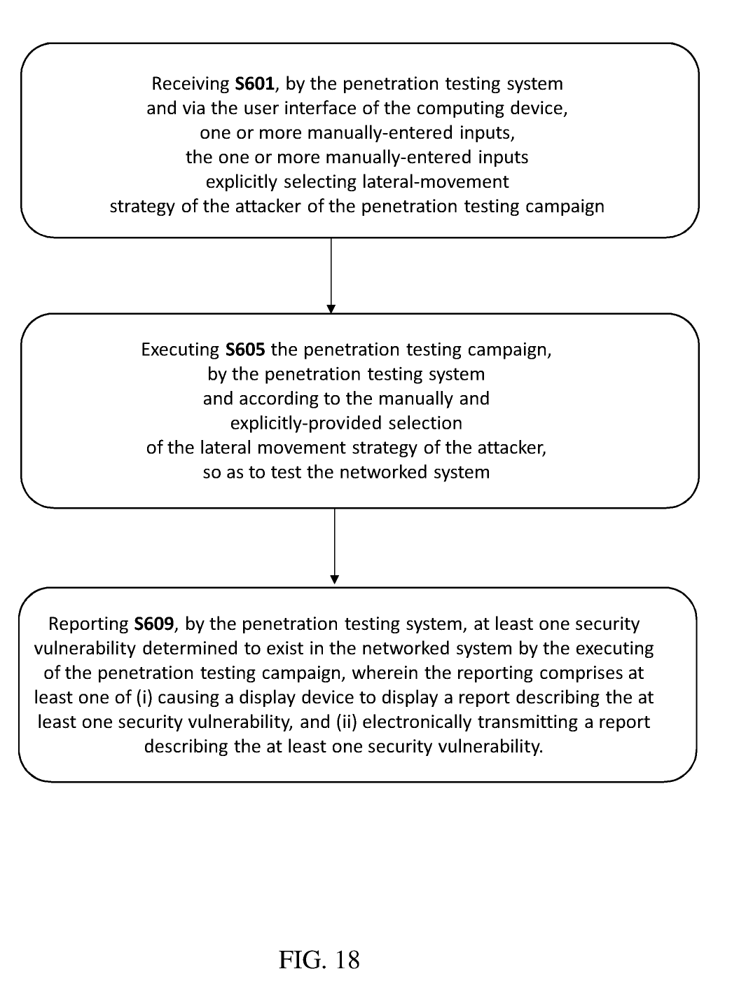

A Discussion of FIGS. 16 and 17A-17B—a Method of Penetration Testing According to One or More Manually and Explicitly Selected Traits of an Attacker of a Penetration Testing Campaign (e.g. Using GUI Element 330H)

In some embodiments, a user manually and explicitly selects one or more traits of an attacker of a penetration testing campaign. FIG. 16 is a flow-chart of a method for penetration testing according to manually and explicitly-selected traits of an attacker of a penetration testing campaign.

Specific examples of step S351 of the flow-chart of FIG. 16 are discussed below with reference to FIGS. 17A-17B. The term ‘trait’ of an attacker is defined below—see definition “29” of the ‘Definitions Section.’

In step S351 of FIG. 16, the penetration testing system receives (i.e. via the user interface of a computing device), one or more manually-entered inputs, where the one or more manually-entered inputs are explicitly selecting one or more traits of the attacker of the penetration testing campaign.

A first example is presented in FIG. 17A which relates to the example of the GUI element 330H.

Two attacker traits are listed in GUI element 330H: (i) how sensitive the attacker is to being detected (e.g. typically ‘lone-wolf’ or ‘free-wheeling’ attackers have ‘less to lose’ if detected while state-sponsored attackers are more sensitive to being detected); and (ii) how resilient the attacker is against initial failure—i.e. often when an attacker tries to accomplish a goal, the attacker may initially fail—more resilient attackers are willing to make more attempts even when previous attempts failed.

For the first trait, the user may select ‘highly sensitive’ (HS), ‘moderately sensitive’ (MS) or ‘not sensitive’(NS)—if the user selects “highly sensitive” then the subsequent penetration testing campaign is performed in step S355 in a manner where the attacker is constrained to be highly sensitive, if the user selects “moderately sensitive” then the subsequent penetration testing campaign is performed in step S355 in a manner where the attacker is constrained to be moderately sensitive, if the user selects “not sensitive” then the subsequent penetration testing campaign is performed in step S355 in a manner where the attacker is not sensitive to being detected.

For the second trait, the user may select ‘very resilient’ (VR), ‘moderately resilient’ (MR) and ‘not resilient’ (NR).

FIG. 17A presents four frames—Frame 1 at time t1, Frame 2 at time t2, Frame 3 at time t3 and Frame 4 at time t4.

Frame 1 of FIG. 17A illustrates an initial state (i.e. at time t1) where only default values are presented as follows: (i) the attacker is moderately sensitive to being detected (i.e. “MS”); (ii) the attacker is moderately resilient against initial failure (i.e. “MR”).

In Frame 2 of FIG. 17A at time t2, the user engages the GUI element 330H (e.g. by clicking when a mouse pointer is within the circle below the words ‘highly sensitive’) to override the default value of the sensitivity, changing from “MS” to “HS.”

In Frame 3 of FIG. 17A at time t3, the user engages the GUI element 330H (e.g. by clicking when a mouse pointer is within the circle below the words ‘not resilient’) to override the default value of the resiliency, changing from “MW” to “NR.”

In Frame 4 of FIG. 17A at time t4, when the user's mouse-pointer is located within the ‘begin’ button 334, the user provides a mouse-click, thereby triggering steps S355 and S359 of FIG. 16 using the manually and explicitly selected values {“HS,”NR″}, discussed below.

FIG. 17B shows another example, where the manual and explicit selecting of the traits of the attacker of the penetration testing campaign is performed by the user accepting, by engaging an ‘accept recommendation” button 328B, a recommendation provided by the penetration testing system.

Frame 1 of FIG. 17B illustrates an initial state (i.e. at time t1) of GUI element 330H' where only system-recommended values are presented as follows: (i) the attacker is highly sensitive to being detected (i.e. “HS” value); (ii) the attacker is moderately resilient against initial failure (“MW” value).

Thus, the {HS,MR} values are illustrated in diagonal gray lines, indicating that these values have not been manually and explicitly selected by the user—in the initial state of FIG. 17B, the {HS, MR} values are only system-generated recommendations.

In Frame 2 of FIG. 17B at time t2, the user engages the GUI element 328B by clicking on the circle labelled ‘accept recommendation’ to accept the system-recommended values presented in Frame 1 of FIG. 17B.

In Frame 3 of FIG. 17B, the values {HS, MR} that were previously (i.e. in Frame 1) presented in gray diagonal shading (i.e. when they were only system-recommended values) are now presented in solid black. Because the user accepted the system-generated recommendations in Frame 2, the values {HS, MR} are now manually and explicitly selected values, and are presented as such in Frame 3 of FIG. 17B. It should be noted that the user is not forced to accept the system-generated recommendations, but may override them. This freedom of choice is what makes the selection of the attacker traits a manual and explicit selection.

In Frame 4 of FIG. 17B, the user clicks on the ‘begin’ button to begin the penetration testing campaign using the manually and explicitly selected {HS,MR} values.

In step S355 of FIG. 16, the following is performed: executing the penetration testing campaign, by the penetration testing system and according to the manually and explicitly-provided selection of the one or more traits of the attacker, so as to test the networked system.

In step S359 of FIG. 16, the following is performed: reporting, by the penetration testing system, at least one security vulnerability determined to exist in the networked system by the executing of the penetration testing campaign, wherein the reporting comprises at least one of (i) causing a display device to display a report describing the at least one security vulnerability, and (ii) electronically transmitting (e.g. over a computer network) (for example, from the computing device mentioned in step S351 to another computing device) a report describing the at least one security vulnerability.

In one example where the reporting comprises causing a display device to display a report describing the at least one security vulnerability, a computing device that performs the reporting causes a local display device (e.g. either residing in a common housing with the computing device that performs the reporting or connected via a local device interface) to display the report. Alternatively or additionally, data describing the report may be sent to another computing device (e.g. in communication with the computing device that performs the reporting via a local or remote network) to cause the other computing device to display the report on a display device local to the other computing device or to store it in a storage device for later use.

In some embodiments, the reporting may be in real time or substantially in real time. Alternatively, the reporting may be a delayed reporting where the data is first stored in volatile and/or non-volatile memory, and the reporting step may be completed only after some delay (e.g. even a delay of weeks or months or years).

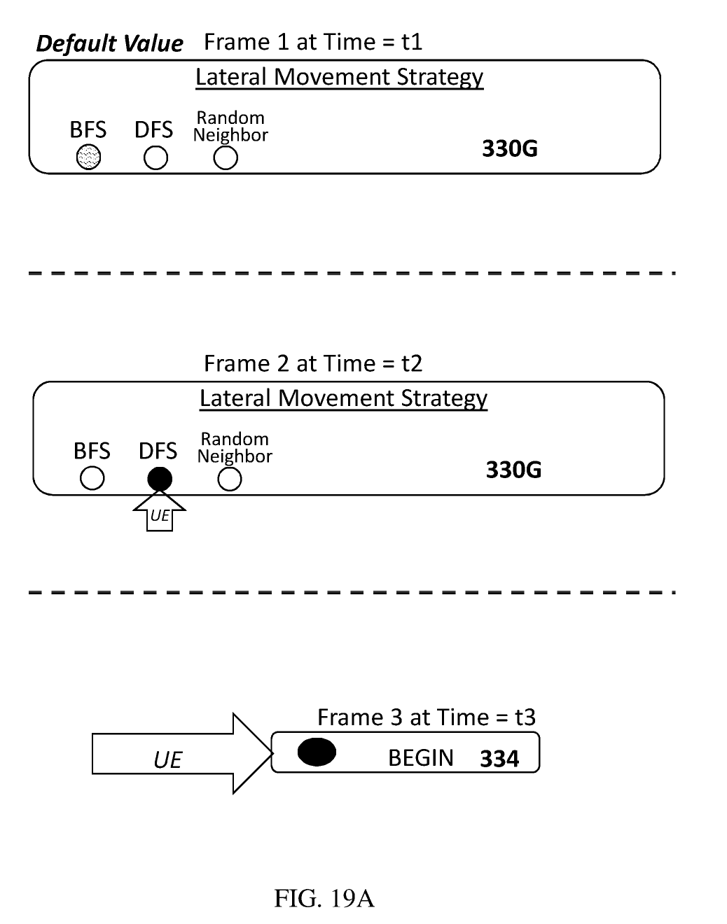

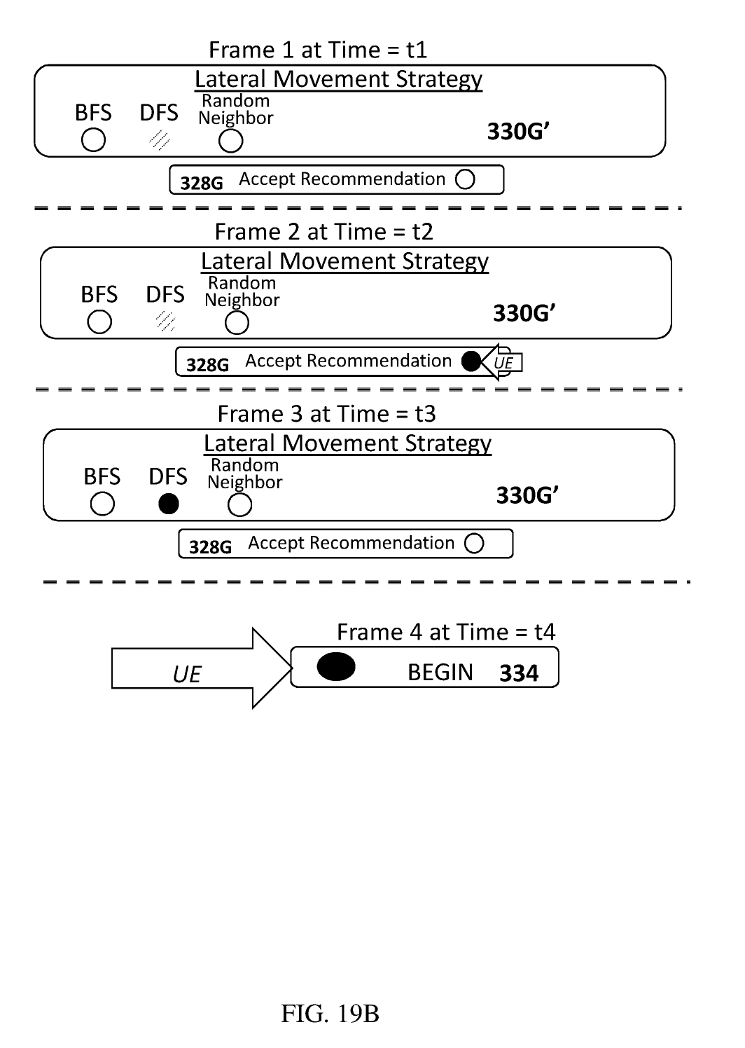

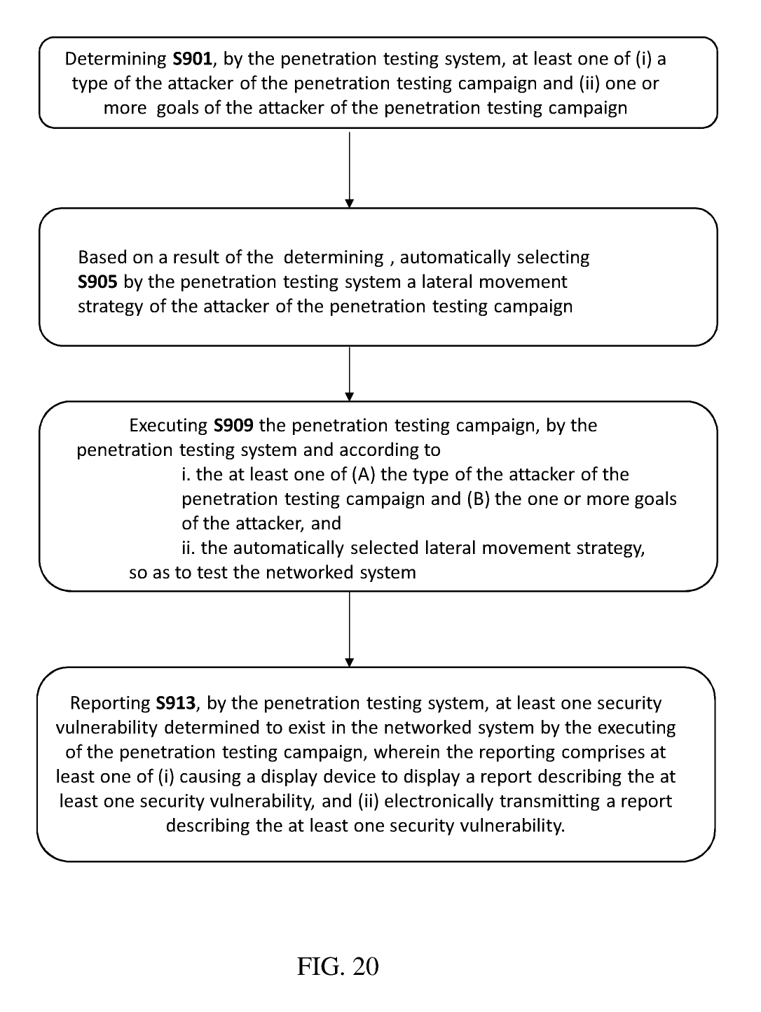

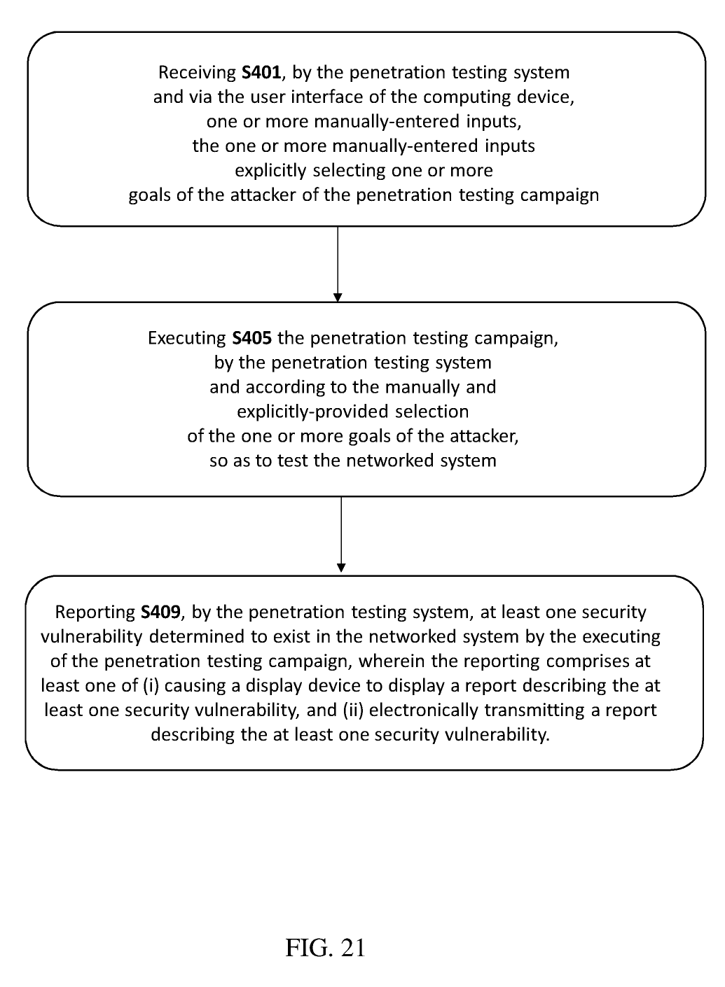

A Discussion of FIGS. 18 and 19A-19B—a Method of Penetration Testing According to a Manually and Explicitly Selected Lateral Movement Strategy of an Attacker of a Penetration Testing Campaign (e.g. Using GUI element 330G)

In some embodiments, a user manually and explicitly selects a lateral movement strategy of an attacker of a penetration testing campaign. FIG. 18 is a flow-chart of a method for penetration testing according to manually and explicitly selected lateral movement strategy of an attacker of a penetration testing campaign.

Specific examples of step S601 of the flow-chart of FIG. 18 are discussed below with reference to FIGS. 19A-19B.

The term ‘lateral movement strategy’ of an attacker is defined below—see definition “42” of the ‘Definitions Section.’

In step S601 of FIG. 18, the penetration testing system receives (i.e. via the user interface of a computing device), one or more manually-entered inputs, where the one or more manually-entered inputs explicitly select a lateral movement strategy of the attacker of the penetration testing campaign.

A first example is presented in FIG. 19A which relates to the example of the GUI element 330G of FIG. 19A.

Three lateral movement strategies are listed in GUI element 330G: (i) breadth-first strategy (BFS); (ii) depth-first-strategy (DFS); and (iii) ‘random neighbor strategy’ where the movement is from a node to an immediately-neighboring node, the immediately-neighboring node being selected randomly.

FIG. 19A presents three frames—Frame 1 at time t1, Frame 2 at time t2, and Frame 3 at time t3.

Frame 1 of FIG. 19A illustrates an initial state (i.e. at time t1) where only a default value is presented as follows: the lateral movement strategy of the attacker is ‘BFS’.

In Frame 2 of FIG. 19A at time t2, the user engages the GUI element 330G (e.g. by clicking when a mouse pointer is within the circle below ‘DFS’) to override the default value, changing from “BFS” to “DFS.”

In Frame 3 of FIG. 19A at time t3, when the user's mouse-pointer is located within the ‘begin’ button 334, the user provides a mouse-click, thereby triggering steps S605 and S609 of FIG. 17 (i.e using the ‘DFS’ value), discussed below.

FIG. 19B shows another example, where the manual and explicit selecting of the lateral movement strategy of the attacker of the penetration testing campaign is performed by the user accepting, by engaging an ‘accept recommendation” button 328G, a recommendation provided by the penetration testing system.

Frame 1 of FIG. 19B illustrates an initial state (i.e. at time t1) of GUI element 330G′ where the system-recommended value is presented as follows: the lateral-movement strategy of the attacker is “DFS”. This “DFS” value is illustrated in diagonal gray lines, indicating that it has not been manually and explicitly selected by the user—in the initial state of FIG. 19B, the “DFS” value is only a system-generated recommendation.

In Frame 2 of FIG. 19B at time t2, the user engages the GUI element 328G by clicking on the circle labelled ‘accept recommendation’ to accept the system-recommended value presented in Frame 1 of FIG. 19B.

In Frame 3 of FIG. 19B, the {DFS } value that was previously (i.e. in Frame 1) presented in gray diagonal shading (i.e. when it was only a system-recommended value) is now presented in solid black. Because the user accepted the system-generated recommendation in Frame 2, the value { DFS } is now a manually and explicitly selected value, and is presented as such in Frame 3 of FIG. 19B. It should be noted that the user is not forced to accept the system-generated recommendation, but may override it. This freedom of choice is what makes the selection of the lateral movement strategy a manual and explicit selection.

In Frame 4 of FIG. 19B, the user clicks on the ‘begin’ button to begin the penetration testing campaign using the manually and explicitly selected { DFS } value.

In step S605 of FIG. 18, the following is performed: executing the penetration testing campaign, by the penetration testing system and according to the manually and explicitly-provided lateral movement strategy of the attacker, so as to test the networked system;

In step S609 of FIG. 18, the following is performed: reporting, by the penetration testing system, at least one security vulnerability determined to exist in the networked system by the executing of the penetration testing campaign, wherein the reporting comprises at least one of (i) causing a display device to display a report describing the at least one security vulnerability, and (ii) electronically transmitting (e.g. over a computer network) (for example, from the computing device mentioned in step S501 to another computing device) a report describing the at least one security vulnerability.

In one example where the reporting comprises causing a display device to display a report describing the at least one security vulnerability, a computing device that performs the reporting causes a local display device (e.g. either residing in a common housing with the computing device that performs the reporting or connected via a local device interface) to display the report. Alternatively or additionally, data describing the report may be sent to another computing device (e.g. in communication with the computing device that performs the reporting via a local or remote network) to cause the other computing device to display the report on a display device local to the other computing device or to store it in a storage device for later use.

In some embodiments, the reporting may be in real time or substantially in real time. Alternatively, the reporting may be a delayed reporting where the data is first stored in volatile and/or non-volatile memory, and the reporting step may be completed only after some delay (e.g. even a delay of weeks or months or years).

### A Discussion of FIG. 20

FIG. 20 is a flow chart of a method of penetration testing of a networked system by a penetration testing system so that a penetration testing campaign is executed according to an automatic selecting of lateral movement strategy of an attacker of the penetration testing campaign.

In step S901 of FIG. 20, the following is performed: determining, by the penetration testing system, at least one of (i) a type of the attacker of the penetration testing campaign and (ii) one or more goals of the attacker of the penetration testing campaign. The type of attacker can be determined in any manner—e.g. according to user-input or automatically or in any other manner. The one or more goals of the attacker can be determined in any manner—e.g. according to user-input or automatically or in any other manner.

In step S905 of FIG. 20, the following is performed: based on a result of the determining, automatically selecting by the penetration testing system a lateral movement strategy of the attacker of the penetration testing campaign.

In step S909 of FIG. 20, the following is performed: executing the penetration testing campaign, by the penetration testing system and according to i. the at least one of the type of the attacker and the one or more goals of the attacker, and ii. the automatically selected lateral movement strategy of the attacker, so as to test the networked system.

In step S913 of FIG. 20, the following is performed: reporting, by the penetration testing system, at least one security vulnerability determined to exist in the networked system by the executing of the penetration testing campaign, wherein the reporting comprises at least one of (i) causing a display device to display a report describing the at least one security vulnerability, and (ii) electronically transmitting (e.g. over a computer network) a report describing the at least one security vulnerability.

In one example where the reporting comprises causing a display device to display a report describing the at least one security vulnerability, a computing device that performs the reporting causes a local display device (e.g. either residing in a common housing with the computing device that performs the reporting or connected via a local device interface) to display the report. Alternatively or additionally, data describing the report may be sent to another computing device (e.g. in communication with the computing device that performs the reporting via a local or remote network) to cause the other computing device to display the report on a display device local to the other computing device or to store it in a storage device for later use.

In some embodiments, the reporting may be in real time or substantially in real time. Alternatively, the reporting may be a delayed reporting where the data is first stored in volatile and/or non-volatile memory, and the reporting step may be completed only after some delay (e.g. even a delay of weeks or months or years).

### A Discussion of Goals of an Attacker of a Penetration Testing Game and Classification of Example Goals

The term a ‘goal of an attacker’ is defined below—see “31” of the Definitions Section.

Seventeen (17) examples of goals of an attacker are listed below:
A. exporting outside the networked system of a file having a specific file name from a specific network node
B. exporting outside the networked system of a file having a specific file name from whatever node of the networked system having a copy of it.
C. exporting outside the networked system of a given number of files from a specific network node.
D. exporting outside the networked system of a given number of files from any nodes.
E. exporting outside the networked system of files having a total size that is more than a given size.
F. exporting outside the networked system of files of a specific type having a total size that is more than a given size.
G. damaging in a specific way a given number of files.
H. damaging in a specific way a file having a specific file name in a specific node.
I. damaging in a specific way a given number of files having a specific type.
J. encrypting a given number of files.
K. encrypting a file having a specific file name in a specific node.
L. encrypting a given number of files having a specific type.
M. compromising a given number of network nodes, without caring which nodes they are (with the given number of nodes larger than one).
N. compromising enough network nodes so that the ratio of the number of already-compromised nodes to the number of not-yet-compromised nodes is higher than a given threshold.
O. compromising enough network nodes so that the difference between the number of already-compromised nodes and the number of not-yet-compromised nodes is higher than a given threshold.
P. compromising a given number of network nodes, all of which are members of a pre-defined subset of the nodes of the tested networked system. The pre-defined subset may be, for example, all the nodes running the Windows 7 Operating system, or all the nodes that are mobile devices.
Q. compromising all the network nodes in the networked system that are members of a pre-defined subset of the nodes of the tested networked system. The pre-defined subset of nodes may be defined, for example, by a condition that has to be satisfied by a member node, such as having a cellular communication channel.

There are many particular species of “goals” of an attacker.

Thus, some goals (but not all goals) are resource-specific goals. The term ‘resource-specific goal’ is defined below in definition ‘32’ of the Definitions Section. Some but not all of the example goals A-Q are resource specific goals. In particular, examples A, B, H, and K are resource-specific goals. Examples C-G, I-J, L-Q are not resource-specific goals.

The term ‘file-specific goal’ is defined below in definition ‘33’ of the Definitions Section. Some but not all of the example goals A-Q are file-specific goals. In particular, examples A, B, H, and K are file specific goals. Examples C-G, I-J, L-Q are not file-specific goals.

The term ‘node-count-maximizing goal’ is defined below in definition ‘34’ of the Definitions Section. Some but not all of the example goals A-Q are node-count-maximizing goals. In particular, examples N, O, and Q are node-count-maximizing goals. Examples A-M and P are not node-count-maximizing goals.

The term ‘file-count-maximizing goal’ is defined below in definition ‘35’ of the Definitions Section. Some but not all of the example goals A-Q are file-count-maximizing goals. In particular, examples E and F are file-count-maximizing goals. Examples A-D, G-Q are not file-count-maximizing goals.

The term ‘encryption-related goal’ is defined below in definition ‘36’ of the Definitions Section. Some but not all of the example goals A-Q are encryption-related goals. In particular, examples J-L are encryption-related goals. Examples A-I and M-Q are not encryption-related goals.

The term ‘file-exporting goal’ is defined below in definition ‘37’ of the Definitions Section. Some but not all of the example goals A-Q are file-exporting goals. In particular, examples A-F are file-exporting goals. Examples G-Q are not file-exporting goals.

The term ‘file-size-related goal’ is defined below in definition ‘38’ of the Definitions Section. Some but not all of the example goals A-Q are file-size-related goals.

In particular, examples E-F are file-size-related goals. Examples A-D and G-Q are not file-size-related goals.

The term ‘file-type-related goal’ is defined below in definition ‘39’ of the Definitions Section. Some but not all of the example goals A-Q are file-type-related goals. In particular, examples F, I and L are file-size-related goals. Examples A-E, G-H, J-K and M-Q are not file-type-related goals.

The term ‘file-damage-related goal’ is defined below in definition ‘40’ of the Definitions Section. Some but not all of the example goals A-Q are file-damage-related goals. In particular, examples G-L are file-damage-related goals. Examples A-F and M-Q are not file-damage-related goals.

The term ‘node-condition-based goal’ is defined below in definition ‘41’ of the Definitions Section. Some but not all of the example goals A-Q are node-condition-based goals. In particular, examples P and Q are node-condition-related goals. Examples A-O are not node-condition-related goals.

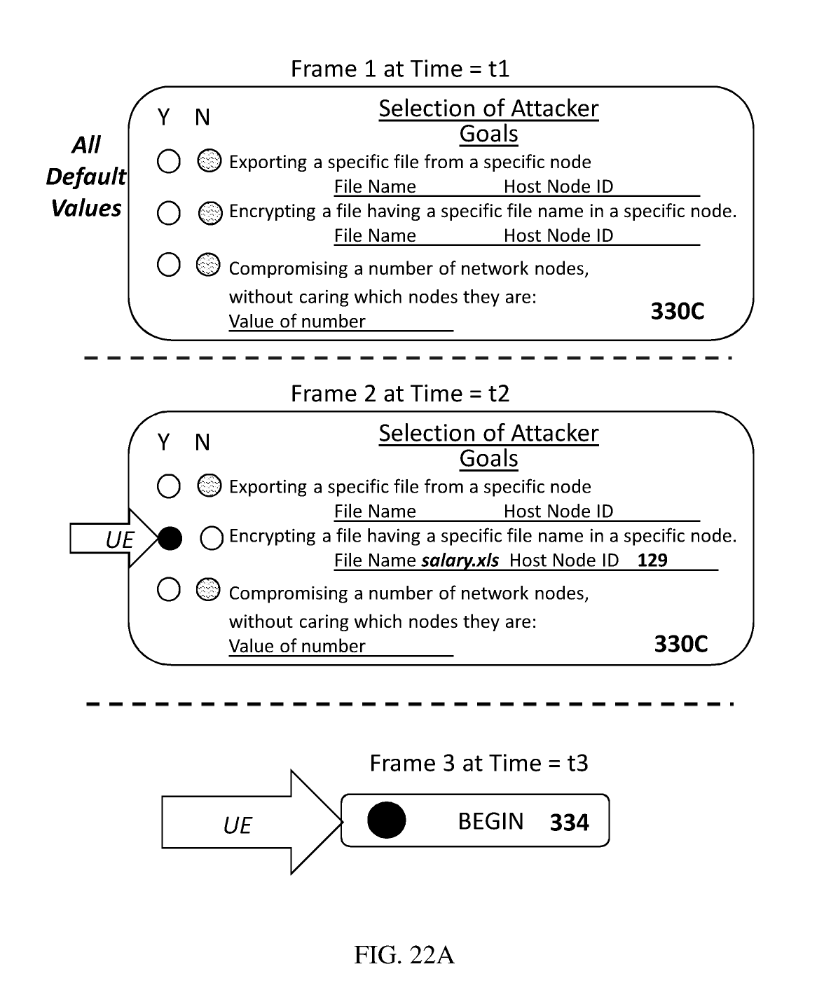

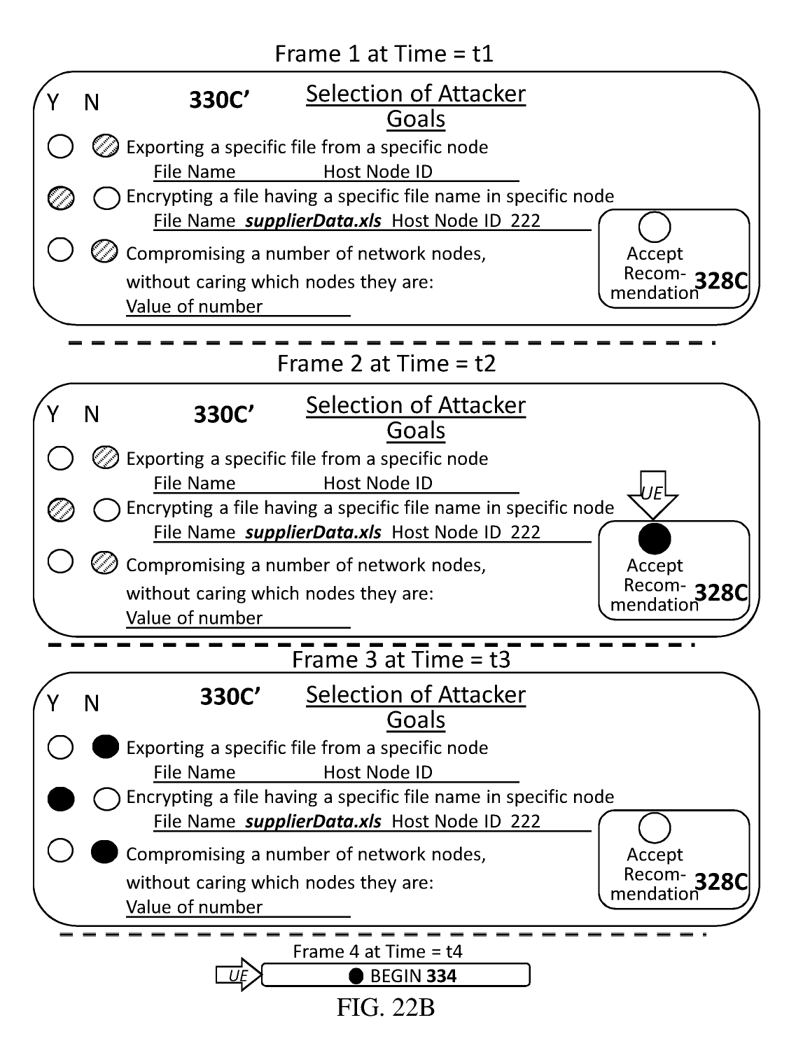

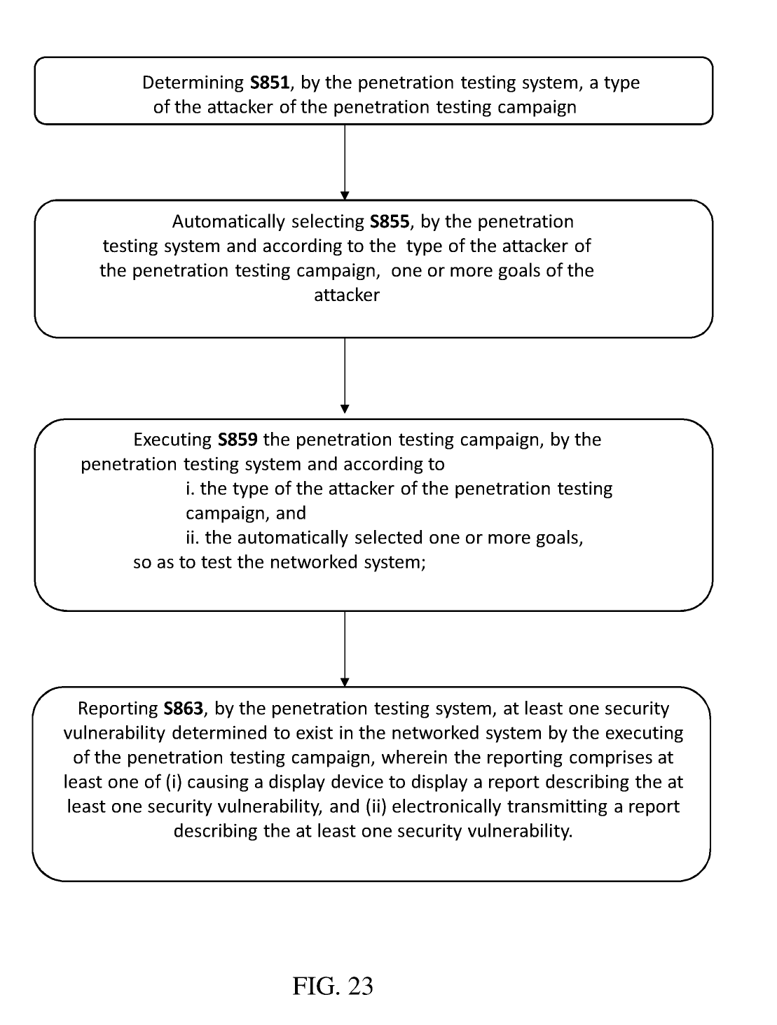

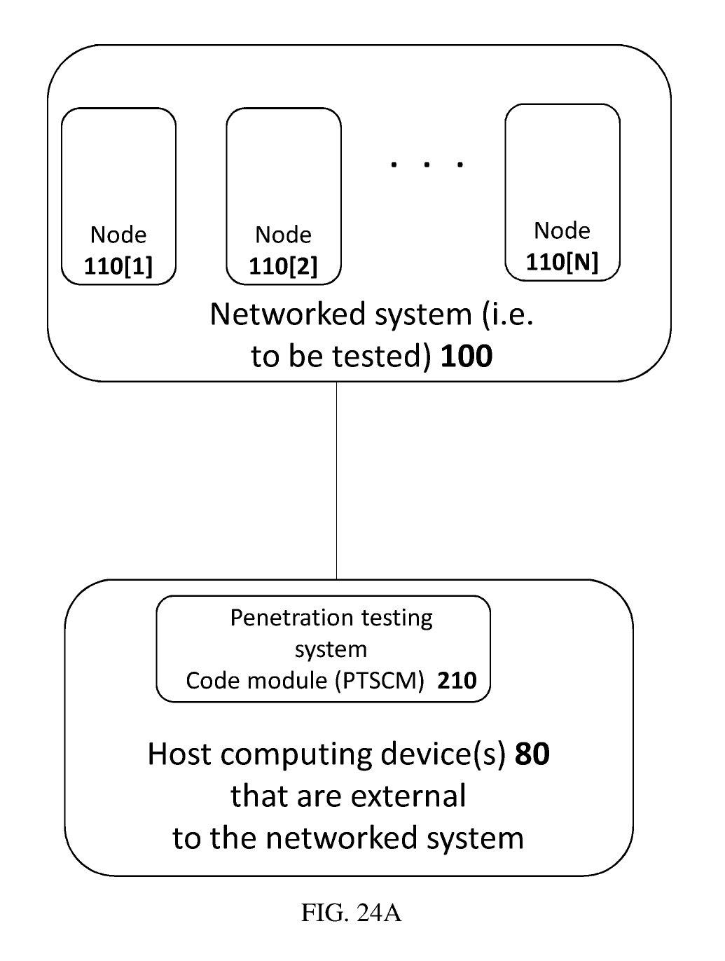

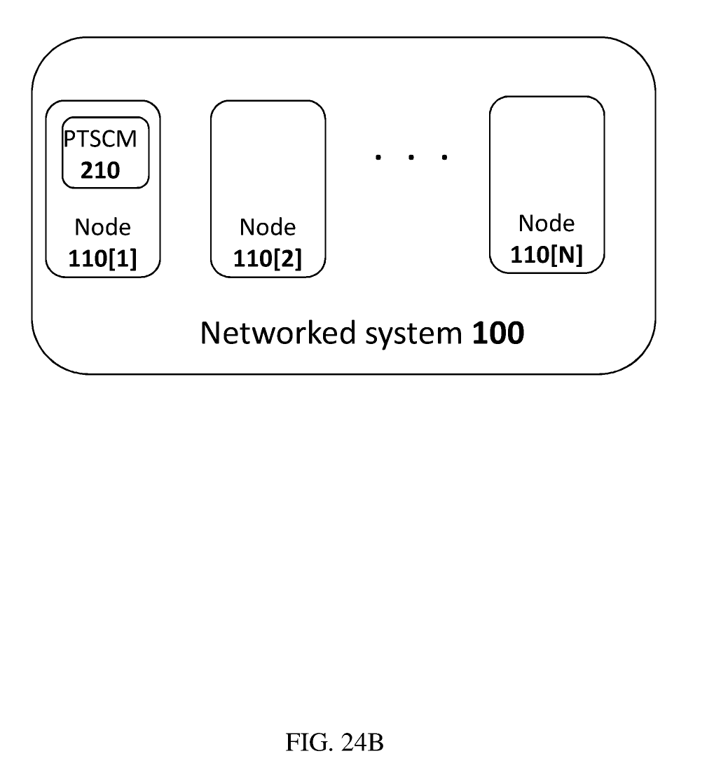

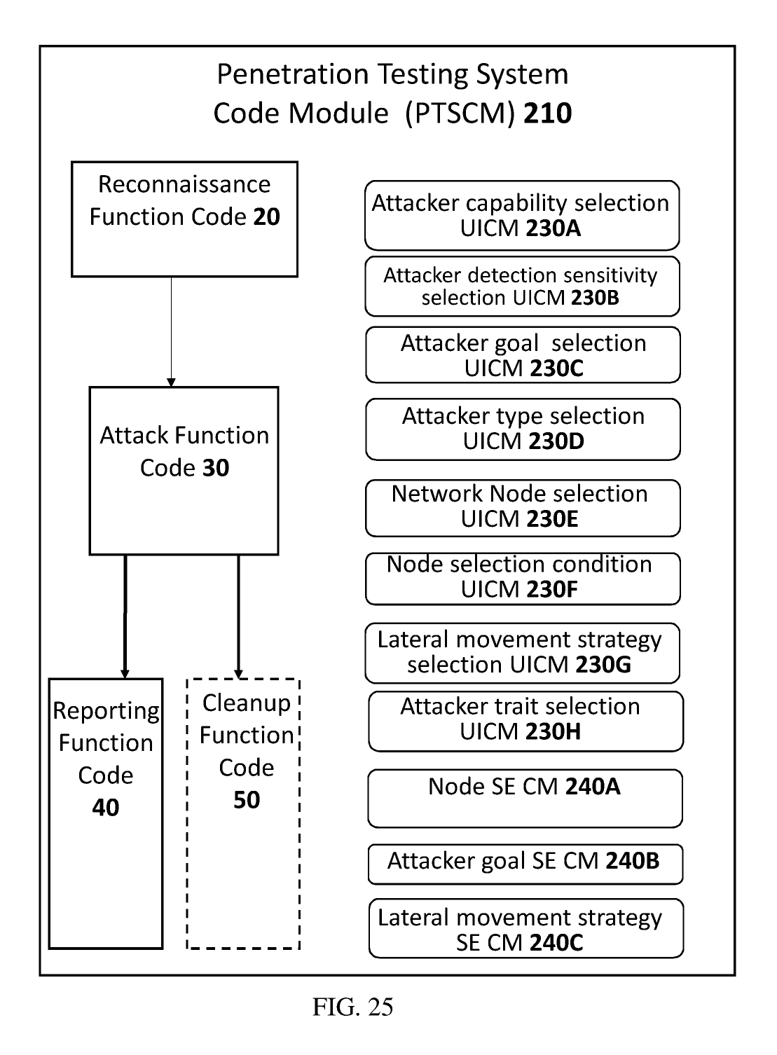

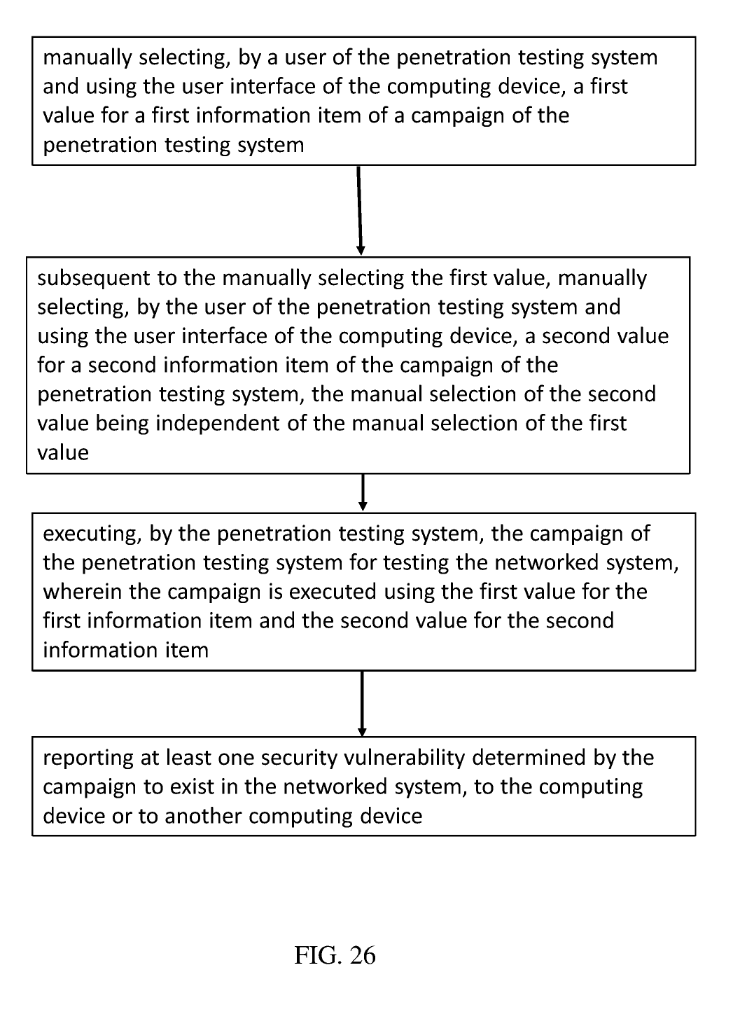

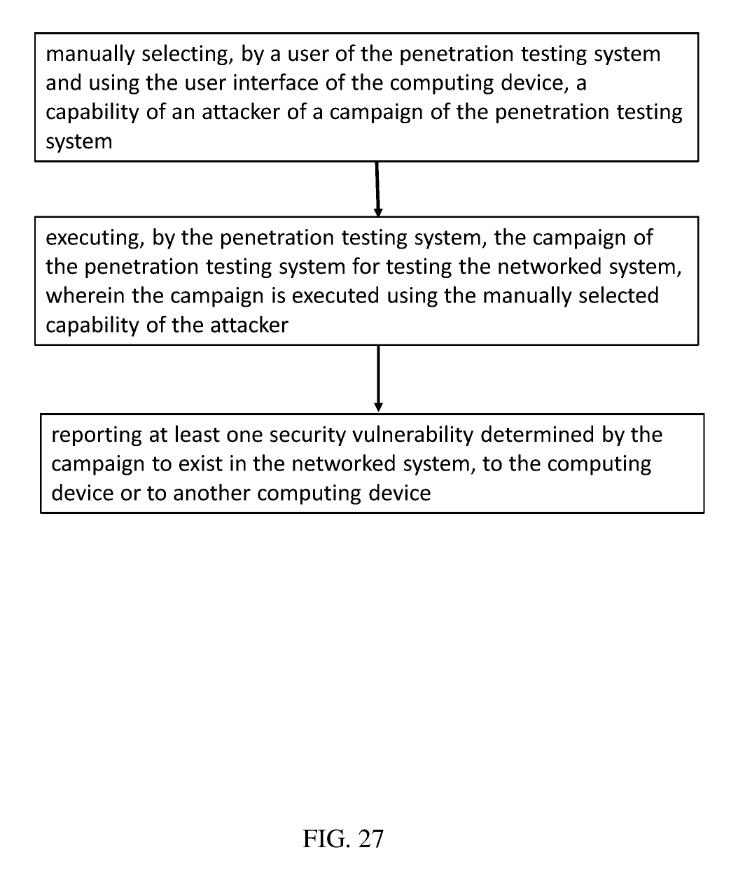

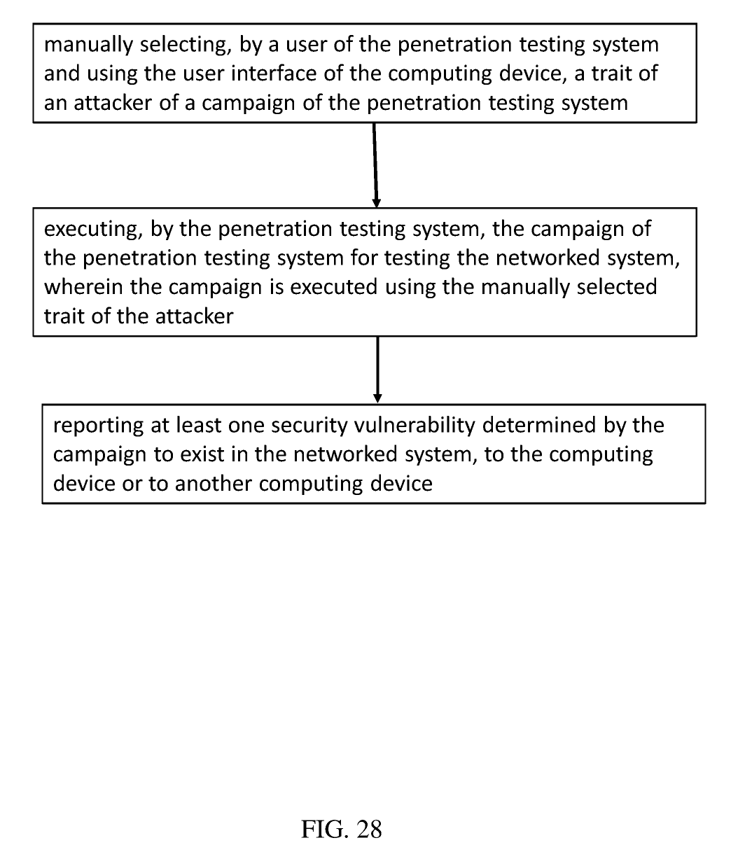

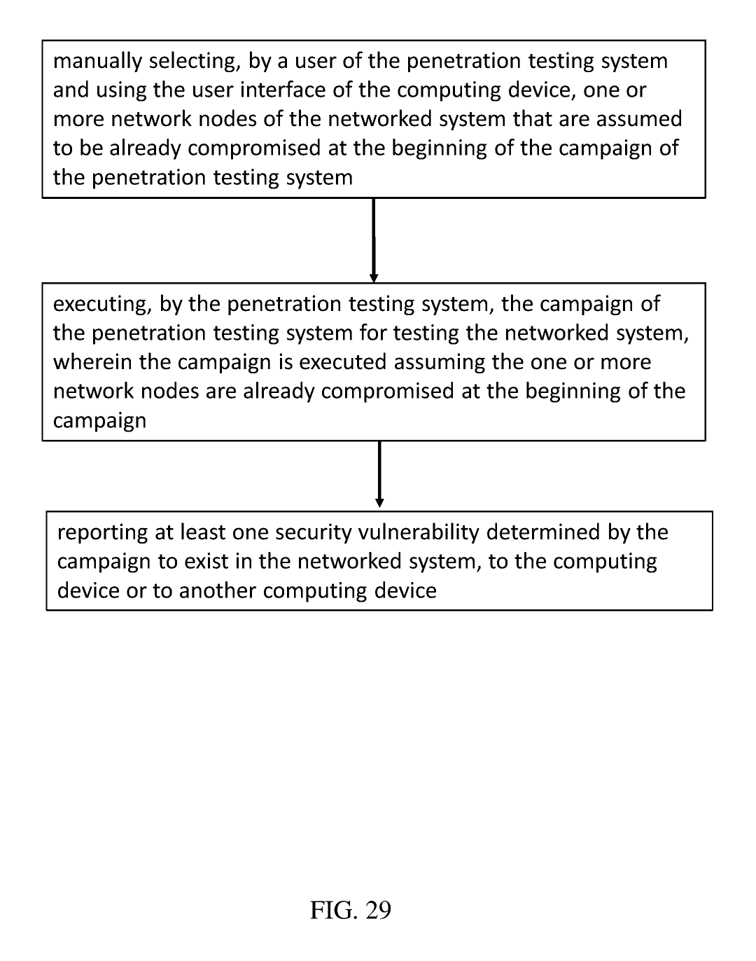

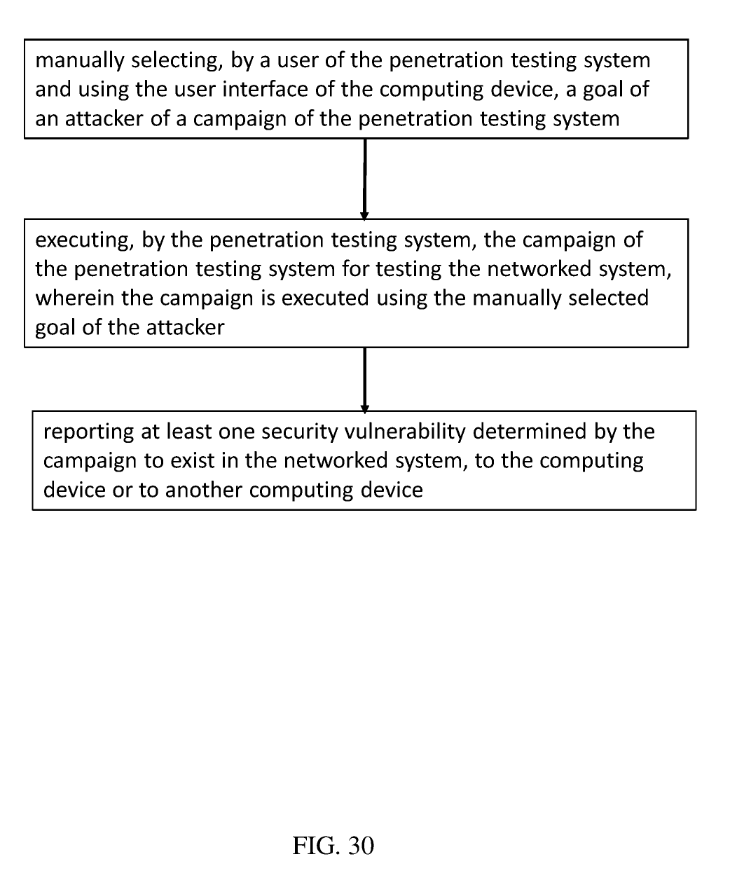

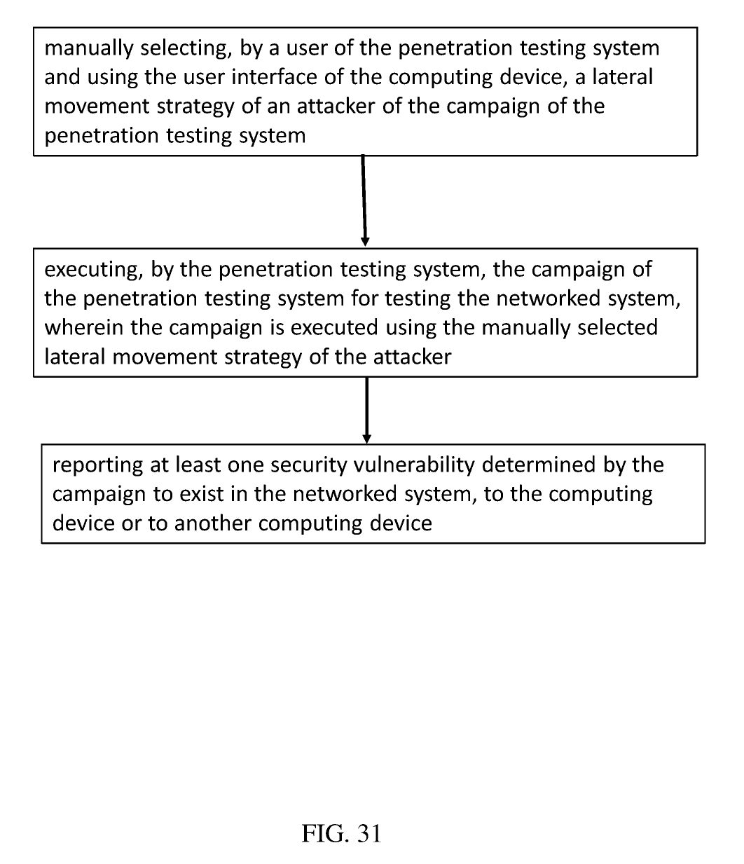

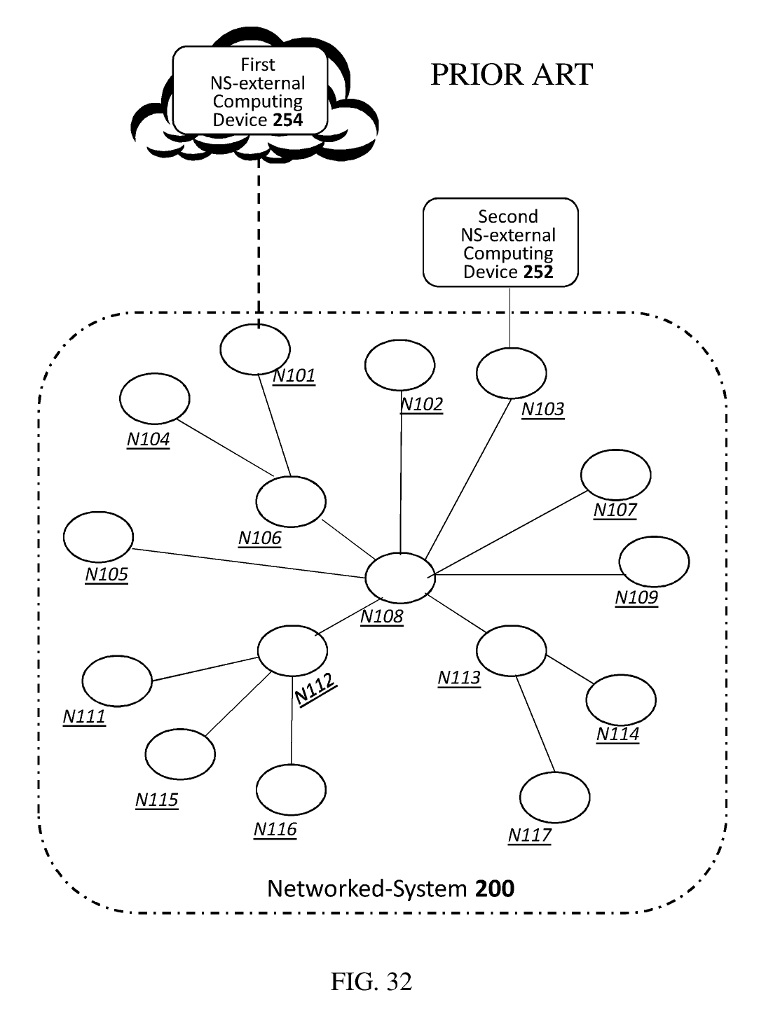

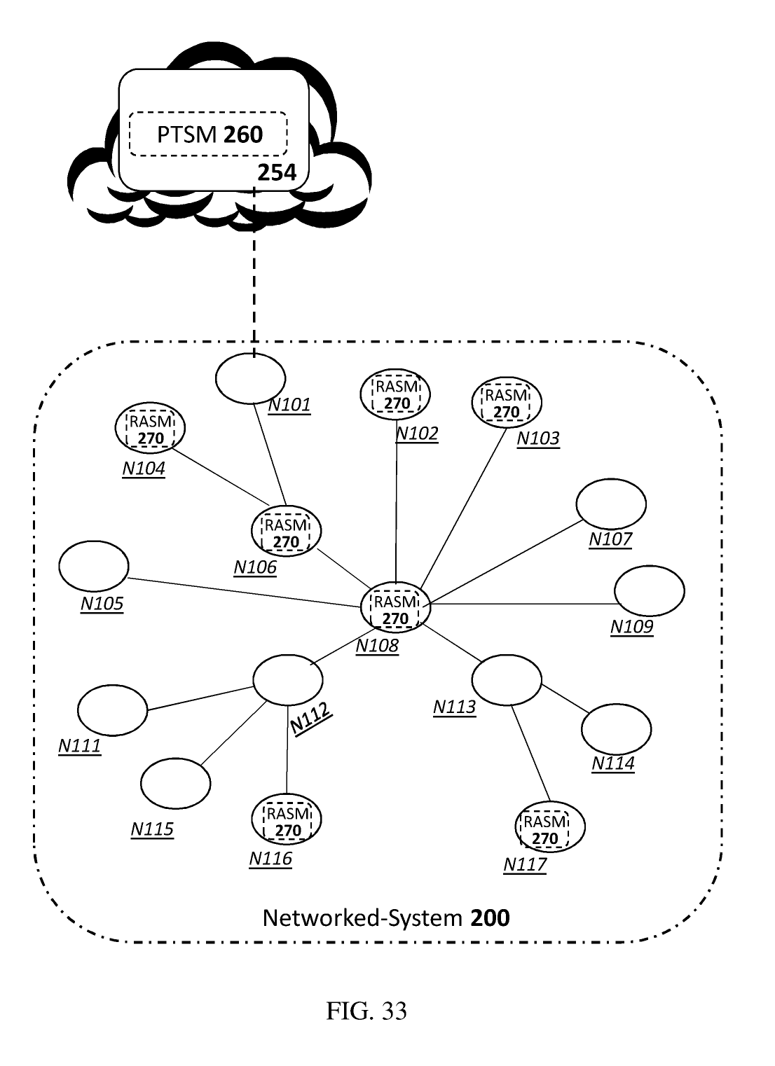

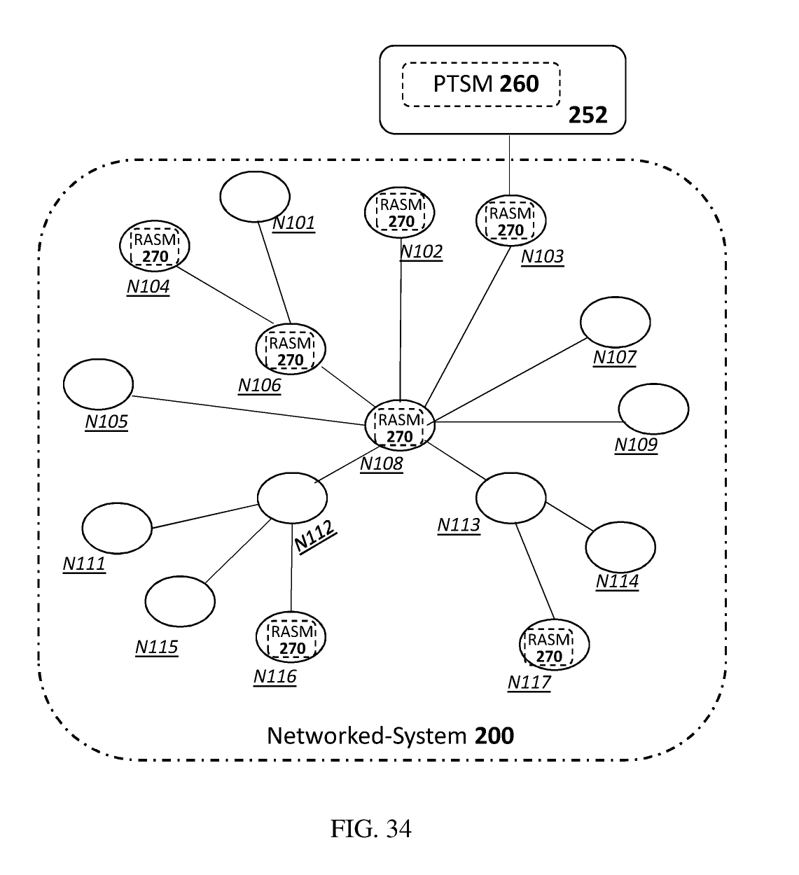

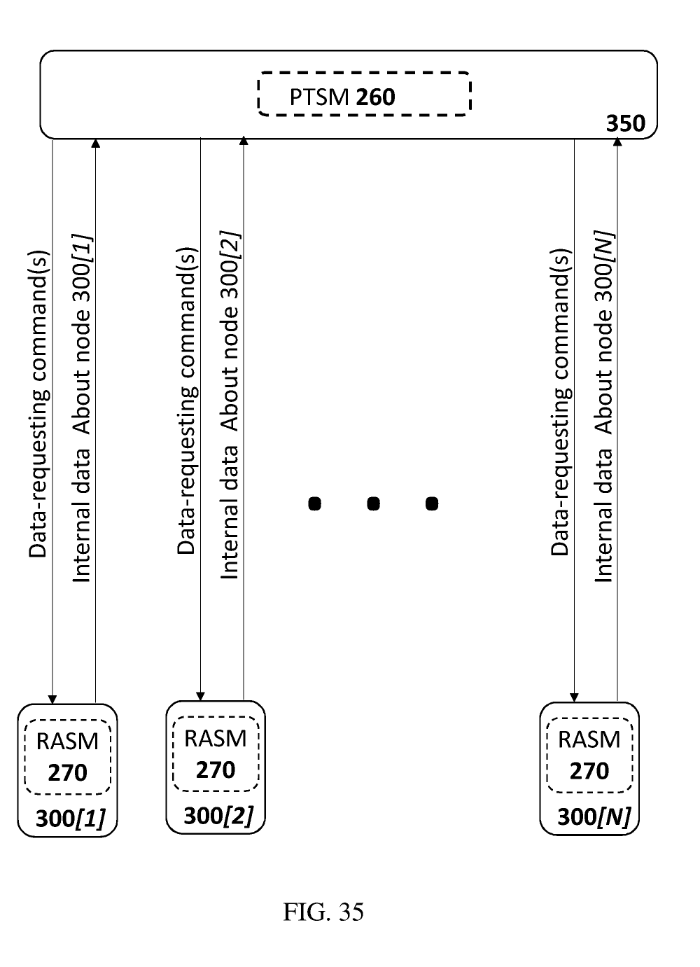

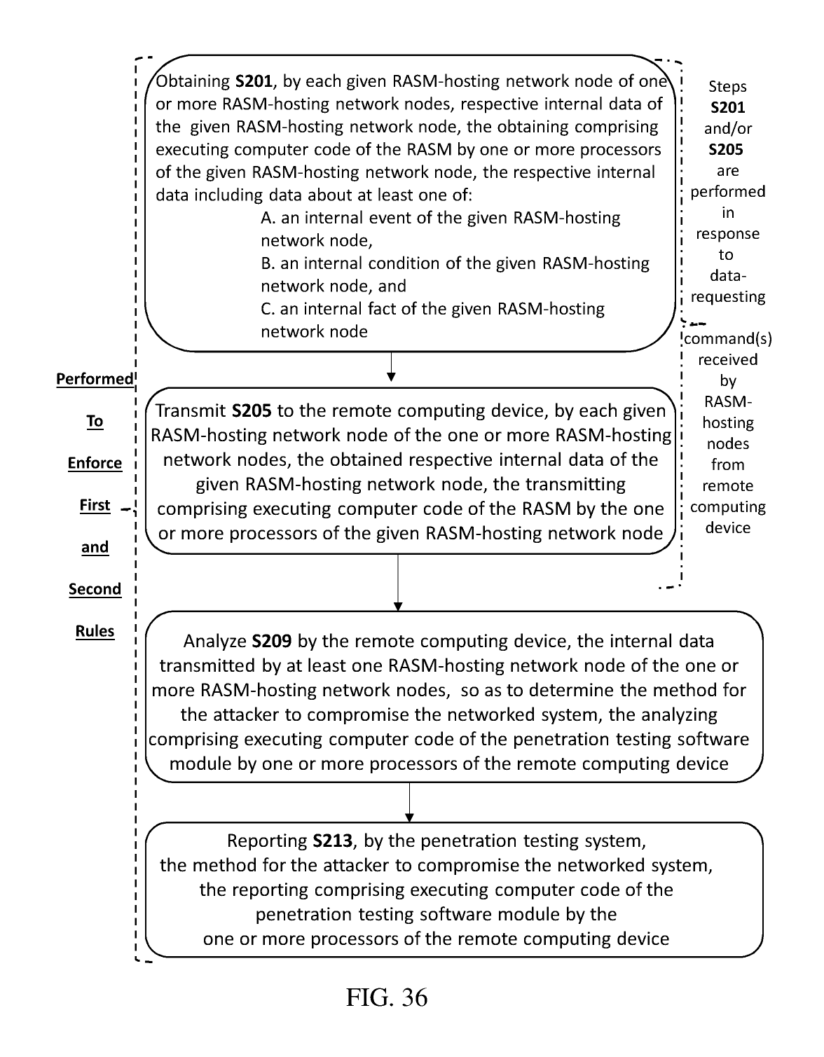

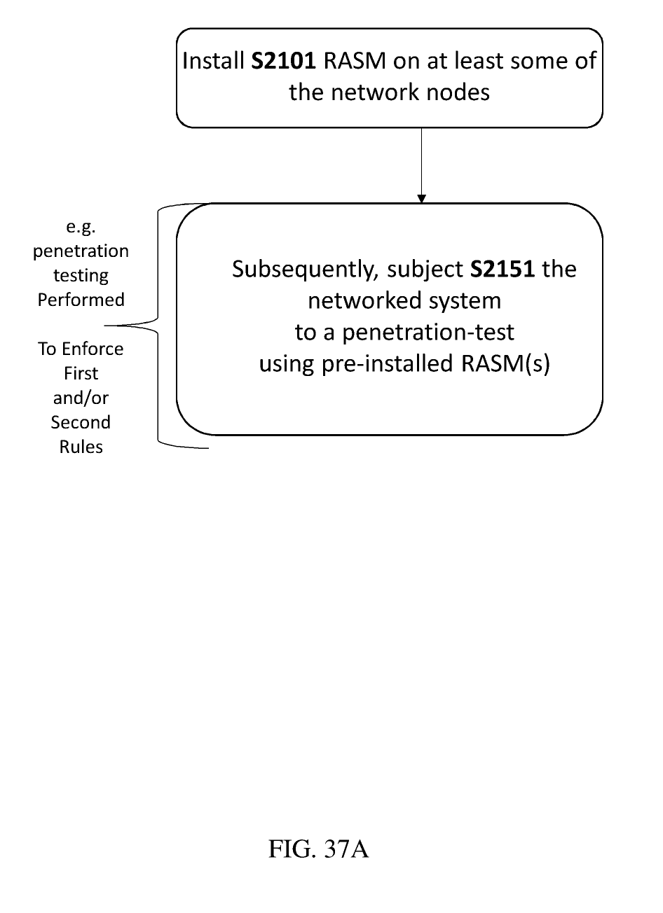

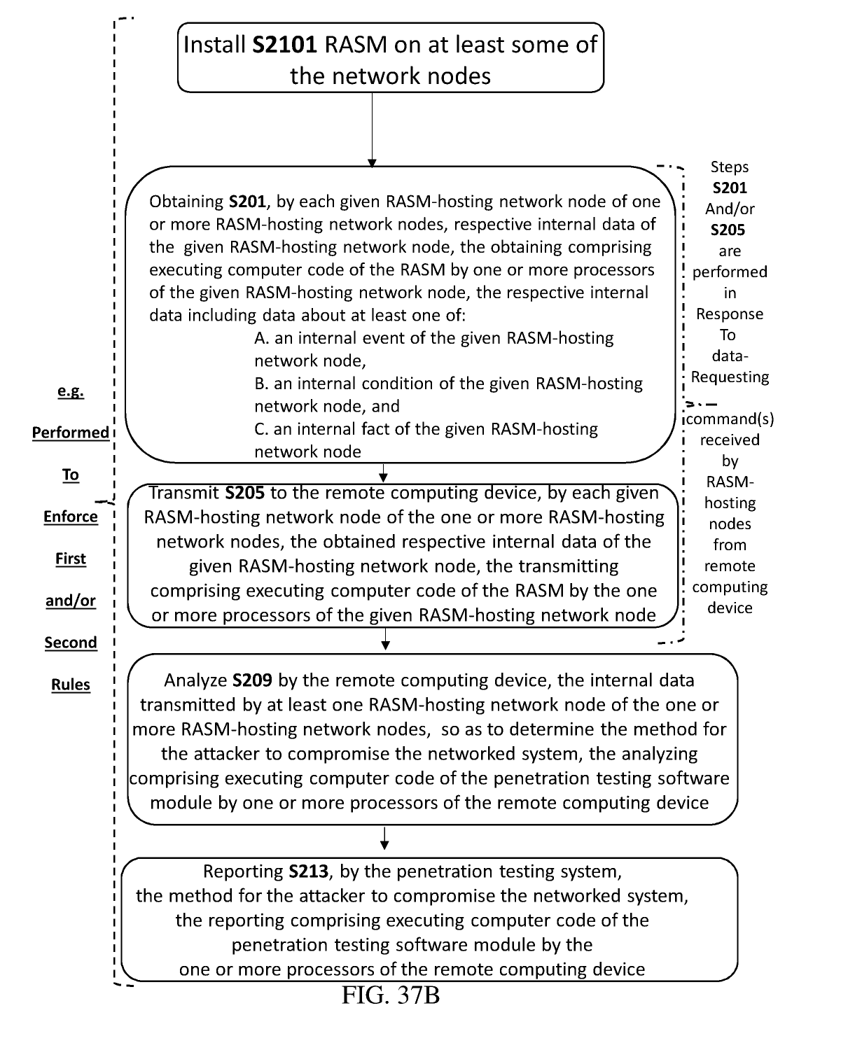

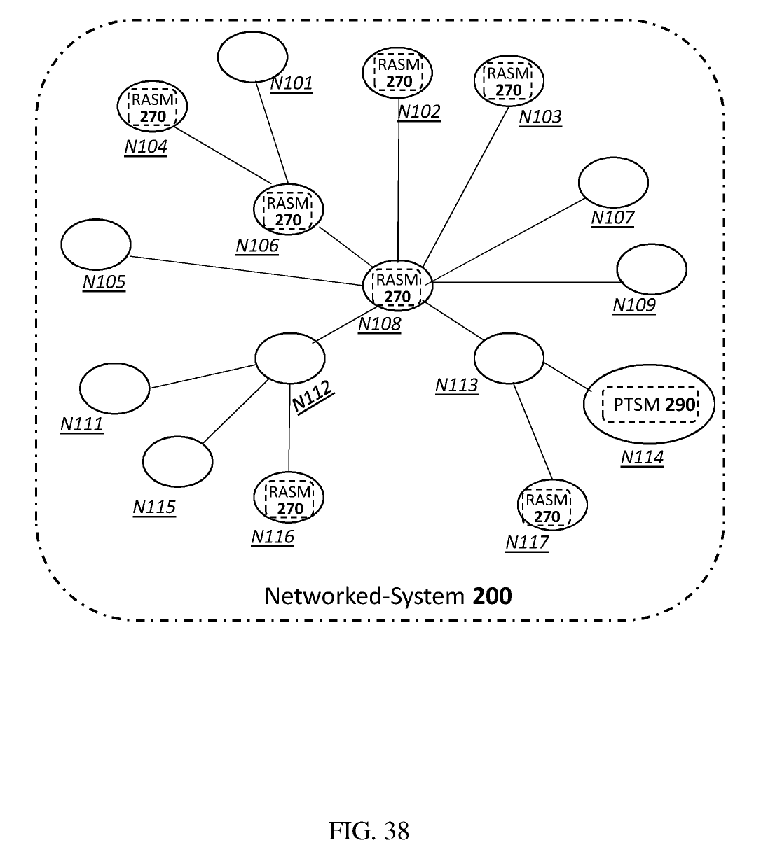

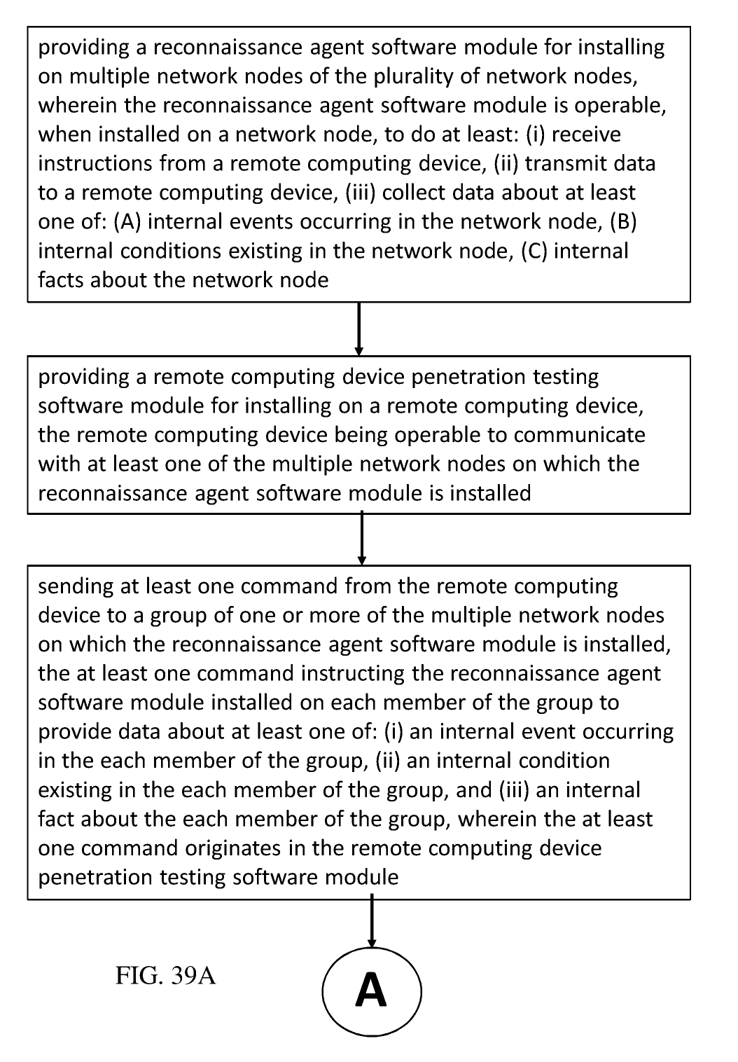

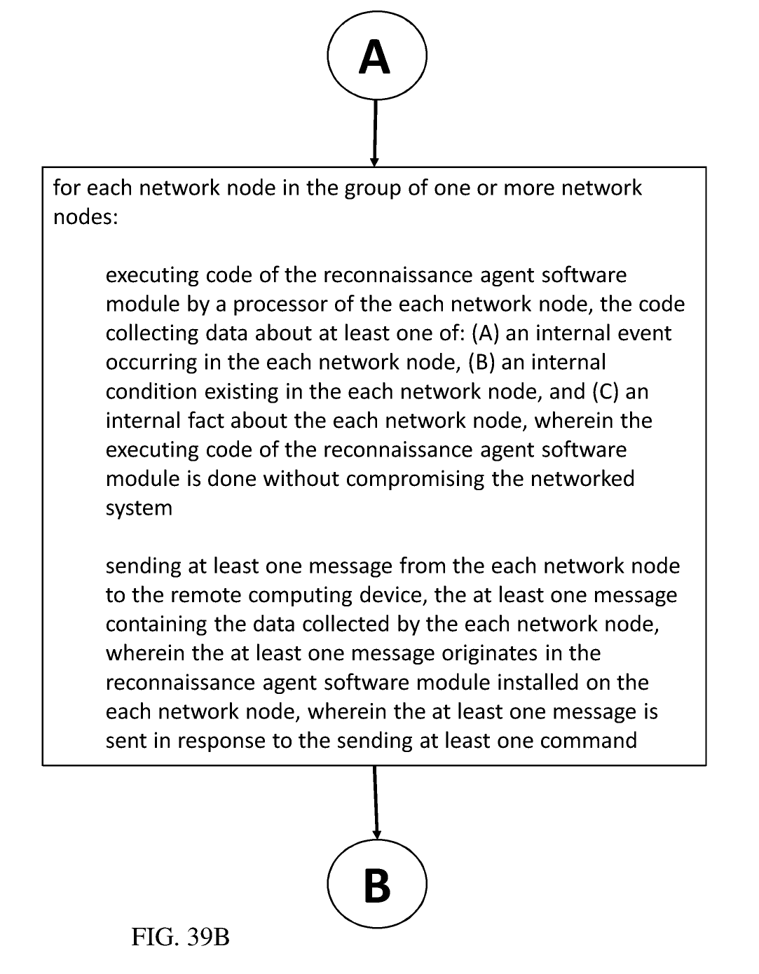

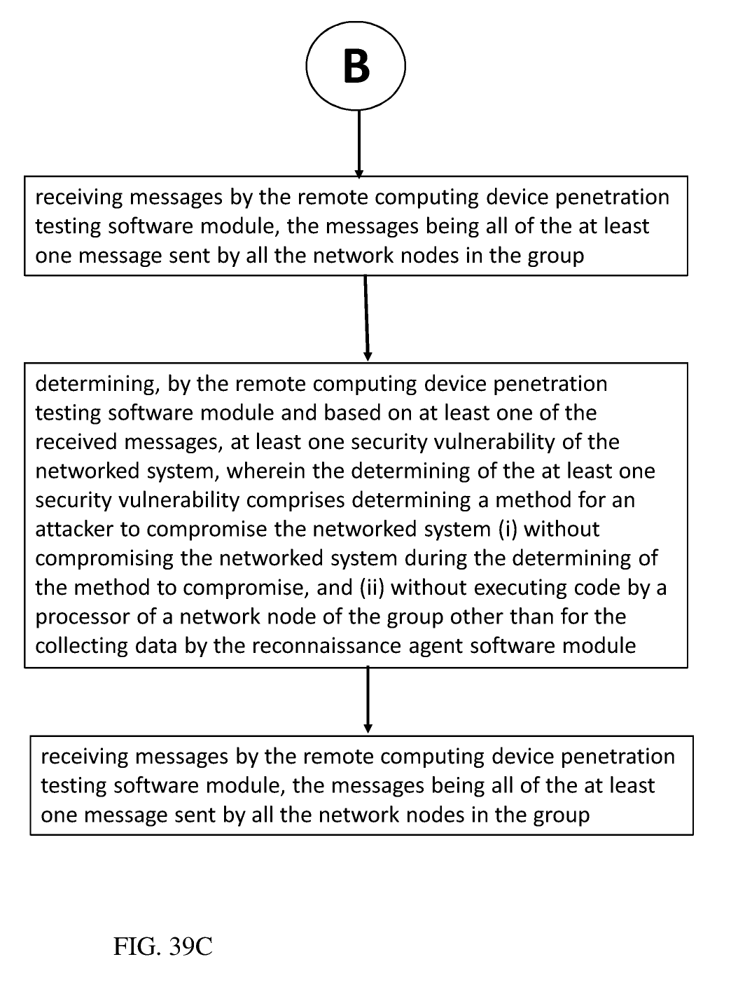

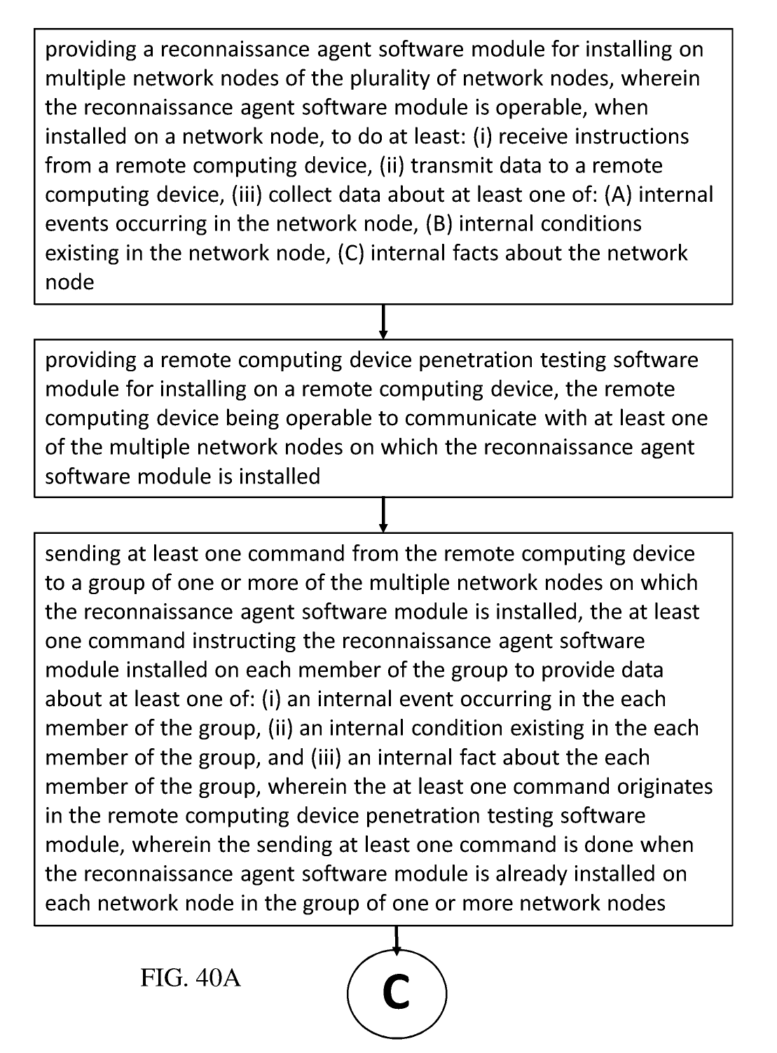

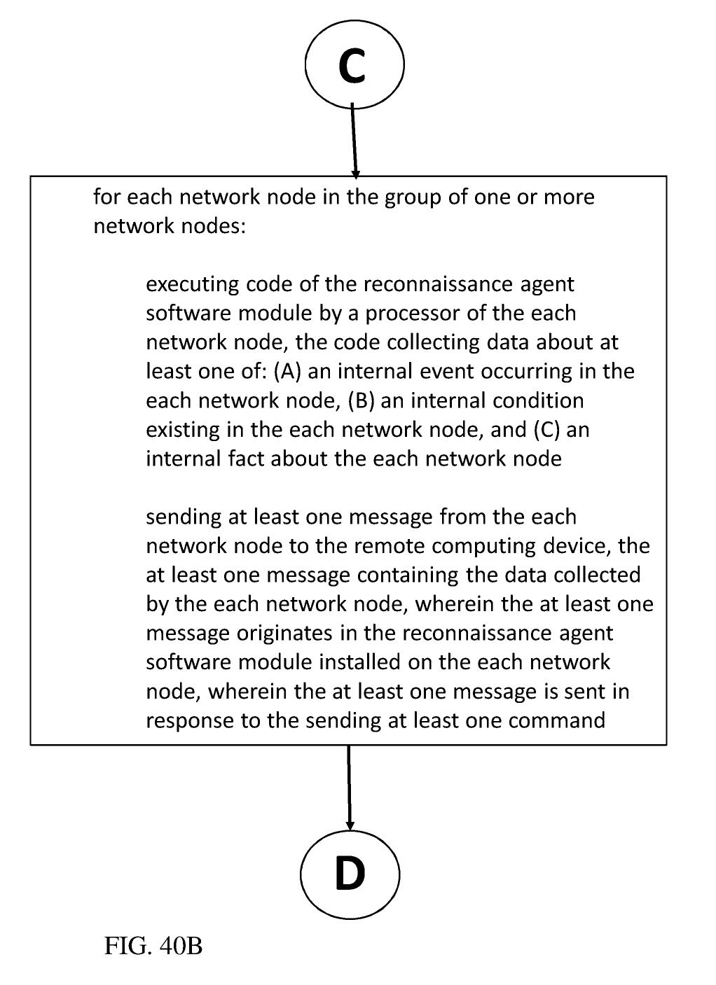

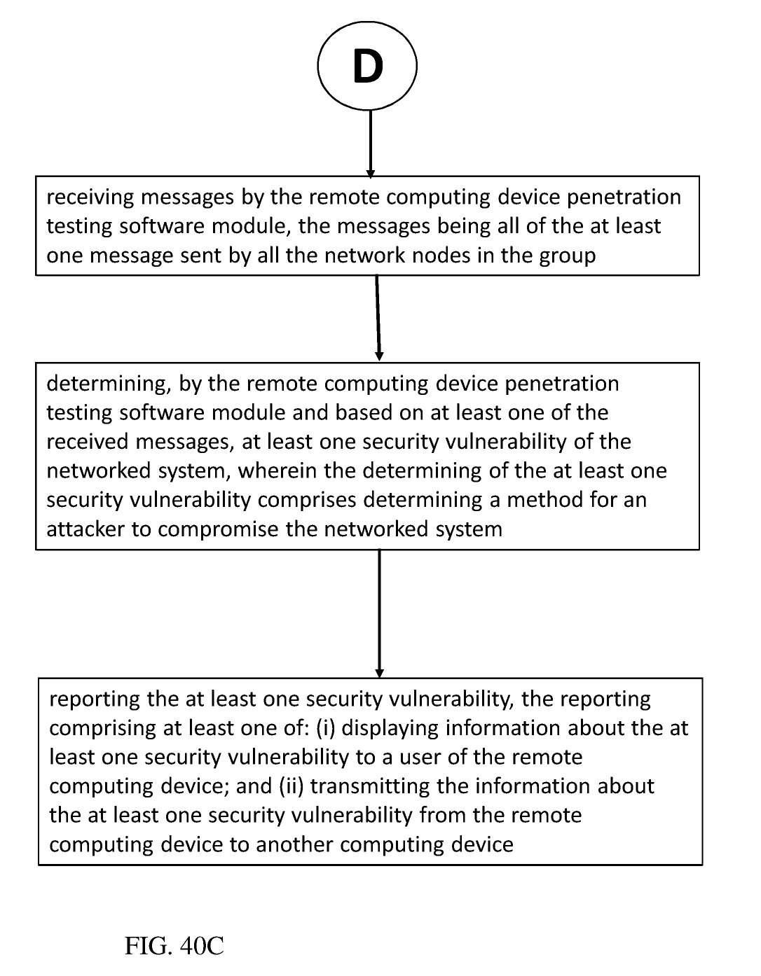

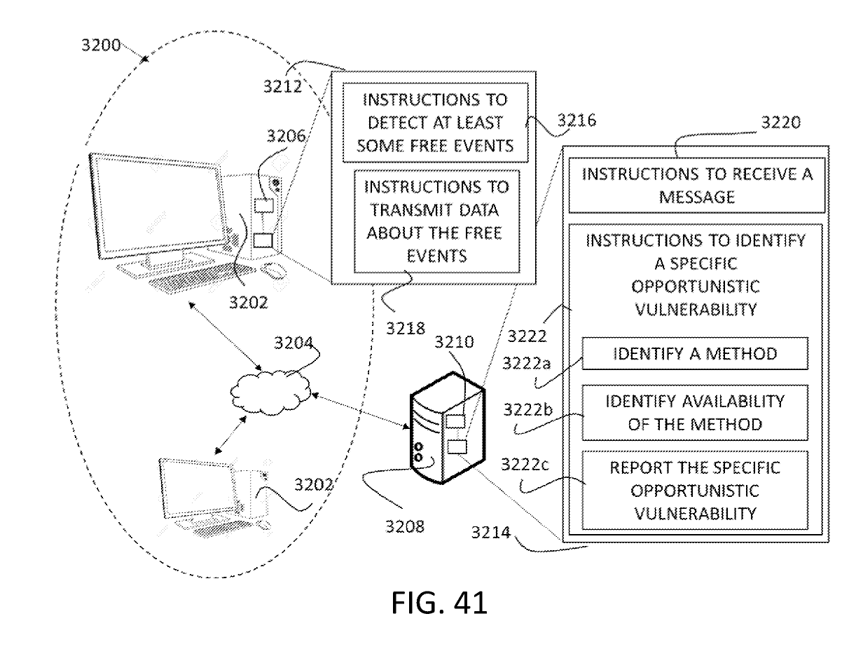

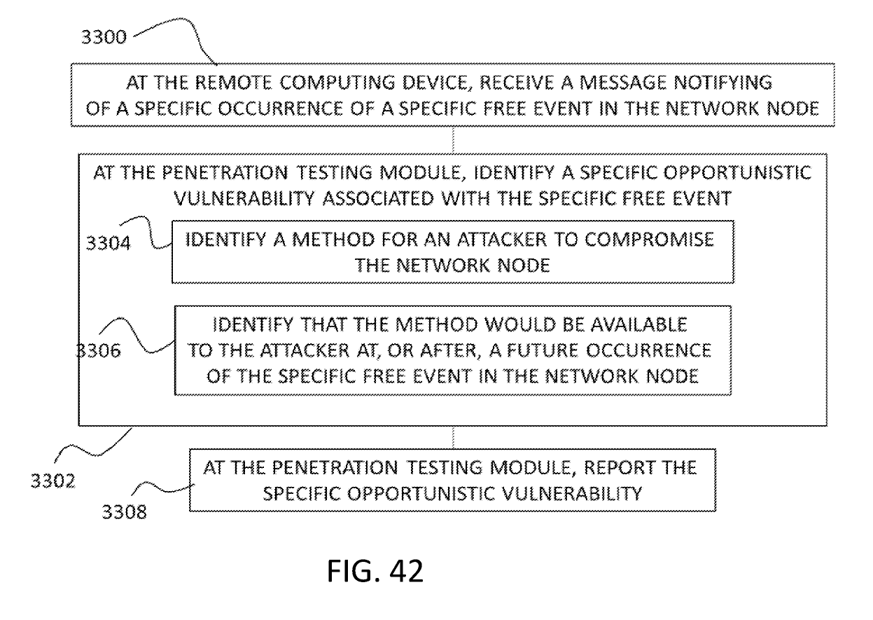

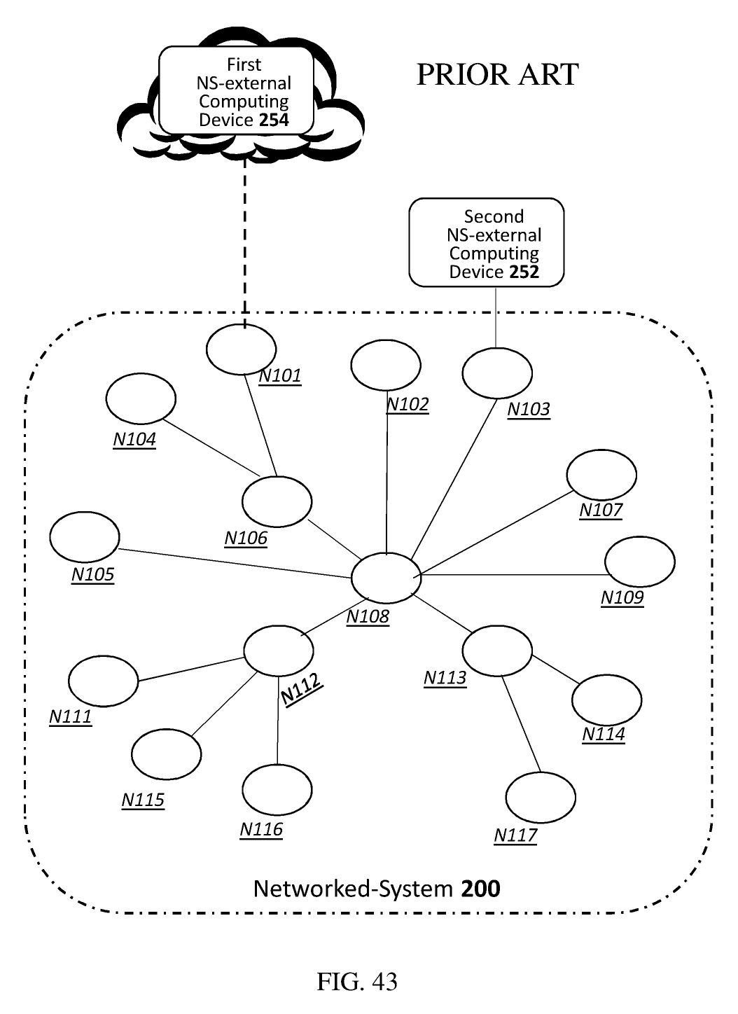

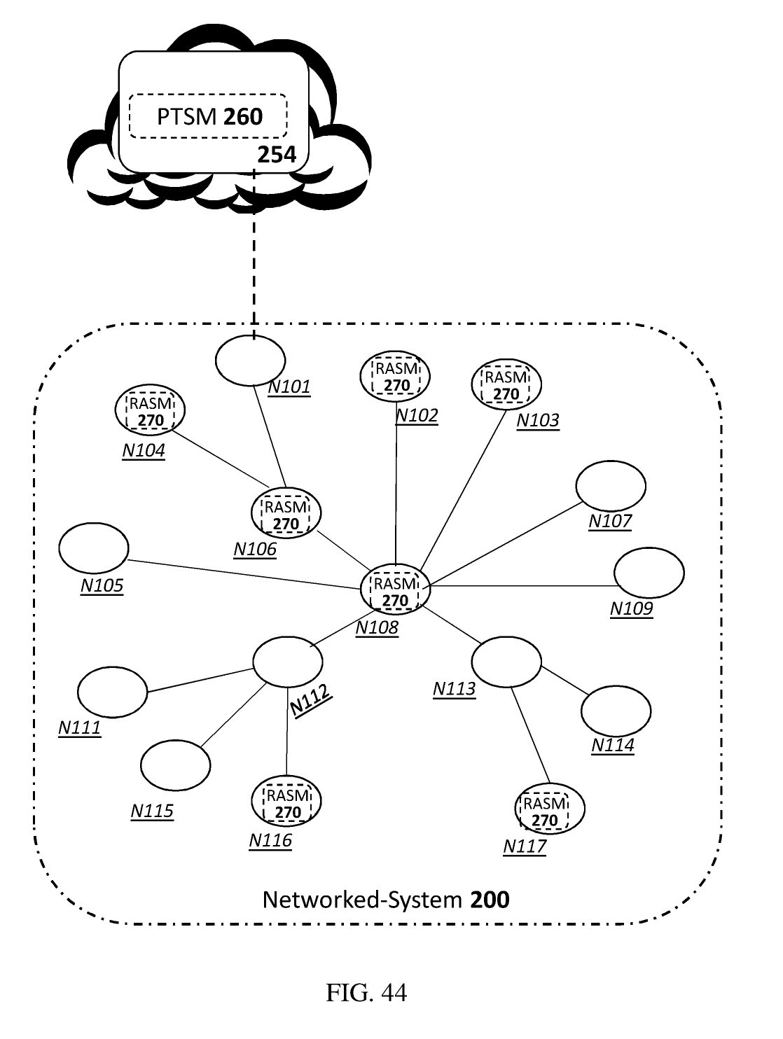

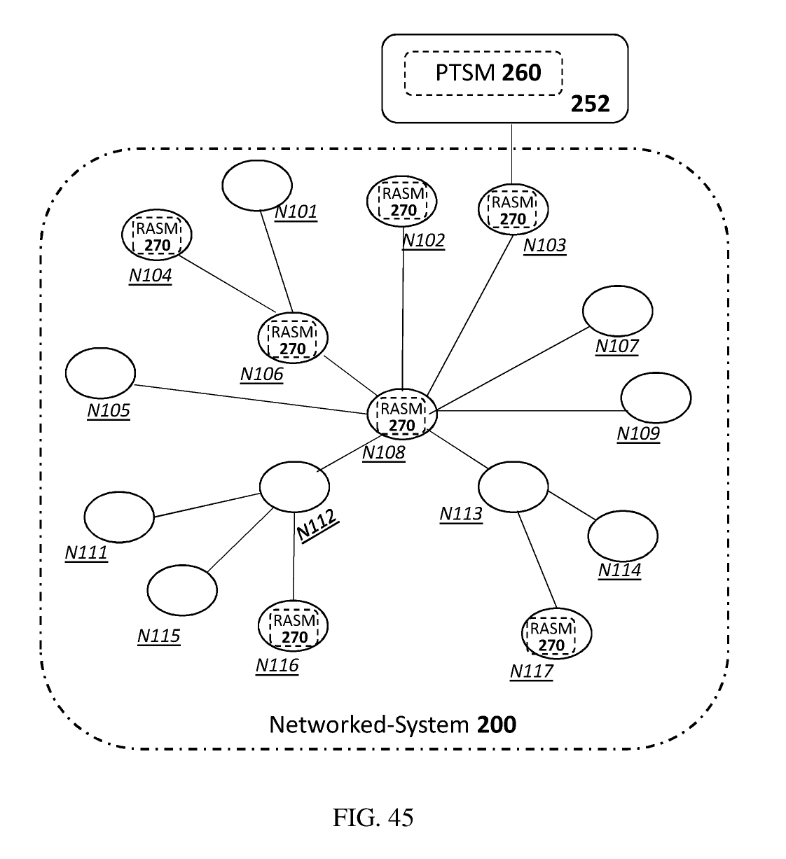

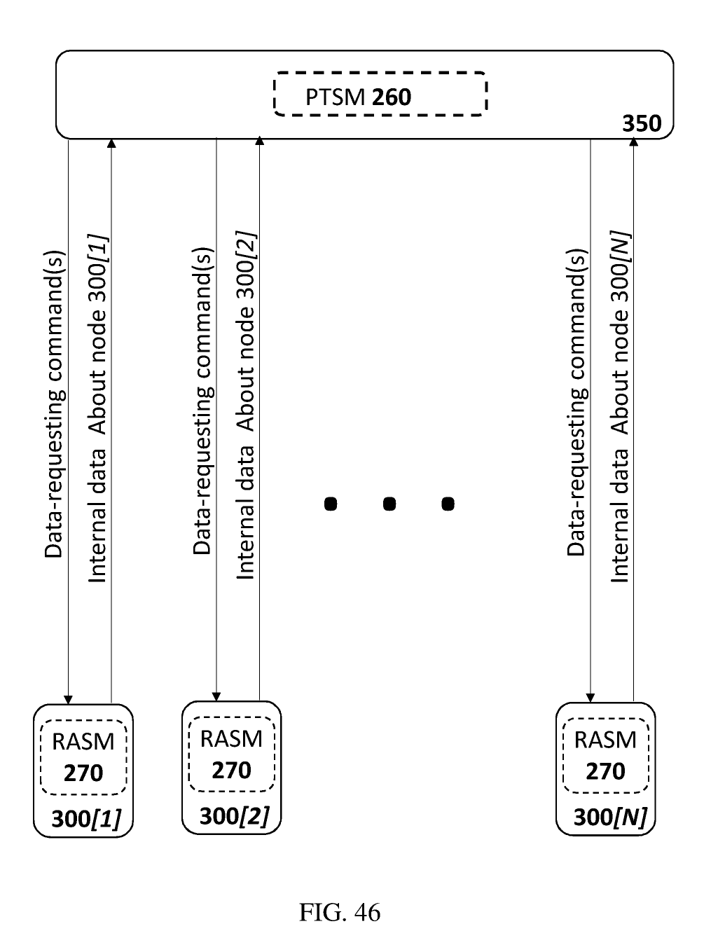

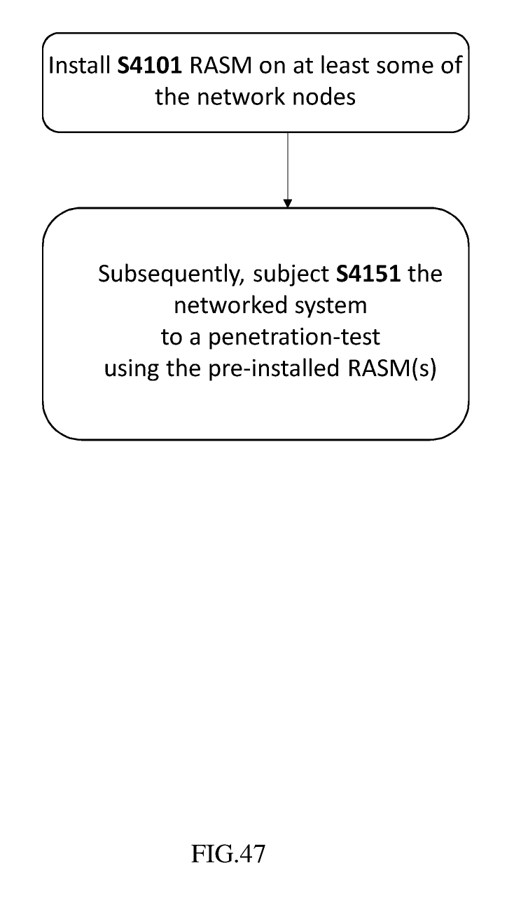

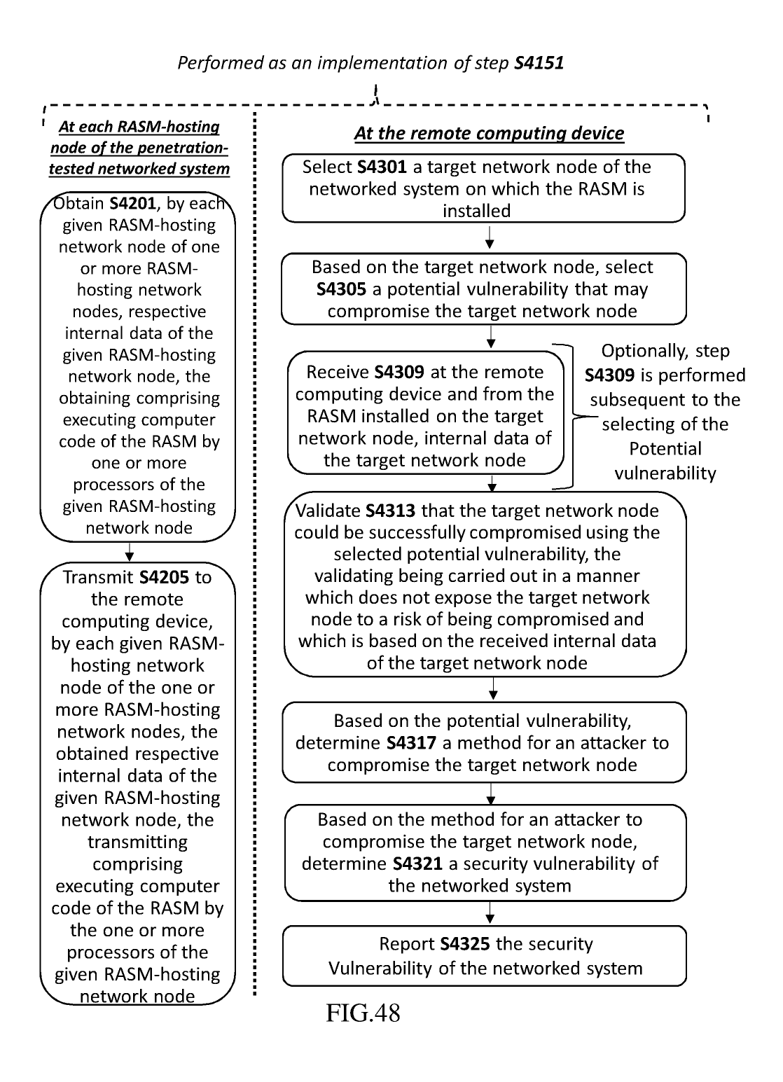

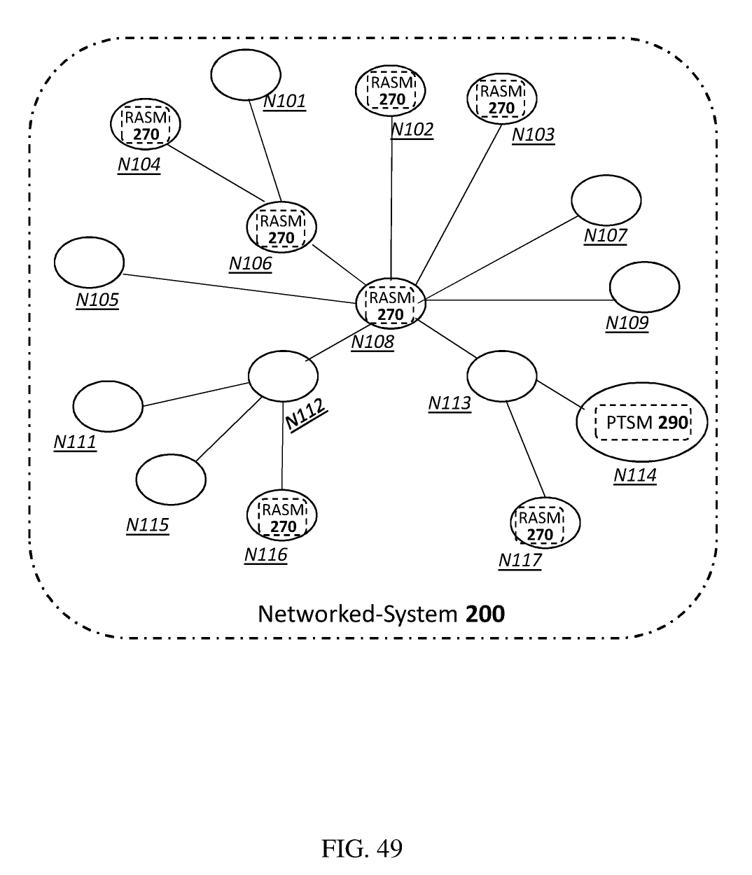

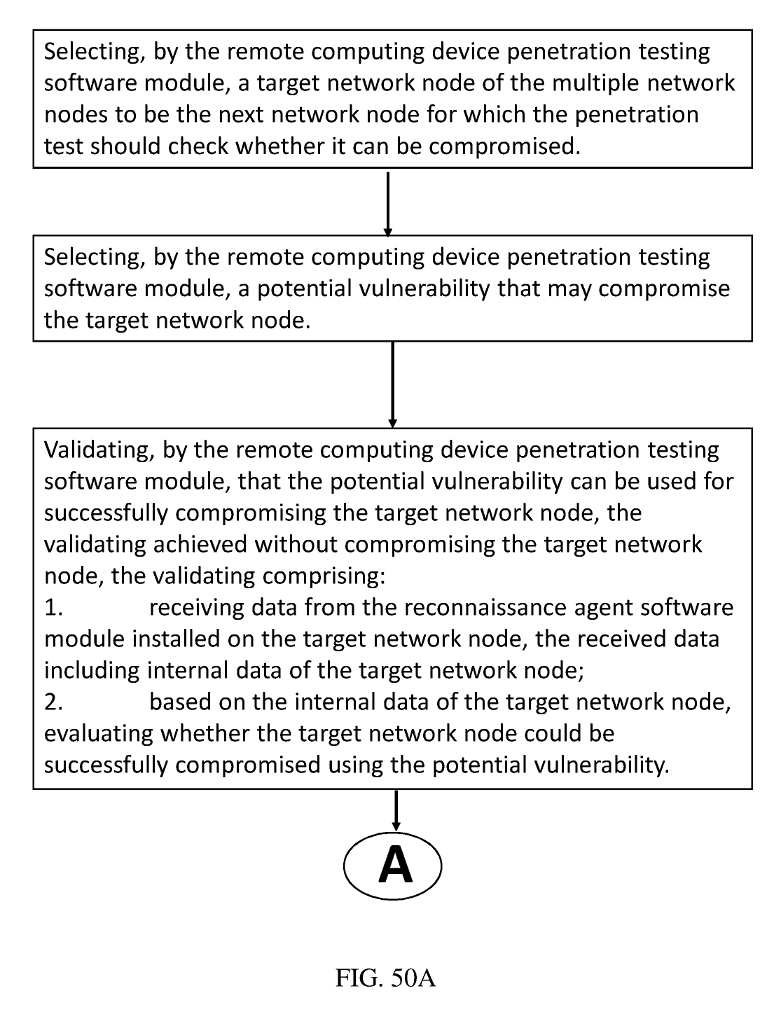

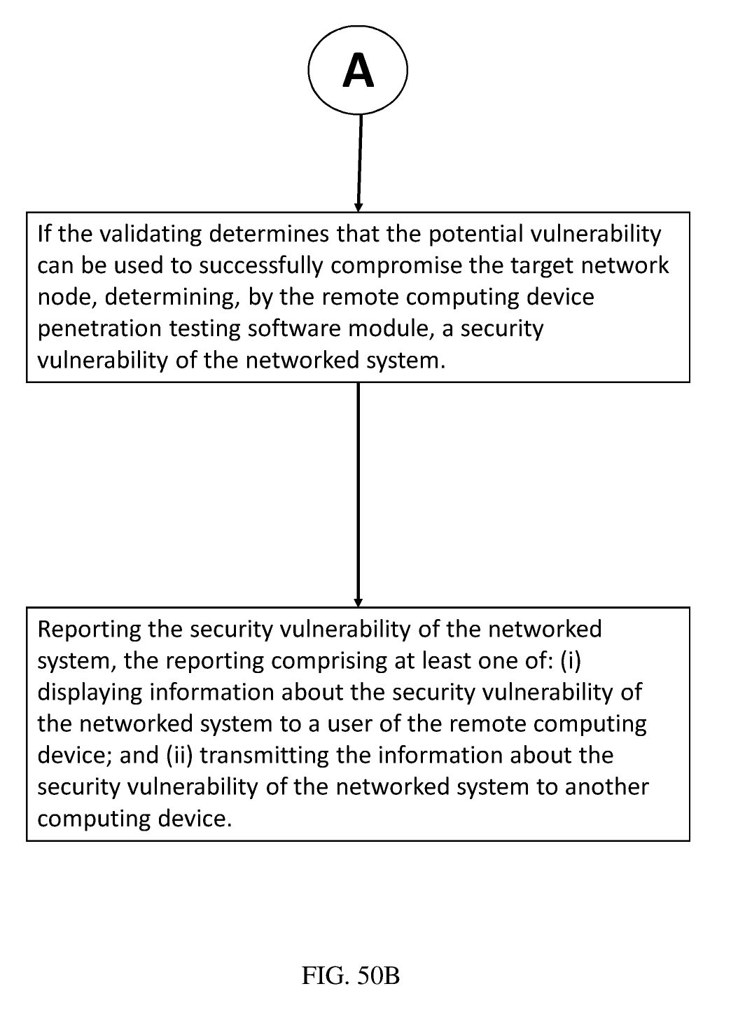

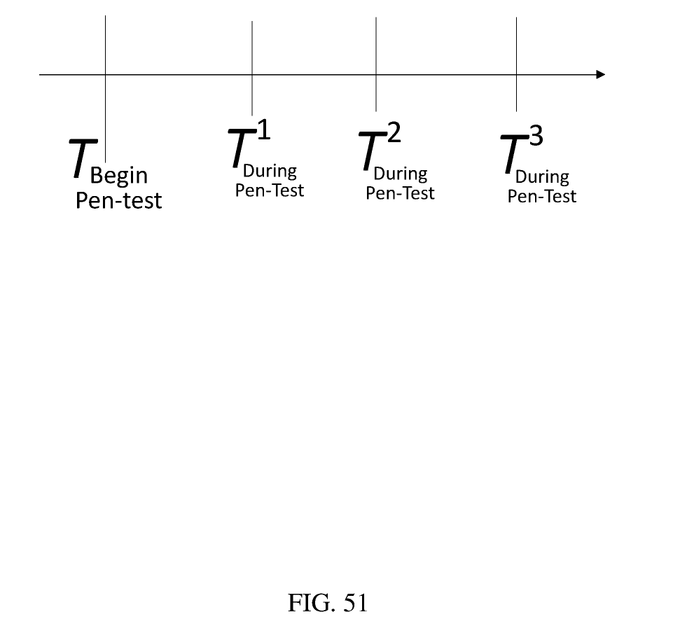

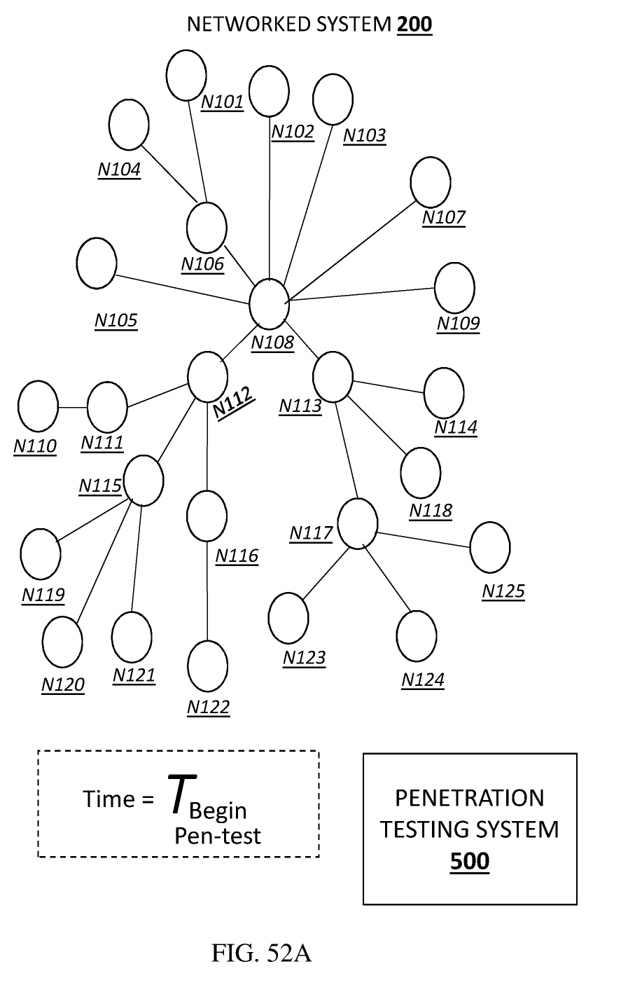

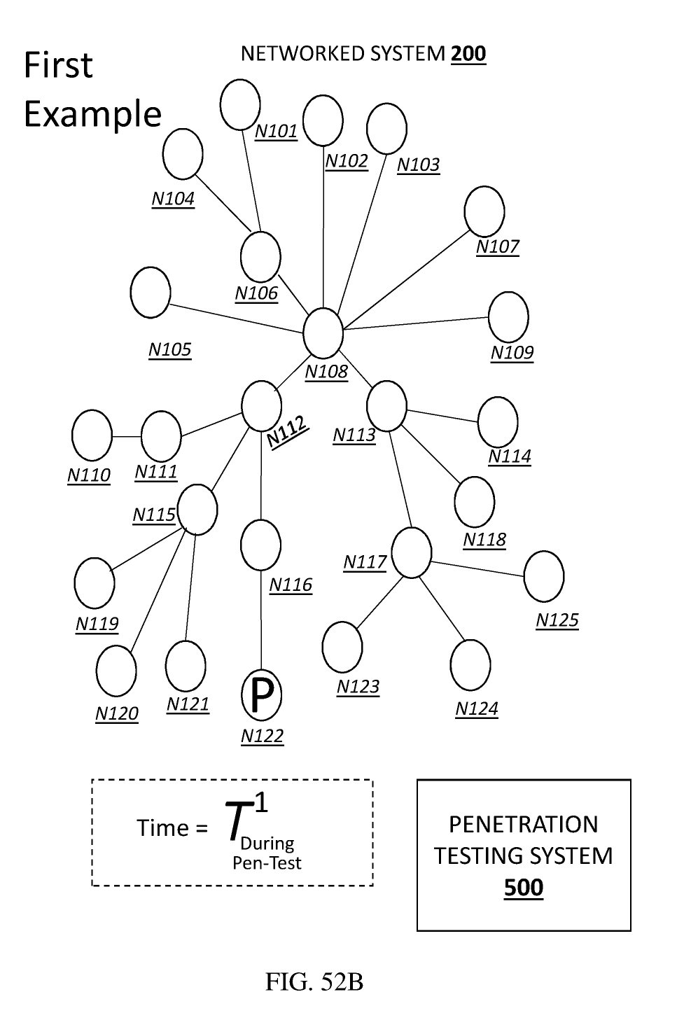

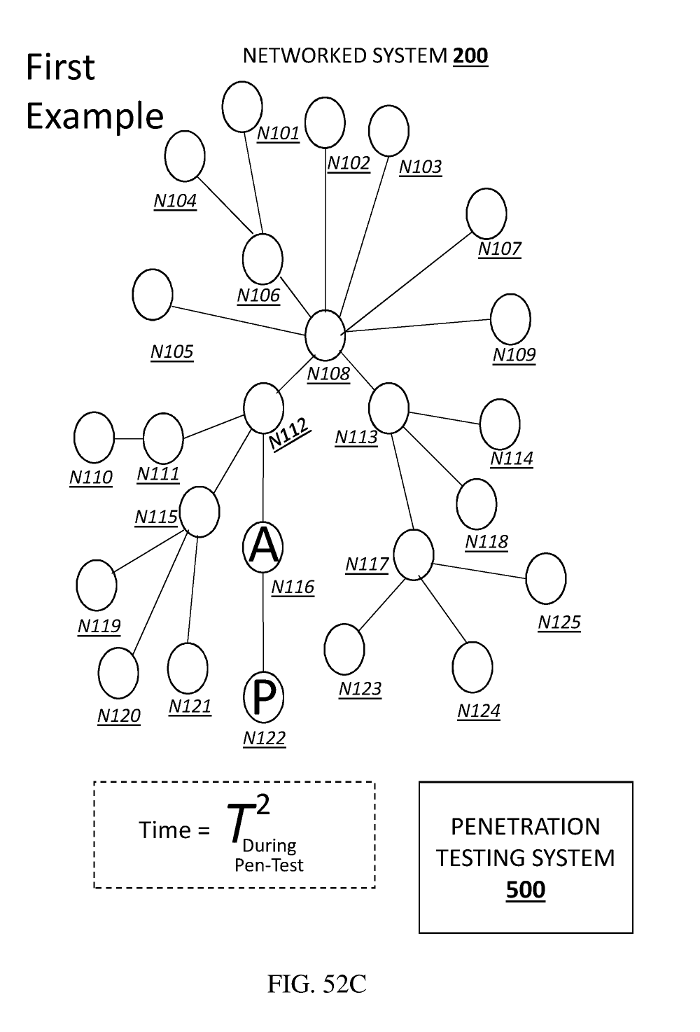

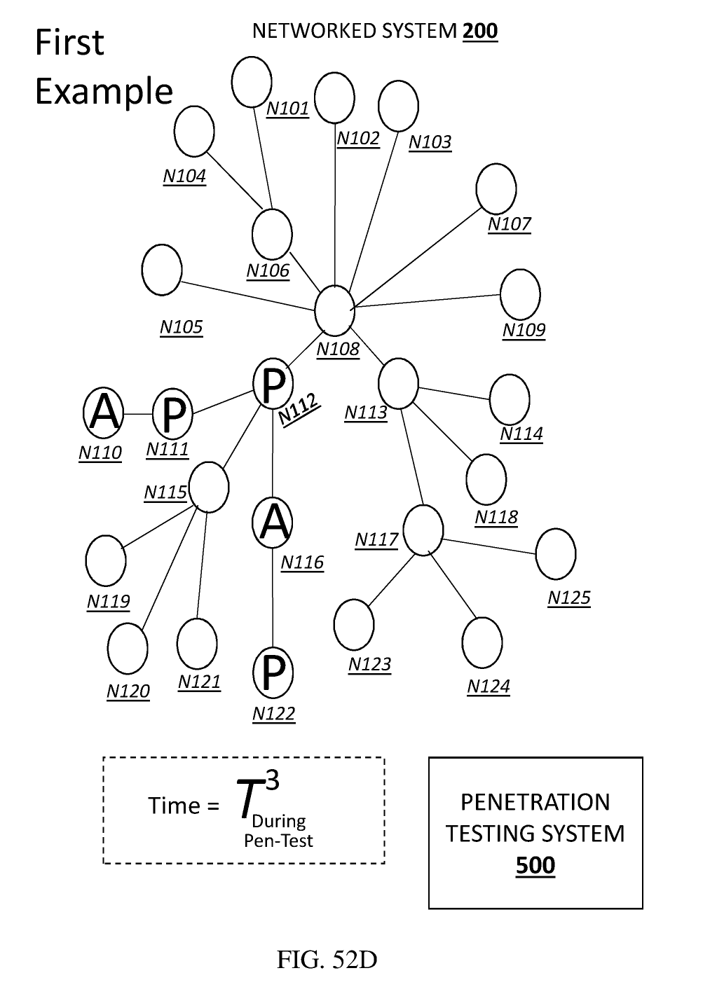

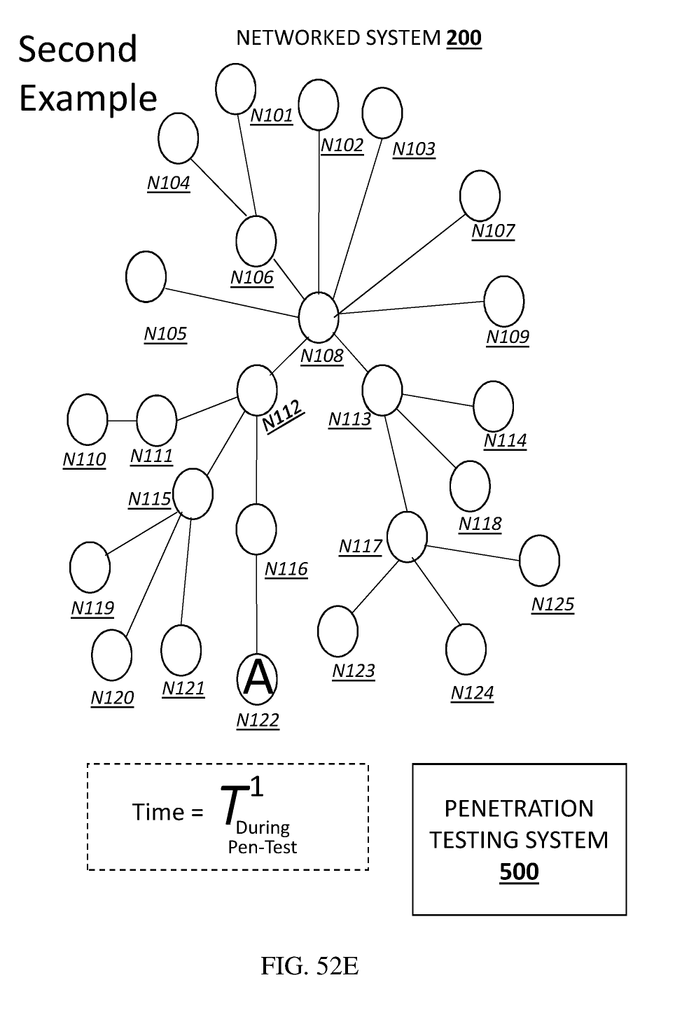

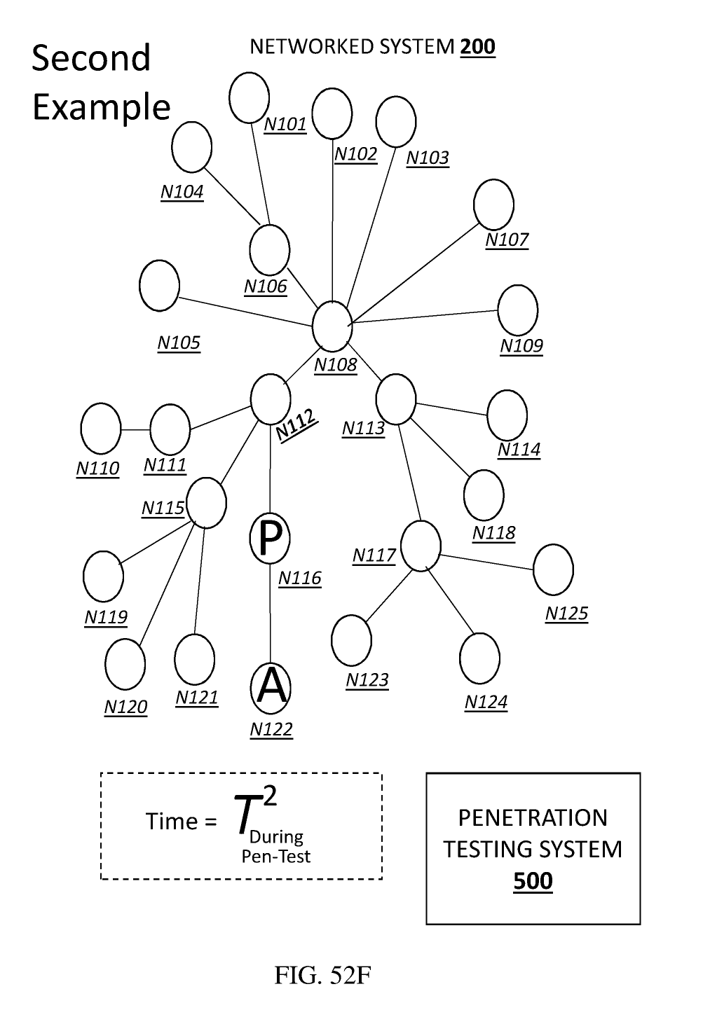

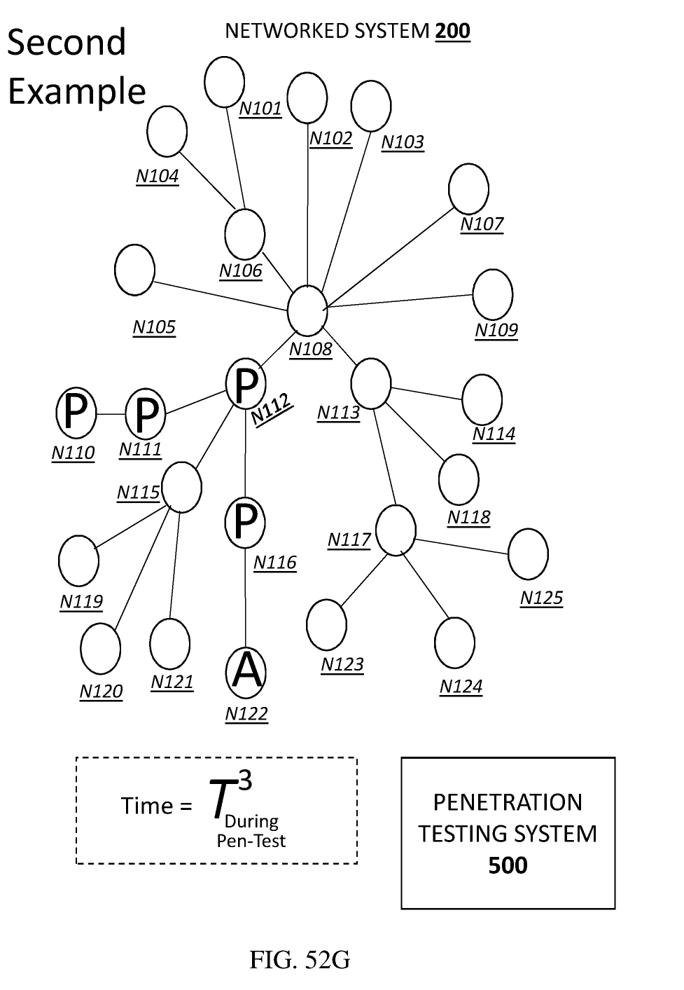

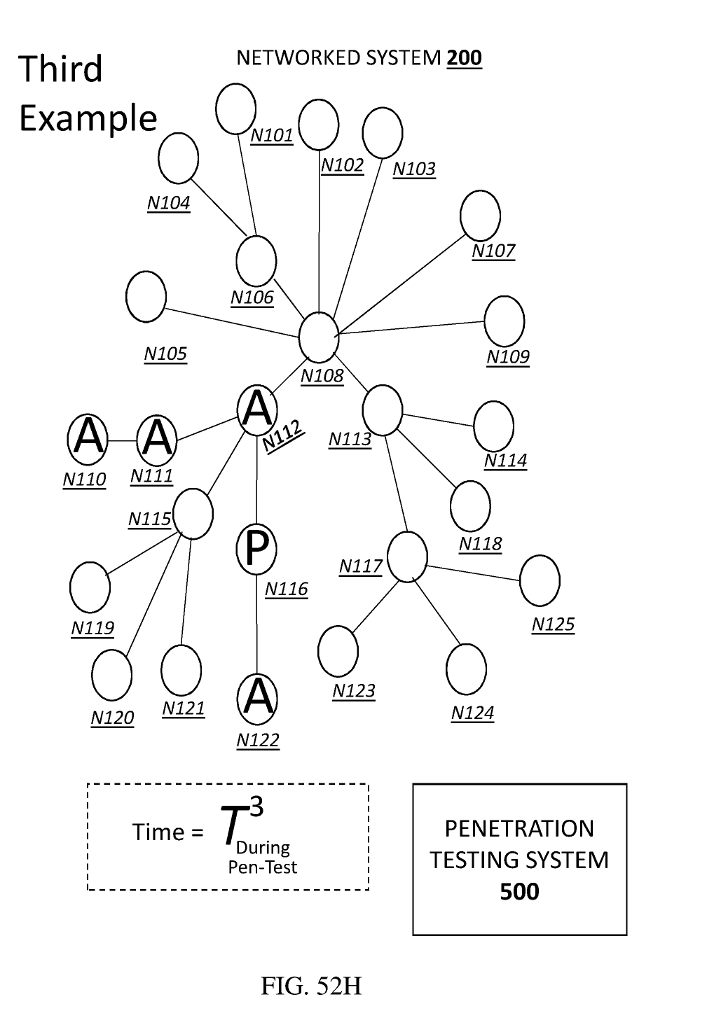

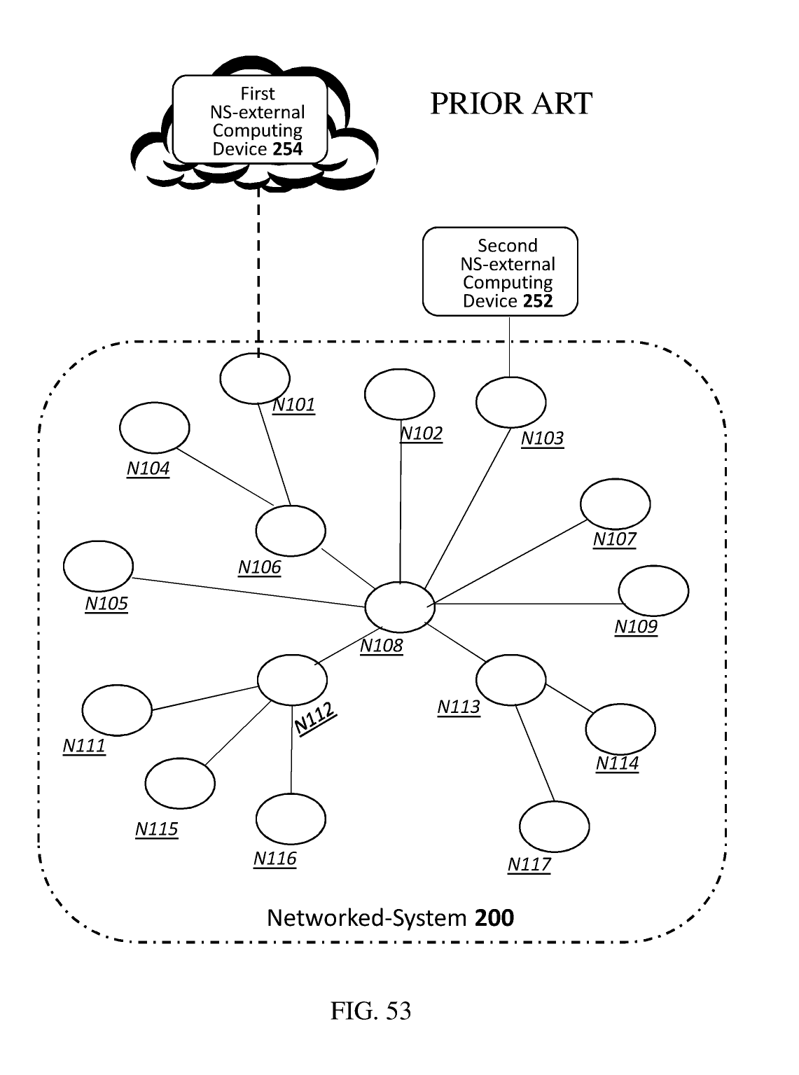

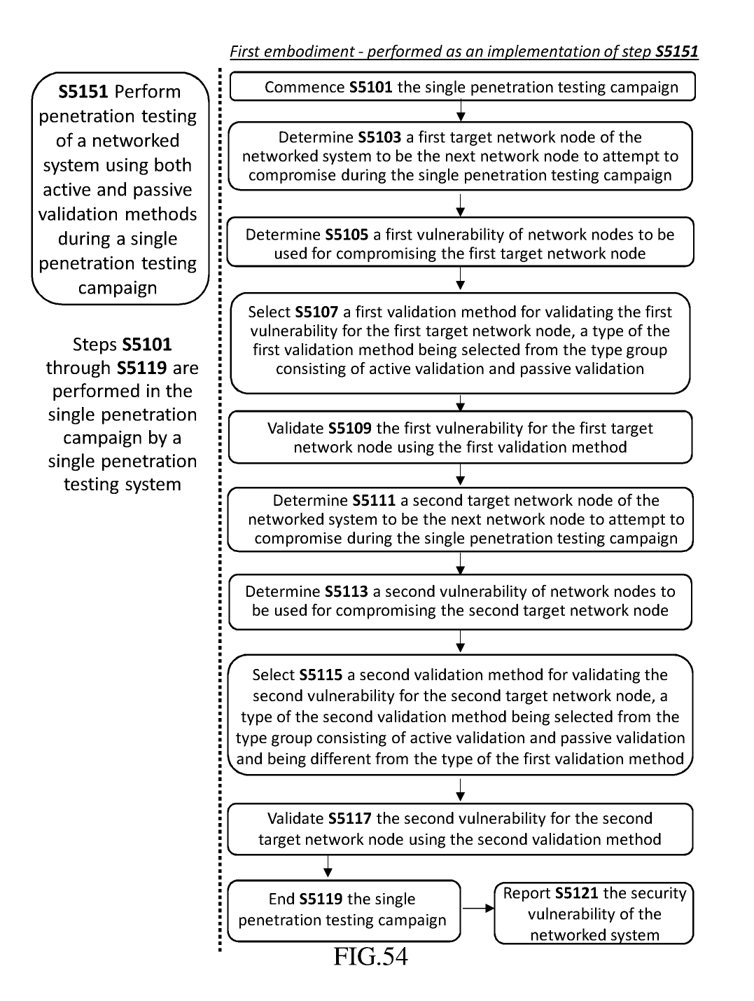

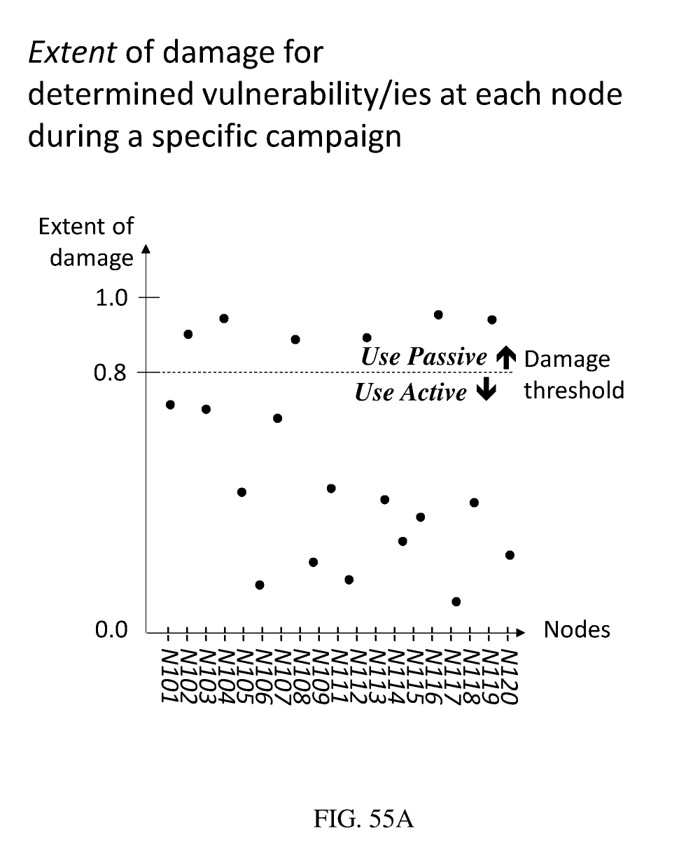

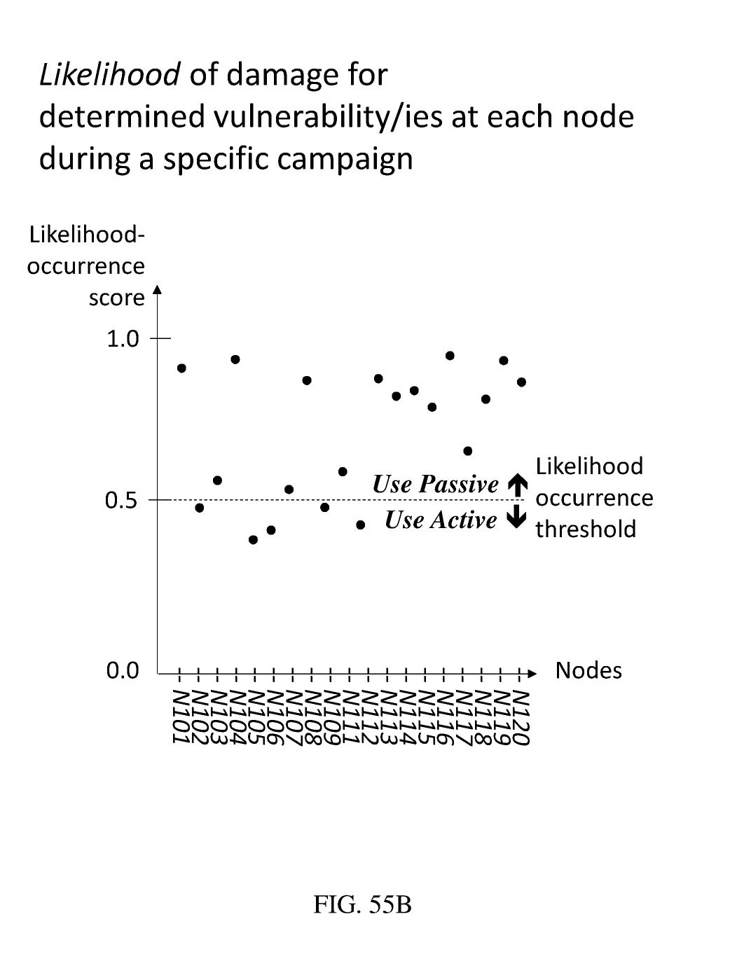

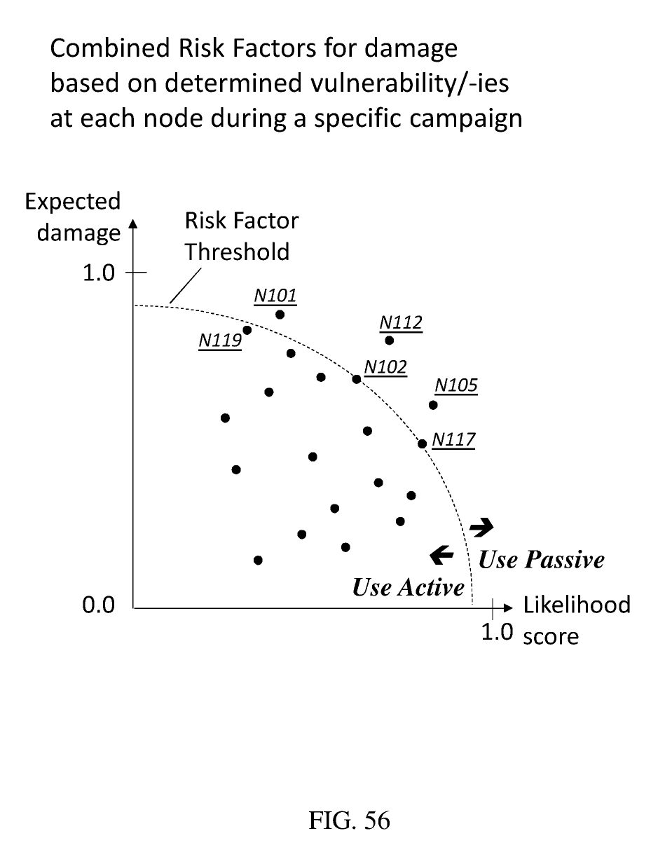

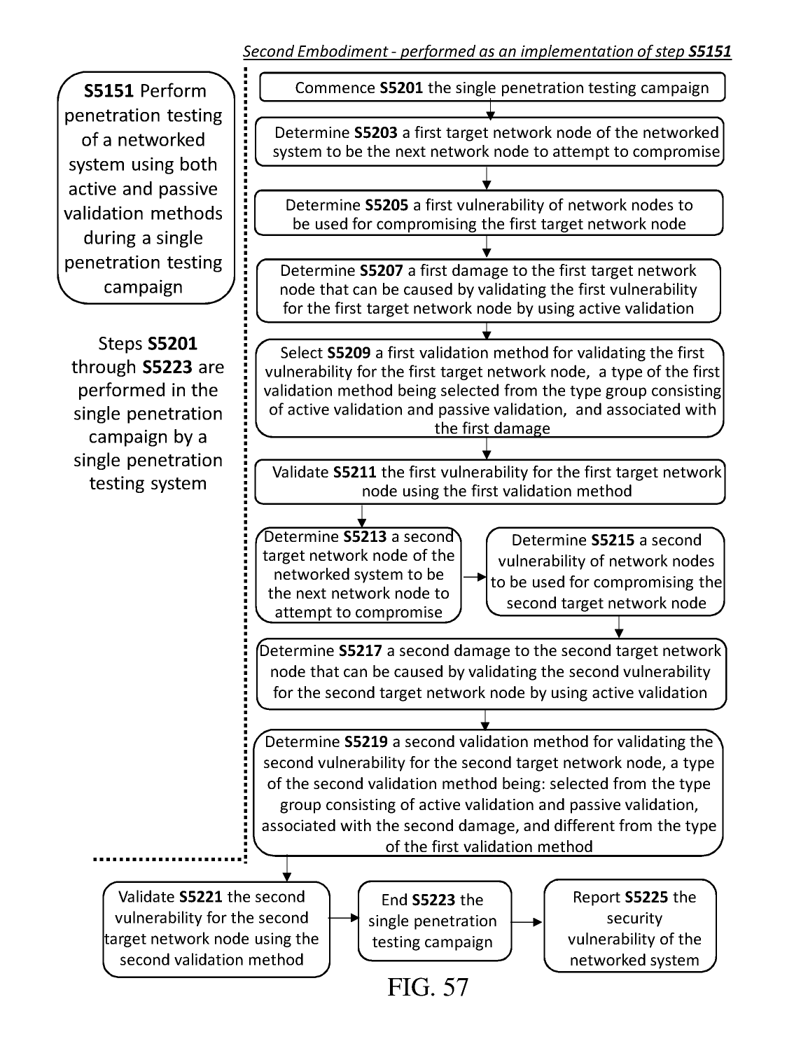

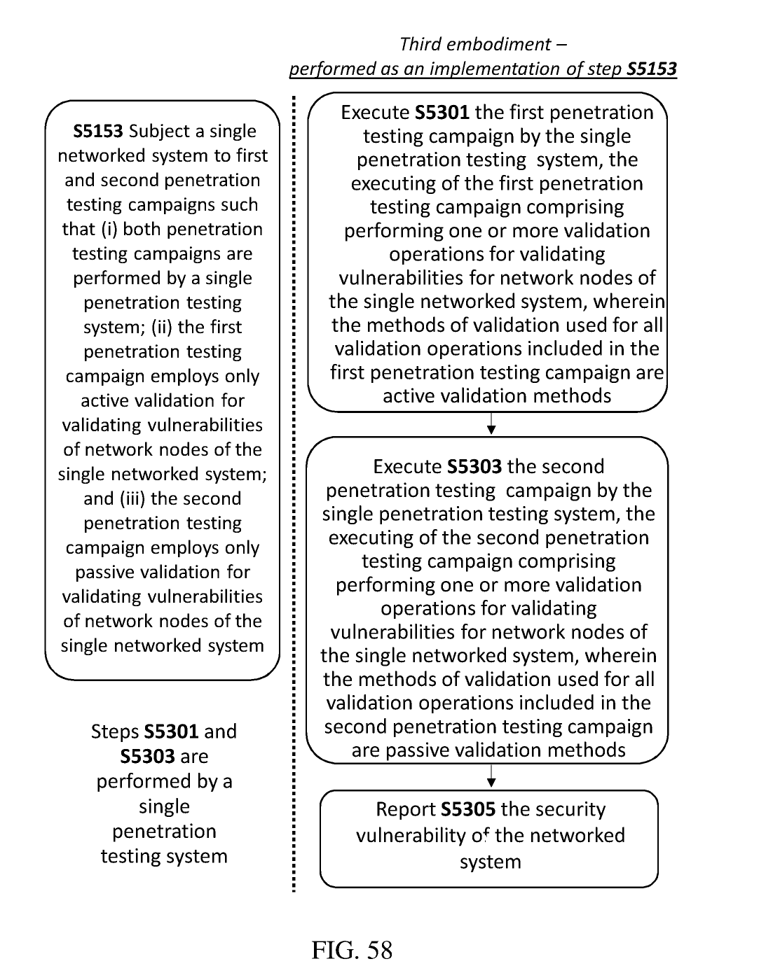

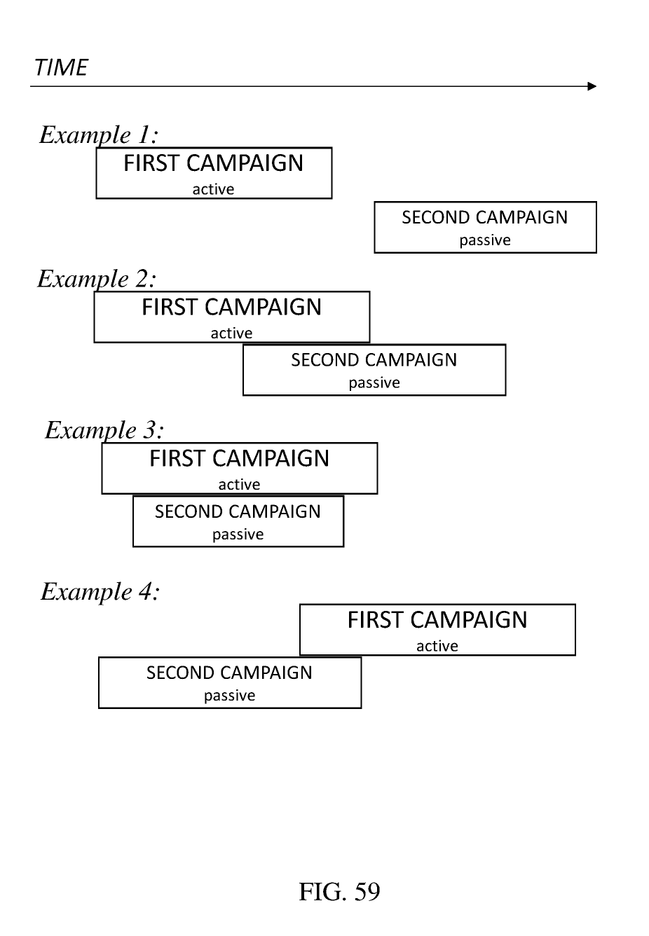

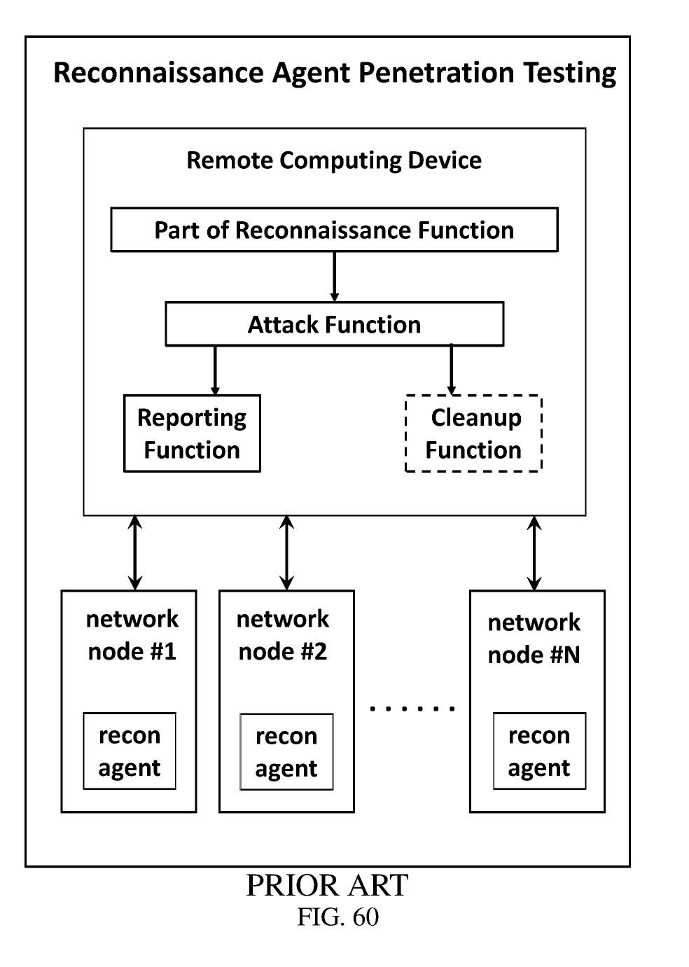

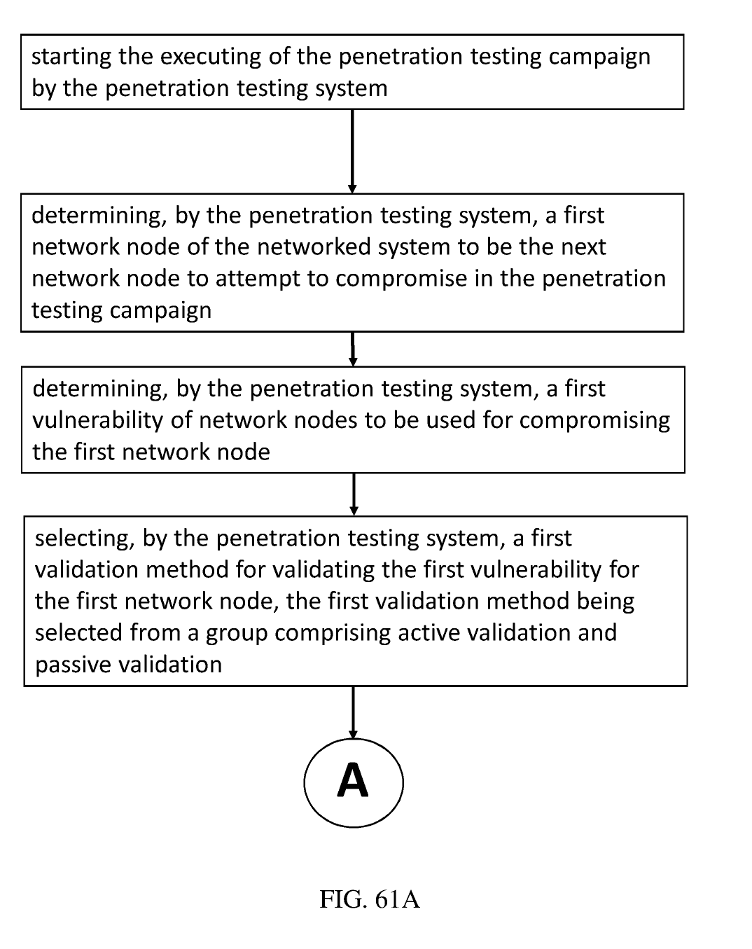

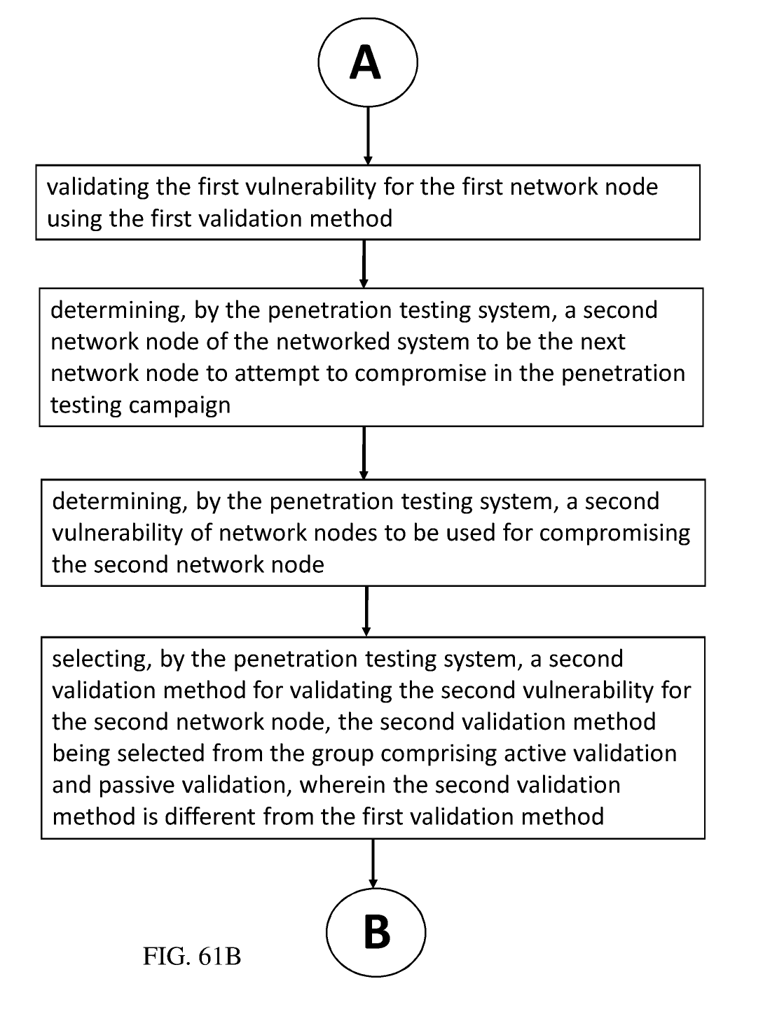

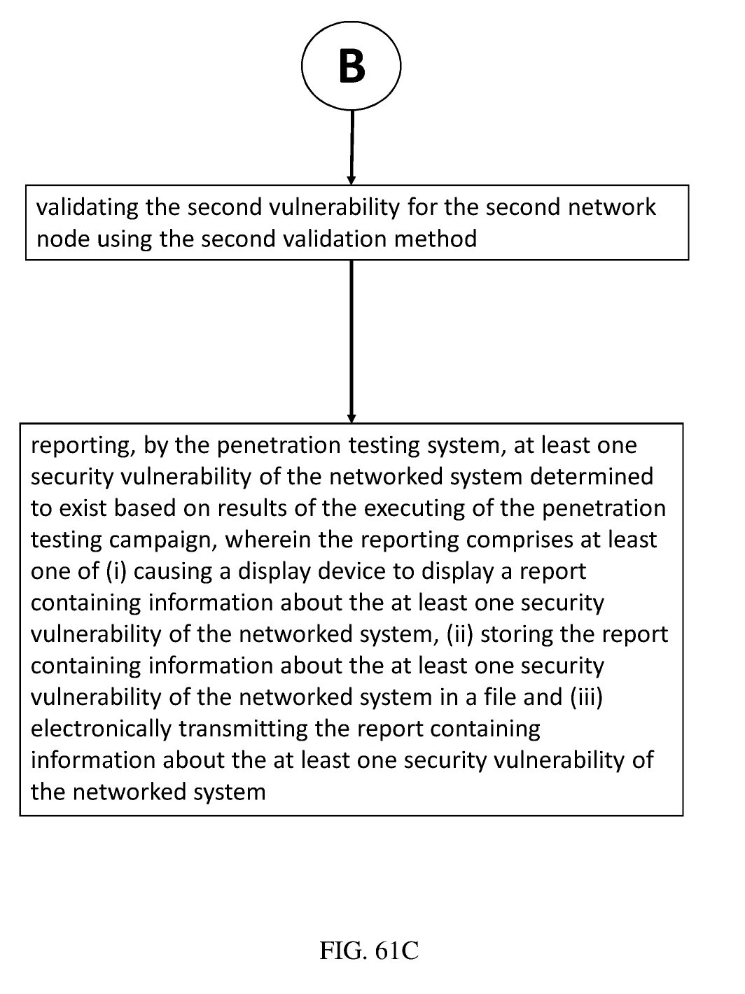

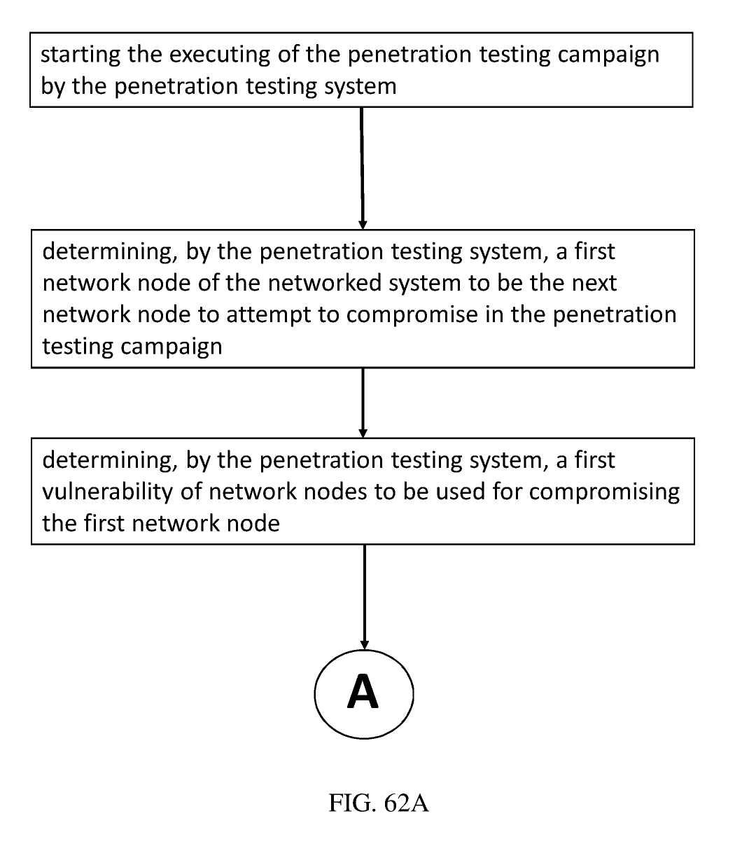

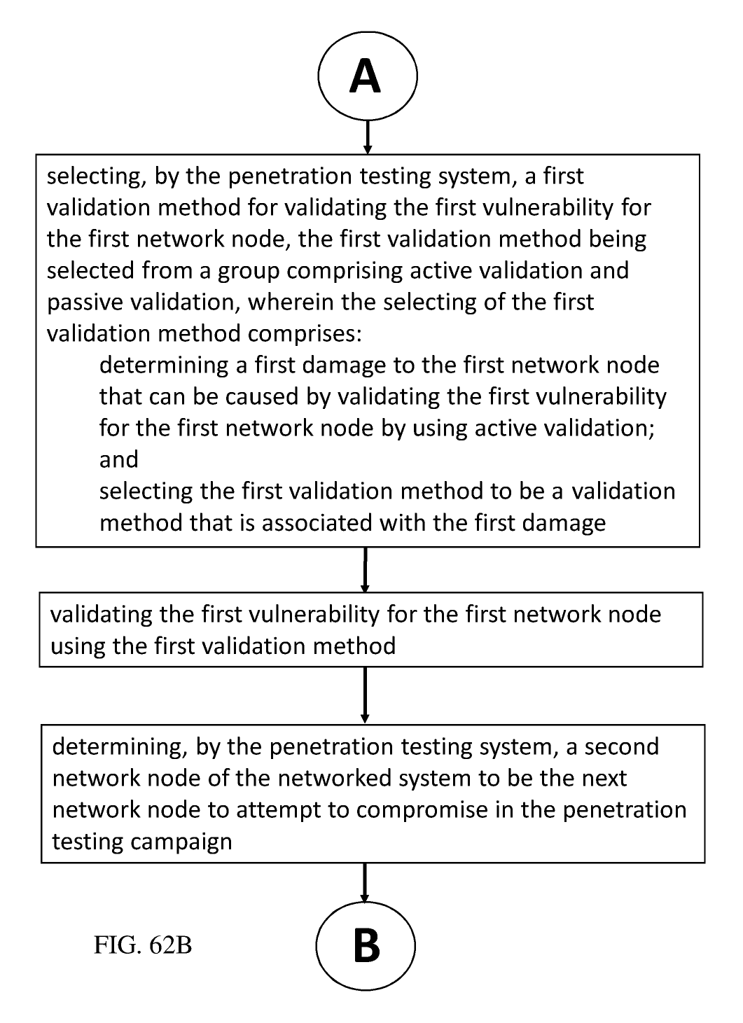

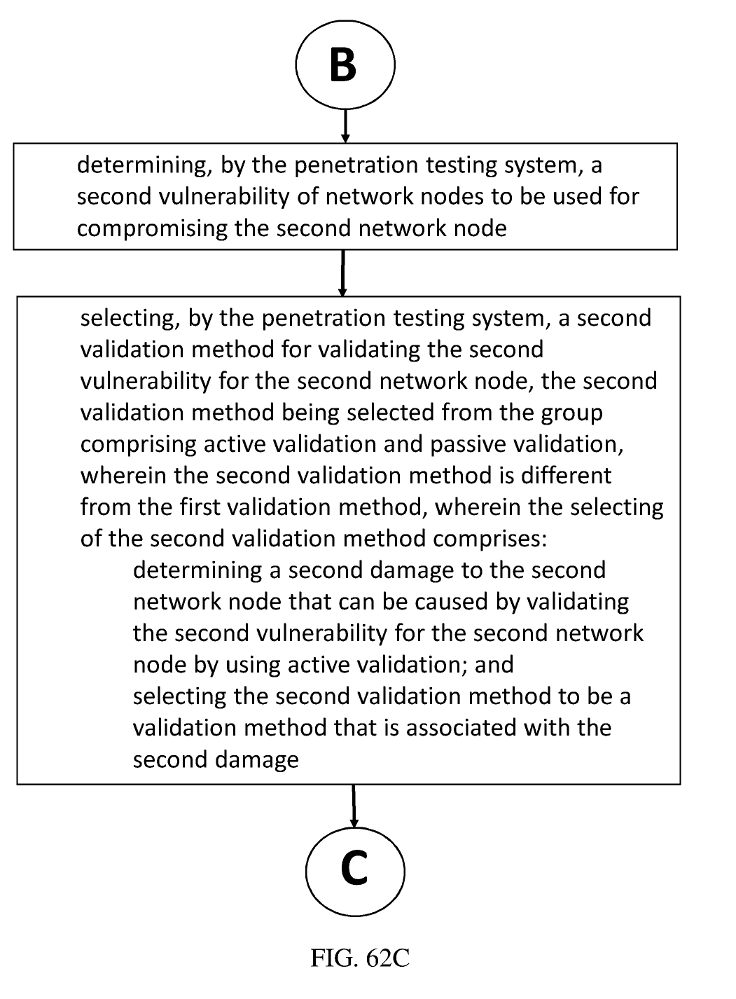

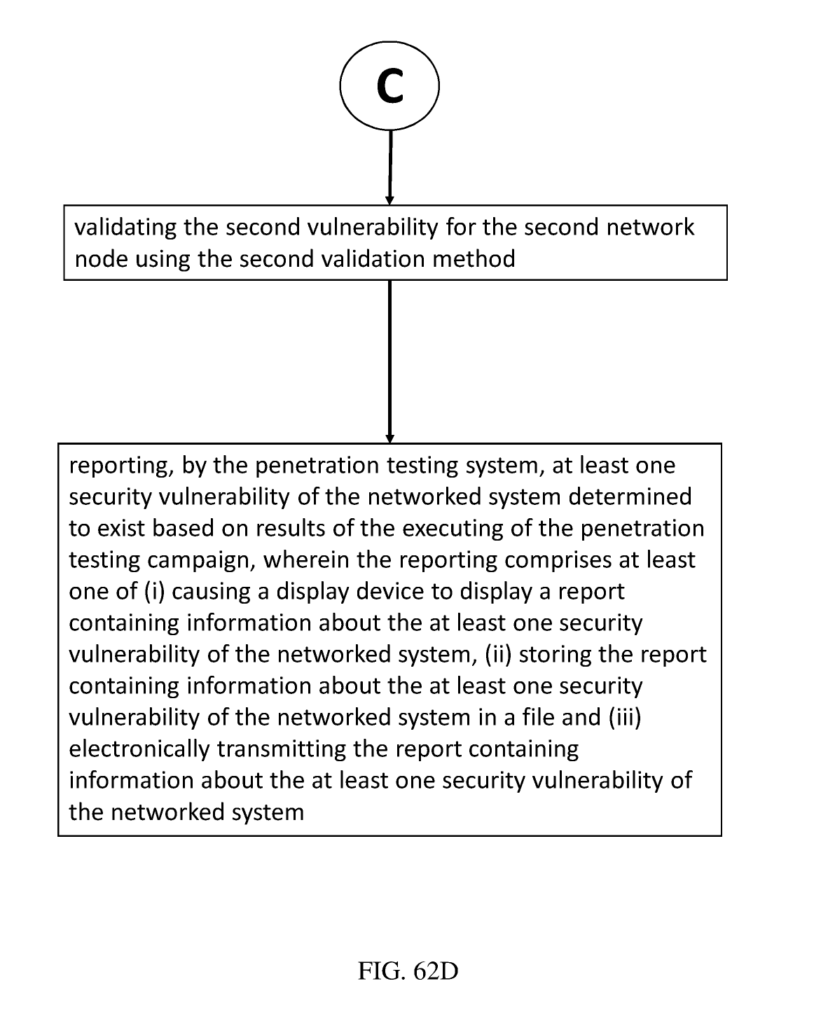

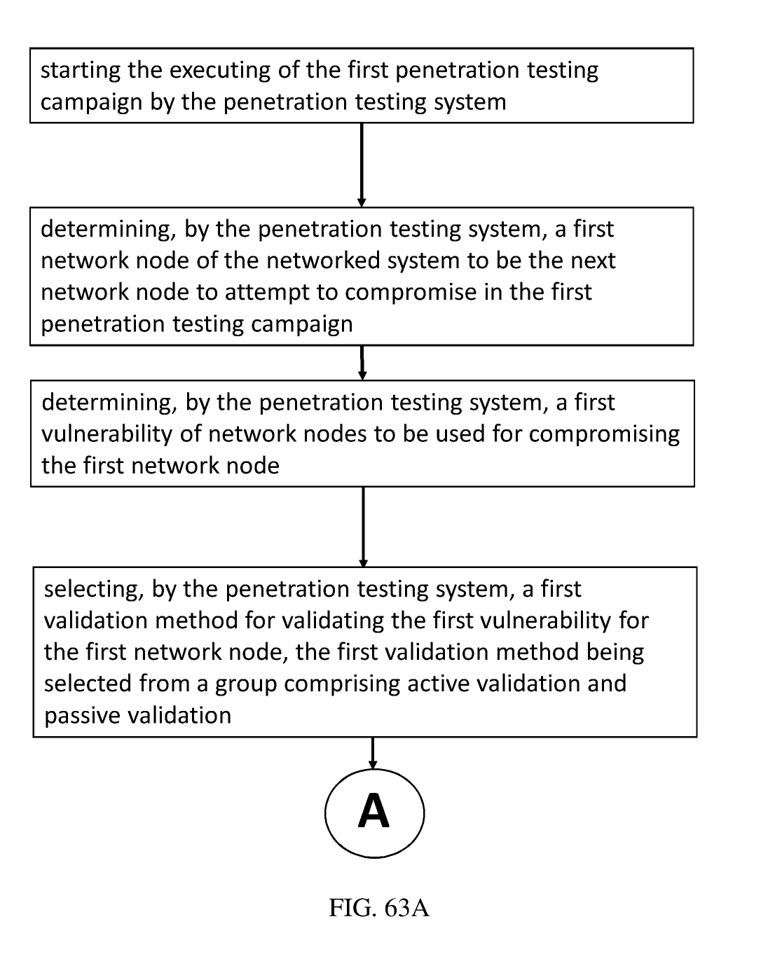

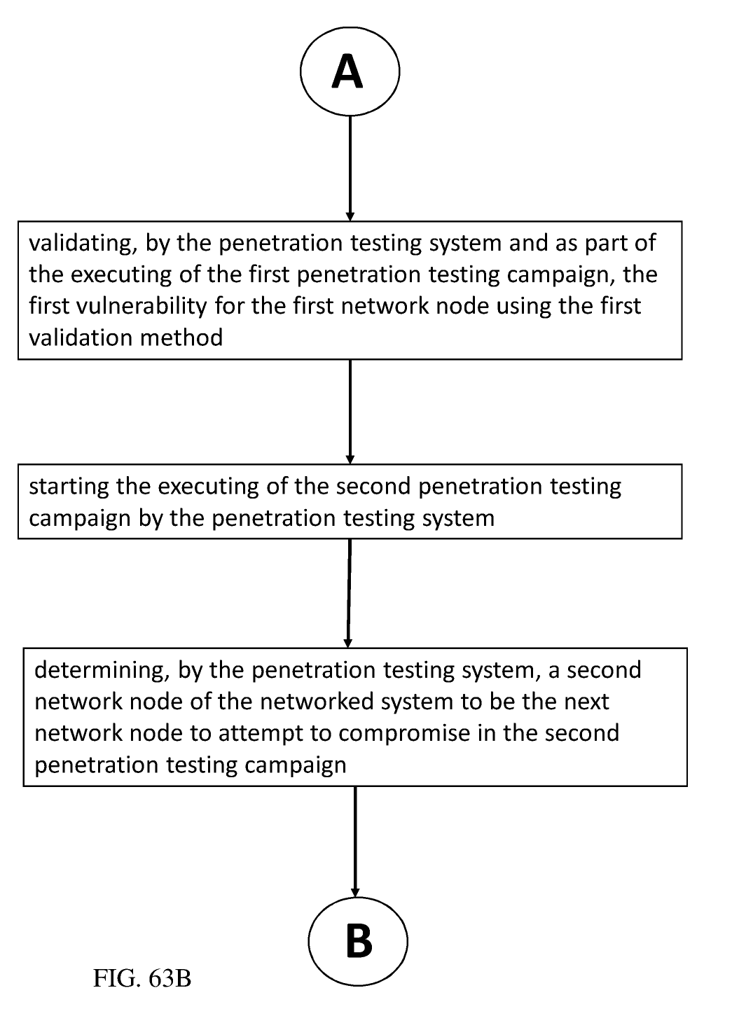

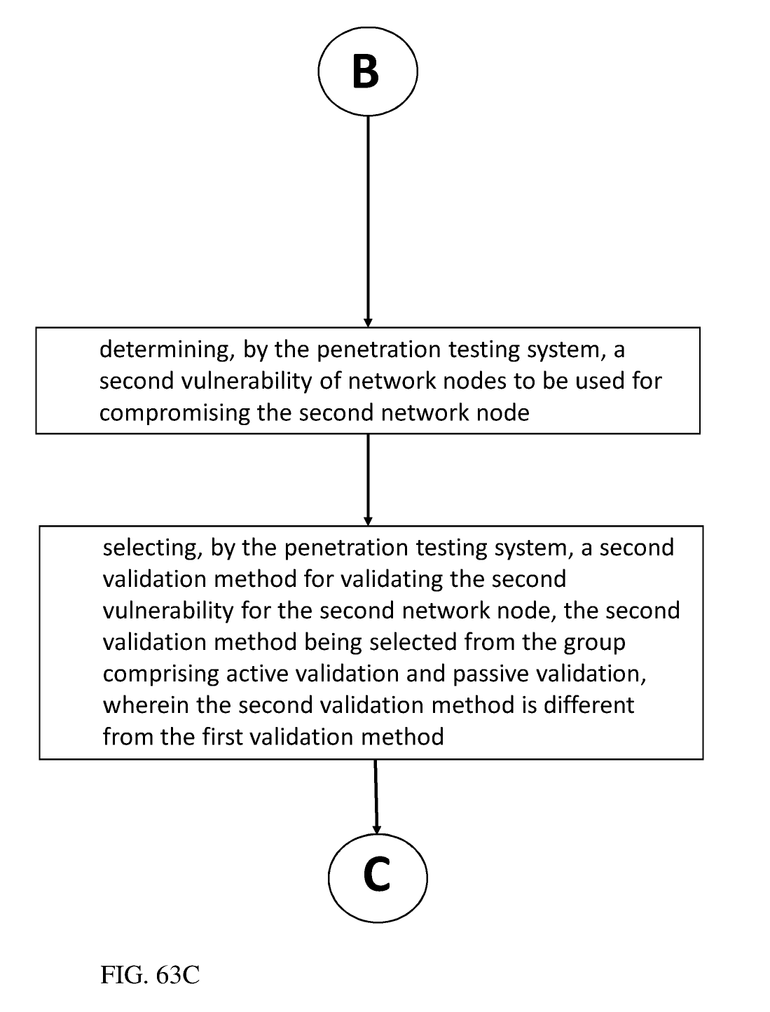

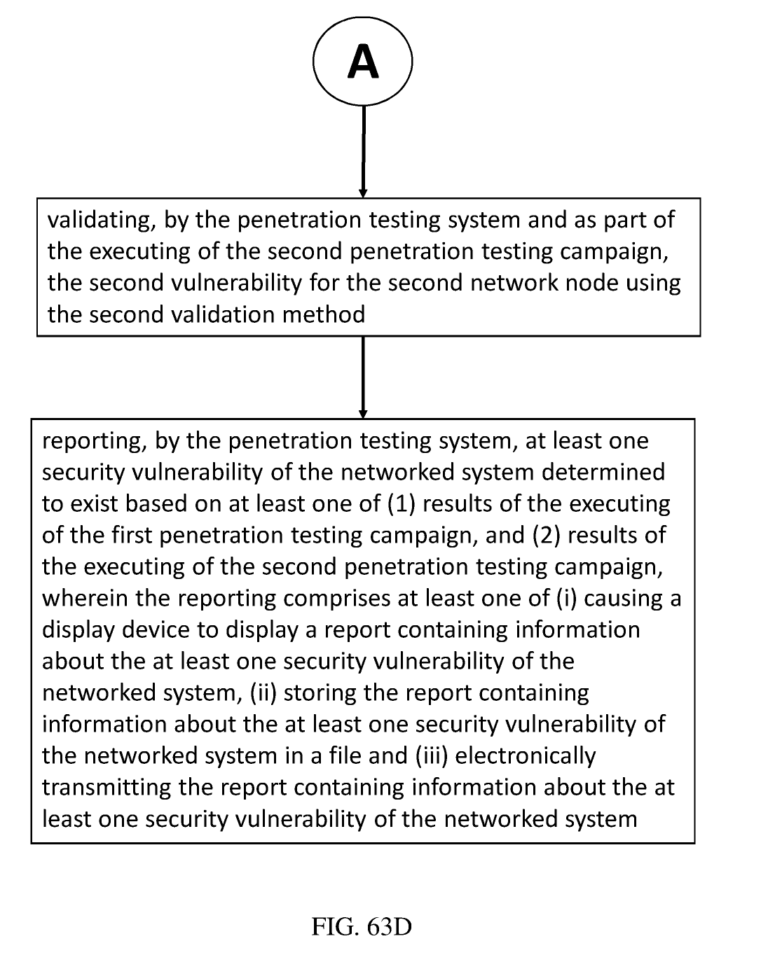

A Discussion of FIGS. 21 and 22A-22B—a Method of Penetration Testing According to One or More Manually and Explicitly Selected Goals of an Attacker of a Penetration Testing Campaign (e.g. Using GUI Element 330C)

In some embodiments, a user manually and explicitly selects one or more capabilities of an attacker of a penetration testing campaign. FIG. 21 is a flow-chart of a method for performing penetration testing according to manually and explicitly selected goals of an attacker of a penetration testing campaign.

Specific examples of step S401 of the flow-chart of FIG. 21 are discussed below with reference to FIGS. 22A-22B.

The term ‘goal of an attacker’ is defined below—see definition “31” of the ‘Definitions Section.’

In step S401 of FIG. 21, the penetration testing system receives (i.e. via the user interface of a computing device), one or more manually-entered inputs, where the one or more manually-entered inputs are explicitly selecting one or more goals of the attacker of the penetration testing campaign.

A first example is presented in FIG. 22A which relates to the example of the GUI element 330C.

Three attacker goals are listed in GUI element 330C: (i) a goal to copy a file having a user-specified file-name from a user-specified network node and export it to the attacker—if the user selects “YES” then the subsequent penetration testing campaign is performed in step S405 such that the attacker is assumed to have this goal; (ii) a goal to encrypt a file having a user-specified file-name residing on a user-specified network node—if the user selects “YES” then the subsequent penetration testing campaign is performed in step S405 such that the attacker is assumed to have this goal; and (iii) a goal to compromise a user-specified number of network nodes without caring which nodes they are—if the user selects “YES” then the subsequent penetration testing campaign is performed in step S405 such that the attacker is assumed to have this goal.

FIG. 22A presents three frames—Frame 1 at time t1, Frame 2 at time t2, and Frame 3 at time t3. In FIG. 22A the default values are indicated by a gray ‘wave’ shading.

Frame 1 of FIG. 22A illustrates an initial state (i.e. at time ti) where only default values are presented as follows: none of the presented goals are goals of the attacker.

In Frame 2 of FIG. 22A at time t2, the user engages the GUI element 330C (e.g. by clicking when a mouse pointer is within the circle next to the capability labeled “Encrypting a file having a specific file name in a specific node) to override the default value, changing from “NO” to “YES.” The user also types in the file name and the host-node-ID.

In Frame 3 of FIG. 22A at time t3, when the user's mouse-pointer is located within the ‘begin’ button 334, the user provides a mouse-click, thereby triggering steps S405 and S409 of FIG. 21, discussed below.

FIG. 22B shows another example, where the manual and explicit selecting of the one or more goals of the attacker of the penetration testing campaign is performed by the user accepting, by engaging an ‘accept recommendation’ button 328C, a recommendation provided by the penetration testing system.

Frame 1 of FIG. 22B illustrates an initial state (i.e. at time t1) of GUI element 330C′ where only system-recommended values are presented as follows: (i) exporting a specific file from a specific node is not a goal of the attacker; (ii) encrypting a file having a specific file name in a specific node is a goal of the attacker and (iii) compromising a number of network nodes, without caring which network nodes they are is not a goal of the attacker.

Thus, the {N,Y,N} values are illustrated in diagonal gray lines, indicating that these values have not been manually and explicitly selected by the user—in the initial state of FIG. 22B, the {N,Y,N} values are only system-generated recommendations.

In Frame 2 of FIG. 22B at time t2, the user engages the GUI element 328C by clicking on the circle labelled ‘accept recommendation’ to accept the system-recommended values presented in Frame 1 of FIG. 22B.

In Frame 3 of FIG. 22B, the values {N,Y,N} that were previously (i.e. in Frame 1) presented in gray diagonal shading (i.e. when they were only system-recommended values) are now presented in solid black. Because the user accepted the system-generated recommendations in Frame 2, the values {N,Y,N} are now manually and explicitly selected values, and are presented as such in Frame 3 of FIG. 22B. It should be noted that the user is not forced to accept the system-generated recommendations, but may override them. This freedom of choice is what makes the selection of the attacker goals a manual and explicit selection.

In Frame 4 of FIG. 22B, the user clicks on the ‘begin’ button to begin the penetration testing campaign using the manually and explicitly selected {N,Y,N} values.

It should be noted that in the example of FIG. 22B the goal recommended by the system required specifying a file name and a node ID. In this example, the system provides the complete specification of the goal, including values for the file name and the host ID, so that if the user wants to accept the recommendation he only has to select the ‘accept recommendation’ button 328C. However, this does not have to be so—in other embodiments when the system recommends a goal of the attacker it does not provide values for some or all of the parameters required for specifying the recommended goal. In such embodiments, if the user wants to accept the recommendation he has to manually provide values for the parameters of the goal before selecting the ‘accept recommendation’ button 328C.

In step S405 of FIG. 21, the following is performed: executing the penetration testing campaign, by the penetration testing system and according to the manually and explicitly-provided selection of the one or more goals of the attacker, so as to test the networked system.

In step S409 of FIG. 21, the following is performed: reporting, by the penetration testing system, at least one security vulnerability determined to exist in the networked system by the executing of the penetration testing campaign, wherein the reporting comprises at least one of (i) causing a display device to display a report describing the at least one security vulnerability, and (ii) electronically transmitting (e.g. over a computer network) (for example, from the computing device mentioned in step S401 to another computing device) a report describing the at least one security vulnerability.

In one example where the reporting comprises causing a display device to display a report describing the at least one security vulnerability, a computing device that performs the reporting causes a local display device (e.g. either residing in a common housing with the computing device that performs the reporting or connected via a local device interface) to display the report. Alternatively or additionally, data describing the report may be sent to another computing device (e.g. in communication with the computing device that performs the reporting via a local or remote network) to cause the other computing device to display the report on a display device local to the other computing device or to store it in a storage device for later use.

In some embodiments, the reporting may be in real time or substantially in real time. Alternatively, the reporting may be a delayed reporting where the data is first stored in volatile and/or non-volatile memory, and the reporting step may be completed only after some delay (e.g. even a delay of weeks or months or years).

### A Discussion of FIG. 23

FIG. 23 is a flow chart of a method of penetration testing of a networked system by a penetration testing system that is controlled by a user interface of a computing device so that a penetration testing campaign is executed according to an automatic selecting of one or more goals of an attacker of the penetration testing campaign.

In step S851 of FIG. 23, the following is performed: determining, by the penetration testing system, a type of the attacker of the penetration testing campaign. The type of attacker can be determined in any manner—e.g. according to user-input or automatically or in any other manner.

In step S855 of FIG. 23, the following is performed: automatically selecting, by the penetration testing system and according to the type of the attacker of the penetration testing campaign, one or more goals of the attacker.

In step S859 of FIG. 23, the following is performed: executing the penetration testing campaign, by the penetration testing system and according to i. the type of the attacker of the penetration testing campaign, and ii. the automatically selected one or more goals, so as to test the networked system.

In step S863 of FIG. 23, the following is performed: reporting, by the penetration testing system, at least one security vulnerability determined to exist in the networked system by the executing of the penetration testing campaign, wherein the reporting comprises at least one of (i) causing a display device to display a report describing the at least one security vulnerability, and (ii) electronically transmitting (e.g. over a computer network) a report describing the at least one security vulnerability.

In one example where the reporting comprises causing a display device to display a report describing the at least one security vulnerability, a computing device that performs the reporting causes a local display device (e.g. either residing in a common housing with the computing device that performs the reporting or connected via a local device interface) to display the report. Alternatively or additionally, data describing the report may be sent to another computing device (e.g. in communication with the computing device that performs the reporting via a local or remote network) to cause the other computing device to display the report on a display device local to the other computing device or to store it in a storage device for later use.

In some embodiments, the reporting may be in real time or substantially in real time. Alternatively, the reporting may be a delayed reporting where the data is first stored in volatile and/or non-volatile memory, and the reporting step may be completed only after some delay (e.g. even a delay of weeks or months or years).

### A Discussion of FIGS. 24A-24B and 25

In the example of FIG. 24A, at least a portion of the penetration testing system is implemented by a code module 210 (e.g. comprising one or more of reconnaissance function code 20, attack function code 30, and reporting function code 40; and additionally comprising user-interface code) that resides on and is executed by host computing device(s) 80. In this example, the host computing device(s) are external to the networked system to be tested.

In the example of FIG. 24B, at least a portion of the penetration testing system code 210 resides on and is executed by one or more of the network nodes 110 of the networked-system to be penetration tested.

One example of a penetration testing system code module 210 is shown in FIG. 25. In FIG. 25, (i) “CM” is an abbreviation for ‘code module’; (ii) UICM is an abbreviation for ‘user interface code module’; (iii) SE is an abbreviation for ‘selection engine’; and (iv) PTSCM is an abbreviation for penetration testing system code module.

Penetration testing system code module 210 includes one or more of (i.e. any combination of): attacker capability selection user interface code module 230A (e.g. which produces GUI element 330A), attacker detection sensitivity selection user interface code modules 230B (e.g. which produces GUI element 330B), attacker goal selection user interface code module 230C (e.g. which produces GUI element 330C), attacker type selection user interface code module 230D (e.g. which produces GUI element 330D), network node selection user interface code module 230E (e.g. which produces GUI element 330E), node selection condition user interface code module 230F (e.g. which produces GUI element 330F), lateral movement strategy selection user interface code module 230G (e.g. which produces GUI element 330G), attacker trait selection user interface code module 230H (e.g. which produces GUI element 330H); node selection engine (SE) code module 240A (e.g. for performing step S805 discussed above); attacker goal selection engine (SE) code module 240B (e.g. for performing step S855 discussed above); lateral movement strategy selection engine (SE) code module 240C (e.g. for performing step S905 discussed above).

### Additional Discussion

Embodiments of the invention relate to a penetration testing system that provides the user great flexibility in defining the specifications of a campaign he wants to run for testing a networked system. In some embodiments, the user of the penetration testing system can directly and independently select values for multiple information items of a campaign. This is different from prior art systems in which the user selects a pre-defined scenario from a list of scenarios, and is also different from prior art systems in which the user indirectly selects a pre-defined scenario by selecting a value for one information item of the campaign that causes the system to automatically choose a specific pre-defined scenario that is the only available scenario having that value for that information item, or causes the system to automatically choose a scenario from a plurality of the available pre-defined scenarios which have that value for that information item. In some embodiments, the user of the penetration testing system can directly select the type of the attacker that will be used in a campaign. Specifically, such selection is done without committing to specific values of other information items of the campaign according to a pre-defined scenario. In other words, after selecting the type of attacker, the user may for example select the goal of the attack independently of his type of attacker selection. This is different from prior art systems in which when the user selects a type of attacker, he is tying his hands by committing to a fully-defined scenario and giving up any options of independently selecting values for other information items of the campaign he is initiating. The selection of the type of the attacker is typically done by selecting from a closed list of alternatives, for example by choosing from a drop-down list. In some embodiments, the user of the penetration testing system can directly select the capabilities of the attacker that will be used in a campaign. An attacker may have one or more capabilities. The selection of the capabilities of the attacker is typically done by selecting from a closed list of alternatives, for example by marking one or more checkboxes. The list of alternatives to the user may depend on the type of the attacker previously selected for the campaign. In some embodiments, the user of the penetration testing system can directly select the methods of a capability of the attacker that will be used in a campaign. A capability of an attacker may have one or more methods. The selection of the methods is typically done by selecting from a closed list of alternatives, for example by marking one or more checkboxes. The list of alternatives to the user may depend on the specific type of the attacker and on the specific capability previously selected. In some embodiments, the user of the penetration testing system can directly select the traits of an attacker that will be used in a campaign. An attacker may have one or more traits. The selection of the traits is typically done by selecting from a closed list of alternatives, for example by marking one or more checkboxes. The list of alternatives to the user may depend on the specific type of the attacker previously selected for the campaign. In some embodiments, the user of the penetration testing system can directly select one or more network nodes of the tested networked system that are assumed to be already compromised at the beginning of the test. Such network nodes are referred to herein as “initial red network nodes” or “initially red network nodes”. This selection is useful for assessing the penetration capability of an attacker to other network nodes of the networked system once those one or more initial red network nodes are compromised. For example, a CISO of an organization may fear that a specific network node of the organization is more prone than other nodes to be compromised, because it is directly facing the external world or because there are employees with access rights to that specific node that are less trustworthy than the other employees of the organization. In such case the CISO may want to know what might happen if his fears will be justified and run a specific penetration test for finding the answer.

In some embodiments, the selection of the initial red network nodes may be done by presenting the user with a graphical map of the networked system in which each network node is shown as a circle identified by a name or by an IP address. Using the graphical map, the user can point, using a mouse or some other pointing device, to each network node to be initially red and press a button (a pointing device button or a keyboard button) for selecting that node to be initially red. Alternatively, the user may be presented with a list of network nodes identified by a name or by an IP address, where each node is accompanied by a corresponding checkbox. Marking a checkbox selects the corresponding node to be initially red.

In some embodiments, the user also has the option to select that there will be no initially red nodes, in which case the penetration test will start with the assumption that none of the network nodes is compromised.

In some embodiments, the user of the penetration testing system can select the one or more network nodes of the tested networked system that are assumed to be already compromised at the beginning of the test by an open definition, rather than by directly identifying those nodes by the methods explained above. By “open definition” it is meant that the user provides a condition a node must satisfy in order to be selected as an initial red network node. For example, the user may specify that all network nodes having a direct connection to the outside world are selected to be initially red. Or that all network nodes that are cellular mobile devices are selected to be initially red. Or that all network nodes that are MacBook computers are selected to be initially red. Or that all network nodes that are running the Windows XP operating system are selected to be initially red. Or that all network nodes having installed Internet Explorer version 8 or earlier are selected to be initially red.

In some embodiments, the selection condition may be a combination of multiple conditions. For example, the user may specify that all network nodes that are both running Windows XP and having installed Internet Explorer version 8 or earlier are selected to be initially red. Additionally, the user may define multiple selection conditions that operate in parallel. For example, one condition is that a node is running Windows XP, and a second condition is that the a node has installed Internet Explorer version 8 or earlier. The effective result of having these two selection conditions is equivalent to specifying that all network nodes having either Windows XP or having installed Internet Explorer version 8 or earlier are selected to be initially red. Also, the user may be able to define a selection condition by using a “not” operator. For example, the user may select that all user nodes that do not have a specific anti-virus installed are selected to be initially red.

In some embodiments, the selection of the initially red network nodes may be done by the user using a GUI (Graphical User Interface). The GUI may include selection of single alternatives from drop-down closed lists, selection of one or more alternatives from closed lists by marking checkboxes, selection of logic operators (AND, OR, NOT) for combining conditions, and any other means required for the user for defining his selection of initially red network nodes.

In some embodiments, the penetration testing system may be configured to relieve the user from the burden of selecting the condition to be satisfied by the initial red network nodes by automatically determining which nodes are the most likely to be compromised in the networked system, for example because they are the ones facing the external world. In such case the system tells the user which nodes it recommends to select as the initial red nodes, and the user may then either confirm the recommendation or disagree with it and make his own selection according to the methods described above.

In some embodiments, the penetration testing system may be configured to completely leave the selection of the initial red network nodes in the hands of the system. In such case the system automatically determines which nodes it recommends to be selected as the initial red nodes, for example those nodes of the networked system that are the most likely to be compromised by the type of attacker previously selected for the campaign, and then selects those nodes to be the initial red network nodes without asking for user confirmation.

In some embodiments, the user of the penetration testing system can directly select the goals of the attacker during a campaign. An attacker may have one or more goals in a campaign. The selection of the goals of the attacker is typically done by selecting from a closed list of alternatives, for example by marking one or more checkboxes or by selecting a single goal from a drop-down list. For some goals, in addition to marking a checkbox or selecting from a drop-down list, the user also must specify one or more parameters. For example, for the goal “export a specific file from a specific network node” the user should specify the file name and the network node. The list of goals to the user may depend on the type of the attacker previously selected for the campaign.

In some embodiments, the user of the penetration testing system can directly select the lateral movement strategy of the attacker during the campaign. The selection of the lateral movement strategy is typically done by selecting from a closed list of alternatives, for example by selecting a single alternative from a drop-down list. For some strategies, the user also has to specify a parameter. For example, for a lateral movement strategy in which a priority is given to compromising network nodes satisfying a specific condition, the user has to specify the condition, possibly selecting it from a second drop-down list that becomes operative after the selection of that strategy from the first drop-down list. The list of alternatives to the user for selecting the lateral movement strategy may depend on the type of the attacker and on the goals of the attacker previously selected for the campaign. In some embodiments, the penetration testing system may be configured to relieve the user from the burden of selecting the lateral movement strategy by automatically determining the most effective strategy for the goals previously selected for the campaign. In such case the system tells the user what lateral movement strategy it recommends to select for the campaign, and the user may then either confirm the recommendation or disagree with it and make his own selection according to the methods described above.

In some embodiments, the penetration testing system may be configured to completely leave the selection of the lateral movement strategy in the hands of the system. In such case the system automatically determines the strategy it recommends to be selected for the campaign, for example the strategy that is most effective for achieving the goals previously selected for the campaign, and then selects that strategy without asking for user confirmation.

In some embodiments, the user performs all the above selections by operating a console with a GUI supporting all the functions described above. The console is typically associated with a remote computing device that includes a processor that executes software implementing part or all of the penetration testing software functions during the execution of a campaign. Alternatively, the console may be associated with a separate computing device that is different from the remote computing device executing the campaign and is in communication with it.

Some embodiments relate to a first method (see FIG. 26) that is most useful for setting up a campaign of penetration testing for reporting security vulnerabilities of a networked system, the campaign being executed by a penetration testing system which is controlled by a user interface of a computing device, the method comprising:
1. manually selecting, by a user of the penetration testing system and using the user interface of the computing device, a first value for a first information item of a campaign of the penetration testing system;
2. subsequent to the manually selecting the first value, manually selecting, by the user of the penetration testing system and using the user interface of the computing device, a second value for a second information item of the campaign of the penetration testing system, the manual selection of the second value being independent of the manual selection of the first value;
3. executing, by the penetration testing system, the campaign of the penetration testing system for testing the networked system, where the campaign is executed using the first value for the first information item and the second value for the second information item;
4. reporting at least one security vulnerability determined by the campaign to exist in the networked system, to the computing device or to another computing device. The first information item may be the type of the attacker of the campaign. Some embodiments relate to a second method (see FIG. 27) that is most useful for setting up a campaign of penetration testing for reporting security vulnerabilities of a networked system, the campaign being executed by a penetration testing system which is controlled by a user interface of a computing device, the method comprising:
1. manually selecting, by a user of the penetration testing system and using the user interface of the computing device, a capability of an attacker of a campaign of the penetration testing system;
2. executing, by the penetration testing system, the campaign of the penetration testing system for testing the networked system, where the campaign is executed using the manually selected capability of the attacker;
3. reporting at least one security vulnerability determined by the campaign to exist in the networked system, to the computing device or to another computing device.

The step of manually selecting the capability may include the following steps:
1. automatically determining, by the penetration testing system, a recommendation for selecting a capability of the attacker;
2. presenting to the user, by the penetration testing system, the recommended capability;
3. manually approving, by the user and using the user interface of the computing device, to use the recommended capability as a capability of the attacker of the campaign.

The second method may further comprise:
1. subsequent to the manually selecting the capability, manually selecting, by the user of the penetration testing system and using the user interface of the computing device, a value for a second information item of the campaign of the penetration testing system, where: (i) the second information item is not a capability of the attacker, (ii) the manual selection of the value is independent of the manual selection of the capability, and (iii) the executing of the campaign is also using the value for the second information item, in addition to using the manually selected capability.

Alternatively, the second method may further comprise:
1. subsequent to the manually selecting the capability, manually selecting, by the user of the penetration testing system and using the user interface of the computing device, a method of the capability, where the executing of the campaign is also using the manually selected method.

Some embodiments relate to a third method (see FIG. 28) that is most useful for setting up a campaign of penetration testing for reporting security vulnerabilities of a networked system, the campaign being executed by a penetration testing system which is controlled by a user interface of a computing device, the method comprising:
1. manually selecting, by a user of the penetration testing system and using the user interface of the computing device, a trait of an attacker of a campaign of the penetration testing system;
2. executing, by the penetration testing system, the campaign of the penetration testing system for testing the networked system, where the campaign is executed using the manually selected trait of the attacker;
3. reporting at least one security vulnerability determined by the campaign to exist in the networked system, to the computing device or to another computing device.

The step of manually selecting the trait of the attacker may include the following steps:
1. automatically determining, by the penetration testing system, a recommended trait of the attacker;
2. presenting to the user, by the penetration testing system, the recommended trait;
3. manually approving, by the user and using the user interface of the computing device, to use the recommended trait as a trait of the attacker of the campaign.

Some embodiments relate to a fourth method (see FIG. 29) that is most useful for setting up a campaign of penetration testing for reporting security vulnerabilities of a networked system, the campaign being executed by a penetration testing system which is controlled by a user interface of a computing device, the method comprising:
1. manually selecting, by a user of the penetration testing system and using the user interface of the computing device, one or more network nodes of the networked system that are assumed to be already compromised at the beginning of the campaign of the penetration testing system;
2. executing, by the penetration testing system, the campaign of the penetration testing system for testing the networked system, where the campaign is executed assuming the one or more network nodes are already compromised at the beginning of the campaign;
3. reporting at least one security vulnerability determined by the campaign to exist in the networked system, to the computing device or to another computing device.

The step of manually selecting the one or more network nodes may include providing a condition, where a network node is included in the one or more network nodes if and only if it satisfies the condition.

Alternatively, the step of manually selecting the one or more network nodes may include the following steps:
i. automatically determining, by the penetration testing system, one or more network nodes that are recommended to be assumed to be already compromised at the beginning of the campaign of the penetration testing system;
ii. presenting to the user, by the penetration testing system, the recommended one or more network nodes;
iii. manually approving, by the user and using the user interface of the computing device, to use the recommended one or more network nodes as the one or more network nodes assumed to be already compromised at the beginning of the campaign.

Some embodiments relate to a fifth method (see FIG. 30) that is most useful for setting up a campaign of penetration testing for reporting security vulnerabilities of a networked system, the campaign being executed by a penetration testing system which is controlled by a user interface of a computing device, the method comprising:
1. manually selecting, by a user of the penetration testing system and using the user interface of the computing device, a goal of an attacker of a campaign of the penetration testing system;
2. executing, by the penetration testing system, the campaign of the penetration testing system for testing the networked system, where the campaign is executed using the manually selected goal of the attacker;
3. reporting at least one security vulnerability determined by the campaign to exist in the networked system, to the computing device or to another computing device.

The step of manually selecting the first value for the goal may include the following steps:
1. automatically determining, by the penetration testing system, a recommended value for the goal of the campaign;
2. presenting to the user, by the penetration testing system, the recommended value;
3. manually approving, by the user and using the user interface of the computing device, to use the recommended goal as a goal of the attacker of the campaign.

Some embodiments relate to a sixth method (see FIG. 31) that is most useful for setting up a campaign of penetration testing for reporting security vulnerabilities of a networked system, the campaign being executed by a penetration testing system which is controlled by a user interface of a computing device, the method comprising:
1. manually selecting, by a user of the penetration testing system and using the user interface of the computing device, a lateral movement strategy of an attacker of the campaign of the penetration testing system;
2. executing, by the penetration testing system, the campaign of the penetration testing system for testing the networked system, where the campaign is executed using the manually selected lateral movement strategy of the attacker;
3. reporting at least one security vulnerability determined by the campaign to exist in the networked system, to the computing device or to another computing device.

The step of manually selecting the lateral movement strategy may include the following steps:
1. automatically determining, by the penetration testing system, a recommended value for the lateral movement strategy of the campaign;
2. presenting to the user, by the penetration testing system, the recommended value;
3. manually approving, by the user and using the user interface of the computing device, to use the recommended lateral movement strategy as a lateral movement strategy of the attacker of the campaign.

### First Discussion Of Additional Embodiments

Embodiments of the invention relate to penetration testing of networked systems, such as that illustrated in FIG. 32.

FIG. 33-34 illustrate examples of penetration testing systems for testing networked systems, such as that illustrated in FIG. 35. FIGS. 36-37 are flow charts of methods of penetration testing—the methods of FIGS. 36-37 may be performed, for example, using the penetration testing system of FIGS. 33-34 in order to penetration test the networked system of FIG. 32.

FIG. 35 illustrates communications between the PTSM and a plurality of nodes hosting the RASM.

Before presenting further discussion of these figures, a description of three Use Case Examples, related to presently-disclosed techniques for penetration testing, is now presented.

### Use Case Example 1

Networked System/Penetration Testing System for Example 1: The first non-limiting example relates to a networked system having the following properties: (i) the networked system comprises a plurality of laptop or desktop work-stations, each of which is a network node; (ii) each network node work-station has one or more USB ports; (iii) a first work-station/node (“Node A”) is “strongly defended”—on this work-station/node the most recent version of Windows® is installed including all of the latest security patches; (iv) a second work-station/node (“Node B”) is “weakly defended”—on this node, a much older version of Window has been installed, and security patches have not been installed for over two years.

This networked system is subjected to penetration testing.

In this example, a penetration testing software module is installed on a remote computing device which is outside of the networked system—in this example, the remote computing device is deployed in the cloud relative to the networked system, and is in networked communication with the networked system. This particular architecture is illustrated in FIG. 33.

In example 1, the terms “work-station A” and “node A” are used interchangeably; Similarly, the terms “work-station B” and “Node B” are also used interchangeably.

Activity that Typically Occurs in the Networked System for Example 1: In addition to the aforementioned networked system and the aforementioned penetration testing system, the first example relates to first, second and third office workers.

The first office worker owns a USB memory stick having the serial number “XA2312YAFIQ”, tends to use both work-stations A and B, and occasionally inserts her USB memory stick into the USB ports of each of those two work-stations.

The second office worker owns a USB memory stick having serial number “9232XG292ZZZ”. The second office worker (i) uses only work station A; (ii) occasionally inserts his USB memory stick into USB ports of work-station A; (iii) never inserts his USB memory stick into USB ports of station B.

The third office worker owns a USB memory stick having serial number “JIJI88812ACDQP”. The third office worker (i) uses only work-station B; (ii) occasionally inserts his USB memory stick into USB ports of work station B; (iii) never inserts his USB memory stick into USB ports of station A.

In this example, “user” and “office worker” are used interchangeably.

Goal of the Penetration Testing Campaign for Example 1: In example 1, the goal of the penetration testing campaign is for an attacker to compromise Node A—only if the attacker succeeds to compromise Node A is the penetration testing campaign considered a success.

### Timing of the Penetration Testing Campaign for Example 1:

In this first example, the penetration testing campaign commences at 10 AM on Apr. 1, 2017 and concludes at 12 noon on Apr. 1, 2017. Thus, in this example the “Commencement Time” is 10 AM on Apr. 1, 2017. Prior to the Commencement Time (e.g. on Mar. 31, 2017), the RASM is pre-installed on each node of the networked system, including Node A which is strongly-defended and Node B which is weakly-defended.

During the two-hour penetration testing campaign, processor(s) of Node A execute code of the RASM to “listen” to events which occur on USB ports of Node A—these events including coupling events, decoupling events, and transfer of data-files (e.g. from the USB memory stick to Node A or vice versa) Similarly, processor(s) of Node B execute code of the RASM to “listen”” to events which occur on USB ports of Node B.

In this example, at 10:01 AM Node A (i.e. by executing code of RASM) transmits to the remote computing device “Windows version/update data” for Node A—the Windows version/update data transmitted from Node A indicates that the most recent version of Windows® including all of the latest security patches is installed on Node A.

In this example, at 10:02 AM Node B (i.e. by executing code of RASM) transmits to the remote computing device “Windows version/update data” for Node B—the Windows® version/update data transmitted from Node B indicates that (i) an older version of Windows® is installed on Node B and (ii) the most recent security patch installed on Node B is over two years old.

In this example, executing code of each instance of the RASM stores a USB-event log file (i.e. a first USB-event log file on Node A for USB events of Node A and a second USB-event log file on Node B for USB events of Node B). Each USB-event log file is updated on an ongoing basis in response to detected events that occur at the USB ports of the corresponding node. Updates of the USB log-files occur locally (i.e. on Nodes A and B) on an ongoing basis without requiring any data-requesting commands from the remote computing device.

### USB-Event Log Files for Example 1:

The content of the USB-event log files (the entire log files or data describing the most recent updates to the log files) are only transmitted out of Nodes A and B (i.e. by executing code of the RASM on Nodes A and B) to the remote computing device in response to a data-requesting command received at each of the nodes (i.e. Nodes A and B) from the remote computing device—e.g. processor(s) of the remote computing device execute code of the penetration testing software module to issue the data-requesting commands and to transmit these data-requesting commands to Nodes A and B.

In this first example, the RASM instances which listen to the USB ports on Nodes A and B detect the following USB-related events that occur at the USB ports:

| Event | | | |
|---|---|---|---|
| No. | Time | Description | Status After Event |
| Begin | 10:00 AM | | Node A - no memory |
| | | | stick coupled |
| | | | Node B - no memory |
| | | | stick coupled |
| Event | 10:12 AM | At Node A -- USB | Node A - Memory stick |
| A1 | | memory stick having | belonging to the |
| | | serial number | first user is coupled |
| | | “XA2312YAFIQ” | Node B -- no memory |
| | | (i.e. belonging to | stick coupled |
| | | the first user) is | |
| | | coupled to a USB | |
| | | port of Node A | |
| Event | 10:13 AM | At Node B -- USB | Node A - Memory stick |
| B1 | | memory stick having | belonging to the |
| | | serial number | first user is coupled |
| | | “JIJI88812ACDQP” | Node B -- Memory stick |
| | | (i.e. belonging to | belonging to the |
| | | the third user) is | third user is coupled |
| | | coupled to a USB | |
| | | port of Node B | |
| Event | 10:22 AM | At Node A -- USB | Node A - No memory |
| A2 | | memory stick having | stick coupled |
| | | serial number | Node B -- Memory stick |
| | | “XA2312YAFIQ” | belonging to the |
| | | (i.e. belonging to | third user is coupled |
| | | the first user) is | |
| | | disconnected from a | |
| | | USB port of Node A | |
| Event | 10:40 AM | At Node A -- USB | Node A - Memory stick |
| A3 | | memory stick having | belonging to the |
| | | serial number | second user is coupled |
| | | “9232XG292ZZZ” | Node B -- Memory stick |
| | | (i.e. belonging to | belonging to the |
| | | the second user) | third user is coupled |
| | | is coupled to a USB | |
| | | port of Node A. | |
| Event | 10:59 AM | At Node B -- USB | Node A - Memory stick |
| B2 | | memory stick having | belonging to the |
| | | serial number | second user is coupled |
| | | “JIJI88812ACDQP” | Node B -- No memory |
| | | (i.e. belonging to | stick coupled |
| | | the third user) is | |
| | | disconnected from a | |
| | | USB port of Node B | |
| Event | 11:13 AM | At Node B -- USB | Node A - Memory stick |
| B3 | | memory stick having | belonging to the |
| | | serial number | second user is coupled |
| | | “XA2312YAFIQ” | Node B -- Memory stick |
| | | (i.e. belonging to | belonging to the |
| | | the first user) is | first user is coupled |
| | | coupled to a USB | |
| | | port of Node B | |
| Event | 11:16 AM | Two files are copied | Node A - Memory stick |
| B4 | | from the host | belonging to the |
| | | (Node B) to the USB | second user is coupled |
| | | memory stick | Node B -- Memory stick |
| | | XA2312YAFIQ | belonging to the |
| | | (i.e. belonging to | first user is coupled |
| | | the first user) - a | |
| | | text file and an | |
| | | MS-Word file | |
| Event | 11:19 AM | At Node A -- USB | Node A - No memory |
| A4 | | memory stick having | stick coupled |
| | | serial number | Node B -- Memory stick |
| | | “9232XG292ZZZ” | belonging to the |
| | | (i.e. belonging to | first user is coupled |
| | | the second user) is | |
| | | disconnected from a | |
| | | USB port of Node A. | |
| Event | 10:13 AM | At Node B -- USB | Node A - no memory |
| B5 | | memory stick having | stick coupled |
| | | serial number | Node B - no memory |
| | | “XA2312YAFIQ” | stick coupled |
| | | (i.e. belonging to | |
| | | the first user) is | |
| | | disconnected from a | |
| | | USB port of Node B | |
| Event | 11:33 AM | At Node A -- USB | Node A - Memory stick |
| A5 | | memory stick having | belonging to the |
| | | serial number | first user is coupled |
| | | “XA2312YAFIQ” | Node B -- no memory |
| | | (i.e. belonging to | stick coupled |
| | | the first user) is | |
| | | coupled to a USB | |
| | | port of Node A | |
| Event | 11:36 AM | Two files are copied | Node A - Memory stick |
| A6 | | from the USB memory | belonging to the |
| | | stick XA2312YAFIQ | first user is coupled |
| | | (i.e. belonging to | Node B -- no memory |
| | | the first user) to | stick coupled |
| | | the node (Node A)- | |
| | | a text file and an | |
| | | MS-Word file | |
| Event | 11:39 AM | User operating Node | Node A - Memory stick |
| A7 | | A opens on Node A | belonging to the |
| | | the MS-Word file | first user is coupled |
| | | that was copied from | Node B -- no memory |
| | | the USB memory stick | stick coupled |
| Event | 11:43 AM | At Node A -- USB | Node A - no memory |
| A8 | | memory stick having | stick coupled |
| | | serial number | Node B - no memory |
| | | “XA2312YAFIQ” | stick coupled |
| | | (i.e. belonging to | |
| | | the first user) is | |
| | | disconnected from a | |
| | | USB port of Node A | |
| Event | 11:48 AM | At Node A -- USB | Node A - memory stick |
| A9 | | memory stick having | belonging to second |
| | | serial number | user is coupled |
| | | “9232XG292ZZZ” | Node B - no memory |
| | | (i.e. belonging to | stick is coupled |
| | | the second user) is | |
| | | coupled to a USB | |
| | | port of Node A. | |

Note -
the instance of RASM installed on Node A records 9 events in the log file residing on Node A - these events are labelled Events A1-A9. Some of these events are coupling events, some are disconnect events, one of these events (i.e. event A6) is a file-copy event, and another one of these events (i.e. event A7) is a detecting of an opening of an MS-Word file imported to the node from a USB memory stick.
Note --
the instance of RASM installed on Node B records 5 events in the log file residing on Node B - these events are labelled Events B1-B5. Some of these events are coupling events, some are disconnect events, and one of these events (i.e. event B4) is a file-copy event.

### Broadcast of Data-Requesting Command; Response to Data-Requesting Commands for Example 1

At 11:56 AM, as part of the penetration testing, the remote computing device broadcasts a data-requesting command to Nodes A and B.

At 11:57, Node A responds to this broadcast data-requesting command by transmitting (i.e. via the Internet), to the remote computing device, the Node A-local USB log file including descriptions of Events A1-A9.

At 11:58, Node B responds to this broadcast data-requesting command by transmitting (i.e. via the Internet), to the remote computing device, the Node B-local USB log file including descriptions of Events B1-B5.

Analysis

At 11:59, an analysis required for determining whether there is a method for an attacker to compromise the networked system is performed exclusively at the remote computing device (i.e. by executing code of the penetration testing software module). This analysis which is performed exclusively at the remote computing device is based upon input data comprising the following:
(i) The “Windows version/update data” for Node A that is transmitted to the remote computing device at 10:01 AM from Node A indicating that Node A is a “strong node”;
(ii) The “Windows version/update data” for Node B that is transmitted to the Remote Computing Device at 10:02 AM from Node B indicating that Node B is a “weak node”;
(iii) The Node A-specific USB log file transmitted to the remote computing device at 11:57 AM from Node A; and
(iv) The Node B-specific USB log file transmitted to the remote computing device at 11:58 AM from Node B.

This analysis, which is performed exclusively at the remote computing device, is effective to conclude the following:
(A) It may not be possible for an attacker to compromise Node A via a direct attack, since the OS version is up-to-date and the latest security patches have been installed.
(B) However, it is possible for an attacker to compromise Node B using a direct attack. The old OS version found to be installed on Node B, which lacks certain security patches, is known (e.g. according to the vulnerabilities knowledge base kept by the penetration testing software module) to be vulnerable to at least one specific attack (e.g. an attack that is able to compromise a node using a known weakness in the SSL protocol, which weakness exists in that old OS version) that would result in the attacker having full control of the node.
(C) Once Node B is compromised, Node A is exposed to attack because of the uncareful behavior of the first user. The events recorded in the two USB-event log files show that the first user does not refrain from transferring files (including MS-Word files, which are known to be vulnerable to auto-executing poisoned macros) from Node B to Node A using his USB memory stick. Moreover, the first user also does not refrain from opening MS-Word files in Node A after importing them from Node B.
(D) As a result of the above, the penetration testing software module can now determine that there is a method for an attacker to achieve the goal of the penetration testing campaign—the compromising of Node A. The method to compromise is as follows: (i) directly compromise Node B by a method known for being able to compromise a Windows® workstation lacking the latest two years of security patches, (ii) once compromised, get Node B to download a poisoned macro from the attacker's website and store it on Node B, (iii) From now on, whenever detecting that an MS-Word or an MS-Excel file is being copied from Node B to a USB storage device, poison the copied file in the USB storage device by inserting into it the poisoned macro as an auto-executing macro (a macro that automatically executes when the file is opened). Additionally, a poisoned AUTOEXEC.BAT file that runs upon insertion of a USB storage device into a USB port of a node may also be copied from Node B to the USB storage device, intending that it will executed when the USB storage device is eventually inserted into other nodes (but this should not be the only measure for attacking Node A, as modern versions of operating systems are aware of the threat of AUTOEXEC.BAT file and block its execution from portable storage devices).

### Reporting

At 12 noon, the remote computing device sends an email to an email account belonging to the system administrator—the email includes information about the determined method for the attacker to compromise the networked system—see Conclusion “D” above. At this point, the penetration testing campaign, which began at 10 AM, has now concluded.

First observation about Example 1—(i) data from the USB log file of Node A is never present on Node B; (ii) data from the USB log file of Node B is never present on Node A; (iii) in order to determine the method for an attacker to compromise the networked system (i.e. to achieve the goal of the penetration testing campaign), USB log file data from both nodes A and B are required.

Conclusion—Neither the RASM instance on Node A nor the RASM instance on Node B has enough information for determining on its own that Node A can be compromised by an attacker. Only after the information collected by both RASM instances is provided to the penetration testing software module in the remote computing device and analyzed together, it becomes possible to determine the existence of a method for compromising Node A.

Second observation about Example 1—No actual attack is ever performed for validating the vulnerability of Node A, and consequently there is no risk of actually compromising Node A by the testing. Instead, an analysis of actual internal data of some network nodes is performed and an evaluation of the results of the analysis is carried out. This analysis and evaluation are performed entirely at the remote computing device.

### Use Case Example 2

Networked System/Penetration Testing System for Example 2: The second non-limiting example relates to a networked system having the following properties: (i) the networked system comprises a plurality of laptop or desktop work-stations, each of which is a network node; (ii) some of the network nodes have access to a shared folder SF which resides on a file-server on one of the nodes (“Node S”); (iii) some of the network nodes have read-only access to the shared folder SF on Node S—i.e. the nodes with read-only access can read files from the shared folder SF but cannot modify these files, and cannot add files to the shared folder SF; (iv) some nodes have both read and write privileges to shared folder SF—these nodes can modify existing files within the shared folder SF and can add new files to shared folder SF, in addition to having read access to shared folder SF; (v) nodes with read-only access and nodes that have both read and write privileges are “nodes having at least read privileges” (vi) nodes having at least read privileges of the folder can import and execute.exe executable files from the shared folder SF, and can import and open MS-Word® files that contain auto-executing macros from the shared folder SF—i.e. content or macros of these files are read into local memory of each such node and executed from the local memory; (vii) a first work-station/node (“Node A”) is “strongly defended”—on this work-station/node the most recent version of Windows® is installed including all of the latest security patches; (viii) a second work-station/node (“Node B”) is “weakly defended”—on this node, a much older version of Window has been installed, and security patches have not been installed for over two years; (ix) Node A has read-only access to shared folder SF; (x) Node B has both read and write privileges to shared folder SF.

This networked system is subjected to penetration testing.

In this example, a penetration testing software module is installed on a remote computing device which is outside of the networked system—in this example, the remote computing device is deployed in the cloud relative to the networked system, and is in networked communication with the networked system. This particular architecture is illustrated in FIG. 33.

In example 2, the terms “work-station A” and “node A” are used interchangeably. Similarly, the terms “work-station B” and “Node B” are also used interchangeably.

Goal of the Penetration Testing Campaign for Example 2: In example 2, the goal of the penetration testing campaign is for an attacker to compromise Node A—only if the attacker succeeds to compromise Node B is the penetration testing campaign considered a success.

### Timing of the Penetration Testing Campaign for Example 2:

In this second example, the penetration testing campaign commences at 1 PM on Apr. 21, 2017 and concludes at 11 PM on Apr. 21, 2017. Thus, in this example the “Commencement Time” is 1 PM on Apr. 21, 2017. Prior to the Commencement Time, the RASM is pre-installed on each node of the networked system, including Node A which is strongly-defended and Node B which is weakly-defended.

During the ten-hour penetration testing campaign, processor(s) of Node A execute code of the RASM both to ascertain status data of Node A and to “listen” to events which occur at Node A. The status data may include: (i) determining a version of an operating system executing on Node A; (ii) determining which security patches have been installed on Node A; (iii) determining whether or not Node A has read privileges for the shared folder SF; and (iv) determining whether or not Node A has write privileges for the shared folder SF. The events may include execution of an executable by processors of Node A, opening of an MS-word® file or an MS-excel® file (applications which support macros) on Node A, mouse and keyboard events on Node A, reading a file from the shared folder SF (i.e. on Node S) into Node A, execution of a file (or a macro) read from the shared folder SF into Node A.

Similarly, processor(s) of Node B execute code of the RASM both to ascertain status data of Node B and to “listen” to events which occur at Node B.

In this example, at 1:01 PM Node A (i.e. by executing code of the RASM) transmits to the remote computing device “Windows version/update data” for Node A—the Windows version/update data transmitted from Node A indicates that the most recent version of Windows® including all of the latest security patches is installed on Node A.

In this example, at 1:02 PM Node B (i.e. by executing code of the RASM) transmits to the remote computing device “Windows version/update data” for Node B—the Windows® version/update data transmitted from Node B indicates that (i) an older version of Windows® is installed on Node B and (ii) the most recent security patch installed on Node B is over two years old.

In this example, RASM code executing on Node B records the following event-Node B writes an executable file entitled “test.exe” to shared folder SF.

In this example, RASM code executing on Node A records the following events-every 60 minutes (e.g. at 1:30, at 2:30, at 3:30, etc.) Node A reads an executable file named “hourly test.exe” from shared folder SF and executes it.

### Broadcast of Data-Requesting Command; Response to Data-Requesting Commands for Example 2

At 7:56 PM, as part of the penetration testing, the remote computing device broadcasts a data-requesting command to Nodes A and B.

At 7:57 PM, Node A responds to this broadcast data-requesting command by transmitting (i.e. via the Internet), to the remote computing device, the status data and the events data of Node A, both of which are stored in volatile and/or non-volatile storage of Node A.

At 7:58 PM, Node B responds to this broadcast data-requesting command by transmitting (i.e. via the Internet), to the remote computing device, the status data and the events data of Node B, both of which are stored in volatile and/or non-volatile storage of Node B.

Analysis

At 7:59 PM, an analysis required for determining whether there is a method for an attacker to compromise the networked system is performed exclusively at the remote computing device (i.e. by executing code of the penetration testing software module). This analysis which is performed exclusively at the remote computing device is based upon input data comprising the following:
(i) The “Windows version/update data” for Node A that is transmitted to the remote computing device at 1:01 PM from Node A indicating that Node A is a “strong node”;
(ii) The “Windows version/update data” for Node B that is transmitted to the Remote Computing Device at 1:02 PM from Node B indicating that Node B is a “weak node”;
(iii) The Node A-specific status data and events data transmitted to the remote computing device at 7:57 PM from Node A; and
(iv) The Node B-specific status data and events data transmitted to the remote computing device at 7:58 PM from Node B.

This analysis, which is performed exclusively at the remote computing device, is effective to conclude the following:
(A) It may not be possible for an attacker to compromise Node A via a direct attack, since the OS version is up-to-date and the latest security patches have been installed.
(B) However, it is possible for an attacker to compromise Node B using a direct attack. The old OS version found to be installed on Node B, which lacks certain security patches, is known (e.g. according to the vulnerabilities knowledge base kept by the penetration testing software module) to be vulnerable to at least one specific attack (e.g. an attack that is able to compromise a node using a known weakness in the SSL protocol, which weakness exists in that old OS version) that would result in the attacker having full control of the node.
(C) Once Node B is compromised, Node A is exposed to attack. In particular, after compromising Node B, an attacker may employ the write privileges of Node B to the shared folder SF by copying into the shared folder SF a poisoned executable file. The reports from Node A indicate that Node A periodically executes a file having that name imported into Node A from the shared folder SF.
(D) As a result of the above, the penetration testing software module can now determine that there is a method for an attacker to achieve the goal of the penetration testing campaign—the compromising of Node A. The method to compromise is as follows: (i) directly compromise Node B by a method known for being able to compromise a Windows® workstation lacking the latest two years of security patches, (ii) once compromised, get Node B to download a poisoned executable file from the attacker's website and store it on Node B, (iii) In the next time of detecting that Node B writes into the shared folder SF, get Node B to replace the existing executable file “hourly test.exe” in the shared folder SF by the poisoned file, leaving a poisoned “hourly-test.exe” file in the shared folder.

### Reporting

At 8 PM, the remote computing device sends an email to an email account belonging to the system administrator—the email includes information about the determined method for the attacker to compromise the networked system—see Conclusion “D” above. At this point, the penetration testing campaign, which began at 1 PM, has now concluded.

First observation about Example 2—(i) data about the status and events of Node A is never present on Node B; (ii) data about the status and events of Node B is never present on Node A; (iii) in order to determine the method for an attacker to compromise the networked system (i.e. to achieve the goal of the penetration testing campaign), status and events data from both nodes A and B are required.

Conclusion—Neither the RASM instance on Node A nor the RASM instance on Node B has enough information for determining on its own that Node A can be compromised by an attacker. Only after the information collected by both RASM instances is provided to the penetration testing software module in the remote computing device and analyzed together, it becomes possible to determine the existence of a method for compromising Node A.

Second observation about Example 2—No actual attack is ever performed for validating the vulnerability of Node A, and consequently there is no risk of actually compromising Node A by the testing. Instead, an analysis of actual internal data of some network nodes is performed and an evaluation of the results of the analysis is carried out. This analysis and evaluation are performed entirely at the remote computing device.

### Use Case Example 3

Networked System/Penetration Testing System for Example 3: The third non-limiting example relates to a networked system, where email clients are installed on a plurality of the nodes including a first node (“Node A”) and a second node (“Node B”).

This networked system is subjected to penetration testing. In this example, a penetration testing software module is installed on a remote computing device which is outside of the networked system—in this example, the remote computing device is deployed in the cloud relative to the networked system, and is in networked communication with the networked system. This particular architecture is illustrated in FIG. 33.

Goal of the Penetration Testing Campaign for Example 3: In example 3, the goal of the penetration testing campaign is for an attacker to compromise Node B—only if the attacker succeeds to compromise Node B is the penetration testing campaign considered a success.

Timing of the Penetration Testing Campaign for Example 3:

In this third example, the penetration testing campaign commences at 9 AM on May 1, 2017 and concludes at 5 PM on May 2, 2017. Thus, in this example the “Commencement Time” is 9 AM on May 1, 2017. Prior to the Commencement Time (e.g. on Apr. 30, 2017), the RASM is pre-installed on each node of the networked system, including Node A and Node B.

During the thirty two-hour penetration testing campaign, processor(s) of Node A execute code of the RASM to “listen” to activity of Node A (e.g. including activity of the email client, link-clicking events, and other activities) and to store the Node-A-specific activity data of Node A on Node A. Similarly, processor(s) of Node B execute code of the RASM to “listen” to activity of Node B (e.g. including activity of the email client, link-clicking events, and other activities) to store the Node-B-specific activity data of Node B on Node B.

In particular, the RASM instance on Node A records that at 2 PM on May 1, the email client of Node A sends an email including an embedded link to Node B.

The RASM instance on Node B records that at 9:15 AM on May 2, the user of Node B opens the email using the email client of Node B and clicks on the embedded link.

Broadcast of Data-Requesting Command; Response to Data-Requesting Commands for Example 3

At 4:56 PM on May 2, as part of the penetration testing, the remote computing device broadcasts a data-requesting command to Nodes A and B.

At 4:57 PM on May 2, Node A responds to this broadcast data-requesting command by transmitting (i.e. via the Internet), to the remote computing device, the Node A-local data including the activity data specific to Node A.

At 4:58 PM on May 2, Node B responds to this broadcast data-requesting command by transmitting (i.e. via the Internet), to the remote computing device, the Node B-local data including the activity data specific to Node B.

Analysis

At 4:59 PM on May 2, an analysis required for determining whether there is a method for an attacker to compromise the networked system is performed exclusively at the remote computing device (i.e. by executing code of the penetration testing software module). This analysis which is performed exclusively at the remote computing device is based upon input data comprising the following:
(A) Node A is known to send emails to Node B;
(B) The user of Node B is known to open emails received from Node A and to click on embedded links appearing in those emails;
(C) Results of additional analysis performed on the remote computing device (i.e. using input data including input data from the RASM instance(s)) indicate that Node A gets compromised during the penetration testing campaign;

This analysis, which is performed exclusively at the remote computing device, is effective to conclude the following:
(A) Since Node A can get compromised, an attacker may take control of Node A and embed poisoned links (i.e. linking to a poisoned executable residing on the cloud on the attacker's server) into outgoing emails sent from the email client on Node A;
(B) Node B is exposed to attack because of the uncareful behavior of the user of Node B—i.e. the user of Node B is known to click on links received in emails coming from Node A. The method of compromising Node B is to first compromise Node A, and then to embed in outgoing emails leaving the email client of Node A poisonous links.

Reporting

At 5 PM on May 2, the remote computing device sends an email to an email account belonging to the system administrator—the email includes information about the determined method for the attacker to compromise the networked system—see Conclusion “B” above. At this point, the penetration testing campaign, which began at 9 AM on May 1, has now concluded.

First observation about Example 3—(i) data about the status and events of Node A is never present on Node B; (ii) data about the status and events of Node B is never present on Node A; (iii) in order to determine the method for an attacker to compromise the networked system (i.e. to achieve the goal of the penetration testing campaign, which in this example is the compromising of Node B), status and events data from Node B are required. However, in this example events data from Node A are not necessarily required for determining the method for an attacker to compromise the networked system—once the remote computing device learns from Node B reports that the user of Node B does not refrain from clicking links embedded in emails received from Node A, it knows that Node B can be compromised if Node A is first compromised. Note that even though Node A may report events of sending emails with embedded links to Node B, the remote computing device may make its determination even without relying on those reported events. However, the remote computing device still needs to know that Node A can be compromised, for example by utilizing a known weakness in its version of operating system, and therefore some status reports from Node A may still be required for making the determination.

Conclusion—Neither the RASM instance on Node A nor the RASM instance on Node B has enough information for determining on its own that Node A can be compromised by an attacker. Even though the RASM instance of Node B can determine that Node B can be compromised if Node A is already compromised, it cannot know whether Node A can be compromised. Only when the information collected by both RASM instances is provided to the penetration testing software module in the remote computing device and analyzed together, it becomes possible to determine the existence of a method for compromising Node B.

Second observation about Example 3—As was the case in Examples 1 and 2, no actual attack is ever performed for validating the vulnerability of Node A, and consequently there is no risk of actually compromising Node A by the testing. Instead, an analysis of actual internal data of some network nodes is performed and an evaluation of the results of the analysis is carried out. This analysis and evaluation are performed entirely at the remote computing device.

A Discussion of FIGS. 32-35

Embodiments of the invention relate to penetration testing of networked systems, such as that illustrated in FIG. 32.

Embodiments of the invention are described below with reference to a networked system of an organization which contains multiple network nodes. The nodes of the networked system may be of different types—different computer hardware, different operating systems, different applications, different resources (printers, communications devices, etc.), etc.

FIG. 33-34 illustrate examples of penetration testing systems according to embodiments of the invention. In each of these examples, the penetration testing system comprises a penetration testing software module (PTSM) 260 installed on a remote computing device and a reconnaissance agent software module (RASM) 270 installed on at least some network nodes of the networked system 200.

In the example of FIG. 33, the remote computing device (i.e. on which the PTSM 260 is installed) is first NS-external node 254 which is in communication with the networked system 200 by an Internet connection. In the example of FIG. 34, the remote computing device (i.e. on which the PTSM 260 is installed) is second NS-external node 252 which is in communication with the networked system 200 via a local-area network (LAN).

As noted above, any network node on which the RASM is installed is defined as a RASM-hosting network node. Thus, in the example of FIGS. 33-34, only the following nodes are RASM-hosting network nodes: N104, N016, N102, N103, N108, N116 and N117.

As will be discussed below, in embodiments of the invention, PTSM 260 and RASM 270 cooperate to collectively subject the networked system 200 to penetration testing. In different embodiments of the invention, the penetration testing test may be performed according to the methods described in any of FIGS. 35, 36, 37A-37B, 39A-39C, and/or 40A-40C.

For example, the penetration testing of the networked system 200 (i.e. performed by execution of PTSM 260 and RASM 270 on their respective hosts) may include both of the following operations: (i) collecting internal data by the RASM 270 of two or more network nodes of networked system 200 (e.g. each RASM 270 collects respective internal data of its RASM-hosting network node and transmits this internal data to the PTSM 260); and (ii) analyzing this data by the PTSM 260 to determine a method for the attacker to compromise the networked system 200.

FIG. 35 illustrates an example where PTSM 260 is installed on a physically remote computing device 350; and the RASM is installed on each node 300[i] of a set of N network-nodes, {300[1], 300[2], . . . 300[N]} where N is a positive integer (N≥2), and i is an index that runs between 1 and N. Each node 300[i] corresponds to a different node of networked system 200.

The label 350 for the remote computing device refers to any remote computing device on which the PTSM 260 is installed. As noted above, for the example of FIG. 33, remote computing device 350 corresponds to the first NS-external node 254 while in the example of FIG. 34, remote computing device 350 corresponds to node 252.

Thus, in the example of FIG. 35, node 300[1] (e.g. in particular, the instance of RASM 270 which is installed on node 300[1]) receives one or more data-requesting commands from remote computing device 350 (e.g. data-requesting commands issued by PTSM 260—i.e. when processor(s) of remote computer device 350 execute code of PTSM 260).

Each RASM-hosting network node 300[i] executes code of RASM 270. Execution of code of RASM 270 by one or more processor(s) of each RASM-hosting network node 300[i]: (i) obtains respective internal data specific to RASM-hosting network node 300[i]; and (ii) respectively transmits the internal data to the remote computing device 350 (e.g. to PTSM 260 executing on remote computing device 350).

Thus, execution by RASM-hosting network node 300[1] of code of RASM 270: (i) obtains internal data specific to node 300[i]; (ii) transmits, to remote computing device 350, the internal data specific to node 300[1]. Execution by RASM-hosting network node 300[2] of code of RASM 270: (i) obtains internal data specific to node 300[2]; (ii) transmits, to remote computing device 350, the internal data specific to node 300[2]. And so on.

The internal data specific to RASM-hosting network node 300[i] (i.e. i is an index that runs between 1 and N) includes data about at least one of: A. an internal event of the RASM-hosting network node 300[i], B. an internal condition of the RASM-hosting network node 300[i], and C. an internal fact of the RASM-hosting network node 300[i].

In the specific example of FIG. 35, the RASM-hosting network node 300[i] may obtain the internal data and/or transmit the internal data in response to data-requesting command(s) received by the RASM-hosting network node 300[i] from the remote computing device 350. For example, the obtaining of the internal data and/or the transmitting thereof may only occur if the data-requesting command(s) is received by the RASM-hosting network node 300[i].

A Discussion of FIG. 36

FIG. 36 is a flow-chart of a method of penetration testing that is performed to enforce both of the following two rules:

First Rule—according to the first rule, all of the analyzing of the internal data for determining the method for the attacker to compromise the networked system is performed by the remote computing device rather than at the RASM-hosting nodes.

In some embodiments, this may be useful, for example, for minimizing the CPU burden of penetration testing imposed on each of the nodes of the penetration-tested networked system. Alternatively or additionally, this may be useful for updating—e.g. when new threats need to be added to a threat-database, there is no need to update this threat-database on each of the nodes. Instead, the threat-database may be updated only on the remote computing device.

Second Rule—in contrast to penetration testing systems in which the nodes of the networked system 200 are subjected to an actual attack, no network node of the networked system is ever put at risk of being compromised by the executing of the penetration test.

In embodiments of the invention, even though no network node is put at risk (“Second Rule”), thanks to the RASM 270 installed on a plurality of nodes 300[i] of the networked system, the penetration testing may be performed in a manner which accurately reflects the current status of the networked system.

Thus, FIG. 36 is a method for executing a penetration test of a networked system by a penetration testing system so as to determine, while enforcing first and second rules, a method for an attacker to compromise the networked system, where the penetration testing system comprises (A) a penetration testing software module installed on a remote computing device and (B) a reconnaissance agent software module (RASM) installed on at least some network nodes of the networked system so that each network node of the networked system on which the RASM is installed is defined as a RASM-hosting network node.

The method of FIG. 36 comprises the following steps:

Step S201—step S201 includes obtaining, by each given RASM-hosting network node 300[i] (i.e. i is an index that runs between 1 and N) of one or more RASM-hosting network nodes of networked system 200, respective internal data of the given RASM-hosting network node 300[i]. The obtaining of step S201 comprises executing computer code of the RASM 270 by one or more processors of the given RASM-hosting network node 300[i].

The respective internal data (i.e. related to node 300[i]) includes data about at least one of: A. an internal event of the given RASM-hosting network node 300[i], B. an internal condition of the given RASM-hosting network node 300[i], and C. an internal fact of the given RASM-hosting network node 300[i].

In some embodiments, for at least one of the RASM-hosting network nodes, step S201 is performed in response to a data-requesting command received by the RASM-hosting network node from the remote computing device. In other embodiments, the RASM executing on the RASM-hosting network node may not require a data-requesting command—for example, the RASM may periodically (e.g. once every minute) update a log of internal data stored in volatile or non-volatile memory of the RASM-hosting network node.

Step S205—step S205 includes transmitting to the remote computing device 350 (e.g. 254 of FIG. 33 or 252 of FIG. 34 or 290 of FIG. 38), by each given RASM-hosting network node300[i] of the one or more RASM-hosting network nodes of networked system 200, the obtained respective internal data of the given RASM-hosting network node 300[i]. The transmitting of step S205 comprises executing computer code of the RASM by the one or more processors of the given RASM-hosting network node 300[i].

In some embodiments, for at least one of the RASM-hosting network nodes, step S205 is performed in response to a data-requesting command received by the RASM-hosting network node from the remote computing device. In other embodiments, the RASM executing on the RASM-hosting network node may not require a data-requesting command—for example, the RASM may be programmed to periodically (e.g. once every minute) transmit internal data stored in volatile or non-volatile memory of the RASM-hosting network node from the RASM-hosting network node to the remote computing device.

Step S209—step S209 includes analyzing, by the remote computing device 350 (e.g. 254 of FIG. 33 or 252 of FIG. 34 or 290 of FIG. 38), the internal data transmitted (i.e. in step S205) by at least one RASM-hosting network nodes 300[i] of the one or more RASM-hosting network nodes. The analyzing of step S209 is performed so as to determine the method for the attacker to compromise the networked system 200. The analyzing of step S209 comprises executing computer code of the penetration testing software module 260 by one or more processors of the remote computing device (e.g. 254 of FIG. 33 or 252 of FIG. 34 or 290 of FIG. 38).

Step S213—step S213 includes reporting, by the penetration testing system the method for the attacker to compromise the networked system 200. The reporting may comprise executing computer code of the PTSM 260 by the one or more processors of the remote computing device 350 (e.g. 254 of FIG. 33 or 252 of FIG. 34 or 290 of FIG. 38). The reporting may comprise at least one of:

(i) causing a display device [NOT SHOWN—e.g. an LCD screen or any other electronic display device] to display a report including information about the determined method for the attacker to compromise the networked system,

(ii) recording the report including the information about the determined method for the attacker to compromise the networked system in a file, and

(iii) electronically transmitting the report including the information about the determined method for the attacker to compromise the networked system.

In different examples, the information about the determined method for the attacker to compromise the system may comprise one or more of: (i) information about a method for compromising one network node of the networked system (ii) information about one or more network nodes of the networked system which are vulnerable to attack, (iii) information about one or more resources of the networked system that could be damaged or exported out of the networked system by an attacker, and (iv) information about an ordered list of network nodes of the networked system, wherein an attacker could use a specific network node in said ordered list that is already compromised as a basis for compromising another network node that immediately follows said specific network node in said ordered list.

In some embodiments, each given RASM-hosting network node 300[i] of the one or more RASM-hosting network nodes performs at least one of step S201 and step S205 in response to a receiving (i.e. by the RASM-hosting network node 300[i]) of one or more data-requesting commands (e.g. see FIG. 35) from the remote computing device 350 (e.g. 254 of FIG. 33 or 252 of FIG. 34 or 290 of FIG. 38).

Discussion of FIGS. 37A-37B

Reference is now made to FIG. 37A. In some embodiments, instead of a situation where all RASM instances 270 are installed on the network nodes after the penetration test has commenced, the method may be performed such that one or more RASM instances 270 are pre-installed (i.e. in step S2101) on at least some of (e.g. on all of) the RASM-hosting network nodes 300[i] prior to beginning of the execution of the penetration test. According to the example of FIG. 37A, only after the one or more (e.g. at least some of, or all of) of the RASM instances 270 are installed on one or more RASM-hosting network nodes 300[i] does the penetration test begin. In step S2151, the networked system 200 is subjected to a penetration test using the one or more pre-installed RASM instances.

Alternatively or additionally, and as shown in FIG. 37B, the method of FIG. 37A may be performed in a manner that enforces at least one of: (i) a first rule and (ii) a second rule. According to the first rule, all of the analyzing of the internal data (i.e. from the RASM-hosting nodes 300[i]) for determining the method for the attacker to compromise the networked system 200 is performed by the remote computing device 350 of FIG. 35 (e.g. 254 of FIG. 33 or 252 of FIG. 34 or 290 of FIG. 38).

According to the second rule, no network node of the networked system 200 is ever put at risk of being compromised by the executing of the penetration test.

In some embodiments, the method of FIG. 37B is performed to enforce only the first rule and not the second rule. In some embodiments, the method of FIG. 37B is performed to enforce only the second rule and not the first rule. In some embodiments, the method of FIG. 37B is performed to enforce both the first and the second rules.

A Discussion of FIG. 38

FIGS. 33-34 and 38 illustrate examples of penetration testing systems where a reconnaissance agent software module (RASM) is installed on multiple nodes of the networked system, where the RASM together with a penetration testing software module (PTSM) subject the networked system to penetration testing.

In the example of FIG. 38, the remote computing device (i.e. on which the PTSM 260 is installed) is one of the nodes of the networked system 200—in this case node N114. For example, PTSM 290 may run on a virtual machine installed on top of the Operating System of node N114. Optionally, no RASM 270 is installed on the node N114.

FIGS. 33-34 and 38 illustrate examples of penetration testing systems where a reconnaissance agent software module (RASM) is installed on multiple nodes of the networked system, where the RASM together with a penetration testing software module (PTSM) subject the networked system to penetration testing.

A Discussion of FIGS. 39A-39C and 40A-40C

It is noted that FIGS. 39A-39C and 40A-40C relate to two different methods of penetration testing. However, the skilled artisan will appreciate that in some embodiments, features of these two methods may be combined.

Embodiments of the invention relate to a method of testing a networked system by a reconnaissance agent penetration testing system and include the following steps.

In a first step the penetration testing software module is installed on a remote computing device. The remote computing device may be a server located outside the tested networked system and owned by a different company than the organization owning the tested networked system. In such case the server is typically owned by a company which provides the testing as a service, including providing the penetration testing tool. Alternatively, the remote computing device may be a server located outside the tested networked system and owned by the organization owning the tested networked system or the remote computing device may be a cloud computing resource operating in the service of the organization owning the tested networked system. In such cases the testing is typically carried out by the organization owning the tested networked system, which may obtain the penetration testing tool from an external source or develop it in-house. Alternatively, the remote computing device may be a network node of the tested networked system.

In all the above alternatives, the remote computing device may be a dedicated computing device that is dedicated only to the penetration testing process or it may be a non-dedicated computing device that also performs other functionality in addition to the penetration testing process.

The penetration testing software module may be installed from scratch for each new penetration test, but typically it is persistently installed on the remote computing device and is not uninstalled or otherwise removed between tests.

In a second step, the reconnaissance agent is installed on multiple network nodes of the tested networked system. The network nodes on which the reconnaissance agent is installed are typically all the network nodes of the portion of the networked system that is tested in the current test. That portion may be the full tested networked system or only a subset of it. For example, in a large company the current test may be directed only to the sales organizational unit, in which case only network nodes belonging to the sales organizational unit get installed with the reconnaissance agent. The installation of the reconnaissance agent on a network node may be either persistent or non-persistent.

In a third step, initial conditions are set for the test. The initial conditions include an identification of which of the network nodes of the tested networked system should be assumed to be already compromised at the beginning of the test. The list of network nodes assumed to be already compromised at the beginning of the test may include zero, one or multiple network nodes. Other initial conditions for the test may also be set. For example, the type and capabilities of the attacker against whom the testing process should run the test, the goals of the attacker in his current attack, etc.

In a fourth step the reconnaissance function is started. This function collects data about the tested networked system, and optionally also other types of data such as business intelligence data about the organization owning the tested networked system. The collection of data about the tested networked system includes at least the following sub-steps.

In a first sub-step of the fourth step, at least one command is sent from the remote computing device to a group of one or more of the network nodes on which the reconnaissance agent is installed. The at least one command originates from the penetration testing software module and is received by the respective reconnaissance agent installed on each addressed network node. The at least one command instructs each of the receiving instances of the reconnaissance agent to collect internal data about the network node hosting it. The at least one command may also instruct each of the receiving instances of the reconnaissance agent to collect other data about the networked system, which is not internal data of the network node on which that instance of the reconnaissance agent is installed.

In a second sub-step of the fourth step, each instance of the reconnaissance agent that received the at least one command collects internal data of the network node on which it is installed, and possibly also other data about the tested networked system.

In a third sub-step of the fourth step, each network node that received the at least one command sends one or more messages to the remote computing device. The one or more messages sent by a network node originate in the corresponding reconnaissance agent installed on that network node. Each message contains data collected by the corresponding instance of the reconnaissance agent installed on the network node that sent it.

In a fifth step the one or more messages of all sending network nodes are received by the penetration testing software module.

In a sixth step, the attack function is started. The penetration testing software module determines, based on data contained in at least one of the messages received from one of the network nodes and based on the current state of the list of already compromised network nodes, whether a network node that was previously not included in the list of already compromised network nodes can now be compromised and should be added to the list. Typically, but not necessarily, the determination of which network node will be the next one to be added to the list is based on data contained in multiple messages received from multiple network nodes, and possibly on data contained in all messages received from all sending network nodes.

A network node is determined to be compromiseable by an attacker if the attack function determines that an attacker can successfully cause execution of an operation in the network node that is not allowed for the attacker by the rules defined by an administrator of the network node or can successfully cause execution of an operation in a software module of the network node that was not predicted by the vendor of the software module. The determination that a new network node can now be compromised is achieved without risking compromising the networked system. That is—the determination is achieved by simulation or by some other method of evaluation, for example by relying on one or more databases that store knowledge about known methods of compromising networks or computing devices. The determination does not attempt to verify an assessment that a given operation or sequence of operations may successfully compromise the network node by actually performing the operation or sequence of operations and then checking if the network node was compromised or not.

In a seventh step, the fourth, fifth and sixth steps are iteratively repeated. In each iteration one or more commands are sent to one or more network nodes, internal data is collected in the addressed network nodes, one or more messages are sent from each of the addressed network nodes to the remote computing device, and the penetration testing software module determines whether a new network node can be compromised and should be added to the list of already compromised networked nodes, all that done without risking compromising the tested networked system. The determination of which network node will be the next one to be added to the list may be based not only on messages received during the present iteration, but also on messages received during previous iterations. The iterations continue until one of: (i) the attack function determines that a security vulnerability exists in the tested networked system and that vulnerability might be utilized by an attacker for the disadvantage of the organization owning the tested networked system or of a user of one of the network nodes, or (ii) the penetration testing system gives up on finding a security vulnerability in the tested networked system.

In an eighth step, if the attack function had determined that a security vulnerability exists in the tested networked system, the reporting function generates at least one report based on the identified vulnerability and possibly also based on additional data prepared by the attack function. The at least one report contains at least one of (i) a list of network nodes which are vulnerable to attack. The list may include network nodes that are not directly subject to attack from outside the networked system, but can be compromised after other network nodes in their vicinity are compromised, (ii) a damage assessment including a list of resources in the networked system that could be damaged or exported out of the networked system by an attacker. The damaged or exported resources may be files that might be corrupted or deleted by an attacker, files that might be exported out of the networked system by an attacker, peripheral devices that might be shut-down by an attacker, etc. Additionally, a damage assessment may include a list of services provided to employees of the organization or to outside customers that might fail to operate, (iii) a trajectory (an ordered list of network nodes) across the networked system according to which an attacker could advance by using a network node that was already compromised as a basis for compromising the next network node in the list.

If the attack function had determined that multiple security vulnerabilities exist in the tested networked system, the reporting function generates at least one report according to the above for each vulnerability.

If the attack function had determined that no security vulnerability could be found, the reporting function generates a report saying so.

In a ninth step, any reports generated in the previous step are output by the reporting function. A report may be output to a screen of a network node, output to a screen of the remote computing device, sent by mail to one or more network nodes, sent by mail to the remote computing device, sent by mail to a predefined address, sent by any delivery method to any destination, or any combination of the above. Typically, the reports are addressed to the CISO of the organization owning the tested networked system or to its administrator.

Once the components of the penetration testing system are installed (see the first and second steps), the above other steps are carried out automatically. As explained in the third step above, a user who initiates a test does it by first defining parameters for the testing process—the portion of the network to be covered in the test, types of threats that have to be taken into account, initial network nodes that are assumed to be already compromised by the attacker when the test starts, etc. The rest of the penetration testing process then proceeds without human intervention until the report(s) are presented or sent out.

The proposed reconnaissance agent penetration testing system eliminates the deficiencies of the prior art penetration testing systems described above. The collection of internal data of network nodes is achieved by installing instances of the reconnaissance agent on network nodes of the tested networked system. The installation is done prior to starting the test and in consent and cooperation with the organization owning the tested networked system. The code of the reconnaissance agent is executed by a processor of each network node on which it is installed and therefore has direct access to all internal data of the hosting network node. If issues of access rights are raised for the reconnaissance agent then they can be resolved ahead of the test by the networked system's administrator by either allocating the reconnaissance agent higher access rights or deciding that certain internal data will not be used by the test.

### Second Discussion of Additional Embodiments

The invention, in some embodiments, relates to penetration testing of a networked system, and specifically to detecting opportunistic vulnerabilities in a network node of a networked system.

The present invention provides a solution to the challenges discussed hereinabove with respect to the prior art, and specifically provides a penetration testing system that detects opportunistic vulnerabilities triggered by free events of a network node.

The proposed solution is an automatic penetration testing system that is capable of detecting opportunistic vulnerabilities, including ones associated with free events, and including ones associated with internal events. The solution is based on a reconnaissance client agent software module, which is installed in multiple nodes of the tested networked system and is capable of detecting and reporting events occurring in the hosting node. The events may be associated with opportunistic vulnerabilities, including when the events are free events and/or internal events. A block diagram of the penetration testing system of the proposed solution is shown and described hereinbelow with respect to FIG. 41.

A reconnaissance client agent according to the present invention is a software module that may be installed on a network node and may be executed by a processor of that network node, for partially or fully implementing the reconnaissance function of a penetration test. The reconnaissance agent must be able, when executed by a processor of the network node in which it is installed, to collect data about at least some of the events occurring in the network node. Such events may be internal events of the network node, or messages sent out of the network node or received by the network node. The reconnaissance client agent may be able to collect data about all types of internal events of its hosting network node. Additionally, the reconnaissance client agent may be able to collect other types of data regarding its hosting network node. The reconnaissance client agent may additionally be able to collect data about other network nodes or about other components of a networked system containing its hosting network node. The reconnaissance client agent can communicate with a server executing penetration testing code and can report any collected data to the server. The collected data may include (but is not necessarily limited to) data about multiple types of events occurring in the hosting node or in the network nodes to which the hosting node is connected.

The reconnaissance client agent of the present invention is an opportunistic reconnaissance agent, capable of detecting and reporting events associated with opportunistic vulnerabilities, including when the events are internal to the network node in which they occur. In some embodiments, it is also a free event reconnaissance agent, capable of detecting and reporting not only events occurring in the hosting network node that have external causes or triggers, but also free events that occur asynchronously relative to external causes and do not depend on any external causes.

Examples of events triggered by external causes include a network node receiving a network message from another network node, transmission of a network message by a network node as an answer to a previously-received incoming network message, etc. Examples of free events not triggered by external causes include insertion and removal of a USB storage device (which are also examples of internal events), transmission of a network message as a result of a manual user command (as in the case of submitting a query to a web server following a user's manual input), transmission of a network message as a result of an internal and independent process of the network node (as in the case of initiating a WPAD message in order to access a URL required by a locally running application), etc.

A free event reconnaissance agent must be able to detect at least some occurrences of at least one type of free events occurring in the network node in which it is installed.

The penetration testing system of the present invention further includes a penetration testing software module installed on a remote computing device. The remote computing device may be a dedicated server that executes only functions of penetrations testing, but may also be a shared computer that also performs other functions in addition to penetration testing.

The remote computing device, and consequently the penetration testing software module installed thereon, receive reports sent by all the reconnaissance client agents installed in all the network nodes included in the test. The penetration testing software module then identifies in the reports (among other things) events that are known to be potentially or unconditionally associated with opportunistic vulnerabilities, based on pre-defined rules. For each such opportunistic vulnerability, the penetration testing software module then determines whether it might be used to advantage by an attacker under the current circumstances in the currently tested networked system.

Such determination can be achieved by one or more of the following methods:

i. Actually generating the potential attack (for example by responding to an ARP request message with a false ARP reply message containing a false MAC address) and checking if the target node is indeed compromised.

ii. Simulating the potential attack without attempting to compromise the tested networked system. This can be done by fully simulating the tested network with both hardware and software simulation, or by using only software simulation.

iii. Evaluating the results of the potential attack without simulating it. For example, the penetration testing server may employ a pre-defined rule according to which, if a hostile node (already compromised by the attacker) is able to capture a WPAD request from another node and the browser submitting the request is Internet Explorer version 8.0 or earlier, it can be assumed that the attack would succeed.

Following a determination that a potential opportunistic vulnerability is indeed exploitable by attackers of the tested networked system, the penetration testing software module reports its findings to the penetration testing system's operator and/or to the tested networked system's administrator and/or to the CISO of the organization owning the tested networked system, possibly as part of a comprehensive report containing findings about multiple vulnerabilities, whether opportunistic or not. For each reported opportunistic vulnerability, the reported findings include at least an identification of the opportunistic vulnerability. Typically, the reported findings also include an identification of the event associated with the opportunistic vulnerability (regardless if it is a free event or not), and some information about the method by which an attacker might use that event to compromise the networked system.

The opportunistic reconnaissance agent of the present invention may achieve detection of free events, whether internal or not, by closely monitoring certain components of its hosting network node that are known to be potential sources of such events. Non-limiting examples of such elements include:
i. Input and output ports of the hosting network node. As explained above regarding the USB drive example, insertion (and sometimes also removal) of a device into/from an interface port might create an opportunity for compromising the hosting node. Therefore, the opportunistic reconnaissance agent of the present invention looks for such events.
   This may be accomplished, for example, by capturing the interrupt generated by physical insertion or removal of devices, identifying the details of the event which are of use to the penetration testing reconnaissance agent, and then dispatching the interrupt to an appropriate software driver or handler whose function is to handle that interrupt under normal circumstances (when the reconnaissance agent is not installed in the network node). Many operating systems provide well-documented methods for implementing interrupt capturing, and chaining of interrupt handlers, as required for implementing the above method.
   Even without using interrupt capturing, detection of insertion of a USB drive or of any other type of removable drive can be achieved using any of the well-known methods in the following non-exhaustive list:
   a. Enumerating of all mounted storage volumes or all physically-attached drives of the type of the monitored port, by periodically submitting polling requests. On Windows operating systems, this can be done with a WIN32 API call, with a WMI (Windows Management Instrumentation) query, with a PowerShell script, or in any other way.
   b. Registering for event notification when a new volume is mounted or physically attached (which is functionally equivalent to the interrupt capturing method described above). On Windows operating systems, this can be done with a WIN32 API call, with a WMI query, or in any other way.
ii. Receipt of incoming network messages, and transmission of outgoing network messages. As explained above with respect to the ARP and WPAD protocols examples, transmissions of certain types of messages of certain network protocols from a network node might create opportunities for compromising that node. Similarly, receipt of certain messages of certain network protocols by a network node might also create opportunities for compromising that node. For example, a message of a certain type of a certain protocol might be known to cause a buffer overflow in the network driver in case it is longer than a given length, which buffer overflow might then be used by an attacker to compromise the network node.
   Therefore, the opportunistic reconnaissance agent of the present invention looks for events of incoming and outgoing messages, and then determines whether any detected message satisfies the conditions making it an event that may (potentially or unconditionally) trigger an opportunistic vulnerability. The tested conditions may relate to the length of the message, its protocol, its sender, or any other of its features.
   Monitoring for relevant network messages may be carried out using methods that are well known in the art and are similar to the methods mentioned above in the USB drive example—the reconnaissance agent may insert itself into the chain of handlers associated, by the local operating system, with handling network messages. This ensures that the reconnaissance agent achieve its goal of detecting messages of interest to penetration testing without disturbing in any way the normal operation of its hosting node.
   To be more specific, detection of ARP or WPAD messages can be accomplished using any sniffer or packet filter, after configuring it with a specific filter that recognizes ARP or WPAD packets. The most common packet filter implementations in Windows operating systems are those using the PCAP library. On the Linux operating system, one can use the TCPDUMP utility with the appropriate filter.

Thus, the penetration testing system of the present invention is superior to prior art penetration testing systems in being able to detect a variety of opportunistic vulnerabilities, including opportunistic vulnerabilities associated with free events and opportunistic vulnerabilities associated with events that are internal events of their corresponding network nodes. This is achieved by using an opportunistic reconnaissance agent installed on the network nodes included in the test, which detects and reports events potentially or unconditionally associated with opportunistic vulnerabilities. The detected events may include free events potentially or unconditionally associated with opportunistic vulnerabilities, and may also include internal events of the node hosting the opportunistic reconnaissance agent potentially or unconditionally associated with opportunistic vulnerabilities.

The identified events that are potentially or unconditionally associated with opportunistic vulnerabilities are reported to the penetration testing software module, which determines whether, under the current circumstances, a given event is indeed associated with an opportunistic vulnerability. If so, the vulnerability, and in some embodiments also the event associated therewith, are reported by the penetration testing system.

It should be noted that the reconnaissance agent cannot always know whether an identified event is associated with an opportunistic vulnerability or not, as this might require knowledge not in the possession of the agent. For this reason, the reconnaissance agent of the present invention is said to detect “events potentially or unconditionally associated with opportunistic vulnerabilities”. For example, a reconnaissance agent detecting sending a query from its hosting node to a web server cannot tell whether this event is currently associated with an actual opportunistic vulnerability. This question depends on whether the server to which the query is addressed is currently compromised by the attacker or not. If the server is currently compromised, then the event is currently associated with a real vulnerability that can be exploited in the next occurrence of such a query event. Otherwise, if the server is currently not compromised, then the event is currently not associated with a real vulnerability.

Therefore, it is essential to have a separation between the detection of events and the identification of the currently relevant opportunistic vulnerabilities—the former is accomplished within the network nodes by the reconnaissance agents, while the latter is accomplished in the remote computing device by the penetration testing software module, that is in possession of the knowledge required for determining whether a potential vulnerability is indeed a real vulnerability under the current circumstances.

Obviously, in some cases, the reconnaissance agent can tell that a given event is associated with an opportunistic vulnerability, because such determination does not require extra knowledge not available to the agent (e.g. it is an unconditional association). In such a case the reconnaissance agent may have reported the associated vulnerability and not just the event. However, in order for all opportunistic vulnerabilities to be handled the same way, the reconnaissance agent of the proposed penetration testing system reports only the identified events for all events and leaves the determination of the relevant opportunistic vulnerabilities to the penetration testing software module.

Reference is now made to FIG. 41, which is a schematic illustration of a networked system 3200 including a system for discovering and reporting a security vulnerability of the networked system, according to an embodiment of the present invention.

As seen in FIG. 41, the networked system 3200 (indicated by a dashed oval in FIG. 41) includes a plurality of network nodes 3202 interconnected by one or more networks 3204. For clarity, details of the structure of the network nodes 3202 are illustrated and described with respect to a single network node 3202, but may be equally applicable to all other network nodes.

As seen, the network node 3202 includes one or more processors 3206, illustrated in FIG. 41 as a single processor, and is in electronic communication, for example via network(s) 3204, with a remote computing device 3208, which includes one or more processors 3210.

A system for discovering and reporting a security vulnerability of the networked system 3200 includes a reconnaissance agent storage medium 3212, and a penetration testing storage medium 3214.

The reconnaissance agent storage medium 3212 may be a non-transitory computer readable storage medium and includes instructions to be executed by processor(s) 3206 of the network node 3202 on which the reconnaissance agent in installed and which is in electronic communication with remote computing device 3208.

Specifically, reconnaissance agent storage medium 3212 has stored:

instructions 3216 to detect at least some free events occurring in network node 3202; and instructions 3218 to transmit data about occurrences of the detected free events to remote computing device 3208.

In some embodiments, the instructions 3216 include instructions to detect at least some internal events occurring in network node 3202.

The penetration testing storage medium 3214 may be a non-transitory computer readable storage medium, and includes instructions to be executed by processor(s) 3210 of remote computing device 3208. Specifically, penetration testing storage medium 3214 has stored:

instructions 3220 to receive a message from network node 3202, the message notifying remote computing device 3208 of a specific occurrence of a specific free event in network node 3202; and

instructions 3222 to identify, based on the received message, a specific opportunistic vulnerability with which the specific free event is associated.

In some embodiment, the specific free event is one of:
a) sending a network message out of network node 3202, caused by a command from a user of the network node, by an operating system of the network node, and/or by a software application installed on the first network node;
b) mounting a storage volume onto network node 3202; and
c) physically attaching a physical device to network node 3202.

In some embodiments, the instructions 3222 to identify a specific opportunistic vulnerability, include:

instructions 3222a to identify a method for an attacker to compromise network node 3202;

instructions 3222b to identify that the method to compromise would be available to the attacker at or after a future occurrence of the specific free event in network node 3202; and

instructions 3222c to report the specific opportunistic vulnerability, including at least one of: (i) instructions to cause a display device to display information about the specific opportunistic vulnerability, (ii) instructions to store the information about the specific opportunistic vulnerability in a file, and (iii) instructions to electronically transmit the information about the specific opportunistic vulnerability.

In some embodiments, the penetration testing is an actual attack penetration testing, and instructions 3222 include instructions to execute the method for an attacker to compromise network node 3202, so as to validate that network node 3202 is compromised by this method.

In other embodiments, the penetration testing is a simulated penetration testing, and instructions 3222 include instructions to simulate or otherwise evaluate the method for an attacker to compromise network node 3202, so as to validate that network node 3202 would be compromised by this method, without attempting to actually compromise network node 3202.

Reference is now additionally made to FIG. 42, which is a flow chart of a method for discovering and reporting a security vulnerability of a networked system, such as networked system 3200 of FIG. 41, according to an embodiment of the invention.

At step 3300, the remote computing device 3208, and specifically the penetration testing software module installed therein, receives a message from network node 3202, and specifically from the reconnaissance agent software module installed thereon, for example by carrying out instructions 3220 of penetration testing memory 3214. The message notifies the penetration testing module of a specific occurrence of a specific free event in the network node 3202, for example as detected by carrying out instructions 3216 and transmitted by carrying out instructions 3218 stored in reconnaissance agent memory 3212.

In some embodiments, the specific free event is an internal event of network node 3202.

In some embodiments, the specific free event includes sending a network message out of network node 3202. Such sending may be caused by a command from a user of network node 3202, by an operating system of network node 3202, or by a software application installed on network node 3202.

As discussed hereinabove, such sending of a network message out of network node 3202 may include submission of a query from the network node 3202 to a server, sending an ARP request message out of network node 3202, or sending a WPAD message out of network node 3202.

In some embodiments, the specific free event includes mounting a storage volume onto network node 3202.

In some embodiments, the specific free event includes physically attaching a physical device to network node 3202. The physical device may be a storage device, such as attaching a removable USB storage device to a USB port of the network node 3202, and may be a communication device attached to a suitable port of network node 3202.

In some embodiments, the message is sent by the reconnaissance agent software module of network node 3202, immediately after and in response to detection of the specific occurrence of the specific free event in network mode 3202.

For the purposes of the present application and claims, the term “immediately after” relates to sending of the message being initiated no later than 100 milliseconds from completing the detection. If delays occur due to the communication hardware or bandwidth limits of the system, the message is still considered sent immediately after detection of the specific occurrence of the free event, even if the message is received in the remote computing device several minutes after such detection.

In some embodiments, the message is sent by the reconnaissance agent software module of network node 3202, and is received by remote computing device 3208, according to a schedule, that is independent of a time of occurrence of the specific free event, and of a time of detection of the specific occurrence of the free event by the reconnaissance agent software module.

In some embodiments, the schedule may be a periodic schedule, for example sending messages once an hour relating to all free events occurring and/or detected by the reconnaissance agent module during the passing hour.

In other embodiments, the schedule may be non periodic, or intermittent. For example, the schedule may dictate that messages are sent every time a user logs into the workstation (in addition to reporting every round hour), or that messages are sent at predetermined times that are not at equal durations from one another (e.g. reporting more frequently during working hours).

At step 3302, the penetration testing software module installed on remote computing device 3208 identifies, based on the received message, a specific opportunistic vulnerability with which the specific free event specified in the message is associated.

In some embodiments, such identification includes:

At step 3304, identifying a method for an attacker to compromise network node 3202, for example by carrying out instructions 3222a; and

At step 3306, identifying that such method, identified in step 3304, would be available for an attacker at, or after, a future occurrence of the specific free event in network node 3202, for example by carrying out instructions 3222b.

In some embodiments, in which the penetration testing system is an actual attack penetration testing system, step 3306 includes executing the method identified in step 3304, so as to validate that network node 3202 is compromised by this method.

In some embodiments, in which the penetration testing system is a simulating penetration testing system, step 3306 includes validating that network node 3202 would be compromised by the method identified in step 3304, by simulating or otherwise evaluating this method, without attempting to actually compromise the network node.

Subsequently, at step 3308, the penetration testing software module installed on remote computing device 3208 reports the specific opportunistic vulnerability, by causing a display device to display a report including information about the specific opportunistic vulnerability, storing the report including information about the specific opportunistic vulnerability in a file, and/or electronically transmitting the report including information about the specific opportunistic vulnerability.

### Third Discussion of Additional Embodiments

Embodiments of the invention relate to penetration testing of networked systems according to the flow-charts of FIG. 47-48. Two specific example use-cases relating to FIG. 48 are presented below in the sections entitled: (i) Use Case Example 1—Bad 7 Trojan; and (ii) Use Case Example 2—Potentially-Poisoned File in a Shared Folder (PPFSF) Vulnerability.

Before discussing the flow-chart of FIGS. 47-48 along with the two specific example use-cases, a discussion of FIG. 44-46, which illustrate examples of penetration testing systems and components thereof, is presented.

A Discussion of FIGS. 44-46

FIG. 44-45 illustrate examples of penetration testing systems for testing networked systems, such as that illustrated in FIG. 43.

FIG. 46 illustrates communications between the PTSM and a plurality of nodes hosting the RASM.

Embodiments of the invention are described below with reference to a networked system of an organization which contains multiple network nodes. The nodes of the networked system may be of different types—different computer hardware, different operating systems, different applications, different resources (printers, communications devices, etc.), etc.

FIG. 44-45 illustrate examples of penetration testing systems according to embodiments of the invention. In each of these examples, the penetration testing system comprises a penetration testing software module (PTSM) 260 installed on a remote computing device and a reconnaissance agent software module (RASM) 270 installed on at least some network nodes of the networked system 200.

In the example of FIG. 44, the remote computing device (i.e. on which the PTSM 260 is installed) is first NS-external node 254 which is in communication with the networked system 200 by an Internet connection. In the example of FIG. 45, the remote computing device (i.e. on which the PTSM 260 is installed) is second NS-external node 252 which is in communication with the networked system 200 via a local-area network (LAN).

As noted above, any network node on which the RASM is installed is defined as a RASM-hosting network node. Thus, in the example of FIGS. 44-45, only the following nodes are RASM-hosting network nodes: N104, N106, N102, N103, N108, N116 and N117.

As will be discussed below, in embodiments of the invention, PTSM 260 and RASM 270 cooperate to collectively subject the networked system 200 to penetration testing. In different embodiments of the invention, the penetration testing test may be performed according to the methods described in any of FIGS. 47, 48, and/or 50A-50B.

For example, the penetration testing of the networked system 200 (i.e. performed by execution of PTSM 260 and RASM 270 on their respective hosts) may include both of the following operations: (i) collecting internal data by the RASM 270 of two or more network nodes of networked system 200 (e.g. each instance of RASM 270 collects respective internal data of its hosting network node and transmits this internal data to the PTSM 260); and (ii) analyzing this data by the PTSM 260 to determine a method for the attacker to compromise the networked system 200.

FIG. 46 illustrates an example where PTSM 260 is installed on a physically remote computing device 350; and the RASM is installed on each node 300[i] of a set of N network-nodes, {300[1], 300[2], . . . 300[N]} where N is a positive integer (N≥2), and i is an index that runs between 1 and N. Each node 300[i] corresponds to a different node of networked system 200.

The label 350 for the remote computing device refers to any remote computing device on which the PTSM 260 is installed. As noted above, for the example of FIG. 44, remote computing device 350 corresponds to computing device 254 while in the example of FIG. 45, remote computing device 350 corresponds to computing device 252.

Thus, in the example of FIG. 46, node 300[1] (i.e. the instance of RASM 270 which is installed on node 300[1]) receives one or more data-requesting commands from remote computing device 350 (i.e. data-requesting commands issued by PTSM 260—when processor(s) of remote computer device 350 execute code of PTSM 260).

Each RASM-hosting network node 300[i] executes code of RASM 270. Execution of code of RASM 270 by one or more processor(s) of each RASM-hosting network node 300[i]: (i) obtains respective internal data specific to RASM-hosting network node 300[i]; and (ii) respectively transmits the internal data to the remote computing device 350 (e.g. to PTSM 260 executing on remote computing device 350).

Thus, execution by RASM-hosting network node 300[1] of code of RASM 270: (i) obtains internal data specific to node 300[1]; (ii) transmits, to remote computing device 350, the internal data specific to node 300[1]. Execution by RASM-hosting network node 300[2] of code of RASM 270: (i) obtains internal data specific to node 300[2]; (ii) transmits, to remote computing device 350, the internal data specific to node 300[2]. And so on.

The internal data specific to RASM-hosting network node 300[i] (i.e. i is an index that runs between 1 and N) includes data about at least one of: A. an internal event of the RASM-hosting network node 300[i], B. an internal condition of the RASM-hosting network node 300[i], and C. an internal fact of the RASM-hosting network node 300[i].

In the specific example of FIG. 46, the RASM-hosting network node 300[i] may obtain the internal data and/or transmit the internal data in response to data-requesting command(s) received by the RASM-hosting network node 300[i] from the remote computing device 350. For example, the obtaining of the internal data and/or the transmitting thereof may only occur if the data-requesting command(s) is received by the RASM-hosting network node 300[i]. In other embodiments, the RASM-hosting network node 300[i] may obtain the internal data and/or transmit the internal data according to a pre-defined schedule that does not depend on commands received from remote computing device 350. For example, node 300[i] may obtain and/or transmit data every 10 minutes regardless of receiving data-requesting commands from remote computing device 350. The independently-scheduled obtaining and/or transmitting of data may be in addition to sending data in response to commands, or it may be the only mechanism by which node 300[i] obtains and transmits data.

A Discussion of FIGS. 47-48

FIG. 47-48 are flowcharts of methods of penetration testing.

In step S4101 of FIG. 47, one or more RASM instances 270 are pre-installed on one or more of (e.g. on all of) the RASM-hosting network nodes 300[i] prior to beginning of the execution of the penetration test. According to the example of FIG. 47, only after the one or more (e.g. all) of the RASM instances 270 are installed on one or more RASM-hosting network nodes 300[i] does the penetration test begin. In step S4151, the networked system 200 is subjected to a penetration test using the one or more pre-installed RASM instances.

FIG. 48 is a flowchart of a method of penetration testing. Preferably, all steps (S4201, S4205, S4301, S4305, S4309, S4313, S4317, S4321 and S4325) of the method of FIG. 48 are performed subsequent to the installing of step S4101—thus, in some embodiments all steps S4201, S4205, S4301, S4305, S4309, S4313, S4317, S4321 and S4325 may be considered an example implementation of step S4151 of FIG. 47.

Steps S4201 and S4205 of the method of FIG. 48 are performed at each RASM-hosting node of the penetration-tested networked system—these steps are indicated on the left hand side of the FIG. 48. Steps S4305, S4309, S4313, S4317, S4321 and S4325 of FIG.

48 are performed at the remote computing device—e.g. computing device 254 of FIG. 44 or computing device 252 of FIG. 45 or computing device N114 of FIG. 49.

LEFT HAND SIDE OF FIG. 48—Steps S4201 and S4205 of FIG. 48 (performed at each RASM-hosting node)

Step S4201 includes obtaining, by each given RASM-hosting network node 300[i] (i.e. i is an index that runs between 1 and N) of one or more RASM-hosting network nodes of networked system 200, respective internal data of the given RASM-hosting network node 300[i]. The obtaining of step S4201 comprises executing computer code of the RASM 270 by one or more processors of the given RASM-hosting network node 300[i].

The respective internal data (i.e. related to node 300[i]) includes data about at least one of: A. an internal event of the given RASM-hosting network node 300[i], B. an internal condition of the given RASM-hosting network node 300[i], and C. an internal fact of the given RASM-hosting network node 300[i].

In some embodiments, for at least one of the RASM-hosting network nodes, step S4201 is performed in response to a data-requesting command received by the RASM-hosting network node from the remote computing device. In other embodiments, the RASM executing on the RASM-hosting network node may not require a data-requesting command—for example, the RASM may periodically (e.g. once every minute) update a log of internal data stored in volatile or non-volatile memory of the RASM-hosting network node.

Step S4205 includes transmitting to the remote computing device 350 (e.g. 254 of FIG. 44 or 252 of FIG. 45 or 290 of FIG. 49), by each given RASM-hosting network node 300[i] of the one or more RASM-hosting network nodes of networked system 200, the obtained respective internal data of the given RASM-hosting network node 300[i]. The transmitting of step S4205 comprises executing computer code of the RASM by the one or more processors of the given RASM-hosting network node 300[i].

In some embodiments, for at least one of the RASM-hosting network nodes, step S4205 is performed in response to a data-requesting command received by the RASM-hosting network node from the remote computing device. In other embodiments, the RASM executing on the RASM-hosting network node may not require a data-requesting command—for example, the RASM may be programmed to periodically (e.g. once every minute) transmit internal data stored in volatile or non-volatile memory of the RASM-hosting network node from the RASM-hosting network node to the remote computing device.

RIGHT HAND SIDE OF FIG. 48—Steps S4305, S4309, S4313, S4317, S4321 and S4325 of FIG. 48 (performed at the remote computing device)

As noted above, steps S4305, S4309, S4313, S4317, S4321 and S4325 of FIG. 48 are performed at the remote computing device—e.g. computing device 254 of FIG. 44 or computing device 252 of FIG. 45 or computing device N114 of FIG. 49.

All of these steps are performed after the installation S4101 of at the RASM on at least some of the network nodes and after initiating the penetration testing campaign. Furthermore, as discussed below, the validating of step S4313 is performed in a manner that does not expose the target node (i.e. selected in step S4301) to a risk of being compromised.

Thus, in step S4301, a target network node is selected—i.e. a target node of the networked system on which the RASM is installed. It is this target node which is the candidate to be compromised in the next iteration of the penetration testing campaign and for which the subsequent validating step S4313 is performed. Typically, the selection of the target network node is done according to a lateral movement strategy employed in the penetration testing campaign. See the definition of “lateral movement strategy” in the Definitions Section.

Alternatively, the selection of the target node can be performed in another manner—for example, if a security alert is published that a recently unleashed computer virus attacks only nodes that run a particular version of Linux®, one such node might be selected in step S4301 to be the next target node.

In one particular non-limiting example, in the first iteration of the penetration testing campaign (when no network nodes are known to be compromisable) step S4301 is performed to select a network node having a direct connection to the outside world—e.g. N101 of FIG. 44.

In another non-limiting example, when an iteration of the penetration testing campaign is performed after some network nodes are already known to be compromisable, step S4301 is performed to select a network node that has a direct connection to one of the compromisable nodes.

In step S4305, a potential vulnerability is selected based on the target node. Thus, in one example, if the target node selected in step S4301 happens to be a Windows XP® node, then a vulnerability specific to MacOs® nodes would not be selected but a vulnerability specific to any Windows® node (or to Windows XP® in particular) may be selected.

In step S4309, internal data of the target network node is received (e.g. data obtained in step S4201 and transmitted in step S4205) at the remote computing device and from the RASM installed on the target network node.

Performing step S4309 subsequent to step S4305 (FIRST OPTION)—Optionally, step S4309 is performed subsequent to the selecting of the potential vulnerability in step S4305. For example, the RASM on each node may not necessarily be completely autonomous and may perform steps S4201 and/or S4205 according to a data-requesting command. Performing step S4309 subsequent to step S4305 provides (i) the ability to the remote computing device to send such a data-requesting command specifically to the node selected in step S4301 (and not, for example, broadcasting the data-requesting command to all nodes of networked system 200)—this may be useful for minimizing consumption of network resources; and (ii) to customize such a data-requesting command to request specific internal-data (i.e. from the target node) that is particularly relevant to the selected potential vulnerability

The skilled artisan is directed below to “Use Case Example 1.”

One potential advantage of this FIRST OPTION is that it may reduce consumption of (i) network resources and/or CPU resources at the remote computing device and/or at node(s) of system 200.

Performing step S4309 before step S4305 (SECOND OPTION)—Alternatively, the timing of step S4309 may not depend on that of step S4305—step S4309 may even be performed before step S4305 and may even be performed before step S4301. For example, RASM instances may perform steps S4201 and/or S4205 without requiring any data-requesting command from the remote computing device. One potential advantage of this SECOND OPTION is that it might simplify the software architecture of PTSM 260.

The skilled artisan is directed below to the section entitled “Use Case Example 2.”

A discussion of steps S4313-S4325 is now provided.

In step S4313, the remote computing device validates that the target network node (i.e. selected in step S4301) could be successfully compromised using the selected potential vulnerability (i.e. selected in step S4305). The validating is based on the internal data of the target node received in step S4309, and is carried out in a manner which does not expose the target network node to a risk of being compromised.

It is noted that in FIG. 48, only step S4313 is qualified by the feature “is carried out in a manner which does not expose the target network node to a risk of being compromised.” Nevertheless, it is understood that, all of steps S4301, S4305, S4309, S4313, S4317, S4321 and S4325 are carried out in a manner which does not expose the target network node to a risk of being compromised. The reason that the qualifier “is carried out in a manner which does not expose the target network node to a risk of being compromised” is only provided for step S4313 is that, in the field of penetration testing, it is typically the validation step that can cause the risk of compromising (i.e. when not performed in accordance with the presently disclosed teachings).

In step S4317, a method for an attacker to compromise the target network node (i.e. the target node selected in step S4301) is determined, by the remote computing device, based on the potential vulnerability (i.e. the vulnerability selected in step S4305).

In step S4321, a security vulnerability of the networked system is determined, by the remote computing device, based on the method (i.e. determined in step S4317) for an attacker to compromise the target network node.

In step S4325 this security vulnerability of the networked system is reported by the penetration testing system. The reporting may comprise at least one of:

(i) causing a display device [NOT SHOWN—e.g. an LCD screen or any other electronic display device] to display a report including information about the determined security vulnerability of the networked system,

(ii) recording the report including the information about the determined security vulnerability of the networked system in a file, and

(iii) electronically transmitting the report including the information about the determined security vulnerability of the networked system.

In different examples, the information about the determined security vulnerability of the networked system may comprise one or more of: (i) information about a method for compromising one network node of the networked system (ii) information about one or more network nodes of the networked system which are vulnerable to attack, (iii) information about one or more resources of the networked system that could be damaged or exported out of the networked system by an attacker, and (iv) information about an ordered list of network nodes of the networked system, wherein an attacker could use a specific network node in said ordered list that is already compromised as a basis for compromising another network node that immediately follows said specific network node in said ordered list.

Although not illustrated in FIG. 48, it is noted that various steps may be repeated—for example, step S4301 may be repeated for a number of nodes, where for each node step S4305-S4313 are performed at least once. Furthermore, for a given node selected in step S4301, steps S4305-S4313 may be performed more than once, each time for a different respective vulnerability.

In embodiments of the invention, all of steps S4305, S4309, S4313, S4317, S4321 and S4325 are performed by executing computer code of the PSTM by one or more processors of the remote computing device.

Logic of S4305; Logic of S4313

For each of the following use-cases, each of steps S4305 and S4313 are performed at the remote computing device. In embodiments of the invention, the logic for implemented steps S4305 and S4313 may be code-based—e.g. hardcoded into code of the penetration testing software module (PTSM) 260. Alternatively, the logic may be rule-based and implemented as data (e.g. as rules in a configuration file or in a relational database) accessible by PTSM 260. Alternatively, the logic may be implemented in any other manner.

For step S4305, a vulnerability is a “potential vulnerability that may compromise the target network node” if and only the vulnerability is determined to compromise the target network node if certain conditions are satisfied (e.g. the vulnerability is associated with a rule that specifies the certain conditions). If information about the target node shows that the certain conditions are currently satisfied, then the potential vulnerability is known to be an actual vulnerability of the target network node under the current circumstances. The identification of the potential vulnerability that should be checked for the target network node selected in step S4301 is performed by step S4305, while the validation that the conditions associated with the potential vulnerability are currently satisfied, and consequently that the vulnerability could successfully compromise the target network node, is performed by step S4313.

Both step S4305 and step S4313 are carried out by PTSM 260, which is stored in remote computing device 252 and executed by processor(s) thereof.

Use Case Example 1I—Bad 7 Trojan

The skilled artisan is referred to the Bad 7 Trojan example, discussed above in the ‘Problem to Solve’ section.

In Use Case Example 1, there are hundreds of potential vulnerabilities which may be investigated during penetration testing, but for simplicity only three of them will be mentioned here:

(i) Macintosh Vulnerability 843, which can only compromise nodes running MacOS® (and not all MacOS® nodes);

(ii) XP Vulnerability 228, which can only compromise nodes running Windows XP® (and not all Windows XP® nodes); and

(iii) Bad 7 Trojan, which can only compromise nodes running Windows 7® (and not all Windows 7® nodes).

In Use Case Example 1, the networked system 200 of FIG. 45 is subjected to penetration testing, and the remote computing device is computing device 252.

In Use Case Example 1, two databases reside on the remote computing device 252:

A) A node OS database describing for each node, the OS type (i.e. Windows® vs. Android® vs. MacOS® vs. Linux®) and version (i.e. Windows 7® vs. Windows 8® vs. Windows 10®) executing on the node;

B) A vulnerabilities database (VDB)—for example, the vulnerabilities database may be periodically updated by the vendor of the penetration testing system according to security updates/alerts (e.g. when a certain new virus or Trojan or phishing technique becomes known to the public).

The Nodes OS database has 16 entries, one each of nodes N101-N109, N111-N117, as follows:

| Node ID | OS type | Version |
|---|---|---|
| N101 | MacOs ® X | 10.8 |
| N102 | MacOs ® X | 10.8 |
| N103 | Windows ® | 7 |
| N104 | Red Hat Enterprise Linux | 6 |
| N105 | MacOs ® X | 10.12 |
| N106 | Windows ® | 10 |
| N107 | Red Hat Enterprise Linux | 7 |
| N108 | MacOs ® X | 10.11 |
| N109 | MacOs ® X | 10.10 |
| N111 | Red Hat Enterprise Linux | 6 |
| N112 | MacOs ® X | 10.8 |
| N113 | Red Hat Enterprise Linux | 7 |
| N114 | MacOs ® X | 10.7 |
| N115 | Windows ® | 7 |
| N116 | MacOs ® X | 10.9 |
| N117 | Windows ® | 7 |

Among the hundreds of entries, there are the following 3 entries in the vulnerabilities database: (i) one entry specifically for Macintosh Vulnerability 843; (ii) one entry specifically for XP Vulnerability 228; and (iii) one entry specifically for Bad 7 Trojan. For brevity, only the entry for the Bad 7 Trojan vulnerability is now discussed.

The Bad 7 Trojan vulnerability defines both LOGIC of S4305 and LOGIC of S4313—in this non-limiting example, LOGIC of S4305 and LOGIC of S4313 are hard-coded into penetration testing software module (PTSM) 260 as follows:

I. LOGIC of S4305—Bad 7 Trojan is a potential vulnerability that may compromise the target network node if and only if the target node is a Windows® 7 node—in this example, Bad 7 Trojan is a potential vulnerability that may compromise the target network node only for nodes N103, N107, N113 and N117. Only if one of these four nodes is selected in step S4301 may the Bad 7 Trojan vulnerability be selected in step S4305;

II. LOGIC of S4313—a target node is deemed to be a node that could be successfully compromised by using the Bad 7 Trojan vulnerability (i.e. in step S4313) if and only all of the following conditions are true (in addition to the Windows 7 condition that was already checked in step S4305):

A. A given Microsoft® security patch must not been installed on the node;

B. Port XYZ is open to receive incoming network messages;

In this particular example, instances of the RASM are preinstalled on all of nodes N101-N109 and N111-N117 on Dec. 18, 2017 at 9 AM. Penetration testing begins at Dec. 18, 2017 at 10 AM.

In this example, RASM instances on each of nodes N101-N109 and N111-N117 (i.e. whose code is executed thereof) perform step S4201 on all 16 of these nodes, no earlier than 10 AM.

In step S4301 (performed at 11:01 AM) the remote computing device selects a node having a direct connection to the outside world—for example node N103.

A lookup of the Nodes OS database indicates that this node is a Windows® 7 node—the only relevant entry in the vulnerabilities database (VDB) is the Bad 7 Trojan Vulnerability entry.

Because Node N103 is a Windows® 7 node, the potential vulnerability selected (i.e. according to LOGIC of S4305) in step S4305 is the Bad 7 Trojan Vulnerability. Step S4305 is carried out at 11:02 AM.

In this particular example, before carrying out step S4309 but subsequent to carrying out step S4305, a single data-request command is sent from remote device 252 to node N103 at 11:03 AM.

In this particular iteration of the penetration testing campaign of this particular example, step S4205 is performed only in node N103.

In step S4205 as performed by node N103, the following data is transmitted at 11:04 AM from node N103 to remote computing device 252:
(i) whether or not the given Microsoft security patch has been installed on node N103—in this example, the security patch data is internal data of node N103;
(ii) whether or not Port XYZ of node N103 is currently open to receive incoming network messages—in this example, the port status data is internal data of node N103;

Other data may also be transmitted from node N103 to remote computing device 252. All of the transmitted data is received at 11:04 AM at remote device 252 in step S4309.

Thus, in this example, both of steps S4205 and S4309 are performed at 11:04 AM.

In this use case example, it turns out that: (i) the given security patch is not installed in node N103; and (ii) port XYZ of node N103 is open to use at the current time.

Therefore, in step S4313, when the entry for the Bad 7 Trojan Vulnerability of the VDB is applied to the data for node N103 received in step S4309, the result is YES (i.e. the vulnerability would succeed in compromising node N103)—this is according to LOGIC of S4313.

In step S4317 a method for an attacker to compromise the target network node N103 is determined to be sending to port XYZ of node N103 a specific network message causing node N103 to download (i.e. from a known repository of Bad 7 Trojan) and execute the Bad 7 Trojan malicious code.

Subsequently, in step S4321 it is determined that networked system 200 suffers from a security vulnerability that includes the use of Bad 7 Trojan to compromise node N103. It should be emphasized that the discovery that node N103 is vulnerable to the Bad 7 Trojan may be just one step in the discovery of the vulnerability of networked system 200. For example, the goal of the penetration testing campaign may be to compromise node N116 (which may be the CEO's computer), and the compromising of node N103 is just a necessary first step for the attacker to reach node N116. The other steps of the method to compromise the networked system by reaching node N116 are each determined using another iteration of the campaign, where in each iteration a new target node is selected, then a new potential vulnerability for compromising that new node is selected, and then the new potential vulnerability is validated to be able to compromise the new target node under the current conditions.

In step S4325, an email message is sent to the system administrator's mobile phone with the following text “Campaign detected a security vulnerability. For more details see the reports screen.”

Additional Comment About Use Case Example 1—because step S4309 is performed after step S4301, it is possible for the remote computing device to target only node N103 with a data-requesting command (as noted above, this command was sent at 11:03 AM). This may obviate the need to broadcast such a command to multiple nodes, reducing consumption of network resources. This may also obviate the need to consume CPU cycles (i.e. for the purpose of penetration testing) at other nodes other than node N103.

Second Additional Comment About Use Case Example 1—because step S4309 is performed after step S4305, it is possible to customize the data-requesting command sent at 11:03 AM to only request data relevant to the Bad 7 Trojan Vulnerability. This may reduce consumption of CPU resources of Node N103 and/or network resources.

### Use Case Example 2

### Potentially-Poisoned File in a Shared Folder (PPFSF) Vulnerability

Similar to Use Case Example 1, in Use Case Example 2, the networked system 200 of FIG. 45 is subjected to penetration testing, and the remote computing device is computing device 252.

In Use Case Example 2, there are hundreds of potential vulnerabilities which may be investigated during penetration testing, but for simplicity only one of them will be mentioned here: the PPFSF vulnerability.

It is known in the art that some nodes can access files residing in a shared folder that is accessible to multiple nodes. The shared folder may physically reside outside of a given network node and is accessible to it either via a LAN or a WAN. Sometimes, these files may be poisoned—i.e. include malicious code. Generally speaking, one technique for attacking well-defended nodes may relate to exploiting such vulnerability—even if a hostile attacker is unable to directly upload malicious code to a node, s/he may succeed in achieving this aim indirectly.

This may be achieved as follows: (i) first, the hostile attacker may compromise a node that is poorly-defended (i.e. a node where the latest security patches have not been installed) that hosts (or at least has write access to) a shared folder from which the well-defended node is known to execute files. Because the node is poorly defended, the compromising has a good chance of success; (ii) then the hostile attacker may cause the compromised node to write a malicious executable file to the shared folder; and (iii) subsequently, even a well-defended node may be compromised if it executes files read from the shared folder.

Potentially Poisoned Executable-File vulnerability in a shared folder—The next example relates to the “potentially-poisoned file in a shared folder” (PPFSF) vulnerability—i.e. a vulnerability that can compromise a node which executes, via LAN or WAN, executable files that reside in a shared folder.

Networked System/Penetration Testing System for Example 2: The networked system 200 of the second non-limiting example has all of the following properties: (i) the networked system comprises a plurality of laptop or desktop work-stations, each of which is a network node; (ii) some of the network nodes have access to a shared folder SF which resides on a file-server on one of the nodes (“Node S”); (iii) some of the network nodes have read-only access to the shared folder SF on Node S—i.e. the nodes with read-only access can read files from the shared folder SF but cannot modify these files, and cannot add files to the shared folder SF; (iv) some nodes have both read and write privileges to shared folder SF—these nodes can modify existing files within the shared folder SF and can add new files to shared folder SF, in addition to having read access to shared folder SF; (v) nodes with read-only access and nodes that have both read and write privileges are “nodes having at least read privileges”; (vi) nodes having at least read privileges of the folder can import and execute.exe executable files from the shared folder SF, and can import and open MS-Word® files that contain auto-executing macros from the shared folder SF—i.e. content or macros of these files are read into local memory of each such node and executed from the local memory; (vii) a first work-station/node (“Node A”) is “strongly defended”—on this work-station/node the most recent version of Windows® is installed including all of the latest security patches; (viii) a second work-station/node (“Node B”) is “weakly defended”—on this node, a much older version of Window has been installed, and security patches have not been installed for over two years; (ix) Node A has read-only access to shared folder SF; (x) Node B has both read and write privileges to shared folder SF.

This networked system is subjected to penetration testing.

In this example, (i) Node A is N108 (for the present example, “Node A” and N108 are interchangeable); (ii) Node S is N113 (for the present example, “Node S” and N113 are interchangeable) and (iii) Node B is N117 (for the present example, “Node B” and N117 are interchangeable).

In this networked system, access privileges to shared folder SF are controlled by a system administrator, and are published in a table entitled “Access Privilege Table for SF on N113 (APT-SF-N113)”—the table is freely available to any node of system 200, and to any external node having a password—in this case, the password (i.e. for reading the table) is provided to the remote computing device 252.

The content of table APT-SF-N113 is as follows:

| Node ID | Access Privileges |
|---|---|
| N101 | None |
| N102 | None |
| N103 | None |
| N104 | None |
| N105 | None |
| N106 | None |
| N107 | None |
| N108 | Read and write |
| N109 | None |
| N111 | None |
| N112 | None |
| N113 | Read and write |
| N114 | None |
| N115 | None |
| N116 | None |
| N117 | Read and write |

In this example, there is only a single shared folder within the entirety of networked system 200.

In this example, the following rules are enforced (e.g. hardcoded into penetration testing software module (PTSM) 260) on the remote device:

I. LOGIC of S4305—in step S4305 (discussed below), the PPFSF vulnerability is a potential vulnerability that may compromise the target network node if and only if the target node (i) has at least read access via the LAN to a given shared folder on another node (the ‘folder-hosting node’); (ii) an additional node other than the target node (which may be the folder-hosting node) has write access to the given shared folder;

II. LOGIC of S4313—a target node is deemed as a node that could be successfully compromised by using the PPFSF potential vulnerability (i.e. in step S4313) if and only if all of the following conditions are true:
A. The target node is determined to periodically read an executable file residing in the shared folder; and
B. The target node is determined to execute the executable file whenever reading it from the shared folder.

Timing of steps S4201 and S4205 of Penetration Testing Campaign for Example 2:

In this second example, the penetration testing campaign commences at 1 PM on Apr. 21, 2017. Thus, in this example the “Commencement Time” is 1 PM on Apr. 21, 2017. Prior to the Commencement Time, the RASM is pre-installed on each node of the networked system, including Node A which is strongly-defended and Node B which is weakly-defended.

Immediately after the Commencement Time, the table APT-SF-N113 is read by the PTSM—in this example, the content of APT-SF-N113 never changes during the penetration testing campaign.

During the ten-hour penetration testing campaign, processor(s) of Node A execute (i.e. in step S4201) code of the RASM both to ascertain status data of Node A and to “listen” to events which occur at Node A. The status data may include: (i) a version of an operating system executing on Node A; (ii) which security patches have been installed on Node A. The events may include execution of an executable file by processors of Node A, opening of an MS-word® file or an MS-excel® file (applications which support macros) on Node A, mouse and keyboard events on Node A, reading a file from the shared folder SF (i.e. on Node S) into Node A, execution of a file read from the shared folder SF into Node A.

Similarly, processor(s) of Node B (i.e. in step S4201) execute code of the RASM both to ascertain status data of Node B and to “listen” to events which occur at Node B.

In this example, at 1:01 PM Node A (i.e. by executing code of the RASM) transmits (i.e. in step S4205) to the remote computing device “Windows version/update data” for Node A—the Windows version/update data transmitted from Node A indicates that the most recent version of Windows® including all of the latest security patches is installed on Node A.

In this example, at 1:02 PM Node B (i.e. by executing code of the RASM) transmits (i.e. in step S4205) to the remote computing device “Windows version/update data” for Node B—the Windows® version/update data transmitted from Node B indicates that (i) an older version of Windows® is installed on Node B and (ii) the most recent security patch installed on Node B is over two years old.

In this example, RASM code executing on Node A records the following events i.e. recorded in step S4201 and transmitted in step S4205)—every 60 minutes (e.g. at 1:30, at 2:30, at 3:30, etc.) Node A reads an executable file named “hourly test.exe” from shared folder SF and executes it.

Broadcast of Data-Requesting Command; Response to Data-Requesting Commands for Example 2

At 7:56 PM, as part of the penetration testing, the remote computing device broadcasts a data-requesting command to all nodes, including Nodes A and B.

At 7:57 PM, Node A responds to this broadcast data-requesting command by transmitting (i.e. via the Internet), to the remote computing device, the status data and the events data of Node A, both of which are stored in volatile and/or non-volatile storage of Node A.

At 7:58 PM, Node B responds to this broadcast data-requesting command by transmitting (i.e. via the Internet), to the remote computing device, the status data and the events data of Node B, both of which are stored in volatile and/or non-volatile storage of Node B.

A discussion of steps S4301-S4325, each performed by the remote computing device 252, is now presented.

At 7:59 PM, in step S4309, the remote computing device receives the following data:

A) status data and the events data of Node A, both of which were transmitted at 7:57 PM from Node A, as mentioned above; and

B) status data and the events data of Node B, both of which were transmitted at 7:58 PM from Node B, as mentioned above;

In step S4301, Node A (N108) is selected from the plurality of nodes of system 200. In one non-limiting example, Node A is selected because it was determined to be a well-defended node, which might indicate it contains important assets.

In step S4305, performed at 8:02 PM, the PPFSF vulnerability is selected (i.e. according to LOGIC of S4305) as a potential vulnerability for compromising Node A. The selection of the PPFSF vulnerability is based on the following:

(i) Based on the APT-SF-N113 table, Node A has read access to shared folder SF.

(ii) Based on the APT-SF-N113 table, Node B has write access to shared folder SF.

(iii) According to the current state of the penetration testing campaign, Node B is already determined to be compromisable.

The above findings indicate that the PPFSF vulnerability is a potential vulnerability for compromising Node A. It is only a “potential” vulnerability, because it is still not known at this stage whether the condition of Node A reading and executing executable files from shared folder SF is satisfied.

In step S4313, performed at 8:05 PM, LOGIC of S4313 at the remote computing device, analyzes the input data received at 7:59 PM in step S4309 in order to check whether the PPFSF vulnerability can compromise Node A under the current circumstances. The input data includes the reporting from Node A that an executable file from shared folder SF is periodically retrieved and executed by Node A.

This analysis, which is performed exclusively at the remote computing device, is effective to conclude that Node A could be compromised by the PPFSF vulnerability, because Node B (which is already determined to be compromisable) can replace the executable file periodically executed by Node A by a poisoned version, that when executed by Node A would result in Node A being compromised.

In step S4317 performed at 8:06 PM, the penetration testing software module can now determine that there is a method for an attacker to compromise the target network node—i.e. N108 (Node A). The method to compromise is as follows: (i) take advantage of the fact that Node B is already found to be compromisable, (ii) get Node B to download a poisoned executable file from the attacker's website and store it on Node B, (iii) In the next time of detecting that Node B writes into the shared folder SF, get Node B to replace the existing executable file “hourly test.exe” in the shared folder SF by the poisoned file, leaving a poisoned “hourly-test.exe” file in the shared folder SF.

Subsequently, in step S4321 it is determined that networked system 200 suffers from a security vulnerability that includes the use of the PPFSF vulnerability to compromise Node A. It should be emphasized that the discovery that Node A is vulnerable to the PPFSF vulnerability may be just one step in the discovery of the vulnerability of networked system 200. For example, the goal of the penetration testing campaign may be to compromise node N116 (which may be the CEO's computer), and the compromising of Node A is just a necessary first step for the attacker to reach node N116. The other steps of the method to compromise the networked system by reaching node N116 are each determined using another iteration of the campaign, where in each iteration a new target node is selected, then a new potential vulnerability for compromising that new node is selected, and then the new potential vulnerability is validated to be able to compromise the new target node under the current conditions.

In step S4325, an email message is sent to the system adminstrator's mobile phone with the following text “Campaign detected a security vulnerability. For more details see the reports screen.”

Additional Comments About Use Case Example 2:

because step S4309 is performed before step S4301, reports are obtained by the remote computing device from all network nodes, and not only from Node A, which at the time of performing step S4309 is not yet selected to be the next target node.

because step S4309 is performed before step S4305, it is not possible to customize data-requesting commands that trigger data reports from network nodes, as at the time of performing step S4309 it is not yet known which vulnerability will be the selected potential vulnerability.

A discussion of FIG. 49

In the example of FIG. 49, the remote computing device (i.e. on which the PTSM 290 is installed) is one of the nodes of the networked system 200—in this case node N114.

For example, PTSM 290 may run on a virtual machine installed on top of the Operating System of node N114. Optionally, no RASM 270 is installed on the node N114.

Additional Discussion of Data Collection By Reconnaissance Client Agents

The proposed solution is a penetration testing system that uses a reconnaissance client agent that is installed in the network nodes of the tested networked system and reports (among other things) current internal data of its hosting network nodes. However, unlike in the '057 solution, in the proposed solution the validation of the success of a potential vulnerability in compromising a target network node is decided by code executing in the central server managing the penetration testing process and not by code of the agent executing in the target network node.

Co-pending U.S. patent application Ser. Nos. 15/911,168 and 15/874,429 disclose an architecture of an automated penetration testing system that is using reconnaissance client agents able to collect internal data of their hosting network nodes, as is required according to embodiments of the invention.

As already explained, a reconnaissance client agent is a software module designed to be installed in nodes of the tested networked system. Such reconnaissance client agent is able to communicate with a central server managing the testing process and executing the penetration testing code and to report to the central server data extracted by the agent from its surroundings. The extracted data includes (but is not necessarily limited to) current data about the hosting node, and specifically current data that is internal to the hosting node.

In embodiments of the invention, the reconnaissance client agent makes no attempt of actually compromising its hosting network node using a given vulnerability. Additionally, in embodiments of the invention the reconnaissance client agent makes no determinations whether a given vulnerability would succeed to compromise the hosting node under current conditions. It only reports factual data about the hosting node (and possibly also about other network elements), leaving all validation decisions to the remote server. The remote server is the device containing the vulnerabilities knowledge base and the validation logic for all potential vulnerabilities. For each validation to be decided for a given vulnerability and a given network node, the server applies the decision logic associated with the given vulnerability using the data collected and reported by the reconnaissance client agent installed on the given node.

For example, the penetration testing server, in embodiments of the invention, retrieves from its vulnerabilities knowledge base a rule for deciding the success of compromising a target node using the given vulnerability. In this example, the rule says that a Windows 7 node is compromisable by that vulnerability if and only if (i) it does not a have a given OS patch installed, and (ii) the Internet port associated with the vulnerability is in use. The server then queries the reconnaissance client agent installed on that node or reviews the most recently report received from the reconnaissance client agent installed on that node, and then checks whether those two conditions are currently satisfied. Only if both conditions are satisfied will the server conclude that the compromising of the node would have been successful.

According to embodiments of the invention, the steps of each iteration of the penetration testing process may be:

a. Data is collected from the reconnaissance client agents installed on all already-compromised nodes. The data collected from the already-compromised nodes may include data about not-yet-compromised nodes, as long as this data can be obtained by any attacker controlling the already-compromised nodes. For example, data may be obtained by querying the not-yet-compromised domain controller or file server by an already-compromised node.

b. Based on the collected data and the vulnerabilities knowledge base in the server, the server chooses the node that will be the next target for compromising.

c. Based on the chosen target node, the server chooses a vulnerability that is highly likely (and preferably the most likely) to succeed in compromising the chosen target node.

d. Based on the chosen vulnerability, the server collects data from the reconnaissance client agent installed on the chosen target node. The collected data includes data of the chosen target node (including internal data) that is required for validating the success of compromising the chosen target node by the chosen vulnerability according to the specific rules associated with the chosen vulnerability.

e. Based on the collected data, the server determines whether the compromising of the chosen target node would have succeeded under the current conditions.

Note that during the first step in the above list of steps data is collected only from agents installed in already-compromised nodes, but not from agents installed in not-yet-compromised nodes, and specifically not from the agent installed on the not-yet-compromised node that would become the target node in the second step. This is because we want to emulate the capabilities of a potential attacker, and an attacker would be able to collect data (including internal data) from the already-compromised nodes that it already controls, but not from the not-yet-compromised nodes.

However, in the fourth step we do collect data (including internal data) from the reconnaissance client agent installed in the not-yet-compromised chosen target node. This is allowed because we are only using such data for finding out the success or failure of compromising that node and not for extending the capabilities of the attacker. Similarly, it is allowed to use data from agents installed on not-yet-compromised nodes even in the first step, provided that such data is only used for speeding up determining factual findings that an attacker would be able to determine, even if with higher effort. For example, an attacker can determine which Internet ports are open in a not-yet-compromised node by instructing an already-compromised node to run a port scanning operation on the not-yet-compromised node. However, it is more efficient for the penetration testing system to obtain the open ports list directly from the agent installed on the not-yet-compromised node, for which this is a relatively simple task, rather than from an agent installed on an already-compromised node that would have to run a port scanning operation, which is a longer and heavier task. Taking such “shortcut” in obtaining the data does not change the end results of the penetration test but saves time in reaching those end results.

This additional discussion is presented with reference to FIGS. 10A-10B, which illustrate a method that is useful for discovering and reporting a security vulnerability of a networked system by a penetration testing system, the networked system comprising a plurality of network nodes.

Additional Discussion of the Role of Reconnaissance Client Agents

The penetration testing system of the present disclosure comprises:

(A) a reconnaissance agent software module installed on multiple network nodes of the plurality of network nodes prior to starting a penetration test of the networked system, wherein the reconnaissance agent software module is operable, when installed on a network node, to do at least (i) collect internal data of the network node, and (ii) transmit the internal data out of the network node, and

(B) a remote computing device penetration testing software module installed on a remote computing device, wherein the remote computing device is operable at least to (i) communicate with at least one network node of the multiple network nodes on which the reconnaissance agent software module is installed, and (ii) receive the internal data transmitted out of the multiple network nodes,

In embodiments of the invention, the method of the present disclosure comprises:
a. executing a penetration test of the networked system by the penetration testing system, the executing of the penetration test comprising:
   i. selecting, by the remote computing device penetration testing software module, a target network node of the multiple network nodes to be the next network node for which the penetration test should check whether it can be compromised;
   ii. selecting, by the remote computing device penetration testing software module, a potential vulnerability that may compromise the target network node;
   iii. validating, by the remote computing device penetration testing software module, that the potential vulnerability can be used for successfully compromising the target network node, the validating achieved without compromising the target network node, the validating comprising:
      1. receiving data from the reconnaissance agent software module installed on the target network node, the received data including internal data of the target network node;
      2. based on the internal data of the target network node, evaluating whether the target network node could be successfully compromised using the potential vulnerability;
   iv. if the validating determines that the potential vulnerability can be used to successfully compromise the target network node, determining, by the remote computing device penetration testing software module, a security vulnerability of the networked system;
b. reporting the security vulnerability of the networked system, the reporting comprising at least one of: (i) displaying information about the security vulnerability of the networked system to a user of the remote computing device; and (ii) transmitting the information about the security vulnerability of the networked system to another computing device.

The method may further be characterized by:

(i) the executing of the penetration test further comprising: validating, by the remote computing device penetration testing software module and prior to the selecting of the target network node, that a second network node of the multiple network nodes can be compromised,

(ii) the validating that the potential vulnerability can be used for successfully compromising the target network node further comprising: receiving data from the reconnaissance agent software module installed on the second network node, and

(iii) the evaluating whether the target network node could be successfully compromised using the potential vulnerability is further based on the data received from the second network node.

In other words, the validating that the potential vulnerability can be used for successfully compromising the target network node may also depend on data received from the reconnaissance agent software module that is installed on a second network node that was already validated to be compromisable prior to the time the validating of the compromisability of the target network node starts.

For example, if the target network node is located behind a firewall that blocks access from the outside world to a certain Internet port, and the potential vulnerability operates by sending a message into this certain port, then even if the potential vulnerability could in theory compromise the target network node, it cannot be directly used by an attacker located outside the networked system. However, if the second network node is already under the control of the attacker and is also behind the same firewall, then it is not blocked by that firewall when attempting to send a message to the certain port of the target node (but may still be blocked by another firewall). Therefore, it is not possible to evaluate whether the target network node could be successfully compromised using the potential vulnerability without knowing whether the second network node can send messages that will reach the certain node of the target network node. This essential information is obtained from the reconnaissance agent software module that is installed on the second network node.

The selecting of the target network node may be based on data received by the remote computing device penetration testing software module from one or more network nodes.

The receiving of the internal data may be prior to the selecting of the target network node. In other words, the internal data of the target network node that is used for evaluating whether or not the target network node could be successfully compromised using the potential vulnerability, may be obtained from reports of the reconnaissance agent software module installed on the target network node that were received during previous stages of the test. For example, the agent may have sent periodic reports to the remote computing device during a previous stage of the penetration tests, or the agent may have sent a report in response to a query from the remote computing device penetration testing software module sent during a previous stage of the penetration test.

Alternatively, the receiving of the internal data may be subsequent to the selecting of the target network node. In other words, the internal data of the target network node that is used for evaluating whether or not the target network node could be successfully compromised using the potential vulnerability, may be obtained from a report of the reconnaissance agent software module installed on the target network node that was generated and sent specifically for the current stage of the penetration test. For example, after selecting the target network node, the remote computing device penetration testing software module may send a query to the newly selected target node, asking for data that may be used for selecting the potential vulnerability.

The internal data of the target network node may include at least one of (i) an internal condition of the target network node, and (ii) internal factual data of the target network node. For example, the internal data may indicate that the memory of the target network node is over 95% used or the identity of the vendor of the communication controller of the target network node.

### Fourth Discussion Of Additional Embodiments

Discussion of FIGS. 51, 52A-H

Embodiments of the invention relate to penetration testing of networked systems, such as networked system 200 illustrated in FIG. 52A.

Penetration testing systems test networked systems. For example, the networked system 200 comprises a plurality of network nodes (referred to simply as “nodes”) in communication with each other—e.g. see FIG. 52A.

In prior art penetration testing systems, a penetration testing campaign performs or emulates an attack of a potential attacker, starting from an initial state in which no network node of the tested networked system is compromised. The attacker is assumed to start by compromising a first network node (e.g. node N122 of FIG. 52B), then to take advantage of the already-compromised first node and compromise a second network node, then to take advantage of the already-compromised first and second nodes and compromise a third network node, and so on.

FIGS. 51 and 52A-4D relate to an example of penetration testing of a networked system. FIG. 51 shows a timeline—i.e. the penetration test begins at a time labelled as T_{Begin Pen-Test}. Subsequent points in time, during the penetration test, are labelled in FIG. 51 as T¹_{During Pen-Test}, T²_{During Pen-Test} and T³_{During Pen-Test}.

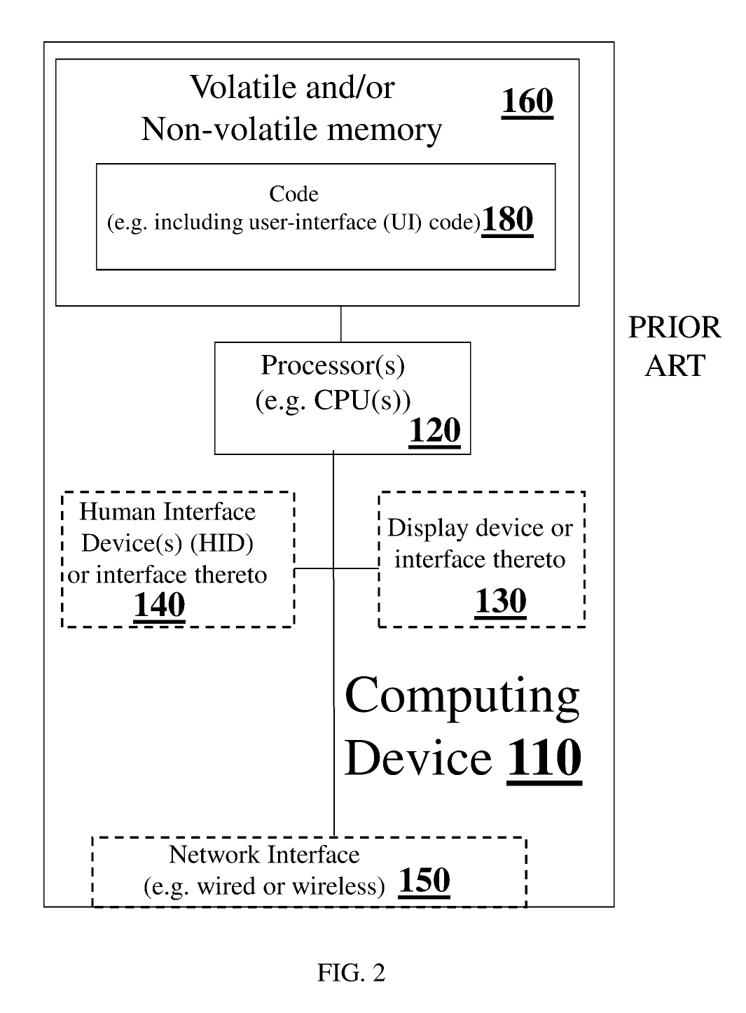

FIG. 52A shows an example networked system 200 comprising a plurality of 25 network nodes labelled N101, N102 . . . N124. In the present document, a network node may be referred to simply as ‘node’—‘network no’ and ‘no’ are interchangeable. Each network node may be a different computing device 110 (e.g., as shown in FIG. 2). Two network nodes are “immediate neighbors” of each other if and only if they have a direct communication link between them that does not pass through any other network node.

In FIG. 52A, initially—i.e. at time T_{Begin Pen-Test} when the penetration test begins—none of the network-nodes have yet been targeted by the penetration testing system. According to the first example illustrated in FIGS. 52B-D, between time T_{Begin Pen-Test} and T¹_{During Pen-Test}, network node N122 is targeted for compromising and is validated by passive validation, e.g., emulation, of a vulnerability as part of a penetration testing campaign—this is indicated in FIG. 52B by the “P” marking of node N122. Between time T¹_{During Pen-Test} and T²_{During Pen-Test}, network node N116 is targeted for compromising and is validated by active validation, e.g., by an actual attack on the node by the penetration testing system, as indicated by the ‘A’ in node N116 in FIG. 52C. Between time T²_{During Pen-Test} and T³_{During Pen-Test}, network nodes N112, N110 and N111 are targeted for compromising and are validated by either active or passive validation as indicated by the A's and P's in FIG. 52D. The penetration testing campaign is performed by the penetration testing system 500. In this example we are assuming that all the validation operations are successful and each of them results in the corresponding target node becoming compromised or determined to be compromisable.

According to the second example illustrated in FIGS. 52E-G, the first network node N122 is validated by active validation (as opposed to the first example where N122 is validated by passive validation), the second network node N116 is validated by passive validation, and by T³_{During Pen-Test} network nodes N112, N110 and N111 are also validated by passive validation. According to the third example illustrated in FIG. 52H, network nodes N112, N110 and N111 are all validated by active validation. FIG. 52G is an example of a penetration testing campaign that tends toward the use of passive validation except under certain circumstances where the use of active validation is deemed preferable or necessary. FIG. 52H is an example of the opposite—a penetration testing campaign that tends toward the use of active validation except under certain circumstances where the use of passive validation is deemed preferable or necessary.

FIG. 53 illustrates one example of a networked system 200 that may be subjected to penetration testing. The networked system comprises a plurality of nodes—in the example of FIG. 53, 16 nodes are illustrated, each labeled by the letter “N” followed by an integer, similar to FIGS. 52A-H. Also illustrated in FIG. 53 are two external computing devices 254, 252 that reside outside the networked system 200. Computing device 254 resides ‘in the cloud’ relative to the networked system 200, while computing device 252 is in communication with the networked system 200 via a local-area network (LAN). Both of nodes 254 and 252 are “networked system external”—i.e. outside of networked system 200. The term ‘networked system external’ is abbreviated as “NS-external”.

In the present document, a network node may be referred to simply as ‘node’—‘network no’ and ‘no’ are interchangeable. Each network node may be a different computing device 110 illustrated in FIG. 2.

Discussion of FIG. 54

FIG. 54 is a flowchart of a method of performing penetration testing by a single penetration testing system that uses both active and passive validation methods. It shows one method in which penetration testing using both active and passive validation methods is performed in a single penetration testing campaign. The reader is referred to the definition of “penetration testing campaign” in the Definitions Section. All of the steps are performed by a single penetration testing system, e.g., penetration testing system 500 of FIG. 52A-H.

In step S5151 of FIG. 54, a networked system, e.g., networked system 200 of FIG. 53 is subjected to a penetration test using both active and passive validation methods during a single penetration testing campaign, and by a single penetration testing system.

The right side of FIG. 54 is a flowchart of a method of implementing the penetration testing campaign of step S5151 according to a first embodiment.

In step S5101, a penetration testing campaign is commenced. In some cases, a penetration testing campaign is commenced automatically by the penetration testing system based on a programmed schedule having a start time, and either an end time or a pre-programmed duration. Alternatively, a penetration testing campaign can be commenced manually—i.e. by a testing operator entering a command to begin the campaign. Besides starting time and duration (or ending time), a penetration testing campaign can have a set of unique characteristics based on its goals and methods. In a non-limiting example, a penetration testing campaign can be designed to determine whether a specific highly confidential file can be reached by an attacker and exported out of the networked system.

In step S5103, a first target network node is selected—i.e. determined to be the next target node for an attempt to compromise during the single penetration campaign. Typically, during a penetration testing campaign the selection of the next target network node is done according to a lateral movement strategy employed in the penetration testing campaign. See the definition of “lateral movement strategy” in the Definitions Section.

In one particular non-limiting example, in the first iteration of the penetration testing campaign (when no network nodes are known to be compromisable) step S5103 is performed to select a network node having a direct connection to the outside world—e.g. N101 of FIG. 53.

In another non-limiting example, when an iteration of the penetration testing campaign is performed after some network nodes are already known to be compromisable, step S5103 is performed to select a network node that has a direct connection to one of the compromisable nodes.

In step S5105, a potential vulnerability is selected based on the target node. Thus, in one example, if the target node selected in step S5103 happens to be a Windows XP® node, then a vulnerability specific to MacOs® nodes would not be selected but a vulnerability specific to any Windows® node (or to Windows XP® in particular) may be selected.

Validation of the vulnerability for any given target network node can be performed either using an active (e.g., actual attack) validation method or a passive (e.g., simulated attack) validation method. In step S5107, a first validation method is selected for validating the first vulnerability for the first target network node. The first validation method is either active validation or passive validation. Examples of network nodes at which an active validation method has been chosen include Nodes N116 in FIGS. 52C-D, N110 in FIGS. 52D and 4H, N122 in FIGS. 52E-H, and N111 and N112 in FIG. 52H. Examples of network nodes at which a passive validation method has been chosen include Nodes N122 in FIGS. 52B-D, N111 and N112 in FIGS. 52D and 4G, N116 in FIGS. 52F-H, and N110 in FIG. 52G. In the “First Additional Discussion” section below, several examples are provided of selection of validation methods.

In step S5109, the first vulnerability for the first target network node is validated using the first validation method as selected in step S5107.

At some other point during the penetration testing campaign, a second target network node (e.g. other than the first target network node) which the penetration testing system will try to compromise is determined in step S5111. As mentioned earlier, the selection of the target network node is done according to a lateral movement strategy employed in the penetration testing campaign. A penetration testing campaign can select subsequent nodes in an order that emulates the progress of an attacker through the networked system 200. For example, an attacker frequently moves on to attempt to compromise a next node which is in communication with an already compromised node (e.g., the network node most recently compromised).

In step S5113, a second vulnerability of network nodes, to be used for compromising the second target network node, is determined.

In step S5115, a second validation method is selected for validating the second vulnerability for the second target network node. The second validation method can be either active or passive. If an active validation method was selected as the first validation method in step S5107, then the second validation method is selected to be a passive validation method. Conversely, if a passive validation method was selected as the first validation method in step S5107, then the second validation method is selected to be an active validation method. Thus, in a single penetration testing campaign, by a single penetration system, both active and passive validation methods can be selected and performed. For example, in FIG. 52C, it can be seen that by T²_{During Pen-Test}, an active validation method has been employed to validate a vulnerability for Node N116, and a passive validation method has been used to validate a vulnerability for Node N122. In step S5117, the second vulnerability for the second target network node (the node determined in step S5111) is validated using the second validation method as selected in step S5115.

In step S5119, the single penetration testing campaign is terminated, either in accordance with a programmed duration or ending time as discussed earlier, or manually by a user, or by achieving its goal of determining a vulnerability ahead of the scheduled ending time. The skilled artisan will appreciate that the penetration testing campaign can encompass the testing/validation of more than two nodes as described here, and, for example, can encompass all of the nodes in a networked system 200.

In step S5121, the following is performed: reporting, by the penetration testing system, at least one security vulnerability determined to exist in the networked system by the executing of the single penetration testing campaign, wherein the reporting comprises at least one of (A) causing a display device to display a report containing information about the at least one security vulnerability of the networked system, (B) storing the report containing information about the at least one security vulnerability of the networked system in a file and (C) electronically transmitting the report containing information about the at least one security vulnerability of the networked system.

FIG. 54 will be further discussed below with reference to the following non limiting examples.

First Additional Discussion of FIG. 54, and Discussion of FIGS. 55A-55B

In some embodiments, it can be preferable to primarily use an active (actual attack) method of validation, in order to determine the existence of any possible vulnerability with the highest reliability. In some embodiments it can be preferable to primarily use a passive (e.g., emulation) method so as to avoid actually compromising network nodes during the testing. In some embodiments, the first and second validation methods are respectively selected in accordance with the first and second vulnerabilities. Even when active methods are preferred, it can be that certain vulnerabilities can be satisfactorily validated using passive methods. Conversely, even when passive methods are preferred, it can be that certain vulnerabilities can only be satisfactorily validated using active methods.

Other, non-technical considerations may come into play when selecting a validation method for a particular vulnerability for a particular network node, such as in the following non-exhaustive illustrative examples: (A) The identity of the node's user—is it someone with access to top-level confidential data, or someone with little or no access to confidential data? Is it the company's CEO whose use of the node cannot be interrupted by an actual attack method? (B) the department within which the node operates—is it a legal or financial department, which have computers storing the company's most sensitive information, or a marketing department with critical customer data, or perhaps an engineering department with the specs and drawings of the company's next generation of products? Or maybe the node belongs to the office manager, whose computer only stores cleaning schedules and orders for office supplies?

It might not be reasonable to make ad hoc decisions about each and every computer in a networked system before commencing a penetration testing campaign. Similarly, it might not be reasonable to make ad hoc decisions about each and every potential vulnerability included the penetration testing system's vulnerabilities knowledge base. However, it is possible to characterize vulnerabilities, with or without co-consideration of the corresponding network nodes, according to a parameter corresponding to the maximum damage (financial, technical, etc.) that would be incurred should a given node be compromised by a given vulnerability. Thus, the method of FIG. 54 can include determining an extent of the damage.

In one non-limiting example, a damage scale is established wherein 0.0 means ‘no damage’ and 1.0 means ‘irreparable or irreversible damage’. A maximum ‘allowable’ damage threshold can be set. Any node and vulnerability for which a successful actual attack would result in damage above the threshold would trigger validation by simulation/evaluation. For nodes and vulnerabilities below the threshold, an active method of validation may be used. In an illustrative first penetration testing campaign, the damage threshold may be set at a moderate 0.5. However, in the first campaign it may be discovered that this threshold is too low and nearly every single validation is performed using a passive validation method, including some nodes and vulnerabilities where use of an active validation method is objectively (i.e. through detailed pre- or post-analysis) deemed necessary. In a second illustrative campaign, the damage threshold may be set at an extreme 0.9. In this iteration it may be discovered that this threshold is too high as nearly every single validation is performed using an active validation method, including some nodes and vulnerabilities where use of an active validation method exposes the tested networked system to unnecessary risk of damage. In a third iteration, a damage threshold of 0.7 may be determined to be optimal for the networked system in which the penetration testing campaign is being carried out.

In one non-limiting implementation of the above example, a look-up table may be established and made available to a penetration testing system for determining the extent of expected damage from using active validation for validating any given vulnerability, regardless of the identity of the attacked node. Such a table may be arranged so as to be indexed by the type of vulnerability determined (regardless of the attacked node), where the table returns a damage ‘score’ based on the type of vulnerability. Multiple vulnerability types may be combined into a joint entry in order to save space, if they share a common attribute and correspond to the same damage score (e.g. multiple vulnerabilities that are all attempting to achieve execution of remote code in the attacked node, but each of them achieving the common goal using a different technique). As explained above, the damage score is a numerical representation of the expected extent or severity of damage from using active validation for the specific type of vulnerability. The damage score can be calculated or determined on any scale, linear or otherwise—for example the 0.0 to 1.0 scale described above. Whatever scale is used, it is created in such a way that a maximum-damage threshold is established somewhere on the scale. An example of an entry in such table is an entry that tells the penetration testing system that any node against which the “ARP Spoofing” technique is employed for active validation corresponds to a damage score of 0.4.

In another non-limiting implementation of the above example, a two-dimensional look-up table may be established and made available to a penetration testing system for determining the extent of expected damage from using active validation for validating any combination of a given vulnerability and a given network node. Such a table may be arranged as having multiple columns, each column corresponding to a specific node or to a specific class of nodes and containing entries for all vulnerability types. As in the above one-dimensional table example, multiple vulnerability types may be combined into a joint entry in order to save space, if they share a common attribute and correspond to the same damage score. The node that is involved in the validation determines the table's column and the vulnerability involved in the validation determines the row within the column. The indexed entry in the table contains the resulting damage score. An example of a row of entries in such table is a row that tells the penetration testing system that actively validating the “ARP Spoofing” technique against the CEO's computer corresponds to a damage score of 0.8, actively validating the “ARP Spoofing” technique against any node residing in the finance group corresponds to a damage score of 0.6, actively validating the “ARP Spoofing” technique against any other node using the Windows XP operating system corresponds to a damage score of 0.5 and actively validating the “ARP Spoofing” technique against any other node corresponds to a damage score of 0.4.

FIG. 55A is an illustrative graph according to a non-limiting example, summarizing data of a specific penetration testing campaign showing the extent of damage expected at each node from using an actual-attack validation of a respective vulnerability that is determined at each node during that specific penetration testing campaign. For each node, at least one vulnerability is determined (in Step S5105 or S5113), and is validated (in Step S5109 or S5117) during the execution of the specific penetration testing campaign. In the example of FIG. 55A, a damage threshold is set equal to 0.8. In other words, if the expected extent of damage as a result of using an active method of validation is greater than the maximum allowable damage of the 0.8 threshold, a possibly less reliable but presumably safer passive method of validation is used.

To illustrate: The leftmost data point in the FIG. 55A graph (for Node N101) shows that a vulnerability determined (e.g., in Step S5105 of FIG. 54) as the one to be used for compromising Node N101 has an expected damage extent of about 0.7 (i.e., on the 0.0-1.0 scale) if validated in the penetration testing campaign using an active validation method. Since the expected extent of damage (from using an active validation method) is below the maximum allowable damage threshold of 0.8, an active validation method can be used. On the other hand, the vulnerability determined (e.g., in step S5113) for compromising Node N102 (the second leftmost data point) has an expected damage extent of 0.9 if validated using an active method of validation—higher than the max. damage threshold of 0.8. Thus, according to the example of FIG. 55A, a passive validation method is selected for validating the vulnerability at Node N102.

In the example of FIG. 55A, the networked system comprises 20 network nodes overall (numbered N101 through N120), and 6 out of the 20 nodes have expected damage over the damage threshold based on the vulnerability/-ies determined to be used for compromising the respective nodes during the specific penetration testing campaign. A passive validation method is therefore selected for testing at each of these 6 nodes, while active validation methods are used at the other 14 nodes.

Additionally or alternatively, the method of FIG. 54 can include determining the likelihood of damage. FIG. 55B is an illustrative graph according to another non-limiting example, summarizing data of a specific penetration testing campaign showing the likelihood of damage occurring at each node from using an actual-attack validation of a respective vulnerability determined at each node during that specific penetration testing campaign. For each node, at least one vulnerability is determined (in Step S5105 or S5113), and is validated (Step S5109 or S5117) during the execution of the specific penetration testing campaign. In the example of FIG. 55B, a likelihood-occurrence threshold is set equal to 0.5—in other words, if the chance of damage occurring as a result of using an active method of validation translates to a likelihood-occurrence score greater than 0.5, a passive method of validation is used instead. A likelihood-occurrence score can be a linear translation of probability, e.g., 50% chance equals a score of 0.5. Alternatively a likelihood-occurrence score can be calculated using a non-linear function—for example, so as to skew the scores higher or lower, or closer or further from the mean, etc.

To illustrate: The leftmost data point in the FIG. 55B graph (for Node N101) shows that a vulnerability determined (e.g., in Step S5105 of FIG. 54) as the one to be used for compromising Node N101 is associated with likelihood-occurrence score of 0.9—i.e., if a linear scale is used for determining the likelihood-occurrence scores, there is a 90% likelihood of damage actually occurring if the vulnerability is validated in the penetration testing campaign using an active validation method. Since this likelihood is well above the likelihood-occurrence threshold of 0.5, a passive validation method is used. On the other hand, the vulnerability determined (e.g., in step S5113) for compromising Node N102 (the second leftmost data point) is associated with a likelihood-occurrence score of only 0.48—a little lower than the likelihood-occurrence threshold of 0.5. Thus, according to the example, an active validation method can be used for validating the vulnerability at Node N102.

In the example of FIG. 55B, the networked system comprises 20 network nodes (numbered N101 through N120), and 5 out of the 20 nodes have damage likelihood-occurrence scores under the likelihood-occurrence threshold based on the vulnerability/ies determined to be used for compromising the various nodes during the specific penetration testing campaign. An active validation method is therefore selected for testing at each of these 5 nodes, while passive validation methods are used at the other 15 nodes.

Second Additional Discussion of FIG. 54, and Discussion of FIG. 56

In other embodiments, potential damage to network nodes from using an active method of validation to validate a vulnerability can be assessed with more than a single parameter as was the case in the preceding paragraphs and in FIGS. 55A and 55B. In an example, a representative damage score for a given node/vulnerability validation can be calculated based on both the extent and likelihood of expected damage from employing an active validation method to validate a vulnerability at a given network node. The representative damage score can be calculated individually for each single validation—i.e. for each node/vulnerability pair in a specific penetration testing campaign.

FIG. 56 is an illustrative graph according to a non-limiting example, wherein a risk score is a determined combination of expected extent of damage and likelihood of damage. A threshold curve is plotted, under which active validation can be used and above which passive validation is preferred because of the extent and/or likelihood (as jointly represented in the determined risk score) of the expected damage from a node being compromised if a determined vulnerability is validated using an active validation method.

In FIG. 56, points are plotted for 20 nodes of a networked system. Nodes N101, N112 and N105 are outside (above) the risk factor threshold curve and according to the example the vulnerabilities at those nodes must be validated using a passive validation method. Nodes N102 and N117 are both lying on the threshold curve. Whether they can be validated using an active validation method depends on whether the threshold in the example is defined as ‘active validation method is permitted if risk factor value is no greater than threshold value’ or ‘active validation method is permitted if risk factor value is below the threshold’. Node N119 and all of the nodes represented by the unlabeled data points are within (under) the threshold and in accordance with this example can be validated using an active validation method.

It should be obvious that the threshold curve shown in FIG. 56 is only one way of representing a combination of parameters that make a risk factor for a node for a given vulnerability. Moreover, in other examples, the curve can have a different shape, and other parameters can enter into the combination of parameters that make up the risk factor.

Discussion of FIG. 57

FIG. 57 is a flowchart of another method of performing penetration testing by a penetration testing system that uses both active and passive validation methods. It shows another method in which penetration testing using both active and passive validation methods is performed in a single penetration testing campaign. The reader is referred to the definition of “penetration testing campaign” in the Definitions Section. The steps of the method are performed by a single penetration testing system.

In step S5151 of FIG. 57, which is the same step S5151 of FIG. 54, a networked system, e.g., networked system 200 of FIG. 53 is subjected to a penetration test using both active and passive validation methods during a single penetration testing campaign.

The right side of FIG. 57 is a flowchart of a method of implementing the penetration testing campaign of step S5151 according to a second embodiment.

In step S5201, a penetration testing campaign is commenced, either automatically by the penetration testing system based on a programmed schedule or manually by a user.

In step S5203, a first target network node is selected—i.e. determined to be the next target node for an attempt to compromise during the single penetration campaign.

In step S5205, a first potential vulnerability is selected based on the target node.

Validation of the first vulnerability in the first target network node can be performed either using an active (e.g., actual attack) validation method or a passive (e.g., simulated attack) validation method. Validation using an active method can lead to various kinds damage—including, but not exhaustively, financial and/or operational damage—by actually compromising the node, and this damage can be assessed before selecting a validation method for the respective vulnerability at each node. In step S5207, a first damage to the first target network node, which can be caused by validating the first vulnerability for the first target network node by using active validation, is determined. This determination of the first damage is then taken into account when selecting a first validation method. The reader is referred to the first and second additional discussions of FIG. 54, as well as FIGS. 55A, 55B and 56 for examples of how assessing potential damage from compromising a node (i.e.—actually attacking a node using an active validation method) can be used in selecting the type of validation to use. Thus, in step S5209, a first validation method is selected for validating the first vulnerability for the first target network node. The type of the first validation method is selected from the type group consisting of active validation and passive validation, and is associated with the first damage, i.e.—the selection takes into account the determination, in step S5207, of the damage that can occur when an active validation method is used for validating the first vulnerability for the first target node.

In step S5211, the first vulnerability for the first target network node is validated using the first validation method as selected in step S5209.

At a second point during the single penetration testing campaign, a second target network node (e.g. different from the first target node) which the penetration testing system will try to compromise is determined in step S5213. As mentioned earlier in the discussion of FIG. 54, the selection of the target network node may be carried out according to a lateral movement strategy employed in the penetration testing campaign.

In step S5215, a second vulnerability of network nodes, to be used for compromising the second target network node, is determined.

In step S5217, a second damage to the second target network node, which can be caused by validating the second vulnerability for the second target network node by using active validation, is determined. This determination of the second damage is then taken into account when selecting a second validation method in step S5219.

In step S5219, a second validation method is selected for validating the second vulnerability for the second target network node. The second validation method can be either active or passive. If an active validation method was selected as the first validation method in step S5209, then the second validation method is selected to be a passive validation method. Conversely, if a passive validation method was selected as the first validation method in step S5209, them the second validation method is selected to be an active validation method. Thus, in a single penetration testing campaign, and by a single penetration system, both active and passive validation methods can be selected and performed. In step S5221, the second vulnerability for the second target network node is validated using the second validation method selected in step S5219.

In step S5223, the single penetration testing campaign is terminated, either in accordance with a programmed duration or ending time as discussed earlier, or manually by a user, or by achieving its goal of determining a vulnerability ahead of the scheduled ending time. The skilled artisan will appreciate that the penetration testing campaign can encompass the testing/validation of more than two nodes as described here, and, for example, can encompass all of the nodes in a networked system 200.

In step S5225, the following is performed: reporting, by the penetration testing system, at least one security vulnerability determined to exist in the networked system by the executing of the single penetration testing campaign, wherein the reporting comprises at least one of (A) causing a display device to display a report containing information about the at least one security vulnerability of the networked system, (B) storing the report containing information about the at least one security vulnerability of the networked system in a file and (C) electronically transmitting the report containing information about the at least one security vulnerability of the networked system.

Discussion of FIGS. 58 and 59

FIG. 58 is a flowchart of a method of performing penetration testing by a penetration testing system that uses both active and passive validation methods. It shows a method in which penetration testing using both active and passive validation methods is performed in two penetration testing campaigns. The reader is referred to the definition of “penetration testing campaign” in the Definitions Section. The steps of the method are performed by a single penetration testing system.

In step S5153 of FIG. 58, a single networked system, e.g., networked system 200 of FIG. 53, is subjected to a penetration test using both active and passive validation methods during first and second penetration testing campaigns, and by a single penetration testing system. According to Step S5153, the first penetration testing campaign employs only active validation for validating vulnerabilities of network nodes of the single networked system, and the second penetration testing campaign employs only passive validation for validating vulnerabilities of network nodes of the single networked system.

The right side of FIG. 58 is a flowchart of a method of implementing the penetration testing campaigns of step S5153 according to an embodiment.

In step S5301, the first penetration testing campaign is executed by the single penetration testing system. The executing of the first penetration testing campaign comprises performing one or more validation operations for validating vulnerabilities for network nodes of the single networked system, wherein the methods of validation used for all validation operations included in the first penetration testing campaign are active validation methods.

In step S5302, the second penetration testing campaign is executed by the single penetration testing system. The executing of the second penetration testing campaign comprises performing one or more validation operations for validating vulnerabilities for network nodes of the single networked system, wherein the methods of validation used for all validation operations included in the second penetration testing campaign are passive validation methods.

In step S5305, the following is performed: reporting, by the penetration testing system, at least one security vulnerability determined to exist in the networked system by the executing of the first and second penetration testing campaigns, wherein the reporting comprises at least one of (A) causing a display device to display a report containing information about the at least one security vulnerability of the networked system, (B) storing the report containing information about the at least one security vulnerability of the networked system in a file and (C) electronically transmitting the report containing information about the at least one security vulnerability of the networked system.

The method of FIG. 58 employs a first penetration testing campaign which uses active validation methods, and a second penetration testing campaign which uses passive validation methods; both campaigns are run by a single penetration testing system in a single networked system. The first and second penetration testing campaigns can be conducted sequentially, in parallel, overlapping, or any combination thereof.

FIG. 59 illustrates non-limiting examples of how the first and second penetration testing campaigns can temporally relate to each other. Example 1 shows the second penetration testing campaign commencing sequentially after the first campaign. It should be obvious that the two campaigns can be one right after the other or, as shown, with a gap in time between the conclusion of the first campaign and the beginning of the second campaign. Example 2 illustrates the possibility of overlap, where the second penetration testing campaign commences while the first penetration testing campaign is still running. Example 3 shows the two campaigns substantially running in parallel. The two penetration testing campaigns are shown as having unequal durations and staggered start times, but in other examples they may have equal durations and/or simultaneous starting times. Example 4 is similar to Example 2 but with the second (passive method) penetration testing campaign commencing first and the first campaign (active methods) starting while the second campaign is still running.

In any of the methods disclosed herein, the penetration testing system 500 can be controlled by a user interface (not shown) of a computing device 110. Any of the methods can additionally include a step (like all other steps, performed by the penetration testing system 500) of receiving, via the user interface of the computing device 110, one or more manually-entered inputs. In the method discussed in connection with the flowchart of FIG. 54, the one or more manually-entered inputs can explicitly define a type of a validation method to be used for validating the first vulnerability, and/or a type of a validation method to be used for validating the second vulnerability. In the method discussed in connection with the flowchart of FIG. 57, the one or more manually-entered inputs can explicitly define a type of a validation method associated with the first damage, and/or a type of a validation method associated with the second damage. In the method discussed in connection with the flowchart of FIG. 58, the first and second penetration campaigns can both be based on a common scenario template. In such an embodiment, the one or more manually-entered inputs can explicitly define a type of a validation method to be used for validating all vulnerabilities in the first penetration testing campaign that is based on the common scenario template, and/or a type of a validation method to be used for validating all vulnerabilities in the second penetration testing campaign that is based on the common scenario template.

Additional Discussion of Control of the Method of Validation of Vulnerabilities.

The proposed solution is a penetration testing system that provides flexible control of the method of validation of potential vulnerabilities that is to be employed—whether validation by actual attack (active validation) or validation by simulation/evaluation (passive validation).

In a first embodiment, each potential vulnerability has a validation method associated with it (e.g. active validation or passive validation), and different potential vulnerabilities may have different validation methods, even during the execution of the same penetration testing campaign. That is, during the execution of a given penetration testing campaign, some vulnerabilities are validated by actual attack, while other vulnerabilities are validated by simulation/evaluation. For example, during the execution of a given penetration testing campaign, a first vulnerability that takes advantage of a weakness in a software driver of an I/O device and might cause a temporary disabling of the output device is validated by actual attack, while a second vulnerability that takes advantage of a weakness in Microsoft Word and might cause corruption of one or more user files is validated by simulation/evaluation. This embodiment addresses the first flexibility issue presented above.

In a first implementation of the first embodiment, the user is given control over the method of validation of each vulnerability. Each vulnerability in the system's knowledge base has a default method of validation associated with it, but the user interface of the penetration testing system provides means for the user to change the validation method currently associated with a vulnerability, selectively for each vulnerability. The change by the user may be temporary for only a single campaign execution, or it may be permanent and remain in effect until explicitly changed again.

In a second implementation of the first embodiment, the vendor of the penetration testing system decides which method of evaluation is associated with each specific vulnerability because it is considered to be more suitable for that specific vulnerability, and the user of the penetration testing system cannot override this decision. For example, the vendor may set the validation method of a first potential vulnerability that might result in a crash of a target network node to be validation by simulation/evaluation, while setting the validation method of a second potential vulnerability that might result in exporting a certain file to validation by actual attack.

In a second embodiment, vulnerabilities are handled according to the damaging operation resulting from their successful exploitation. Each damaging operation has a method of validation associated with it, and different damaging operations may be associated with different validation methods, even during the execution of the same penetration testing campaign. This embodiment eliminates the tedious task of separately associating a validation method with each one of the many potential vulnerabilities typically included in a vulnerabilities knowledge base of a penetration testing system. For example, during the execution of a given penetration testing campaign, some vulnerabilities (that might cause some damaging operations) are validated by actual attack, while other vulnerabilities (that might cause other damaging operations) are validated by simulation/evaluation. Whenever a vulnerability has to be validated, its damaging operation is determined, and the vulnerability is validated using the validation method associated with its damaging operation. Examples of damaging operations caused by vulnerabilities are corrupting of a system file, exporting of a user file, exporting of a passwords file, crashing down a network node, temporary disabling of an I/O device, etc. As an example, all vulnerabilities that might cause a temporary disabling of an I/O device are validated by actual attack, while all vulnerabilities that might cause corruption of a user file are validated by simulation/evaluation. This embodiment also addresses the first flexibility issue presented above.

In a first implementation of the second embodiment, the user is given control over the method of validation associated with each damaging operation. Each damaging operation has a default method of validation associated with it, but the user interface of the penetration testing system provides means for the user to change the validation method currently associated with a damaging operation, selectively for each damaging operation. The change by the user may be temporary for only a single campaign execution, or it may be permanent and remain in effect until explicitly changed again.

In a second implementation of the second embodiment, the vendor of the penetration testing system decides which method of validation is associated with each specific damaging operation because it is considered to be more suitable for that specific damaging operation, and the user of the penetration testing system cannot override this decision. For example, the vendor may set the validation method of all vulnerabilities that might result in a crash of the target network node to be validation by simulation/evaluation, while setting the validation method of all vulnerabilities that might result in exporting a system file to validation by actual attack.

In a third embodiment, each execution of a penetration testing campaign has a method of validation associated with it, so that all the vulnerabilities validated during the execution of the campaign are validated using that campaign-associated validation method. Different campaigns may have different validation methods. In some implementations, the same scenario template may be the basis for multiple campaigns executed at different points in time while having different validation methods associated with them. This embodiment addresses the second and third flexibility issues presented above.

In a first implementation of the third embodiment, the user is given control over the method of validation associated with each penetration testing campaign. The user interface of the penetration testing system provides means for the user to select the validation method associated with either the next campaign or with all campaigns that are based on a scenario template, selectively for each scenario template. That is, when selecting a scenario template in order to define a penetration testing campaign to execute, the user is given an option to select the validation method to be associated with that campaign, thus overriding any validation method previously defined for that scenario template.

If the scenario template is created by the user of the penetration testing system, then during the creation process the user selects the validation method that is to be associated with the newly-created scenario template. If the scenario template is selected from a library of scenario templates provided by the vendor of the penetration testing system or from a library of scenario templates previously defined by a user, then the current user may override the validation method previously associated with the scenario template (by the vendor, by another user, or by himself) and select a new validation method to be associated with the scenario template. The user selection may be temporary and be in effect only for a single campaign execution, or it may be permanent and stay in effect for all executions of campaigns that are based on the scenario template until a different selection is explicitly made.

In a second implementation of the third embodiment, the creator of a scenario template (either the vendor of the penetration testing system or a user of it) decides which method of validation is associated with the currently-created scenario template, and the user of the penetration testing system cannot later override this decision.

In any of the above embodiments, the considerations according to which a method of validation is selected for a given vulnerability, a given damaging operation, a given scenario template or a given campaign may be based on any type of reasoning. Specific examples are:
1. Based on the type of damaging operation caused to the tested networked system as a result of successfully exploiting the vulnerability.
2. Based on the probability of being successful in exploiting the vulnerability.
3. Based on the importance of the vulnerability (for example, a vulnerability that is frequently used by attackers in recent weeks vs. a vulnerability that is rarely used).
4. Based on the level of reliability desired for the conclusion of the validation of the vulnerability.
5. Based on the goal of the attacker of the campaign or the scenario template.
6. Based on the time of day of executing the campaign.
7. Based on a weighted combination of two or more of the above factors.

As an example, in a penetration testing system that employs local reconnaissance agents installed in network nodes of the tested networked system (as shown in FIG. 60, and as disclosed in U.S. patent application Ser. Nos. 15/681,782, 15/874,429, 15/940,376, and 15/983,309, and U.S. Pat. No. 10,038,711 which are all herein incorporated in this application by reference in their entirety), using the proposed solution results in the steps of each iteration of the penetration testing process being:
a. Collecting data from the reconnaissance client agents installed on some or all already-compromised nodes.
b. Based on the collected data (and the vulnerabilities knowledge base of the penetration testing system), choosing the network node that will be the next target node for compromising.
c. Based on the chosen target node, choosing the vulnerability that is the most likely to succeed in compromising the chosen target node.
d. Selecting the method of validation to be used for validating the success of the chosen vulnerability for the chosen target node. The selection is based on one or more of (i) the method of validation assigned to the chosen vulnerability, (ii) the method of validation assigned to the damaging operation associated with the chosen vulnerability, or (iii) the method of validation assigned to the current penetration testing campaign, depending on the embodiment.
e. Validating the success of the chosen vulnerability for the chosen target node using the selected method of validation. If the selected method of validation is actual attack, then the validating includes attempting to exploit the vulnerability against the chosen target node and then collecting data from the reconnaissance client agent installed on the chosen target node. The collected data depends on the chosen vulnerability and includes data of the chosen target node that is relevant for checking the success of compromising the chosen target node by the chosen vulnerability. If the selected method of validation is simulation/evaluation, then the validating is achieved in the remote computing device of the penetration testing system, without attempting to exploit the vulnerability against the chosen target node. The validating may include collecting data from the reconnaissance client agent installed on the chosen target node.
f. If necessary, updating the state of the campaign according to the result of the validation.
g. If not end of campaign, proceed to the next iteration of the penetration testing campaign.

Additional Discussion of Methods

We propose a method (see FIGS. 61A-61C) that is most useful for executing a penetration testing campaign for testing a networked system, wherein the executing of the penetration testing campaign includes validating two different vulnerabilities for corresponding two different network nodes of the networked system by two different validation methods, the method for executing the penetration testing campaign comprising:
a. starting the executing of the penetration testing campaign by the penetration testing system;
b. determining, by the penetration testing system, a first network node of the networked system to be the next network node to attempt to compromise in the penetration testing campaign;
c. determining, by the penetration testing system, a first vulnerability of network nodes to be used for compromising the first network node;
d. selecting, by the penetration testing system, a first validation method for validating the first vulnerability for the first network node, the first validation method being selected from a group comprising active validation and passive validation;
e. validating the first vulnerability for the first network node using the first validation method;
f. determining, by the penetration testing system, a second network node of the networked system to be the next network node to attempt to compromise in the penetration testing campaign;
g. determining, by the penetration testing system, a second vulnerability of network nodes to be used for compromising the second network node;
h. selecting, by the penetration testing system, a second validation method for validating the second vulnerability for the second network node, the second validation method being selected from the group comprising active validation and passive validation, wherein the second validation method is different from the first validation method;
i. validating the second vulnerability for the second network node using the second validation method;
j. reporting, by the penetration testing system, at least one security vulnerability of the networked system determined to exist based on results of the executing of the penetration testing campaign, wherein the reporting comprises at least one of (i) causing a display device to display a report containing information about the at least one security vulnerability of the networked system, (ii) storing the report containing information about the at least one security vulnerability of the networked system in a file and (iii) electronically transmitting the report containing information about the at least one security vulnerability of the networked system.

The identity of the first vulnerability may uniquely determine the first validation method, and the identity of the second vulnerability may uniquely determine the second validation method.

The penetration testing system may be controlled by a user interface of a computing device, and the method for executing the penetration testing campaign may further comprise:
k. receiving, by the penetration testing system and via the user interface of the computing device, one or more manually-entered inputs, the one or more manually-entered inputs explicitly defining at least one of (i) a validation method to be used for validating the first vulnerability, and (ii) a validation method to be used for validating the second vulnerability.

We also propose an additional method (see FIGS. 62A-62D) that is most useful for executing a penetration testing campaign for testing a networked system, wherein the executing of the penetration testing campaign includes validating two different vulnerabilities for corresponding two different network nodes of the networked system by two different validation methods, the method for executing the penetration testing campaign comprising:
a. starting the executing of the penetration testing campaign by the penetration testing system; p1 b. determining, by the penetration testing system, a first network node of the networked system to be the next network node to attempt to compromise in the penetration testing campaign;
c. determining, by the penetration testing system, a first vulnerability of network nodes to be used for compromising the first network node;
d. selecting, by the penetration testing system, a first validation method for validating the first vulnerability for the first network node, the first validation method being selected from a group comprising active validation and passive validation, wherein the selecting of the first validation method comprises:
   i. determining a first damage to the first network node that can be caused by validating the first vulnerability for the first network node by using active validation;
   ii. selecting the first validation method to be a validation method that is associated with the first damage;
e. validating the first vulnerability for the first network node using the first validation method;
f. determining, by the penetration testing system, a second network node of the networked system to be the next network node to attempt to compromise in the penetration testing campaign;
g. determining, by the penetration testing system, a second vulnerability of network nodes to be used for compromising the second network node;
h. selecting, by the penetration testing system, a second validation method for validating the second vulnerability for the second network node, the second validation method being selected from the group comprising active validation and passive validation, wherein the second validation method is different from the first validation method, wherein the selecting of the second validation method comprises:
   i. determining a second damage to the second network node that can be caused by validating the second vulnerability for the second network node by using active validation;
   ii. selecting the second validation method to be a validation method that is associated with the second damage;
i. validating the second vulnerability for the second network node using the second validation method;
j. reporting, by the penetration testing system, at least one security vulnerability of the networked system determined to exist based on results of the executing of the penetration testing campaign, wherein the reporting comprises at least one of (i) causing a display device to display a report containing information about the at least one security vulnerability of the networked system, (ii) storing the report containing information about the at least one security vulnerability of the networked system in a file and (iii) electronically transmitting the report containing information about the at least one security vulnerability of the networked system.

The identity of the first damage may uniquely determine the first validation method, and the identity of the second damage may uniquely determine the second validation method. The penetration testing system may be controlled by a user interface of a computing device, and the method for executing the penetration testing campaign may further comprise:
k. receiving, by the penetration testing system and via the user interface of the computing device, one or more manually-entered inputs, the one or more manually-entered inputs explicitly defining at least one of (i) a validation method associated with the first damage, and (ii) a validation method associated with the second damage.

We also propose yet another method (see FIGS. 63A-63D) that is most useful for executing penetration testing campaigns for testing a networked system, wherein the executing of the penetration testing campaigns includes executing a first penetration testing campaign using a first validation method for validating vulnerabilities of network nodes of the networked system, and executing a second penetration system campaign for testing the networked system using a second validation method for validating vulnerabilities of network nodes of the networked system, the second validation method being different from the first validation method, the method for executing the penetration testing campaigns comprising:
a. starting the executing of the first penetration testing campaign by the penetration testing system;
b. determining, by the penetration testing system, a first network node of the networked system to be the next network node to attempt to compromise in the first penetration testing campaign;
c. determining, by the penetration testing system, a first vulnerability of network nodes to be used for compromising the first network node;
d. selecting, by the penetration testing system, a first validation method for validating the first vulnerability for the first network node, the first validation method being selected from a group comprising active validation and passive validation;
e. validating, by the penetration testing system and as part of the executing of the first penetration testing campaign, the first vulnerability for the first network node using the first validation method;
f. starting the executing of the second penetration testing campaign by the penetration testing system;
g. determining, by the penetration testing system, a second network node of the networked system to be the next network node to attempt to compromise in the second penetration testing campaign;
h. determining, by the penetration testing system, a second vulnerability of network nodes to be used for compromising the second network node;
i. selecting, by the penetration testing system, a second validation method for validating the second vulnerability for the second network node, the second validation method being selected from the group comprising active validation and passive validation, wherein the second validation method is different from the first validation method;
j. validating, by the penetration testing system and as part of the executing of the second penetration testing campaign, the second vulnerability for the second network node using the second validation method;
k. reporting, by the penetration testing system, at least one security vulnerability of the networked system determined to exist based on at least one of (1) results of the executing of the first penetration testing campaign, and (2) results of the executing of the second penetration testing campaign, wherein the reporting comprises at least one of (i) causing a display device to display a report containing information about the at least one security vulnerability of the networked system, (ii) storing the report containing information about the at least one security vulnerability of the networked system in a file and (iii) electronically transmitting the report containing information about the at least one security vulnerability of the networked system.

In a first case, the first penetration testing campaign may be based on a first scenario template, the second penetration testing campaign may be based on a second scenario template, and the second scenario template may be different from the first scenario template.

In that first case, the identity of the first scenario template may uniquely determine the first validation method, and the identity of the second scenario template may uniquely determine the second validation method.

Also in that first case, the penetration testing system may be controlled by a user interface of a computing device, and the method for executing the penetration testing campaigns may further comprise:
1. receiving, by the penetration testing system and via the user interface of the computing device, one or more manually-entered inputs, the one or more manually-entered inputs explicitly defining at least one of (i) a validation method to be used for validating vulnerabilities in a penetration testing campaign that is based on the first scenario template, and (ii) a validation method to be used for validating vulnerabilities in a penetration testing campaign that is based on the second scenario template.

Also in that first case, the one or more manually-entered inputs may explicitly define at least one of (i) a validation method to be used for validating vulnerabilities in all penetration testing campaigns that are based on the first scenario template, and (ii) a validation method to be used for validating vulnerabilities in all penetration testing campaigns that are based on the second scenario template.

In a second case, the first penetration testing campaign and the second penetration testing campaign may be both based on a common scenario template.

In that second case, the penetration testing system may be controlled by a user interface of a computing device, and the method for executing the penetration testing campaigns may further comprise:
1. receiving, by the penetration testing system and via the user interface of the computing device, one or more manually-entered inputs, the one or more manually-entered inputs explicitly defining a validation method to be used for validating vulnerabilities in a penetration testing campaign that is based on the common scenario template.

Also in that second case, the one or more manually-entered inputs may explicitly define a validation method to be used for validating vulnerabilities in all penetration testing campaigns that are based on the common scenario template.

Definitions

This disclosure should be interpreted according to the definitions below. In case of a contradiction between the definitions in this Definitions section and other sections of this disclosure, this section should prevail.

In case of a contradiction between the definitions in this section and a definition or a description in any other document, including in another document incorporated in this disclosure by reference, this section should prevail, even if the definition or the description in the other document is commonly accepted by a person of ordinary skill in the art.
1. “computing device”—Any device having a processing unit into which it is possible to install code that can be executed by the processing unit. The installation of the code may be possible even while the device is operative in the field or it may be possible only in the factory.
2.“peripheral device”—Any device, whether a computing device or not, that provides input or output services to at least one other device that is a computing device. Examples of peripheral devices are printers, plotters, scanners, environmental sensors, smart-home controllers, digital cameras, speakers and display screens. A peripheral device may be directly connected to a single computing device or may be connected to a communication system through which it can communicate with one or more computing devices. A storage device that is (i) not included in or directly connected to a single computing device, and (ii) accessible by multiple computing devices, is a peripheral device.
3.“network” or “computing network”—A collection of computing devices and peripheral devices which are all connected to common communication means that allow direct communication between any two of the devices without requiring passing the communicated data through a third device. The network includes both the connected devices and the communication means. A network may be wired or wireless or partially wired and partially wireless.
4.“networked system” or “networked computing system”—One or more networks that are interconnected so that communication is possible between any two devices of the one or more networks, even if they do not belong to the same network. The connection between different networks of the networked system may be achieved through dedicated computing devices, and/or through computing devices that belong to multiple networks of the networked system and also have other functionality in addition to connecting between networks. The networked system includes the one or more networks, any connecting computing devices and also peripheral devices accessible by any computing device of the networked system. Note that a single network is a networked system having only one network, and therefore a network is a special case of a networked system.
5.“module ”—A portion of a system that implements a specific task. A module may be composed of hardware, software or any combination of both. For example, in a module composed of both hardware and software, the hardware may include a portion of a computing device, a single computing device or multiple computing devices, and the software may include software code executed by the portion of the computing device, by the single computing device or by the multiple computing devices. A computing device associated with a module may include one or more processors and computer readable storage medium (non-transitory, transitory or a combination of both) for storing instructions or for executing instructions by the one or more processors.
6.“network node of a networked system” or “node of a networked system”—Any computing device or peripheral device that belongs to the networked system.
7.“security vulnerability of a network node” or “vulnerability of a network node”—A weakness which allows an attacker to compromise the network node. A vulnerability of a network node may be caused by one or more of a flawed configuration of a component of the network node, a flawed setting of a software module in the network node, a bug in a software module in the network node, a human error while operating the network node, having trust in an already-compromised other network node, and the like.
   A weakness that allows an attacker to compromise a network node only conditionally, depending on current conditions in the network node or in the networked system in which the network node resides, is still a vulnerability of the network node, but may also be referred to as a “potential vulnerability of the network node”. For example, a vulnerability that compromises any network node running the Windows 7 Operating System, but only if the network node receives messages through a certain Internet port, can be said to be a vulnerability of any Windows 7 network node, and can also be said to be a potential vulnerability of any such node. Note that in this example the potential vulnerability may fail in compromising the node either because the certain port is not open (a condition in the node) or because a firewall is blocking messages from reaching the certain port in the node (a condition of the networked system).
8.“security vulnerability of a networked system” or “vulnerability of a networked system”—A weakness which allows an attacker to compromise the networked system. A vulnerability of a networked system may be caused by one or more of a vulnerability of a network node of the networked system, a flawed configuration of a component of the networked system, a flawed setting of a software module in the networked system, a bug in a software module in the networked system, a human error while operating the networked system, and the like.
   A weakness that allows an attacker to compromise a networked system only conditionally, depending on current conditions in the networked system, is still a vulnerability of the networked system, but may also be referred to as a “potential vulnerability of the networked system”. For example, if a network node of the networked system has a potential vulnerability then that vulnerability can be said to be a vulnerability of the networked system, and can also be said to be a potential vulnerability of the networked system.
9.“validating a vulnerability” or “validating a potential vulnerability” (for a given network node or for a given networked system)—Verifying that the vulnerability compromises the given network node or the given networked system under the conditions currently existing in the given network node or the given networked system.
   The validation of the vulnerability may be achieved by actively attempting to compromise the given network node or the given networked system and then checking if the compromising attempt was successful. Such validation is referred to as “active validation”.
   Alternatively, the validation of the vulnerability may be achieved by simulating the exploitation of the vulnerability or by otherwise evaluating the results of such exploitation without actively attempting to compromise the given network node or the given networked system. Such validation is referred to as “passive validation”. Note that just assuming that a vulnerability will succeed in compromising a given network node or a given networked system under current conditions without executing either active validation or passive validation, is not considered as validating the vulnerability.
10.“vulnerability management”—A cyclical practice of identifying, classifying, remediating, and mitigating vulnerabilities of network nodes in a networked system.
11.“penetration testing” or “pen testing” (in some references also known as “red team assessment” or “red team testing”, but in other references those terms referring to a red team have a different meaning than “penetration testing”)—A process in which a networked system is evaluated in order to determine if it can be compromised by an attacker by utilizing one or more security vulnerabilities of the networked system. If it is determined that the networked system can be compromised, then the one or more security vulnerabilities of the networked system are identified and reported.
   Unlike a vulnerability management process which operates at the level of isolated vulnerabilities of individual network nodes, a penetration test may operate at a higher level which considers vulnerabilities of multiple network nodes that might be jointly used by an attacker to compromise the networked system.
   A penetration testing process involves at least the following functions: (i) a reconnaissance function, (ii) an attack function, and (iii) a reporting function. It should be noted that the above functions do not necessarily operate sequentially according to the above order, but may operate in parallel or in an interleaved mode.

Unless otherwise explicitly specified, a reference to penetration testing should be understood as referring to automated penetration testing.
12.“automated penetration testing”—Penetration testing in which at least one of the reconnaissance function, the attack function and the reporting function is at least partially automated.
13.“penetration testing system”—A system capable of performing penetration testing, regardless if composed of hardware, software or combination of both.
14.“reconnaissance function” or “recon function”—The function in a penetration testing process that handles collection of data about the tested networked system. The collected data may include internal data of one or more network nodes of the tested networked system. Additionally, the collected data may include data about communication means of the tested networked system and about peripheral devices of the tested networked system. The collected data may also include data that is only indirectly related to the tested networked system, for example business intelligence data about the organization owning the tested networked system, collected in order to use it for assessing importance of resources of the networked system.
   The functionality of a reconnaissance function may be implemented by any combination of (i) software executing in a remote computing device, where the remote computing device may probe the tested networked system for the purpose of collecting data about it, (ii) hardware and/or software simulating or duplicating the tested networked system, (iii) a reconnaissance agent software module executing in one or more network nodes of the tested networked system.
15.“attack function”—The function in a penetration testing process that handles determination of whether one or more security vulnerabilities exist in the tested networked system. The determination is based on data collected by the reconnaissance function of the penetration testing. The attack function generates data about each of the identified security vulnerabilities, if any.
   The functionality of an attack function may be implemented by any combination of (i) software executing in a remote computing device, where the remote computing device may attack the tested networked system for the purpose of verifying that it can be compromised, (ii) hardware and/or software simulating or duplicating the tested networked system, (iii) an attack agent software module executing in one or more network nodes of the tested networked system.
   The methods used by an attack function may include executing a real attack on the tested networked system by attempting to change at least one setting, mode or state of a network node or of a hardware or software component of a network node, in order to verify that the tested networked system may be compromised. In such case, the attempt may result in actually compromising the tested networked system. Alternatively, the methods used by an attack function may be such that whenever there is a need to verify whether a setting, a mode or a state of a network node or of a hardware or software component of a network node can be changed in a way that compromises the tested networked system, the verification is done by simulating the effects of the change or by otherwise evaluating them without ever actually compromising the tested networked system.
16.“reporting function”—The function in a penetration testing process that handles reporting of results of the penetration testing. The reporting comprises at least one of (i) causing a display device to display a report including information about the results of the penetration testing, (ii) recording a report including information about the results of the penetration testing in a file, and (iii) electronically transmitting a report including information about the results of the penetration testing.
   The functionality of a reporting function may be implemented by software executing in a remote computing device, for example in the computing device implementing the attack function of the penetration testing.
17.“recovery function” or “clean-up function”—The function in a penetration testing process that handles cleaning-up after a penetration test. The recovery includes undoing any operation done during the penetration testing process that results in compromising the tested networked system.
   The functionality of a recovery function may be implemented by any combination of (i) software executing in a remote computing device, for example in the computing device implementing the attack function of the penetration testing, (ii) an attack agent software module executing in one or more network nodes of the tested networked system.
18.“a campaign of penetration testing” or “penetration testing campaign” or just “campaign”—A specific run of a specific test of a specific networked system by the penetration testing system.

An execution of a campaign must end by one of the following: (i) determining by the penetration testing system that the goal of the attacker was reached by the campaign, (ii) determining by the penetration testing system that the goal of the attacker cannot be reached by the campaign, (iii) if the campaign is assigned a time limit, exceeding the time limit by the campaign, and (iv) manually terminating the campaign by a user of the penetration testing system.
19.“results of a penetration testing campaign”—Any output generated by the penetration testing campaign. This includes, among other things, data about any security vulnerability of the networked system tested by the penetration testing campaign that is detected by the campaign. It should be noted that in this context the word “results” is used in its plural form regardless of the amount of output data generated by the penetration testing campaign, including when the output consists of data about a single security vulnerability.
20.“information item of a campaign”—A variable data item that a penetration testing system must know its value before executing the campaign. Note that a data item must be able to have different values at different campaigns in order to be considered an information item of the campaign. If a data item always has the same value for all campaigns, it is not an information item of the campaign, even if it must be known and is being used by the penetration testing system when executing the campaign.
   An information item of a campaign is either a primary information item of the campaign or a secondary information item of the campaign.
   A type of an attacker and a goal of an attacker are examples of information items of a campaign. Another example of an information item of a campaign that is more complex than the previous two simple examples is a subset of the network nodes of the networked system that is assumed to be already compromised at the time of beginning the penetration testing campaign, with the subset defined either by an explicit selection of network nodes or by a Boolean condition each node of the subset has to satisfy.
   A value of an information item may be composed either of a simple value or of both a main value and one or more auxiliary values. If a specific main value of an information item requires one or more auxiliary values that complete the full characterization of the value, then the combination of the main value and the one or more auxiliary values together is considered to be the value assigned to the information item. For example, for a “goal of the attacker” information item, after a user selects a main value of “exporting a specific file from whatever node having a copy of it”, the user still has to provide a file name as an auxiliary value in order for the goal information item to be fully characterized. In this case the combination of “exporting a specific file from whatever node having a copy of it” and the specific file name is considered to be the value of the “goal of the attacker” information item.
21.“primary information item of a campaign”—An information item of the campaign which is completely independent of previously selected values of other information items of the campaign. In other words, the options available to a user for selecting the value of a primary information item of the campaign are not dependent on any value previously selected for any another information item of the campaign. For example, the options available to the user for selecting a goal of the attacker are independent of values previously selected for any other information item of the campaign, and therefore the goal of the attacker is a primary information item of the campaign.
22.“secondary information item of a campaign”—An information item of the campaign which depends on at least one previously selected value of another information item of the campaign. In other words, the options available to a user for selecting the value of a secondary information item of the campaign depend on at least one value previously selected for another information item of the campaign. For example, the options available to the user for selecting a capability of an attacker may depend on the previously selected value of the type of the attacker. For a first type of attacker the available capabilities to select from may be a first group of capabilities, while for a second type of attacker the available capabilities to select from may be a second group of capabilities, different from the first group. Therefore, a capability of the attacker is a secondary information item of the campaign.
23.“specifications of a campaign” or “scenario”—A collection of values assigned to all information items of the campaign. As having a value for each information item of a campaign is essential for running it, a campaign of a penetration testing system cannot be run without providing the penetration testing system with full specifications of the campaign. A value of an information item included in the specifications of a campaign may be manually selected by a user or may be automatically determined by the penetration testing system. In the latter case, the automatic determination by the system may depend on one or more values selected by the user for one or more information items of the campaign, or it may be independent of any selection by the user. For example, the selection of the capabilities of the attacker may automatically be determined by the system based on the user-selected type of the attacker, and the lateral movement strategy of the attacker may be automatically determined by the system independently of any user selection.
24.“pre-defined scenario”, “pre-defined test scenario”, “scenario template” or “template scenario”—A scenario that exists in storage accessible to a penetration testing system before the time a campaign is started, and can be selected by a user of the penetration testing system for defining a campaign of penetration testing.
   A pre-defined scenario may be created and provided by the provider of the penetration testing system and may be part of a library of multiple pre-defined scenarios. Alternatively, a pre-defined scenario may be created by the user of the penetration testing system using a scenario editor provided by the provider of the penetration testing system.
   A penetration testing system may require that a campaign of penetration testing that is based on a pre-defined scenario must have all its values of information items taken from the pre-defined scenario, with no exceptions. Alternatively, a penetration testing system may allow a user to select a pre-defined scenario and then override and change one or more values of information items of a campaign that is based on the pre-defined scenario.
25.“attacker” or “threat actor”—An entity, whether a single person, a group of persons or an organization, that might conduct an attack against a networked system by penetrating it for uncovering its security vulnerabilities and/or for compromising it.
26.“a type of an attacker”—A classification of the attacker that indicates its main incentive in conducting attacks of networked systems. Typical values for a type of an attacker are state-sponsored, opportunistic cyber criminal, organized cyber criminal and insider.
   An attacker can have only a single type.
27.“a capability of an attacker”—A tool in the toolbox of the attacker. A capability describes a specific action that the attacker can perform. Examples of capabilities are copying a local file of a network node and exporting it to the attacker out of the networked system and remotely collecting database information from an SQL server of the networked system. In some systems, selecting a type of an attacker causes a corresponding default selection of capabilities for that type of attacker, but the user may have an option to override the default selection and add or delete capabilities.
   An attacker can have one or multiple capabilities.
28.“a method of a capability”—A combination of (i) an algorithm for implementing the capability, and (ii) a required condition for the capability to be applicable and feasible for an attacker having that capability. For example, an opportunistic cyber-criminal may have the knowledge of forcing RCE (Remote Code Execution) in a browser of a targeted network node using a simple and well-known algorithm, but that algorithm is only applicable when the browser is an old version of IE (Internet Explorer) not higher than a specific version number. On the other hand, a state-sponsored attacker may have the knowledge of forcing RCE using a complex and sophisticated algorithm, that algorithm being applicable to every type of browser and every version of it. The two attackers both have the same capability of forcing RCE for browsers, but have different methods for that capability—for one attacker the RCE capability is implemented by a first method which is limited to a certain subclass of browsers, while for the other attacker the RCE capability is implemented by a second method which is applicable to all browsers.
   The condition of a method may be the trivial condition that is always satisfied, as is demonstrated in the above example in which a state-sponsored attacker has an RCE capability with an always-true condition. A capability can have one or multiple methods.
29.“a trait of an attacker”—A behavioral and non-technical feature of the attacker that may affect how he conducts his attack. A trait may be a condition controlling the conducting of the attack by the attacker. An example of a trait of an attacker is the sensitivity of the attacker to detection (a.k.a. the aggression level of the attacker). A state-sponsored attacker may be assumed to only use his capabilities if the attack can be hidden and remain undetected by the organization owning the attacked networked system. On the other hand, an opportunistic cyber criminal that has the same capabilities and methods may be assumed to completely ignore considerations of being detected or not. The two attackers have the same capabilities and methods, but different values for the sensitivity to detection trait, that control their operation during the attack. Alternatively, a trait may have several (more than two) discrete possible values. For example, the sensitivity to detection trait described above, may be assigned any one of the values “highly sensitive”, “moderately sensitive” and “not sensitive”. Alternatively, a trait may have a value selectable from a continuous scale, for example from the range [0 . . . 100].
   An attacker can have one or multiple traits.
30.“a level of sensitivity to detection of an attacker” or “an aggression level of an attacker”—The extent to which the attacker prefers not to be detected while carrying out his attack. A high level of sensitivity to detection or a high aggression level indicate a strong preference for not being detected. A low level of sensitivity to detection or low aggression level indicate weak preference for not being detected. The sensitivity/aggression level may be specified as one of two possible values (e.g. “sensitive” vs. “not sensitive”). Alternatively, the sensitivity/aggression level may be specified as one of several (more than two) discrete possible values (e.g. “highly sensitive”, “moderately sensitive”, “moderately not sensitive”, “highly not sensitive”). Alternatively, the sensitivity/aggression level may be specified as a value selectable from a continuous scale (e.g. from the range [0 . . . 10]).
31.“a goal of an attacker”—What the attacker of a campaign is trying to achieve when attacking a targeted networked system. In other words, what is the criterion according to which the attacker will judge whether the attack was a success or a failure and/or to what extent was it a success or a failure. Selecting a type of an attacker may cause a default selection of a goal for that attacker, but the user may have an option to override the default selection. An attacker can have one or multiple goals.
32.“a resource-specific goal of an attacker”—A goal of the attacker that has a characteristic of being associated with a specific resource in the tested networked system. Examples of resource-specific goals are deleting a specific folder, shutting down a specific peripheral device, and exporting a specific file out of the networked system. The specific resource may be identified by a name (e.g. a file name), an address (e.g. a network address of a peripheral device), a serial number (e.g. a serial number of a peripheral device), or in any other way that unambiguously identifies it. Note that a goal specifying a resource existing in multiple identical copies in the networked system (e.g. a file existing in multiple network nodes), where the attacker does not mind which of the copies is targeted, is a resource-specific goal.
33.“a file-specific goal of an attacker”—A goal of the attacker that has a characteristic of being associated with a specific file in the tested networked system. Examples of file-specific goals are deleting a specific file, exporting a specific file out of the networked system, and encrypting a specific file. The specific file may be identified by a name (e.g. a file name), or in any other way that unambiguously identifies it. Note that a goal specifying a file existing in multiple identical copies in the networked system (e.g. a file existing in multiple network nodes), where the attacker does not mind which of the copies is targeted, is a file-specific goal. Also note a file-specific goal is also a resource-specific goal.
34.“a node-count-maximizing goal of an attacker”—A goal of the attacker that has a characteristic of being associated with maximizing the number of network nodes satisfying a given condition. Examples of node-count-maximizing goals are compromising as many nodes as possible, and encrypting at least one file on as many nodes as possible. A goal that is associated with increasing the number of network nodes satisfying a given condition until a given networked-system-level condition is satisfied, is also a node-count-maximizing goal. An example of such goal is compromising enough network nodes so that the ratio of the number of already-compromised nodes to the number of not-yet-compromised nodes in the networked system is higher than a given threshold. However, a goal of compromising a given number of nodes in the networked system is not a node-count-maximizing goal, because it does not include a networked-system-level condition.
35.“a file-count-maximizing goal of an attacker”—A goal of the attacker that has a characteristic of being associated with maximizing the number of files satisfying a given condition. Examples of file-count-maximizing goals are exporting out of the networked system as many files as possible, and encrypting as many files as possible. A goal that is associated with increasing the number of files satisfying a given condition until a given networked-system-level condition is satisfied, is also a file-count-maximizing goal. An example of such goal is exporting outside the networked system of files having a total size that is more than a given size. However, a goal of exporting a given number of files is not a file-count-maximizing goal, because it does not include a networked-system-level condition.
36.“an encryption-related goal of an attacker”—A goal of an attacker that has a characteristic of being associated with encrypting one or more files. Examples of encryption-related goals are encrypting a specific file, encrypting as many files as possible, and encrypting as many files of a specific file type. Note that an encryption-related goals is also a file-damage-related goal.
37.“a file-exporting goal of an attacker”—A goal of an attacker that has a characteristic of being associated with exporting one or more files out of the networked system. Examples of file-exporting goals are exporting a specific file, exporting as many files as possible, and exporting as many files of a specific type.
38.“a file-size-related goal of an attacker”—A goal of an attacker that has a characteristic of being associated with the file size of one or more files. Examples of file-size-related goals are exporting a file larger than 100 Megabytes, exporting one or more files whose combined size is larger than 100 Megabytes, and encrypting one or more files whose combined size is larger than 100 Megabytes.
39.“a file-type-related goal of an attacker”—A goal of an attacker that has a characteristic of being associated with a file type of one or more files. Examples of file-type-related goals are exporting out of the networked system of as many files of a given type as possible, and encrypting as many files of a given type as possible.
40. “a file-damage-related goal of an attacker”—A goal of an attacker that has a characteristic of being associated with damaging one or more files. Examples of file-damage-related goals are deleting a specific file, deleting as many files as possible, and renaming as many files as possible.
41. “a node-condition-based goal of an attacker”—A goal of an attacker that has a characteristic of being associated with a Boolean condition applied to network nodes of the tested networked system. One example of a node-condition-based goal is compromising a given number of network nodes, all of which are members of a subset of the nodes of the tested networked system, where the subset of nodes is defined as all nodes of the tested networked system satisfying a given condition. The condition may be, for example, “running the Windows 7 Operating system” or “being a mobile device”. Another example of a node-condition-based goal is compromising all the network nodes that are members of a subset of the nodes of the tested networked system, where the subset of nodes is defined as all the nodes of the tested networked system satisfying a given condition, where the given condition is “having a cellular communication channel”.
42. “a lateral movement strategy of an attacker”—A decision logic applied by the attacker of a campaign for selecting the next network node to try to compromise.
   During a penetration testing campaign, the attacker is assumed to make progress by an iterative process in which in each iteration he selects the next node to attack, based on the group of network nodes he already controls (i.e. that are already compromised). If the attack on the selected node is successful, that node is added to the group of nodes that are already compromised, and another iteration starts. If the attempt to compromise the selected node fails, another node is selected, either according to some other rule or randomly.
   It should be noted that all types of penetration testing systems, whether using simulated penetration testing, actual attack penetration testing or some other form of penetration testing, must use a lateral movement strategy. In the case of a penetration testing system that actually attacks the tested networked system, the lateral movement strategy selects the path of attack actually taken through the networked system. In the case of a penetration testing system that simulates or evaluates the results of attacking the tested networked system, the lateral movement strategy selects the path of attack taken in the simulation or the evaluation through the networked system. Therefore in the above explanation, the term “attack” should be understood to mean “actual attack or simulated attack”, the term “already controls” should be understood to mean “already controls or already determined to be able to control”, the term “already compromised” should be understood to mean “already compromised or already determined to be compromisable”, etc.
A simple example of a lateral movement strategy is a “depth first” strategy. In such strategy, the next network node to try to compromise is an immediate neighbor of the last network node that was compromised that is not yet compromised (provided such neighbor node exists). Two network nodes are “immediate neighbors” of each other if and only if they have a direct communication link between them that does not pass through any other network node.
   Another simple example is a “breadth search” strategy. In such strategy, the next network node to try to compromise is a network node whose distance from the first node compromised by the campaign is the smallest possible. The distance between two network nodes is the number of network nodes along the shortest path between them, plus one. A path is an ordered list of network nodes in which each pair of adjacent nodes in the list is a pair of immediate neighbors. Thus, the distance between two immediate neighbors is one.
   An example of a more advanced lateral movement strategy is a strategy that is applicable when a goal of the attacker is related to a resource of the networked system that resides in a specific network node. In such case the next network node to try to compromise may be selected by determining the shortest path in the networked system leading from an already compromised node to the specific node containing the desired resource, and picking the first node on this path to be the next node to try to compromise. Note that if the shortest path has a length of one (which happens when the specific node is an immediate neighbor of an already compromised node), then the next node to try to compromise is the specific node containing the desired resource. Another example of a lateral movement strategy is a strategy that gives priority to network nodes satisfying a specific condition, for example nodes that are known to have a specific weakness, such as running the Windows XP operating system. In such case the next node to try to compromise is a node that satisfies the condition and is also an immediate neighbor of an already compromised node (if such node exists). Selecting a type of an attacker may cause a default selection of a lateral movement strategy for that attacker, but the user may have an option to override the default selection.
An attacker can only have a single lateral movement strategy.
43.“penetration testing by simulation” or “simulated penetration testing”—Penetration testing in which (i) the functionality of the reconnaissance function is fully implemented by software executing by a remote computing device and/or by hardware and/or software simulating or duplicating the tested networked system, where the remote computing device may probe the tested networked system for the purpose of collecting data about it, as long as this is done without risking compromising the tested networked system, and (ii) the methods used by the attack function are such that whenever there is a need to verify whether a setting, a mode or a state of a network node or of a hardware or software component of a network node can be changed in a way that compromises the tested networked system, the verification is done by simulating the effects of the change or by otherwise evaluating them without risking compromising the tested networked system.
44.“penetration testing by actual attack” or “actual attack penetration testing” or “penetration testing by actual exploit” or “actual exploit penetration testing”—Penetration testing in which (i) the functionality of the reconnaissance function is fully implemented by (A) software executing in a remote computing device, where the remote computing device may probe the tested networked system for the purpose of collecting data about it even if this risks compromising the tested networked system, and/or by (B) software executing in one or more network nodes of the tested networked system that analyzes network traffic and network packets of the tested networked system for collecting data about it, and (ii) the methods used by the attack function include executing a real attack on the tested networked system by attempting to change at least one setting, mode or state of a network node or of a hardware or software component of a network node in order to verify that the tested networked system may be compromised, such that the attempt may result in compromising the tested networked system.
45.“penetration testing by reconnaissance agents” or “reconnaissance agent penetration testing”—Penetration testing in which (i) the functionality of the reconnaissance function is at least partially implemented by a reconnaissance agent software module installed and executed in each one of multiple network nodes of the tested networked system, where the data collected by at least one instance of the reconnaissance agent software module includes internal data of the network node in which it is installed, and the data collected by at least one instance of the reconnaissance agent software module is at least partially collected during the penetration testing process, and (ii) the methods used by the attack function are such that whenever there is a need to verify whether a setting, a mode or a state of a network node or of a hardware or software component of a network node can be changed in a way that compromises the tested networked system, this is done by simulating the effects of the change or by otherwise evaluating them without risking compromising the tested networked system.
46.“reconnaissance client agent”, “reconnaissance agent” or “recon agent”—A software module that can be installed on a network node and can be executed by a processor of that network node for partially or fully implementing the reconnaissance function of a penetration test. A reconnaissance agent must be capable, when executed by a processor of the network node in which it is installed, of collecting data at least about some of the events occurring in the network node. Such events may be internal events of the network node or messages sent out of the network node or received by the network node. A reconnaissance agent may be capable of collecting data about all types of internal events of its hosting network node. Additionally, it may be capable of collecting other types of data of its hosting network node. A reconnaissance agent may additionally be capable of collecting data about other network nodes or about other components of a networked system containing the hosting network node. A reconnaissance agent may be persistently installed on a network node, where “persistently” means that once installed on a network node the reconnaissance agent survives a reboot of the network node. Alternatively, a reconnaissance agent may be non-persistently installed on a network node, where “non-persistently” means that the reconnaissance agent does not survive a reboot of the network node and consequently should be installed again on the network node for a new penetration test in which the network node takes part, if the network node was rebooted since the previous penetration test in which it took part.
47.“attack client agent” or “attack agent”—A software module that can be installed on a network node and can be executed by a processor of that network node for partially or fully implementing the attack function of a penetration test. Typically, an attack agent is installed by an actual attack penetration testing system in a network node that it had succeeded to compromise during a penetration test. Once installed on such network node, the attack agent may be used as a tool for compromising other network nodes in the same networked system. In such case, the attack agent may include code that when executed by a processor of the compromised network node compromises another network node that is adjacent to it in the networked system, possibly taking advantage of the high level of trust it may have from the point of view of the adjacent network node. Another type of an attack agent may include code that when executed by a processor of a network node determines whether that network node would be compromised if a given operation is performed.
48.“penetration testing software module” or “remote computing device penetration testing software module”—A software module that implements the full functionality of a penetration testing system, except for the functionality implemented by (i) reconnaissance agents, (ii) attack agents, and (iii) hardware and/or software simulating or duplicating the tested networked system, if such components are used in the implementation of the penetration testing system.
   The penetration testing software module may be installed and executed on a single computing device or comprise multiple software components that reside on multiple computing devices. For example, a first component of the penetration testing software module may implement part or all of the reconnaissance function and be installed and executed on a first computing device, a second component of the penetration testing software module may implement part or all of the attack function and be installed and executed on a second computing device, and a third component of the penetration testing software module may implement the reporting function and be installed and executed on a third computing device.
49.“internal data of a network node”—Data related to the network node that is only directly accessible to code executing by a processor of the network node and is only accessible to any code executing outside of the network node by receiving it from code executing by a processor of the network node. Examples of internal data of a network node are data about internal events of the network node, data about internal conditions of the network node, and internal factual data of the network node.
50.“internal event of/in a network node”—An event occurring in the network node whose occurrence is only directly detectable by code executing by a processor of the network node. Examples of an internal event of a network node are an insertion of a USB drive into a port of the network node, and a removal of a USB drive from a port of the network node. An internal event may be a free event or a non-free event.

It should be noted that the term “an event of X” refers to any occurrence of an event of the type X and not to a specific occurrence of it. For referring to a specific occurrence of an event of type X one should explicitly say “an occurrence of event of X”. Thus, a software module which looks for detecting insertions of a USB drive into a port is “detecting an event of USB drive insertion”, while after that module had detected such event it may report “an occurrence of an event of USB drive insertion”.
51.“internal condition of/in a network node”—A Boolean condition related to the network node which can only be directly tested by code executing by a processor of the network node. Examples of an internal condition of a network node are whether the local disk of the terminal node is more than 98% full or not, and whether a USB drive is currently inserted in a port of the network node.
52.“internal factual data of/in a network node” or “internal facts of a network node”—Facts related to the network node which can only be directly found by code executing by a processor of the network node. Examples of factual data of a network node are the version of the firmware of a solid-state drive installed in the network node, the hardware version of a processor of the network node, and the amount of free space in a local disk of the network node.
53.“resource of a networked system”—A file in a network node of the networked system, a folder in a network node of the networked system, credentials of a user of the networked system, a peripheral device of a network node of the networked system, or a peripheral device directly attached to a network of the networked system.
54.“compromising a network node”—Successfully causing execution of an operation in the network node that is not allowed for the entity requesting the operation by the rules defined by an administrator of the network node, or successfully causing execution of code in a software module of the network node that was not predicted by the vendor of the software module. Examples for compromising a network node are reading a file without having read permission for it, modifying a file without having write permission for it, deleting a file without having delete permission for it, exporting a file out of the network node without having permission to do so, getting an access right higher than the one originally assigned without having permission to get it, getting a priority higher than the one originally assigned without having permission to get it, changing a configuration of a firewall network node such that it allows access to other network nodes that were previously hidden behind the firewall without having permission to do it, and causing execution of software code by utilizing a buffer overflow. As shown by the firewall example, the effects of compromising a certain network node are not necessarily limited to that certain network node. In addition, executing successful ARP spoofing, denial-of-service, man-in-the-middle or session-hijacking attacks against a network node are also considered compromising that network node, even if not satisfying any of the conditions listed above in this definition.
55.“ARP spoofing”—a technique for compromising a target network node in which an attacker sends a false Address Resolution Protocol (ARP) reply message to the target network node. The aim is to associate an attacker's MAC address (either a MAC address of the node sending the false ARP reply message or a MAC address of another node controlled by the attacker) with the IP address of another host, such as the default gateway, causing any traffic sent by the target node and meant for that IP address to be sent to the attacker instead. ARP spoofing may allow an attacker to intercept data frames on a network, modify the traffic, or stop all traffic to a certain node. Often the attack is used as an opening for other attacks, such as denial-of-service, man-in-the-middle, or session-hijacking attacks.
56.“denial-of-service attack”—a cyber-attack where an attacker seeks to make a service provided by a network node to other network nodes unavailable to its intended users either temporarily or indefinitely. The denial-of-service attack may be accomplished by flooding the node providing the targeted service with superfluous requests in an attempt to overload it and prevent some or all legitimate requests from being fulfilled. Alternatively, the denial-of-service attack may be accomplished by causing some or all of the legitimate requests addressed to the targeted service to not reach their destination.
57.“man-in-the-middle attack”—a cyber-attack where an attacker secretly relays and possibly alters the communication between two network nodes who believe they are directly communicating with each other. One example of man-in-the-middle attacks is active eavesdropping, in which the attacker makes independent connections with the victims and relays messages between them to make them believe they are communicating directly with each other, when in fact the entire communication session is controlled by the attacker. The attacker must be able to intercept all relevant messages passing between the two victims and inject new ones.
58.“session-hijacking attack”—a cyber-attack where a valid communication session between two network nodes in a networked system is used by an attacker to gain unauthorized access to information or services in the networked computer system.
59.“compromising a networked system”—Compromising at least one network node of the networked system or successfully causing execution of an operation in the networked system that is not allowed for the entity requesting the operation by the rules defined by an administrator of the networked system. Examples for operations in the networked system that may not be allowed are exporting a file out of the networked system without having permission to do so, sending a file to a network printer without having permission to do so, and copying a file from one network node to another network node without having permission to do so.
60.“compromising a software application”—Successfully causing the software application to execute an operation that is not allowed for the entity requesting the operation by the rules defined by an administrator of the network node on which the software application is installed or by a vendor of the software application, or successfully causing the execution of code in the software application that was not predicted by the vendor of the software application. Examples for compromising a software application are changing a configuration file controlling the operation of the software application without having permission for doing so, and activating a privileged function of the software application without having permission for doing so. In addition, causing the software application to execute a macro without checking rights of the macro code to do what it is attempting to do is also considered compromising that software application, even if not satisfying any of the conditions listed above in this definition.
61.“administrator of a network node”—Any person that is authorized, among other things, to define or change at least one rule controlling at least one of an access right, a permission, a priority and a configuration in the network node.
62.“administrator of a networked system”—Any person that is authorized, among other things, to define or change at least one rule controlling at least one of an access right, a permission, a priority and a configuration in the networked system. Note that an administrator of a networked system may also be an administrator of one or more of the network nodes of the networked system.
63.“remote computing device” or “penetration testing remote computing device” (with respect to a given networked system)—A computing device that executes software implementing part or all of the penetration testing software module that is used for testing the given networked system.
   A remote computing device may be (i) outside of the given networked system, or (ii) inside the given networked system. In other words, a remote computing device is not necessarily physically remote from the given networked system. It is called “remote” to indicate its functionality is logically separate from the functionality of the given networked system.
   A remote computing device may (i) be a dedicated computing device that is dedicated only to doing penetration testing, or (ii) also implement other functionality not directly related to penetration testing.
   A remote computing device is not limited to be a single physical device with a single processing unit. It may be implemented by multiple separate physical devices packaged in separate packages that may be located at different locations. Each of the separate physical devices may include one or multiple processing units.

A remote computing device may be (i) a physical computing device, or (ii) a virtual machine running inside a physical computing device on top of a hosting operating system.
64.“free event of/in a network node”—An event occurring in the network node which is initiated in and by the network node and is not directly caused or triggered by an entity outside that network node. A free event of a network node may be initiated by a user of the network node, by an operating system of the network node or by an application executing on the network node. A free event of a network node may be either an internal event or a non-internal event of the network node. Examples of free events of a network node are the insertion or removal of a USB removable storage device into/from a socket of the network node, the sending of a query to a web server in response to a user manually entering the query, the sending of an ARP request message by the network node while initializing the network node after manually powering it up, and the sending of a WPAD message by the network node in response to manually typing by the user of a URL into a browser's address input box. Examples of events of a network node that are not free events are the receiving of a network message by the network node, and the sending of a network message by the network node that is done in response to receiving another network message from another network node.
65.“free event reconnaissance agent”—A reconnaissance agent that is capable of detecting and reporting at least some occurrences of at least one type of free events occurring in a network node in which it is installed. Note that it is not necessary for a free event reconnaissance agent to be able to detect each and every type of free event, and not even all occurrences of the types of free events it does detect. For example, a reconnaissance agent that only detects insertions of USB drives but does not detect any transmissions of network nodes, and additionally detects only insertions of USB drives into a first USB port but not into a second USB port of its hosting node, or randomly detects only 50% of the insertions of USB drives into USB ports of its hosting node, is still considered a free event reconnaissance agent.
66.“termination condition of a campaign”, “terminating condition of a campaign”, “halting condition of a campaign”, “stopping condition of a campaign”, “termination criterion of a campaign”, “terminating criterion of a campaign”, “halting criterion of a campaign”, or “stopping criterion of a campaign”—A Boolean condition defined for the campaign that if and when satisfied causes the halting of the campaign, even if the goal of the attacker of the campaign was not yet reached.
   For the sake of the above defined terms the singular and plural forms are equivalent—“criterion” and “criteria” are used interchangeably, and so are “condition” and “conditions”.
   The condition may be a simple condition (for example “the number of already compromised nodes in the tested networked system is five or more”) or a compound condition composed of multiple simple conditions and one or more logical operators (for example “a file named company budget.xls is exported out of the tested networked system from any network node, or at least ten files were encrypted by the attacker in the network node used by the organization's CFO”).
   A halting condition of a campaign can be defined for all types of penetration testing systems. For an actual attack penetration testing system, the halting condition is typically associated with the state or status of the tested networked system. For penetration testing systems that do not attempt to compromise the tested networked system, the halting condition is typically associated with a state or status of a simulation of the networked system or may be evaluated based on such state or status. However, the above is not limiting in any way, and the halting condition may depend on any factor that is available to the penetration testing system during the campaign, including on factors that are independent of the state and the status of the campaign, for example on the amount of time spent on running the campaign or on the time of day.
   A halting condition may be either a direct halting condition or an indirect halting condition.
67.“damaging a file”—Changing the file in a way that the file cannot be recovered to its original form without having extra information. Examples of specific ways of damaging a file are (i) deleting the file, (ii) removing the first 100 bytes of the file, (iii) changing the order of bytes in the file (without removing any of them), (iv) encrypting the file using a secret key, etc.
   Note that changing the access rights of a file is not considered damaging the file.
68.“damaging a network node”—Carrying out an operation related to the network node that is not allowed by the owner of the network node and that causes a change of state in the network node or in some resource related to the network node.
   Examples of operations damaging a network node are: (i) damaging a file residing in the network node, (ii) exporting a file (or a portion of it) residing in the network node out of the network node, (iii) shutting down the network node, (iv) shutting down or disabling a service provided by the network node, or (v) closing or disabling a software application executing in the network node.
69.“explicitly selecting”—Directly and clearly selecting, by a human user, of one option out of multiple options available to the human user, leaving no room for doubt and not relying on making deductions by a computing device.
   Examples of explicit selections are (i) selection of a specific type of an attacker from a drop-down list of types, (ii) selection of specific one or more attacker capabilities by marking one or more check boxes in a group of multiple check boxes corresponding to multiple attacker capabilities, and (iii) reception for viewing by a user of a recommendation automatically computed by a computing device for a value of an information item and actively approving by the user of the recommendation for using the value, provided that the approving user has an option of rejecting the recommendation and selecting a different value for the information item.
   Examples of selections that are not explicit selections are (i) selection of specific one or more attacker capabilities by selecting a specific scenario of a penetration testing system from a pre-defined library of scenarios, where the specific scenario includes an attacker having the one or more capabilities, and (ii) selection of specific one or more attacker capabilities by selecting a specific goal of an attacker, accompanied by a deduction by a computing device concluding that the specific one or more attacker capabilities must be selected because they are essential for the attacker to succeed in meeting the specific goal.
70.“automatically selecting”—Selecting, by a computing device, of one option out of multiple options, without receiving from a human user an explicit selection of the selected option. It should be noted that the selecting of an option is an automatic selecting even if the computing device is basing the selection on one or more explicit selections by the user, as long as the selected option itself is not explicitly selected by the user. It should also be noted that receiving from a user of an approval for a recommendation which is otherwise automatically selected without giving the user an ability to override the recommendation does not make the selection a non-automatic selection.
   An example of an automatic selection is a selection by a computing device of one or more attacker capabilities by (a) receiving from a user an explicit selection of a specific scenario of a penetration testing system from a pre-defined library of scenarios, (b) determining by the computing device that the specific scenario includes an attacker having the one or more capabilities, and (c) deducing by the computing device that the user wants to select the one or more attacker capabilities.
   An example of a selection that is not an automatic selection is a selection of a value for an information item by (a) calculating by a computing device of a recommended value for the information item, (b) displaying the recommendation to a user, and (c) receiving from the user an explicit approval to use the recommended value of the information item, provided that the approving user has an option of rejecting the recommendation and selecting a different value for the information item.
71.“defensive application”—A software application whose task is to defend the network node in which it is installed against potential attackers. A defensive application may be a passive defensive application, in which case it only detects and reports penetration attempts into its hosting network node but does not attempt to defend against the detected attacks. Alternatively, a defensive application may be an active defensive application, in which case it not only detects penetration attempts into its hosting network node but also attempts to defend its hosting node against the detected attacks by activating at least one counter-measure.
72.“macro language”—A programming language which is embedded inside a software application (e.g., inside a word processor or a spreadsheet application). A software application in which a macro language is embedded is said “to support the macro language”, and is a “macro-supporting software application”.
73.“macro”—A sequence of commands written in a macro language.
74.“auto-executing macro”—A macro that is embedded inside a given file, is written in a macro language that is embedded inside a given software application, and is automatically executed whenever the given file is opened by the given software application. A file in which an auto-executing macro is embedded is said “to contain the auto-executing macro”.
75.“macro-based security vulnerability” or “opportunistic security vulnerability” or “macro-based vulnerability”—A security vulnerability of a network node which requires execution of an auto-executing macro in the network node in order to cause the network node to become compromised.
76.“macro-based attack”—An attack of a network node attempting to exploit a macro-based security vulnerability.
77.“selecting a link”—Making an operation by a user that causes following the link to a destination pointed to by the link. Typically, selecting a link is achieved by pointing a visible cursor to the link and clicking a button on a pointing device (e.g. a mouse). However, there are other ways of selecting a link, for example by moving a selection indicator until the link is marked as selected and then hitting a selection button (e.g. an “Enter” button in a keyboard or an “OK” button in a remote-control device).
78.“user interface”—A man-machine interface that does at least one of (i) providing information to a user, and (ii) receiving input from the user. Towards this end, any user interface includes at least one of (i) an input device (e.g. touch-screen, mouse, keyboard, joystick, camera) for receiving input from the user, and (ii) an output device (e.g. display screen such as a touch-screen, speaker) for providing information to the user. A user interface typically also includes executable user-interface code for at least one of (i) causing the output device to provide information to the user (e.g. to display text associated with radio-buttons or with a check list, or text of a drop-down list) and (ii) processing user-input received via the input device.
   In different examples, the executable code may be compiled-code (e.g. in assembly or machine-language), interpreted byte-code (e.g. Java byte-code), or browser-executed code (e.g. JavaScript code) that may be sent to a client device from a remote server and then executed by the client device.
79.“user interface of a computing device”—A user interface that is functionally attached to the computing device and serves the computing device for interacting with the user.
   An input device of a user interface of a computing device may share a common housing with the computing device (e.g. a touch-screen of a tablet), or may be physically separate from the computing device and be in communication with it, either through a physical port (e.g. a USB port) or wirelessly (e.g. a wireless mouse).
   An output device of a user interface of a computing device may share a common housing with the computing device (e.g. a touch-screen of a tablet), or may be physically separate from the computing device and be in communication with it, either through a physical port (e.g. an HDMI port) or wirelessly.
   User-interface code of a user interface of a computing device is stored in a memory accessible to the computing device and is executed by one or more processors of the computing device. In one example related to web-based user interfaces, at least some of this code may be received from a remote server and then locally executed by the computing device which functions as a client. In another example related to locally-implemented user interfaces, all of the user-interface code is pre-loaded onto the computing device.
80.“setting a campaign to be based on a pre-defined scenario”—Selecting the values of the information items of the campaign at least partially according to the corresponding values of the information items of the pre-defined scenario. The setting includes assigning to every information item of the campaign the value of the corresponding information item of the pre-defined scenario. Optionally, after the assigning, the setting may further include manually overriding and changing one or more of the assigned values of the information items of the campaign.
81.“random selection”—A selection that depends on a random or pseudo-random factor. Different possible outcomes in a random selection do not necessarily have the same probabilities to be selected.
82.“opportunistic security vulnerability” or “opportunistic vulnerability”—A security vulnerability that becomes available to attackers only after an occurrence of a specific event. In many cases an opportunistic security vulnerability remains available to attackers only for a limited time interval, and once that time interval is over, the vulnerability is no longer available to them. However, in some cases an opportunistic vulnerability remains available to attackers with no time limit.
   In some cases the availability of the vulnerability to the attackers is created by the occurrence of the event, for example when a transmission of a WPAD network message creates the weakness making an attack possible. In other cases, the availability of the vulnerability to attackers is not created by the occurrence of the event. The vulnerability exists beforehand and the occurrence of the event only makes it known to the attackers. For example, an event of inserting a USB drive into a network node when that USB drive was previously inserted into an already compromised node only exposes a method for compromising the network node but does not change or create anything in the networked system.
   A specific event that triggers the availability of a specific opportunistic vulnerability is said to be an event “associated with” that specific opportunistic vulnerability, and the specific opportunistic vulnerability is said to be an opportunistic vulnerability “associated with” that specific event.
   A specific event that triggers the availability of a specific opportunistic vulnerability may trigger that availability unconditionally. That is—the specific opportunistic vulnerability will become available to attackers following every occurrence of the specific event. However, it may also be the case that the specific event might sometimes trigger the specific opportunistic vulnerability and sometimes not trigger it, depending on some condition. For example, an event of submitting a query to web server in the networked system may or may not cause a vulnerability of being “poisoned” by a malicious HTML answer page, depending on the condition of whether that web server is currently compromised by the attacker or not. An event is said to be associated with an opportunistic vulnerability and an opportunistic vulnerability is said to be associated with an event if the event may trigger the opportunistic vulnerability, regardless if the triggering relation is conditional or unconditional. In the first case we say that the event is “unconditionally associated” with the opportunistic vulnerability, and in the second case we say that the event is “potentially associated” or “conditionally associated” with the opportunistic event. As a result of the above, detecting an event that is associated with an opportunistic vulnerability does not necessarily imply that the vulnerability will be available to the attacker in a future occurrence of the event. In order to conclude that the opportunistic vulnerability will indeed be available to the attacker for a future occurrence of the event, it must be determined that the condition enabling the triggering of the vulnerability by the event (if such exists) is satisfied.
   A time interval during which a specific opportunistic vulnerability is available to attackers (if such limiting time interval exists for that specific opportunistic vulnerability) is said to be a time interval “associated with” that specific opportunistic vulnerability.
   A time interval associated with an opportunistic vulnerability may be of a fixed length for all occurrences of the event associated with that opportunistic vulnerability, or it may have different length in different occurrences of the associated event and be terminated by the occurrence of another event that makes the use of the vulnerability to attackers no longer possible. An example of the latter case is the vulnerability created by sending an ARP request message, in which case a response to the message by an ARP reply message sent by the true addressee of the request closes the window of opportunity for attackers to exploit the ARP spoofing vulnerability created by sending the ARP request message. It should be noted that it is not always the case that a time interval associated with an opportunistic vulnerability that is terminated by a terminating event will actually be terminated by the terminating event in a specific occurrence of the opportunistic vulnerability—in the above ARP message example it might happen that no valid ARP reply message is ever received and the window of opportunity for attackers remains open for a long time (most probably until a timeout mechanism in the network node that sent the ARP request message terminates the wait for a reply, thus closing the window of opportunity).
   Examples of opportunistic vulnerabilities are the above mentioned ability of an attacker to take advantage of a sending of an ARP request message by a network node for executing an ARP spoofing attack, the ability of an attacker to take advantage of a sending of a WPAD message by a network node for executing a session-hijacking attack, and the ability of an attacker to take advantage (under certain conditions) of an insertion of a USB removable storage device into a network node for compromising the network node.
83.“opportunistic reconnaissance agent”—A reconnaissance agent that is capable of detecting and reporting occurrences of at least one event occurring in a network node in which it is installed that is associated with an opportunistic vulnerability.
84.“subset/subgroup of a given set/group” or “sub-set/sub-group of a given set/group”—A set/group that satisfies the condition that that every member of it is also a member of the given set/group. Unless otherwise stated, a subset/subgroup may be empty and contain no members at all. Unless otherwise stated, a subset/subgroup of a given set/group may contain all the members of the given set/group and be equal to the given set/group.
85.“proper subset/subgroup of a given set/group” or “proper sub-set/sub-group of a given set/group”—A subset/subgroup of the given set/group that is not equal to the given set/group. In other words, there is at least one member of the given set/group that is not a member of the subset/subgroup.
86.“or”—A logical operator combining two Boolean input conditions into a Boolean compound condition, such that the compound condition is satisfied if and only if at least one of the two input conditions is satisfied. In other words, if condition C=condition A or condition B, then condition C is not satisfied when both condition A and condition B are not satisfied, but is satisfied in each of the following cases: (i) condition A is satisfied and condition B is not satisfied, (ii) condition A is not satisfied and condition B is satisfied, and (iii) both condition A and condition B are satisfied.
87.“one of A and B”—If A and B are specific items, then “one of A and B” is equivalent to “only A or only B, but not both”. For example, “one of John and Mary” is equivalent to “only John or only Mary, but not both John and Mary”. If A and B are categories, then “one of A and B” is equivalent to “only one of A or only one of B, but not both one of A and one of B”. For example, “one of a dog and a cat” is equivalent to “only one dog or only one cat, but not both one dog and one cat”. Similarly, if A and B are specific items, then “at least one of A and B” is equivalent to “only A or only B, or both A and B”. For example, “at least one of John and Mary” is equivalent to “only John or only Mary, or both John and Mary”. If A and B are categories, then “at least one of A and B” is equivalent to “only at least one of A or only at least one of B, or both at least one of A and at least one of B”. For example, “at least one of a dog and a cat” is equivalent to “only at least one dog or only at least one cat, or both at least one dog and at least one cat”.
   Note that in “one of dogs and cats”, “dogs” and “cats” are not categories but specific groups (i.e. specific items). Therefore, “one of dogs and cats” is equivalent to “only dogs or only cats, but not both dogs and cats” Similarly, “at least one of dogs and cats” is equivalent to “only dogs or only cats, or both dogs and cats”.
   If A, B and C are specific items, then “one of A, B and C” is equivalent to “only A or only B or only C, but not a combination of two or three members of the group consisting of: A, B and C”, and “at least one of A, B and C” is equivalent to “only A or only B or only C, or any combination of two or three members of the group consisting of: A, B and C”.
   If A, B and C are categories, then “one of A, B and C” is equivalent to “only one of A or only one of B or only one of C, but not a combination of two or three members of the group consisting of: one of A, one of B and one of C”, and “at least one of A, B and C” is equivalent to “only at least one of A or only at least one of B or only at least one of C, or any combination of two or three members of the group consisting of: one of A, one of B and one of C”. If the list following the “one of” or the “at least one of” contains more than three members, then the previous definitions are again applicable, with the appropriate modifications that extrapolate the above logic.
   Note that “one or more of” is equivalent to “at least one of”, and the two terms are synonyms.

### CONCLUDING COMMENT

All references cited herein are incorporated by reference in their entirety. Citation of a reference does not constitute an admission that the reference is prior art. It is further noted that any of the embodiments described above may further include receiving, sending or storing instructions and/or data that implement the operations described above in conjunction with the figures upon a computer readable medium. Generally speaking, a computer readable medium (e.g. non-transitory medium) may include storage media or memory media such as magnetic or flash or optical media, e.g. disk or CD-ROM, volatile or non-volatile media such as RAM, ROM, etc.

Having thus described the foregoing exemplary embodiments it will be apparent to those skilled in the art that various equivalents, alterations, modifications, and improvements thereof are possible without departing from the scope and spirit of the claims as hereafter recited. In particular, different embodiments may include combinations of features other than those described herein. Accordingly, the claims are not limited to the foregoing discussion.

1-124. (canceled)

125. A method of penetration testing of a networked system by a penetration testing system that is controlled by a user interface of a computing device so that a penetration testing campaign is executed according to manually and explicitly-selected sensitivity to detection of an attacker of the penetration testing campaign, the method comprising:
receiving, by the penetration testing system and via the user interface of the computing device, one or more manually-entered inputs, the one or more manually-entered inputs explicitly selecting a level of sensitivity to detection of the attacker of the penetration testing campaign;
executing the penetration testing campaign, by the penetration testing system and according to the manually and explicitly-provided selection of the level of sensitivity to detection of the attacker, so as to test the networked system; and
reporting, by the penetration testing system, at least one security vulnerability determined to exist in the networked system by the executing of the penetration testing campaign, wherein the reporting comprises at least one of (i) causing a display device to display a report describing the at least one security vulnerability, and (ii) electronically transmitting a report describing the at least one security vulnerability.

126. The method of claim 125, wherein before receiving the one or more manually-entered inputs that explicitly select the level of sensitivity to detection of the attacker, the penetration testing system automatically computes and displays an explicit recommendation for selecting the level of sensitivity to detection of the attacker.

127. The method of claim 126 wherein the received one or more manually-entered inputs comprises an explicit user approval of the explicit recommendation.

128. The method of claim 125, further comprising:
subsequent to the receiving by the penetration testing system of the one or more manually-entered inputs that explicitly select the level of sensitivity to detection of the attacker, receiving, by the penetration testing system and via the user interface of the computing device, one or more additional manually-entered inputs, the one or more additional manually-entered inputs explicitly selecting a value for a second information item of the penetration testing campaign, wherein the second information item is not a level of sensitivity to detection of the attacker.

129. The method of claim 128 wherein the executing of the penetration testing campaign is performed using both (i) the manually and explicitly selected value for the second information item, and (ii) the manually and explicitly selected level of sensitivity to detection of the attacker.

130. The method of claim 125 wherein the manual and explicit selection of the level of sensitivity to detection of the attacker is a selection between two pre-defined alternative levels.

131. The method of claim 125 wherein the manual and explicit selection of the level of sensitivity to detection of the attacker is a selection from a list of multiple pre-defined levels, the list containing at least three levels.

132. The method of claim 125 wherein the manual and explicit selection of the level of sensitivity to detection of the attacker is a selection in which any value from a pre-defined numerical interval may be selected.

133. A system for penetration testing of a networked system, the system comprising:
a. an attacker-sensitivity-selection user interface including one or more user interface components for manual and explicit selection of a level of sensitivity to detection of an attacker of a penetration testing campaign;
b. a penetration-testing-campaign module programmed to perform the penetration testing campaign whose attacker has the level of sensitivity to detection that is manually and explicitly selected via the attacker-sensitivity-selection user interface; and
c. a reporting module for reporting at least one security vulnerability determined to exist in the networked system according to results of the penetration testing campaign that is performed by the penetration-testing-campaign module, wherein the reporting module is configured to report the at least one security vulnerability by performing at least one of (i) causing a display device to display a report describing the at least one security vulnerability, and (ii) electronically transmitting a report describing the at least one security vulnerability.

134. The system of claim 133, further comprising a recommendation module configured to automatically compute an explicit recommendation for selecting the level of sensitivity to detection of the attacker, wherein the attacker-sensitivity-selection user interface displays the explicit recommendation.

135. The system of claim 134, wherein the manual and explicit selection of the level of sensitivity to detection of the attacker includes a manual and explicit approval of the explicit recommendation.

136. The system of claim 133, further comprising a second user interface including one or more user interface components for manual and explicit selection of a value of a second information item of the penetration testing campaign, the second information item being other than a level of sensitivity to detection of the attacker, wherein the system is configured to receive the manual and explicit selection of the value of the second information item subsequent to the manual and explicit selection of the level of sensitivity to detection.

137. The system of claim 136, wherein the penetration-testing-campaign module is configured, subsequent to the manual and explicit selection of both (i) the level of sensitivity to detection of the attacker and (ii) the value of the second information item, to perform the penetration testing campaign using both (i) the manually and explicitly selected level of sensitivity to detection of the attacker and (ii) the manually and explicitly selected value of the second information item.

138. The system of claim 133 wherein the manual and explicit selection of the level of sensitivity to detection of the attacker is a selection between two pre-defined alternative levels.

139. The system of claim 133 wherein wherein the manual and explicit selection of the level of sensitivity to detection of the attacker is a selection from a list of multiple pre-defined levels, the list containing at least three levels.

140. The system of claim 133 wherein the manual and explicit selection of the level of sensitivity to detection of the attacker is a selection in which any value from a pre-defined numerical interval may be selected.

141-242. (canceled)
